(19) United States
(12) Patent Application Publication
(10) Pub. No.: US 2026/0162459 A1
(43) Pub. Date: Jun. 11, 2026

(54) METHODS AND SYSTEMS FOR DETERMINING THE LIKELIHOOD OF ASSOCIATION OF A GRAPHIC CODE WITH A PERSON

(71) Applicant: FaceTec, Inc., Las Vegas, NV (US)

(72) Inventor: Kevin Alan TUSSY, Las Vegas, NV (US)

(73) Assignee: FaceTec, Inc., Las Vegas, NV (US)

(21) Appl. No.: 19/414,141

(22) Filed: Dec. 9, 2025

Related U.S. Application Data
(63) Continuation-in-part of application No. 19/318,287, filed on Sep. 3, 2025.
(63) Continuation-in-part of application No. 18/627,393, filed on Apr. 4, 2024.
(63) Continuation-in-part of application No. 18/627,421, filed on Apr. 4, 2024.
(60) Provisional application No. 63/457,085, filed on Apr. 4, 2023.
(60) Provisional application No. 63/457,085, filed on Apr. 4, 2023.
(60) Provisional application No. 63/690,249, filed on Sep. 3, 2024.
(60) Provisional application No. 63/729,923, filed on Dec. 9, 2024.

(51) Int. Cl. G06V 40/16; G06K 19/06; G06V 10/12; G06V 10/74; G06V 20/64; H04N 23/63

(52) U.S. Cl. CPC G06V 40/172; G06K 19/06037; G06V 10/12; G06V 10/761; G06V 20/64; G06V 40/166; H04N 23/632

(57) ABSTRACT

Determining a likelihood of a graphic code being associated with a person presenting the graphic code includes: causing a user interface to display all or a portion of a field of view of a first camera; while the graphic code is aligned within the displayed portion, capturing an image that includes the graphic code; extracting graphic-derived biometric data; causing the user interface to display all or a portion of a field of view of a second camera; capturing and processing at least one image that includes the face of the person presenting the graphic code to generate face-derived biometric data; comparing the graphic-derived biometric data to the face-derived biometric data and calculating a similarity value based on the comparison; and causing the similarity value or an indicator to be displayed, and/or provided to an entity requesting verification of an association between the graphic code and the person.

### CROSS-REFERENCES TO RELATED APPLICATIONS

This application claims the benefit of priority of U.S. Provisional Application No. 63/729,923, filed on Dec. 9, 2024, and is a continuation-in-part of U.S. application Ser. No. 19/318,287, filed on Sep. 3, 2025, which claims the benefit of priority to U.S. Provisional Application No. 63/690,249, filed on Sep. 3, 2024, and is a continuation-in-part of U.S. application Ser. No. 18/627,393, filed on Apr. 4, 2024, which claims the benefit of priority to U.S. Provisional Application No. 63/457,085, filed on Apr. 4, 2023, and is a continuation-in-part of U.S. application Ser. No. 18/627,421, filed on Apr. 4, 2024, which claims the benefit of priority to U.S. Provisional Application No. 63/457,085, filed on Apr. 4, 2023. The contents of all of the foregoing applications are incorporated herein by reference in their entirety.

### BACKGROUND

### 1. Field of the Invention

The disclosed embodiments relate to biometric security. More specifically, the disclosed embodiments relate to face matching verification systems.

### 2. Related Art

Online Identity Verification (IDV) has become an important component of modern digital interactions, yet the current methods often compromise user privacy and security. Traditional IDV systems require individuals to upload digital photographs of their government-issued identification cards or present physical documents to a camera. This process inevitably exposes sensitive Personally Identifiable Information (PII) to third-party Know-Your-Customer (KYC) vendors, entities that are typically for-profit and operate without oversight from the official identity-issuing authorities. In many cases, these vendors employ overseas human operators to manually inspect ID images, making subjective judgments about authenticity. This approach not only introduces significant vulnerabilities, such as large-scale fake ID fraud, but also erodes trust by placing user identities in the hands of unregulated intermediaries. The result is a broken trust model that leaves identity issuers, relying parties, and end-users eager for a more secure and privacy-preserving solution.

Biometric e-Passports are other identification mechanisms that would benefit from improved identity verification processes. These passports incorporate Near Field Communication (NFC) chips that store a digital copy of the holder's facial image along with a tamper-proof digital signature. While this technology offers strong cryptographic security, its adoption has been limited to passports and has not extended to other forms of identification, such as driver's licenses. NFC chips present usability challenges, require specialized readers, suffer from durability concerns, and impose prohibitive manufacturing and deployment costs. These barriers prevent widespread implementation, leaving the market without a scalable solution that combines security, affordability, and convenience. Accordingly, there is a need for reliable, cost-effective, and convenient methods to verify or confirm the identity of a person and/or associate the person with an item or document.

### SUMMARY

In some embodiments a method for determining the likelihood of a graphic code being associated with a person presenting the graphic code is provided, the method comprising: causing a user interface displayed on a screen of a computing device to display all or a portion of a first camera feed from a first camera associated with the computing device, the displayed first camera feed including all or a portion of a field of view of the first camera; while the graphic code is aligned within the displayed portion of the field of view of the first camera, capturing, from the first camera feed, an image that includes the graphic code or data representing the graphic code; extracting, from the captured image, graphic-derived data that includes graphic-derived biometric data, the graphic-derived biometric data generated from one or more images of a face of a person associated with the graphic code; causing the user interface to display on the screen of the computing device all or a portion of a second camera feed from a second camera associated with the computing device, the displayed second camera feed including all or a portion of a field of view of the second camera, wherein the second camera is different from the first camera or is the first camera; while a face of the person presenting the graphic code is aligned within the displayed portion of the field of view of the second camera, capturing, from the second camera feed, one or more images that include the face of the person presenting the graphic code; processing at least one of the one or more images including the face of the person presenting the graphic code to generate face-derived biometric data; comparing the graphic-derived biometric data to the face-derived biometric data; responsive to the comparing, calculating a similarity value between the graphic-derived biometric data and the face-derived biometric data, wherein the similarity value defines a likelihood that the graphic code is associated with the person presenting the graphic code; and responsive to calculating the similarity value, performing at least one of: causing the similarity value or an indicator based on the similarity value to be displayed on the screen of the computing device, or providing the similarity value or the indicator based on the similarity value to an entity requesting verification of an association between the graphic code and the person presenting the graphic code.

In some embodiments a system for determining the likelihood of a graphic code being associated with a person presenting the graphic code is provided, the system comprising: a display for displaying a user interface on a user device; and a processor configured to cause the system to: cause a user interface displayed on a screen of a computing device to display all or a portion of a first camera feed from a first camera associated with the computing device, the displayed first camera feed including all or a portion of a field of view of the first camera; while the graphic code is aligned within the displayed portion of the field of view of the first camera, capture, from the first camera feed, an image that includes the graphic code or data representing the graphic code; extract, from the captured Image, graphic-derived data that includes graphic-derived biometric data, the graphic-derived biometric data generated from one or more images of a face of a person associated with the graphic code; cause the user interface to display on the screen of the computing device all or a portion of a second camera feed from a second camera associated with the computing device, the displayed second camera feed including all or a portion of a field of view of the second camera, wherein the second camera is different from the first camera or is the first camera; while a face of the person presenting the graphic code is aligned within the displayed portion of the field of view of the second camera, capture, from the second camera feed, one or more images that include the face of the person presenting the graphic code; process at least one of the one or more images including the face of the person presenting the graphic code to generate face-derived biometric data; compare the graphic-derived biometric data to the face-derived biometric data; responsive to the comparing, calculate a similarity value between the graphic-derived biometric data and the face-derived biometric data, wherein the similarity value defines a likelihood that the graphic code is associated with the person presenting the graphic code; and responsive to calculating the similarity value, perform at least one of: causing the similarity value or an indicator based on the similarity value to be displayed on the screen of the computing device, or providing the similarity value or the indicator based on the similarity value to an entity requesting verification of an association between the graphic code and the person presenting the graphic code.

In some embodiments, a non-transitory computer-readable medium storing instructions which, when executed by at least one processor, cause the at least one processor to perform a method for determining the likelihood of a graphic code being associated with a person presenting the graphic code is provided, the method comprising: causing a user interface displayed on a screen of a computing device to display all or a portion of a first camera feed from a first camera associated with the computing device, the displayed first camera feed including all or a portion of a field of view of the first camera; while the graphic code is aligned within the displayed portion of the field of view of the first camera, capturing, from the first camera feed, an image that includes the graphic code or data representing the graphic code; extracting, from the captured image, graphic-derived data that includes graphic-derived biometric data, the graphic-derived biometric data generated from one or more images of a face of a person associated with the graphic code; causing the user interface to display on the screen of the computing device all or a portion of a second camera feed from a second camera associated with the computing device, the displayed second camera feed including all or a portion of a field of view of the second camera, wherein the second camera is different from the first camera or is the first camera; while a face of the person presenting the graphic code is aligned within the displayed portion of the field of view of the second camera, capturing, from the second camera feed, one or more images that include the face of the person presenting the graphic code; processing at least one of the one or more images including the face of the person presenting the graphic code to generate face-derived biometric data; comparing the graphic-derived biometric data to the face-derived biometric data; responsive to the comparing, calculating a similarity value between the graphic-derived biometric data and the face-derived biometric data, wherein the similarity value defines a likelihood that the graphic code is associated with the person presenting the graphic code; and responsive to calculating the similarity value, performing at least one of: causing the similarity value or an indicator based on the similarity value to be displayed on the screen of the computing device, or providing the similarity value or the indicator based on the similarity value to an entity requesting verification of an association between the graphic code and the person presenting the graphic code.

### BRIEF DESCRIPTION OF THE DRAWINGS

The components in the Figures are not necessarily to scale, emphasis instead being placed upon illustrating the principles of the invention. In the Figures, like reference numerals designate corresponding parts throughout the different views.

FIG. 1 illustrates an example environment of use of the face matching and verification system, according to one exemplary embodiment.

FIG. 2 illustrates an example embodiment of a mobile device.

FIG. 3 illustrates exemplary software modules that are part of the mobile device and server.

FIG. 4 shows a method for performing face matching and/or verification according to one embodiment.

FIG. 5 shows a method for enrolling a user in a face matching verification system, according to one exemplary embodiment.

FIG. 6A and FIG. 6B show an example of movement of a mobile device about a user's face according to one exemplary embodiment.

FIG. 7A and FIG. 7B show an example of movement of a mobile device about a user's face according to one exemplary embodiment.

FIG. 8 shows a method of providing verification information in a face matching and/or verification system, according to one exemplary embodiment.

FIG. 9 shows a method of verifying verification credential in a face matching and/or verification system, according to one exemplary embodiment.

FIG. 10 illustrates an exemplary display showing a graphical and numeric feedback in a face matching and/or verification system.

FIG. 11A, FIG. 11B, and FIG. 11C illustrate exemplary video feedback displays corresponding to front-facing camera positions in a face matching and/or verification system.

FIG. 12A shows an exemplary video display feedback of a face matching and/or verification system where edge pixels on the sides of the display are stretched horizontally.

FIG. 12B shows a method of verifying liveness or three-dimensionality of a user utilizing pixel velocity analysis detection.

FIG. 13A and FIG. 13B Illustrate exemplary screen displays with face alignment indicators shown as an oval to serve as a guide as the user moves the mobile device closer to or away from their face.

FIG. 14 illustrates an exemplary mobile device display showing a graphical code entry interface with an imaging area.

FIG. 15 illustrates an example mobile device display showing a numeric and graphical code entry interface with an imaging area.

FIG. 16 shows a system for biometric identification using root identity information, according to an exemplary embodiment.

FIG. 17 shows a method for authenticating using a root identification system, according to one exemplary embodiment.

FIG. 18 shows a method of remotely establishing a biometric identity, according to one exemplary embodiment.

FIG. 19 shows a system of biometric verification using a blockchain, according to an exemplary embodiment.

FIG. 20 is a schematic of a computing or mobile device, such as one of the devices described above, according to one exemplary embodiment.

FIG. 21 illustrates a block diagram of an example system and environment of use.

FIG. 22 illustrates a flow chart providing an example method of operation.

FIG. 23 illustrates an exemplary photo identification card.

FIG. 24 illustrates a method for verification using biometric identification and a photo identification card.

FIG. 25 shows examples of validation of a photo identification card, according to an exemplary embodiment.

FIG. 26 shows an example of validation of a photo identification card, according to an exemplary embodiment.

FIG. 27 is an operational flow chart of an example method for creating the digital ID.

FIG. 28 illustrates an example screen display for the software used to capture the first image.

FIG. 29 illustrates an exemplary digital ID.

FIG. 30 illustrates an example screen display for photo ID type selection.

FIG. 31 illustrates an exemplary photo ID image capture screen display.

FIG. 32 illustrates an exemplary photo ID image acceptance screen.

FIG. 33 is an operational flow chart of an example method for a third party to verify the digital ID at the verification server.

FIG. 34 illustrates an exemplary digital ID upload screen presented by the verification server to the third party.

FIG. 35 illustrates an exemplary notification screen that may be provided to the third party.

FIG. 36A illustrates an exemplary embodiment of the various stages of facial image data processing during the creation of the face vector data suitable to be stored in a graphical code (graphic (UR™) code, for example), which represents facial biometric data.

FIG. 36B incorporates many of the same features as shown in FIG. 23 and includes a graphic code (e.g., graphic (UR™) code).

FIG. 36C is a high level overview of the graphical code as used during validation of a person's identity or an items'association with a person.

FIG. 37 illustrates and shows the process of FIG. 25 and also includes the step of scanning the back side of an ID, which includes the graphic code (e.g., graphic (UR™) code).

FIG. 38 illustrates an example embodiment of a graphical code generation system. FIG. 39 illustrates an example method of creating a graphical code which includes facial biometric data (e.g., graphic (UR™) code).

FIG. 40 illustrates an example embodiment of a system configured to process the graphical code and analyze the similarities between the graphical code and a face vector generated from an image of the person.

FIG. 41 is an operational flow diagram of an example method of verifying an association between document or other item having a code and the person associated with the document.

FIG. 42 is a block diagram of an example embodiment of a system configured to process the graphical code and analyze the similarities between the face vector stored in the graphical code with use of a trusted source and/or trusted source image or code.

FIG. 43 illustrates an operational flow chart of an example method of operation of verifying identity or association of an item bearing a graphic code using access to a trusted entity.

FIG. 44 illustrates an embodiment with an additional feature of a URL address to assist in the ID assurance process.

FIG. 45 illustrates a general block diagram of a neural network.

FIG. 46 is a block diagram that is representative of a node of FIG. 45.

FIG. 47 illustrates a flow chart of one exemplary method of facial image processing in connection with face vector generation and comparison using a neural network.

FIG. 48 illustrates a high-level overview of the creation and use for a graphical code that represents two or more people.

FIG. 49 illustrates an example method of operation for creation of a graphic code (e.g., UR™ code) based on two or more faces.

FIG. 50 illustrates a flow diagram of an example method of use of the graphic code (e.g., UR™ code) to verify the association of the document to the two or more people from which the graphic code (e.g., UR™ code) was created or otherwise, verify the association of the graphic code (e.g., UR™ code), independent of the document.

FIG. 51 illustrates an example embodiment of a graphic code that represents a person (e.g., UR™ code) or two or more people (e.g., 2UR code).

FIGS. 52A and 52B illustrate a block diagram flow chart of an example method of graphic code (e.g., UR™ code) creation and use.

FIG. 53 illustrates a functional flow chart of an example method of using a graphic code (e.g., UR™ code).

FIG. 54 illustrates exemplary content of a graphic code (e.g., UR™ code) data.

FIG. 55 is an illustration of exemplary user interfaces displayed on a user device, in accordance with some of the disclosed embodiments.

FIG. 56A illustrates a flowchart of an exemplary process for determining the likelihood of a graphic code (e.g., UR™ code) being associated with a person presenting the graphic code, in accordance with some of the disclosed embodiments.

FIG. 56B illustrates a flowchart of an exemplary process for determining the likelihood of a graphic code (e.g., UR™ code) being associated with a person presenting the graphic code, in accordance with some of the disclosed embodiments.

FIG. 56C illustrates a flowchart of an exemplary process for determining the likelihood of a graphic code (e.g., UR™ code) being associated with two ormore persons, in accordance with some of the disclosed embodiments.

FIGS. 57A-57I are exemplary illustrations of a user interface displayed on a user device, in accordance with some of the disclosed embodiments.

FIG. 58 illustrates stages encountered by a user, using a user device to determine the likelihood of a graphic code (e.g., UR™ code) being associated with a person, in accordance with some of the disclosed embodiments.

### DETAILED DESCRIPTION OF EMBODIMENTS

A system and method for providing secure and convenient face matching and/or verification will be described below. The system and method may be achieved without the need for additional expensive biometric readers or systems while offering enhanced security over conventional face matching systems.

Face matching and/or verification environment.

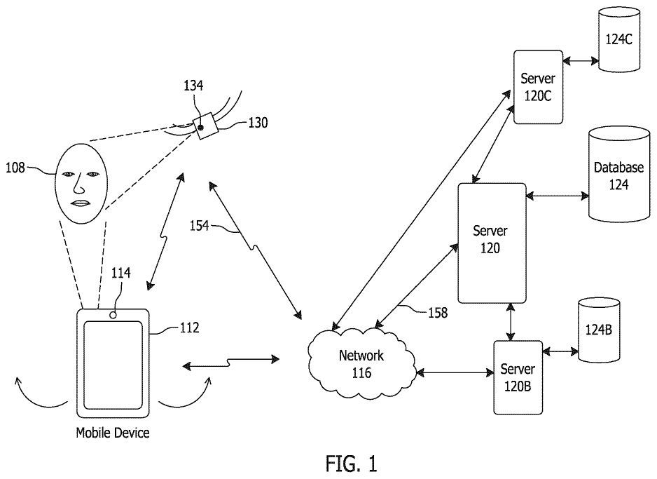

FIG. 1 illustrates an example environment of use of the face matching and/or verification system described herein. This is but one possible environment of use and system. It is contemplated that, after reading the specification provided below in connection with the figures, one of ordinary skill in the art may arrive at different environments of use and configurations.

In this environment, a user 108 may have a mobile device 112, which may be used to access one or more of the user's accounts via verification systems. A user 108 may have a mobile device 112 that can capture a picture of the user 108, such as an image of the user's face. The user may use a camera 114 on or connected to the mobile device 112 to capture an image or multiple images or video of himself or herself. The mobile device 112 may comprise any type of mobile device capable of capturing an image, either still or video, and performing processing of the image or communication over a network.

In this embodiment, the user 108 may carry and hold the mobile device 112 to capture the image. The user may also wear or hold any number of other devices. For example, the user may wear a watch 130 containing one or more cameras 134 or biosensors disposed on the watch. The camera 134 may be configured to create an image from visible light as well as infrared light. The camera 134 may additionally or alternatively employ image intensification, active illumination, or thermal vision to obtain images in dark environments.

When pointed towards a user 108, the camera 134 may capture an image of the user's face. The camera 134 may be part of a module that may either include communication capability that communicates with either a mobile device 112, such as via Bluetooth®, NFC, or other format, or communicate directly with a network 116 over a wired or wireless link 154. The watch 130 may include a screen on its face to allow the user to view information. If the camera module 134 communicates with the mobile device 112, the mobile device 134 may relay communications to the network 116. The mobile device 134 may be configured with more than one front-facing camera 114 to provide for a 3D or stereoscopic view, or to obtain images across different spectral ranges, such as near infrared and visible light.

The mobile device 112 is configured to wirelessly communicate over a network 116 with a remote server 120. The server 120 may communicate with one or more databases 124. The network 116 may be any type of network capable of communicating to and from the mobile device, including but not limited to a LAN (Local area network), WAN (Wide area network), PAN (Personal area network), or the Internet. The mobile device 112 may communicate with the network via a wired or wireless connection, such as via Ethernet, Wi-Fi, NFC, and the like. The server 120 may include any type of computing device capable of communicating with the mobile device 112. The server 120 and mobile device 112 are configured with a processor and memory, and are configured to execute machine-readable code or machine instructions stored in the memory.

The database 124, stored on the mobile device 112 or on a remote location as shown, may contain facial biometric information and verification information of users 108 to identify the users 108 to allow access to associated user data based on one or more images or biometric information received from the mobile device 112 or watch 134. The data may be, for example, information relating to a user account or instructions to allow access to a separate account information server 120B. The term biometric data may include, among other information, biometric information concerning facial features and path parameters. Examples of path parameters may include an acceleration and speed of the mobile device, angle of the mobile device during image capture, distance of the mobile device to the user, path direction in relation to the user's face position in relation to the user, or any other type parameter associated with movement of the mobile device or the user face in relation to a camera. Other data may also be included, such as GPS data, device identification information, and the like.

In this embodiment, the server 120 processes requests for identification from the mobile device 112 or the user 108. In one configuration, the image captured by the mobile device 112, using facial detection, comprises one or more images of the user's face 108 during movement of the mobile device relative to the user's face, such as in a side to side or horizontal arc or line, vertical arc or line, forward and backwards from the user's face, or any other direction of motion. In another configuration, the mobile device 112 calculates biometric information from the obtained images and sends the biometric information to the server 120. In yet another embodiment, the mobile device 112 compares biometric information with stored biometric information on the mobile device 112 and sends a verification result from the comparison to the server 120.

The data, including either the image(s), biometric information, or both, is sent over the network 116 to the server 120. Using image processing and image recognition algorithms, the server 120 processes the person's biometric information, such as facial data, and compares the biometric information with biometric data stored in the database 124 to determine the likelihood of a match. In other embodiments, the image processing and comparison are done on the mobile device 112, and data sent to the server indicates a result of the comparison. In further embodiments, the image processing and comparison are done on the mobile device 112 without accessing the server, for example, to obtain access to the mobile device 112 itself.

By using face match processing, an accurate identity match may be established. Based on this and optionally one or more other factors, access may be granted, or an unauthorized user may be rejected. Face match processing is known in the art (or is an established process) and, as a result, it is not described in detail herein.

Also shown is a second server 120B with associated second database 124B, and a third server 120C with associated third database 124C. The second and third databases may be provided to contain additional information that is not available on the server 120 and database 124. For example, one of the additional servers may only be accessed based on the verification of the user 108 performed by the server 120.

Executing on the mobile device 112 is one or more software applications. This software is defined herein as an identification application (ID app). The ID app may be configured with either or both facial detection and face matching, and one or more software modules that monitor the path parameters and/or biometric data. Facial detection, as used herein, refers to a process that detects a face in an image. Face matching, as used herein, refers to a process that can analyze a face using an algorithm, mapping its facial features, and converting them to biometric data, such as numeric data. The biometric data can be compared to that derived from one or more different images for similarities or dissimilarities. If a high percentage of similarity is found in the biometric data, the individual shown in the images may be considered a match.

With the ultimate goal of matching a face of a user to an identity or image stored in a database 124, to verify the user, the ID app may first process the image captured by the camera 114, 134 to identify and locate the face that is in the image. As shown in FIG. 1, there may be the face 108. The verification may be used for logging into an online account or for numerous other access control functions.

The portion of the photo that contains the detected face may then be cropped, cut, and stored for processing by one or more face matching algorithms. By first detecting the face in the image and cropping only that portion of the face, the face matching algorithm need not process the entire image. Further, in embodiments where the face matching processing occurs remotely from the mobile device 112, such as at a server 120, much less image data is required to be sent over the network to the remote location. It is contemplated that the entire image, a cropped face, or only biometric data may be sent to the remote server 120 for processing.

Facial detection software can detect a face from a variety of angles. However, face matching algorithms are most accurate in straight on images in well-lit situations. In one embodiment, the highest quality face image for face matching that is captured is processed first, then images of the face that are lower quality or at different angles other than straight toward the face are then processed. The processing may occur on the mobile device or at a remote server that has access to large databases of image data or facial identification data.

The facial detection is preferred to occur on the mobile device and is performed by the mobile device software, such as the ID app. This reduces the number or size of images (data) that are sent to the server for processing, where faces are not found, and minimizes the overall amount of data that must be sent over the network. Thisreduces bandwidth needs, and network speed requirements are reduced.

In another preferred embodiment, the facial detection, face matching, and biometric comparison all occur on the mobile device. However, it is contemplated that the face matching processing may occur on the mobile device, the remote server, or both.

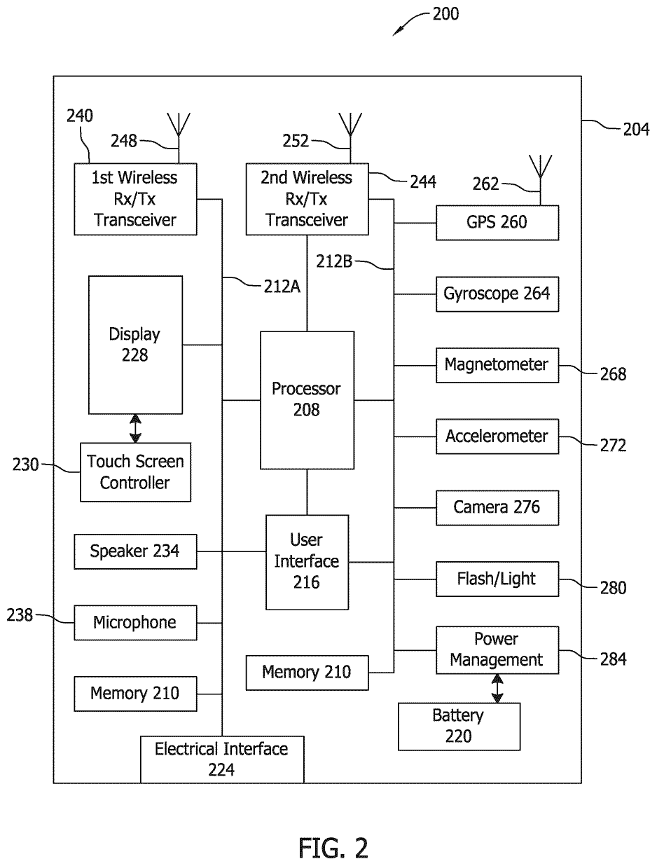

FIG. 2 illustrates an example embodiment of a mobile device. This is but one possible mobile device configuration, and as such, it is contemplated that one of ordinary skill in the art may differently configure the mobile device. The mobile device 200 may comprise any type of mobile communication device capable of performing as described below. The mobile device may comprise a PDA, cellular telephone, smart phone, tablet PC, wireless electronic pad, an loT device, a “wearable” electronic device, or any other computing device.

In this example embodiment, the mobile device 200 is configured with an outer housing 204 configured to protect and contain the components described below. Within the housing 204 is a processor 208 and a first and second bus 212A, 212B (collectively 212). The processor 208 communicates over the buses 212 with the other components of the mobile device 200. The processor 208 may comprise any type of processor or controller capable of performing as described herein. The processor 208 may comprise a general-purpose processor, ASIC (Application-Specific Integrated Circuits), ARM, DSP (Digital Signal Processing), controller, or any other type of processing device. The processor 208 and other elements of the mobile device 200 receive power from a battery 220 or other power source. An electrical interface 224 provides one or more electrical ports to electrically interface with the mobile device, such as with a second electronic device, computer, a medical device, or a power supply/charging device. The interface 224 may comprise any type of electrical interface or connector format.

One or more memories 210 are part of the mobile device 200 for storage of machine-readable code for execution on the processor 208 and for storage of data, such as image data, audio data, user data, medical data, location data, accelerometer data, or any other type of data. The memory 210 may comprise RAM (Random Access Memory), ROM (Read Only Memory), flash memory, optical memory, or micro-drive memory. The machine-readable code as described herein is non-transitory.

As part of this embodiment, the processor 208 connects to a user interface 216. The user interface 216 may comprise any system or device configured to accept user input to control the mobile device. The user interface 216 may comprise one or more of the following: keyboard, roller ball, buttons, wheels, pointer key, touch pad, and touch screen. A touch screen controller 230 is also provided, which interfaces through the bus 212 and connects to a display 228.

The display comprises any type of display screen configured to display visual information to the user. The screen may comprise an LED (Light-emitting diode), LCD (Liquid-crystal display), thin-film transistor screen, OEL (Organic Electroluminescent) CSTN (color super twisted nematic), TFT (thin-film transistor). TFD (thin-film diode), OLED (organic light-emitting diode), AMOLED (Active-Matrix Organic Light-Emitting Diode) display (active-matrix organic light-emitting diode), capacitive touch screen, resistive touch screen, or any combination of these technologies. The display 228 receives signals from the processor 208, and these signals are translated by the display into text and images as is understood in the art. The display 228 may further comprise a display processor (not shown) or controller that interfaces with the processor 208. The touch screen controller 230 may comprise a module configured to receive signals from a touch screen that is overlaid on the display 228.

Also part of this exemplary mobile device is a speaker 234 and a microphone 238. The speaker 234 and microphone 238 may be controlled by the processor 208. The microphone 238 is configured to receive and convert audio signals to electrical signals based on processor 208 control. Likewise, the processor 208 may activate the speaker 234 to generate audio signals. These devices operate as is understood in the art and, as such, are not described in detail herein.

Also connected to one or more of the buses 212 is a first wireless transceiver 240 and a second wireless transceiver 244, each of which connects to respective antennas 248, 252. The first and second transceivers 240, 244 are configured to receive incoming signals from a remote transmitter and perform analog front-end processing on the signals to generate analog baseband signals. The incoming signal may be further processed by conversion to a digital format, such as by an analog-to-digital converter, for subsequent processing by the processor 208. Likewise, the first and second transceivers 240, 244 are configured to receive outgoing signals from the processor 208, or another component of the mobile device 208, and up-convert these signals from baseband to RF frequency (Radio Frequency) for transmission over the respective antennas 248, 252. Although shown with a first wireless transceiver 240 and a second wireless transceiver 244, it is contemplated that the mobile device 200 may have only one such system or two or more transceivers. For example, some devices are tri-band or quad-band capable, or have Bluetooth®, NFC, or other communication capabilities.

It is contemplated that the mobile device, and hence the first wireless transceiver 240 and a second wireless transceiver 244 may be configured to operate according to any presently existing or future developed wireless standard including, but not limited to, Bluetooth, WI-FI such as IEEE 802.11a, b, g, n, wireless LAN, WMAN (Wireless Metropolitan Area Network), broadband fixed access, WIMAX, any cellular technology including CDMA (Code-Division Multiple Access), GSM (Global System for Mobile Communications), EDGE (Enhanced Data rates for GSM Evolution), 3G, 4G, 5G, TDMA (Time-division multiple access), AMPS (Advanced Mobile Phone System), FRS (Family Radio Service), GMRS (General Mobile Radio Service), citizen band radio, VHF (Very High Frequency), AM (Amplitude Modulation), FM (Frequency Modulation), and wireless USB (Universal Serial Bus).

Also part of the mobile device is one or more systems connected to the second bus 212B, which also interfaces with the processor 208. These devices include a global positioning system (GPS) module 260 with associated antenna 262. The GPS module 260 can receive and process signals from satellites or other transponders to generate location data regarding the location, direction of travel, and speed of the GPS module 260. GPS is generally understood in the art and hence not described in detail herein. A gyroscope 264 connects to the bus 212B to generate and provide orientation data regarding the orientation of the mobile device 204. A magnetometer 268 is provided to provide directional information to the mobile device 204. An accelerometer 272 connects to the bus 212B to provide information or data regarding shocks or forces experienced by the mobile device. In one configuration, the accelerometer 272 and gyroscope 264 generate and provide data to the processor 208 to indicate a movement path and orientation of the mobile device.

One or more cameras (still, video, or both) 276 are provided to capture image data for storage in the memory 210 and/or for possible transmission over a wireless or wired link or for viewing later. The one or more cameras 276 may be configured to detect an image using visible light and/or near-infrared light. The camera 276 may also be configured to utilize image intensification, active illumination, or thermal vision to obtain images in dark environments. The processor 208 may process image data to perform image recognition, such as in the case of, facial detection, item detection, face matching, item recognition, or bar/box code reading. (98) A flasher and/or flashlight 280, such as an LED light, is provided and is processor controllable. The flasher or flashlight 280 may serve as a strobe or traditional flashlight. The flasher or flashlight 280 may also be configured to emit near-infrared light. A power management module 284 interfaces with or monitors the battery 220 to manage power consumption, control battery charging, and provide supply voltages to the various devices that may require different power requirements.

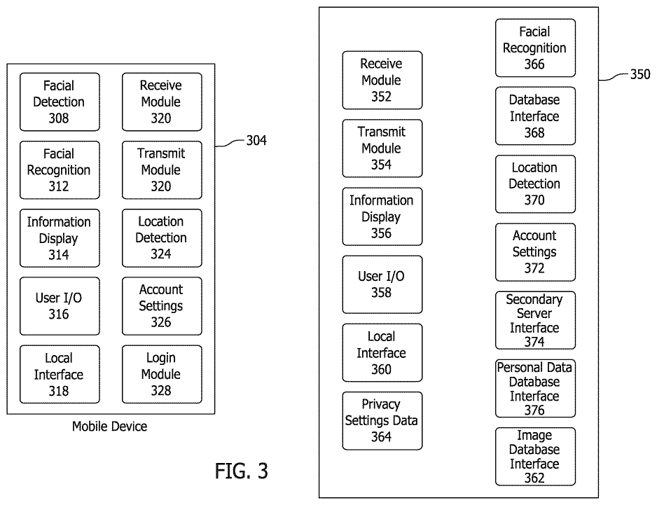

FIG. 3 illustrates exemplary software modules that are part of the mobile device and server. Other software modules may be provided to provide the functionality described below. It is provided that for the functionality described herein, there is matching software (non-transitory machine-readable code, machine executable instructions, or code) configured to execute the functionality. The software would be stored in a memory and executable by a processor.

In this example, the mobile device 304 includes a receive module 320 and a transmit module 322. These software modules are configured to receive and transmit data to remote devices, such as cameras, glasses, servers, cellular towers, or WIFI system, such as a router or access points.

Also part of the mobile device 304 is a location detection module 324 configured to determine the location of the mobile device, such as with triangulation or GPS. An account setting module 326 is provided to establish, store, and allow a user to adjust account settings. A log-in module 328 is also provided to allow a user to log in, such as with password protection, to the mobile device 304. A facial detection module 308 is provided to execute facial detection algorithms, while a face matching module 321 includes software code that recognizes the face or facial features of a user, such as to create numeric values that represent one or more facial features (facial biometric information) that are unique to the user.

An information display module 314 controls the display of information to the user of the mobile device. The display may occur on the screen of the mobile device or watch. A user input/output module 316 is configured to accept data from and display data to the user. A local interface 318 is configured to interface with other local devices, such as using Bluetooth® or other shorter-range communication, or wired links using connectors to connect cameras, batteries, data storage elements. All the software (with associated hardware) shown in the mobile device 304 operates to provide the functionality described herein.

Also shown in FIG. 3 is the server software module 350. These modules are located remotely from the mobile device but can be located on any server or remote processing element. As is understood in the art, networks and network data use a distributed processing approach with multiple servers and databases operating together to provide a unified server. As a result, it is contemplated that the module shown in the server block 350 may not all be locatedat the same server or at the same physical location.

As shown in FIG. 3, the server 350 includes a receive module 352 and a transmit module 354. These software modules are configured to receive and transmit data to remote devices, such as cameras, watches, glasses, servers, cellular towers, or WIFI systems, such as routers or access points.

An information display module 356 controls a display of information at the server 350. A user input/output module 358 controls a user interface in connection with the local interface module 360. Also located on the server side of the system is a face matching module 366 that is configured to process the image data from the mobile device. The face matching module 366 may process the image data to generate facial data (biometric information) and perform a comparison function in relation to other facial data to determine a facial match as part of an identity determination.

A database interface 368 enables communication with one or more databases that contain information used by the server modules. A location detection module 370 may utilize the location data from the mobile device 304 for processing and to increase accuracy. Likewise, an account settings module 372 controls user accounts and may interface with the account settings module 326 of the mobile device 304. A secondary server interface 374 is provided to interface and communicate with one or more other servers.

One or more databases or database interfaces are provided to facilitate communication with and searching of databases. In this example embodiment, the system includes an image database that contains images or image data for one or more people. This database interface 362 may be used to access image data for users as part of the identity match process. Also part of this embodiment is a personal data database interface 376 and a privacy settings data module 364. These two modules, 376, 364 operate to establish privacy settings for individuals and to access a database that may contain privacy settings.

### Verification System

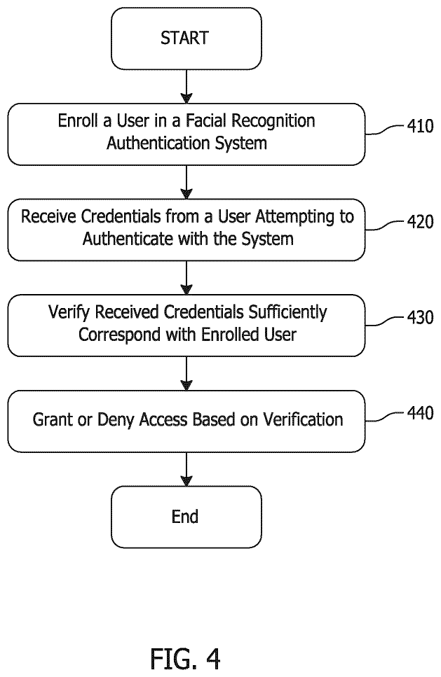

A verification system with path parameters that is operable in the above-described environment and system will now be described as shown in FIG. 4. FIG. 4 shows a method for performing face matching verification with path parameters according to one embodiment of the invention. As will be described in more detail below, the system utilizes the features of the mobile device 112 and server 120 defined above to generate a secure and convenient login system as one example of a verification system. This reduces the burden of the user having to type in complex passwords onto a small screen of a mobile device, prevents fraud through means such as key logging or screenshot captures, and increases security by combining several path parameters and/or device parameters that must be met before a user is verified.

In step 410, the system enrolls a user in the face matching and/or verification system. In one embodiment, a verification server, such as the server 120 (FIG. 1), may be configured to verify identity or a match to an earlier photo of the user to allow access to a user's account, such as a bank or other account, via the mobile device 112. The verification server 120 may be included as a part of a server of the institution or entity providing user accounts (hereinafter “account server”), or the verification server may be provided separately. For example, in the environment shown in FIG. 1, servers 120B and 120C may represent account servers. In other embodiments, the account server and the verification server are one in the same. In one embodiment, the verification server 120 may provide a verification application to the user for installation on the mobile device 112.

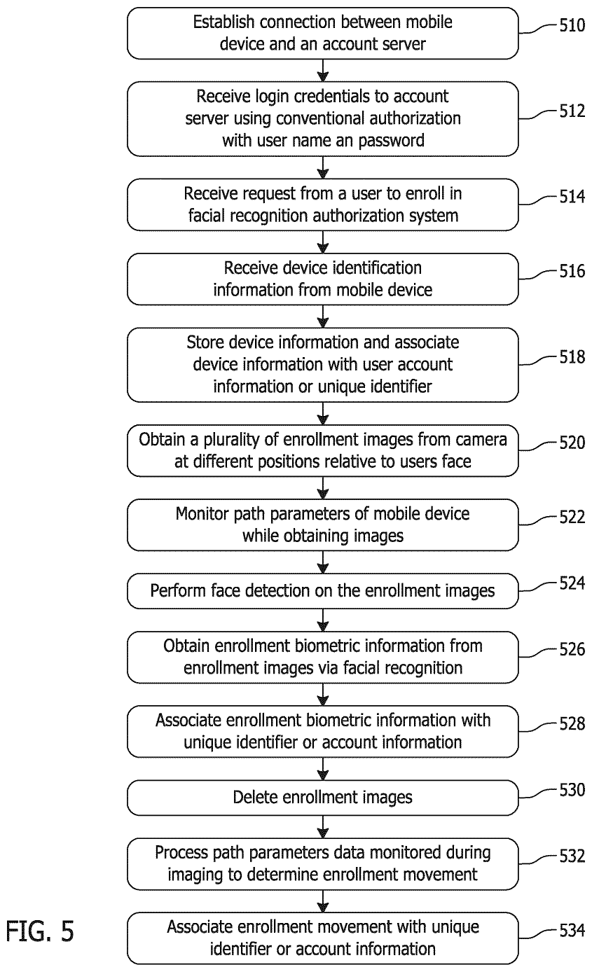

An enrollment process, according to one embodiment, will be described with reference to FIG. 5. In this embodiment, a user via a mobile device 112 establishes a connection between the mobile device 112 and the account server 120B in step 510. As just one example, the user may establish a connection with a server of a financial institution, such as a bank, or this connection may occur later in the process after verification. The user then provides typical login information to verify the user, such as a username and password for a financial account, in step 512. In step 514, the user may next receive a prompt at the mobile device 112 to enroll in the face matching and/or verification system. The user then, via the user interface, indicates that he or she would like to set up the verification System in response to the prompt.

Next, in step 516, the mobile device 112 may send device informationto the verification server 120. The device information may include, among other information, a device identifier that uniquely identifies the mobile device of the user. Such information may include device manufacturer, model number, serial number, and mobile network information. In step 518, when the verification server 120 is incorporated with the account server 120B, the verification server 120 associates and stores the device information with the user's account information. When the verification server 120 is separate from the account server 120B, the account server 120B may generate a unique identifier related to the account information and send the unique identifier to the verification server 120. The verification server 120 may associate the device information and the unique identifier with each other and may store the information in a database 124.

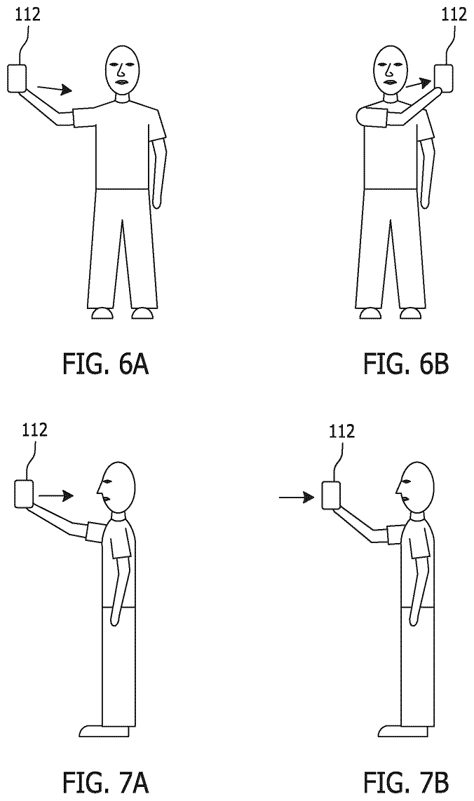

The user is next prompted to provide a plurality of images of his or her face using a camera 114 on the mobile device 112 (hereinafter, “enrollment images”) in step 510. The enrollment images of the user's face are taken as the user holds the mobile device and moves the mobile device to different positions relative to his or her head and face. Thus, the enrollment images of the user's face are taken from many different angles or positions. Furthermore, the path parameters of the mobile device are monitored and recorded for future comparison in step 522. Some non-limiting examples of how a user might hold a mobile device and take a plurality of images of her face are shown in FIG. 6A through FIG. 7B.

In FIG. 6A and FIG. 6B, the user holds the mobile device 112 on one side of his or her face and moves the mobile device 112 in an arc-like path horizontally about his or her face until the mobile device 112 is on the other side of her or her face. In FIG. 7A and FIG. 7B, the user holds the mobile device 112 far away from his or her face, and then brings the mobile device 112 forward closer to his or her face. Of course, any number of other paths may be used in addition to those shown in FIGS. 6A through 7B. Additionally, the user may move his or her head while the camera is held fixed. The user could also hold the camera steady and move their head in relation to the camera. This method can thus be implemented with a webcam on a laptop or desktop, or on any other device, such as an loT device where a camera is mounted on a similarly stationary location or object.

The enrollment images may be obtained as follows. The user holds and orients a mobile device 112 with a camera 114 so that the camera 114 is positioned to image the user's face. For example, the user may use a front-facing camera 114 on a mobile device 112 with a display screen and may confirm on the display screen that his or her face is in position to be imaged by the camera 114.

Once the user has oriented the device, the device may begin obtaining the enrollment images of the user. In one embodiment, the user may press a button on the device 112, such as on a touchscreen or other button on the device, to initiate the obtaining of the enrollment images. The user then moves the mobile device to different positions relative to his or her head as the device images the user's face from a plurality of angles or positions as described above. When the above-mentioned front-facing camera is used, the user may continually confirm that his or her face is being imaged by viewing the imaging on the display screen. The user may again press the button to indicate that the imaging is completed. Alternatively, the user may hold the button during imaging and then release the button to indicate that imaging is complete.

As described above, the mobile device 112 may include face detection. In this embodiment, in step 524, the mobile device may detect the user's face in each of the enrollment images, crop the images to include only the user's face, and send, via a network, the images to the verification server 120. In step 526, upon receipt of the enrollment images, the verification server 120 performs face matching on the images to determine biometric information (“enrollment biometrics”) for the user. The verification server 120 may then associate the enrollment biometrics with the device information and the unique identifier (or account information) and store the biometric information in the database 124 in step 528. For added security, in step 530, the mobile device 112 and the verification server 120 may be configured to delete the enrollment images after the enrollment biometrics of the user are obtained.

In another embodiment, the mobile device 112 may send the images to the verification server 120 without performing face detection. The verification server 120 may then perform the face detection, facial recognition, and biometric information processing. In another embodiment, the mobile device 112 may be configured to perform the facial detection, facial recognition, and biometric processing, and then send the results or data resulting from the processing to the verification server 120 to be associated with the unique identifier or user account. This prevents sensitive personal data (images) from leaving the user's device. In yet another embodiment, the mobile device 112 may perform each of the above-mentioned steps, and the mobile device 112 may store the enrollment information without sending any of the enrollment biometrics or images to the server.

In one embodiment, the mobile device's gyroscope, magnetometer, and accelerometer are configured to generate and store data while the user moves the mobile device about his or her head to obtain the enrollment images (path parameters). The mobile device may process this data in step 532 to determine a path or arc in which the mobile device moved while the user imaged his or her face (“enrollment movement”). By using data from the accelerometer, magnetometer, and gyroscope, the system may check when a user is ready to begin scanning himself/herself, as well as determine the scan path. The data is thus used to determine when to start and stop the scan interval. The data may additionally include the time elapsed during scanning. This time may be measured from the user pressing the button to start and stop the imaging, or may be measured from the duration the button is held down while imaging, or during more movement, or to complete a sweep.

The enrollment movement of the mobile device 112 (which is data that defined the movement of the mobile device during image capture) may be sent to the verification server 120. The verification server 120 associates and stores the enrollment movement, the enrollment biometrics, the device information, and the unique identifier or account information. Alternatively, the data generated by the gyroscope, magnetometer, and accelerometer may be sent to the server 120, and the server 120 may process the data to determine the enrollment movement.

Thus, in the above-described embodiment, the enrollment information may thus comprise the device information, the enrollment biometrics, and the enrollment movement (based on movement of the mobile device 112).

Returning to FIG. 4, once enrollment is complete, the verification server 120 may later receive credentials from a user attempting to verify with the system, as shown in step 420. For example, a user may attempt to log in to a user account. When a user attempts to log in, instead of or in addition to providing typical account credentials such as user name and password, the user may again take a plurality of images or video of his or her face as the mobile device 112 is held in the hand and moved to different positions relative to the head (“verification images”) in the same manner as was done during enrollment (such as shown in FIG. 6A through FIG. 7B). In this manner, the user may provide the necessary images (the term images includes video as video is a succession of images) from many different angles and/or positions, and may provide path parameters of the device while obtaining the images (“verification movement”) to both confirm the identity of the user as well as the liveness and realness of that individual to ensure it is not a video, screen shot, or other representation of the person.

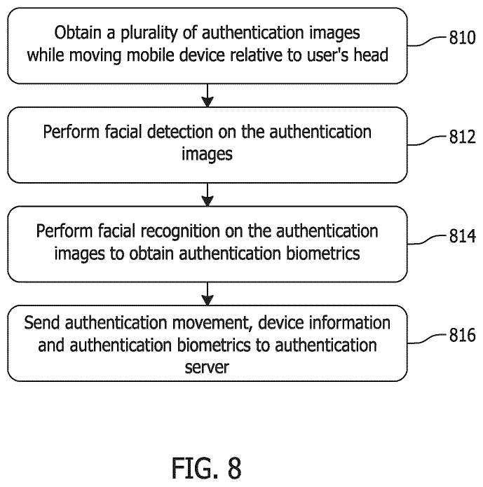

In one embodiment outlined in FIG. 8, the user, via the mobile device 112, obtains several verification images in step 810 while moving the mobile device 112 to different positions relative to the user's head. Using facial detection in step 812, the mobile device 112 detects the user's face in each of the verification images, crops the images, and sends the images to the verification server 120. In another embodiment, the mobile device 112 sends the images to the server 124, and the server 124 performs facial detection. In step 814, the verification routing 120 may perform face matching on the verification images to obtain biometric information (“verification biometrics”). In another embodiment, the mobile device 112 performs face matching to obtain the verification biometrics and sends the verification biometrics to the server 120.

In step 816, the mobile device 112 sends the device information identifying the device and sends path parameters such as gyroscope, magnetometer, and accelerometer information defining the path of the mobile device taken during imaging, as well as the elapsed time during imaging (“verification movement”) to the server 120. The credentials received by the verification server 120 for a login in the face matching system may thus comprise the device information, the verification images or the verification biometrics, and the verification movement (path parameters).

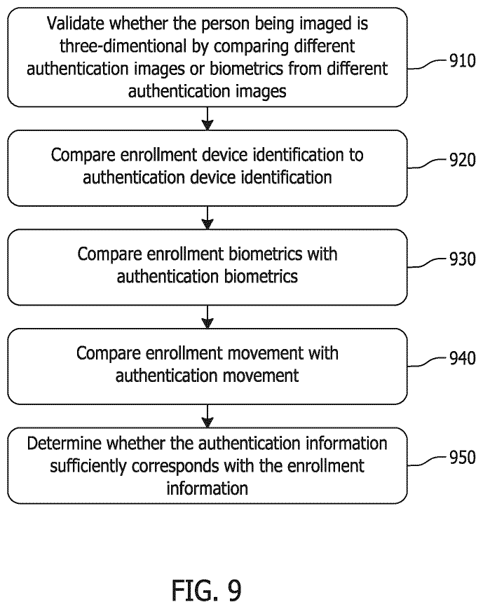

Returning to FIG. 4, in step 430, the verification server 120 verifies that the credentials received from the mobile device 112 sufficiently correspond with the information obtained during enrollment. For example, as shown in step 910 in FIG. 9, by using algorithms to process the characteristics of the face and light striking the face between the different images, the verification server 120 can determine that the face in the verification images is three-dimensional, i.e., not a representation on a printed picture or video screen. Where the mobile device 120 sends only the verification biometrics 120 to the server, the server 120 may validate the realness or three-dimensional aspects of the user imaged by comparing the biometric results of the different images.

In step 920, the verification server 120 may then compare the login credentials with the information stored from the enrollment process. In step 920, the server 120 compares the identification of the device obtained during the login process to that stored during enrollment. In step 930, the verification biometrics may be compared with the enrollment biometrics to determine whether they sufficiently correspond with the enrollment biometrics. In step 940, the verification movement may be compared with the enrollment movement to determine whether it sufficiently corresponds with the enrollment movement.

In some embodiments, a copy of the enrollment information may be stored on the mobile device 112, and the mobile device 112 may verify that the credentials received on the mobile device 112 sufficiently correspond with the enrollment information. This would allow a user to secure documents, files, or applications on the mobile device 112 itself, in addition to securing a user's account hosted on a remote device, such as the verification server 120, even when a connection to the verification server 120 may be temporarily unavailable, such as when a user does not have accessto the internet. Further, this would allow the user to secure access to the mobile device 112 itself. Or enrollment info may be stored on a server.

Accordingly, in step 950, if the verification server 120 or mobile device 112 determines that the enrollment information sufficiently corresponds with the credentials received, then the server or mobile device may verify that the identification of the user attempting login corresponds to the account holder. This avoids the cumbersome process of the user having to manually type in a complex password using the small screen of the mobile device. Many passwords now require capital, non-text letter, lower case, and numbers, The level of correspondence required to determine that the enrollment information sufficiently corresponds with the verification information in the login attempt may be set in advance. For example, the level of correspondence may be a 99.9% match rate between the enrollment biometrics and the verification biometrics, and a 90% match rate between the enrollment movement and the verification movement. The required level of correspondence may be static or elastic based on the established thresholds.

For example, the required level of correspondence may be based on GPS information from the mobile device 112. In one embodiment, the verification server 120 may require a 99,9% match rate as the level of correspondence when the GPS Information of the mobile device corresponds with the location of the user's home or other authorized location(s). In contrast, if the GPS information shows the device is in a foreign country far from the user's home, the verification server may require a 99.99% match rate as the level of correspondence or may be denied entirely. Hence, the required match between pre-stored verification data (enrollment information) and presently received verification data (verification information) is elastic in that the required percentage match between path parameters or images may change depending on various factors, such as time of day, location, frequency of login attempt, date, or any other factor.

The required level of correspondence may additionally depend on time. For instance, If a second verification attempt is made shortly after a first verification attempt in a location far from the first verification location, based on GPS information from the mobile device 112, the level of correspondence threshold may be set higher. For example, a user cannot travel from Seattle to New York in 1 hour. Likewise, login attempts from midnight to three in the morning may be a sign of fraud for some users based on patterns of the users'usage.

The level of correspondence between the enrollment information and the verification information may be the result of compounding the various parameters of the enrollment information and the verification information. For example, when the button hold time in the verification information is within 5% of the button hold time of the enrollment information, the correspondence of the button hold time may constitute 20% of the overall match. Similarly, when the motion path trajectory of the verification information is within 10% of the enrollment information, the motion path trajectory may constitute 20% of the overall match. Further parameter match rates, such as the face size and face matching, as compared to the enrollment information, may constitute the remaining 10% and 50% of the overall level of correspondence. In this manner, the total overall level of correspondence may be adjusted (total of all parameters being more than 75%, for example), or the match rate of individual parameters may be adjusted. For example, on a second attempted login, the threshold match rate of one parameter may be increased, or the overall level of correspondence for all parameters may be increased. The threshold match rates may also be adjusted based on the account being verified or other different desired levels of security.

Returning to FIG. 4, in step 440, the verification server 120 may grant or deny access based on the verification in step 430. For example, if the verification server 120 verifies that the credentials match the enrollment information, then the server 120 may verify the user to allow access to the user's account. In the instance where the verification server 120 is separate from the account server 120B (such as a bank's server), the verification server 120 may transmit the unique identifier to the account server along with an indication that the identity of the user associated with the unique identifier has been verified. The account server 120B may then authorize the user's mobile device 112 to transmit and receive data from the account server 120B. Of course, all this may occur at only the account server 120B or on the mobile device 112 itself.

Alternatively, if the credentials provided by the user are not verified, the verification server may transmit a message to display on the screen of the mobile device 112 indicating that the login attempt failed. The verification server 120 may then allow the user to try again to log in via the face matching login system, or the verification server 120 may require the user to enter typical account credentials, such as a username and password.

In one embodiment, the server 120 may allow three consecutive failed login attempts before requiring a username and password. If in one of the attempts, the required level of correspondence is met, then the user may be verified, and access may be granted. According to one embodiment, the verification server 120 may retain the information from each successive verification attempt and combine the data from the multiple verification attempts to achieve more accurate facial biometric information of the person attempting to be verified. In addition, the level of correspondence may be increased at each successive attempt to verify. In addition, by averaging the path data (verification movement) and/or image data (verification images/biometrics) from several login attempts, the login data (enrollment information) is perfected and improved.

Accordingly, the above-described verification system allows for verification to a remote server 120 or on the mobile device 112 itself. This may be accomplished as described above by the mobile device 112 capturing the verification credentials, and the verification server 120 processing and analyzing the credentials compared to the enrollment information (cloud processing and analysis); the mobile device 112 capturing the verification credentials and processing the credentials, and the verification server 120 analyzing the credentials compared to the enrollment information (mobile device processing, cloud analysis); or the mobile device 112 capturing the verification credentials, and processing and analyzing the credentials compared to the enrollment information (mobile device processing and analysis).

### Advantages And features of the Embodiments

The above-described system provides several advantages. As one advantage, the face matching and/or verification system provides a secure login. For example, if during a login attempt the camera of the mobile device imaged a digital screen displaying a person rotating their head while the phone was not moving, the accelerometer, magnetometer, and gyroscope data would not detect any motion. Thus, the enrollment movement and the verification movement would not correspond, and the login attempt would be denied.

In addition, because a plurality of images are used as enrollment images and verification images, histograms or other photo manipulation techniques may be used to determine if a digital screen is present in place of a human face in the images. For example, the system may check for light frequency changes in the captured images, or banding in an image which would indicate an electronic display generated the image, backlighting, suspicious changes in lighting, or conduct other analyses on the images by comparing the images to determine that the actual live user is indeed alive, present, and requesting authorization to log in.

As yet another advantage, as explained above, not only must the enrollment biometrics sufficiently correspond to the verification biometrics, but also the enrollment movement must match the verification movement, and the device information must match the enrollment device information. For example, an application may be downloaded to a mobile device that has a digital camera. The application may be a login application or may be an application from a financial institution or other entity with which the user has an account. The user may then log into the application using typical login credentials such as a website username and password. Further, the user may have a device code from logging in on another device or may use the camera to scan a QR (Quick Response) code or other such code to pair the device to their user account.

The user then holds the mobile device to move the mobile phone to different positions relative to his or her head while keeping his or her face visible to the camera as it is moved. As the mobile device is moved, the camera takes the enrollment images of the face. During imaging, the speed and angle of the current user's mobile device movement are measured using the accelerometer, magnetometer, and gyroscope to generate the enrollment movement. Further continuous imaging and detection of the face throughout the process has been shown to prevent fraud. This is because a fraud attempt cannot be made by rotating images in and out of the front of the camera.

For example, a user may start the movement from right to left or from left to right, as shown in FIG. 6A and FIG. 6B. The movement may also be in a front and back direction, as shown in FIG. 7A and FIG. 7B. Any other movement may be utilized, such as starting in the center, then going right, and then going back to the center. Vertical and diagonal movements may also be used to further compound the complexity of the enrollment movement. When the user then later attempts login, the user must repeat the motion pattern in the verification movement to match the enrollment movement, in addition to the biometric data and device information matching. Thus, the security of the system is greatly enhanced.

The system therefore provides enhanced security for authenticating a user who has a mobile device. As explained above, the systemmay use at least any one or more of the following in any number of combinations to securely verify the user: physical device verification, mobile network verification, face matching including the size of the face in the image, a face detected in every frame during the movement, accelerometer information, gyroscope information, magnetometer information, pixels per square inch, color bits per pixel, type of image, user entered code or pattern, and GPS information.

As another advantage, the face matching login system provides a convenient manner for a user to log in to an account with a mobile device. For example, once enrolled, a user does not need to enter a username and password on a small mobile device each time the user wishes to access the account. Instead, the user simply needs to image himself or herself while mimicking the enrollment movement with the mobile device. This is especially advantageous with smaller mobile devices such as mobile phones, smart watches, and the like.

The system may be further configured to allow a user to securely log on to multiple devices or to allow users to securely share devices. In one embodiment, the enrollment information may be stored on a verification server (or on “the cloud”) and thus is not associated only with the user's original device. This allows the user to use any number of suitable devices to verify with the verification server. In this manner, a user may use a friend's phone (third-party device) or other device to access his or her information, such as account information, address book information, email, or other messaging, etc. By performing the verification operation on any device.

For example, the user may provide an email address, username code, or similar identifier on the friend's phone such that the verification server compares the login information with enrollment information for the user's account. This would indicate to the verification server which verification profile to use, but does not by itself allow access to the user's data, accounts, or tasks. Upon logging out of a friend's phone, access to the user's information on the friend's phone is terminated. This provides the benefit of allowing a user to securely access an account or other verification accessible information or tasks using any device without having to type the user's password into the third-party device, where it could be logged or copied. In a sense, the user is the password.

Through cloud-based enrollment information, a single user may also securely transfer data between verified devices. In one embodiment, a user may own a first device, such as a mobile phone, and be verified on the first device via the verification system. The user may then acquire a new device, such as a new phone, tablet computer, or other device. Using the cloud-based verification system, the user may verify identity or image continuity on the new device and transfer data from the first device to the new device. The transfer of data may be completed via the internet, a local network connection, a Bluetooth connection, a wired connection, or near field communication. The verification process may also be part of a security check to resent or restore a system after the phone is lost or stolen. Thus, the verification system may be used to activate or verify a new device, with the verification used to verify the user of the new device.

Similarly, the system may facilitate secure access to a single shared device by multiple people to control content or other features on the device. In many cases, passwords can be viewed, copied, guessed, or otherwise detected, particularly when a device is shared by several users. The users may be, for example, family members including parents and children, coworkers, or other relationships, such as students. The verification system may allow each of the family members to log in based on his or her own unique enrollment information associated with a user account.

The device may restrict access to certain content or features for one or more of the certain user's accounts, such as children's user accounts, while allowing access to content and features for others, such as the parents'accounts. By using the verification system for the shared device, users, such as children, are unable to utilize a password to try and gain access to the restricted content because the verification system requires the presence of the parent for verification, as explained above. Thus, device sharing among users with different privileges is further secured and enhanced. Likewise, in a classroom setting, a single device may be securely shared between multiple people for testing, research, and grade reporting.

### Adaptations and Modifications

Numerous modifications may be made to the above system and method without departing from the scope of the invention. For example, the images may be processed by a face matching algorithm on the device and may also be converted to biometric data on the device, which is then compared to previously created biometric data for an authorized user. Alternatively, the images from a device may be sent through a wired or wireless network where the face matching algorithms running on a separate server can process the images, create biometric data, and compare that data against previously stored data that is assigned to that device.

### Multiple Profiles for a Single User

Further, the photo enrollment process may be done multiple times for a user to create multiple user profiles. For example, the user may enroll with profiles with and without glasses on, with and without other wearable devices, in different lighting conditions, wearing hats, with different hair styles, with or without facial or ear jewelry, or making different and unique faces, such as eyes closed, winking or tongue out to establish another level of uniqueness to each user profile. Such ‘faces’ made by the user would not be available on the user's social media pages and hence not available for copying, manipulation, and use during a fraud attempt. Each set of enrollment images, enrollment biometrics, or both may be saved along with separate enrollment movement. In one embodiment, at least three images are captured as the mobile device completes the path. It is contemplated that any number of images may be captured.

### Linking Enrollment Information

It is also contemplated that the enrollment process may be linked to an email address, phone number, or other identifier. For example, a user may sign up with an email address, complete one or more enrollments as described above, and confirm the enrollments via the same email address. The email address may then further enhance the security of the system. For example, if a user unsuccessfully attempts to log in via the verification system a predetermined number of times, such as three times, for example, then the verification system locks the account and sends an email to the email address informing the user of the unsuccessful login attempts. The email might also include one or more pictures of the person who failed to log in and GPS or other data from the login attempt. The user may then confirm whether this was a valid login attempt and reset the system, or the user may report the login attempt as fraudulent. If there is a reported fraudulent login or if there are too many lockouts, the system may delete the account associated with the email address to protect the user's security. Thus, future fraudulent attempts could not be possible.

### Feedback Meters

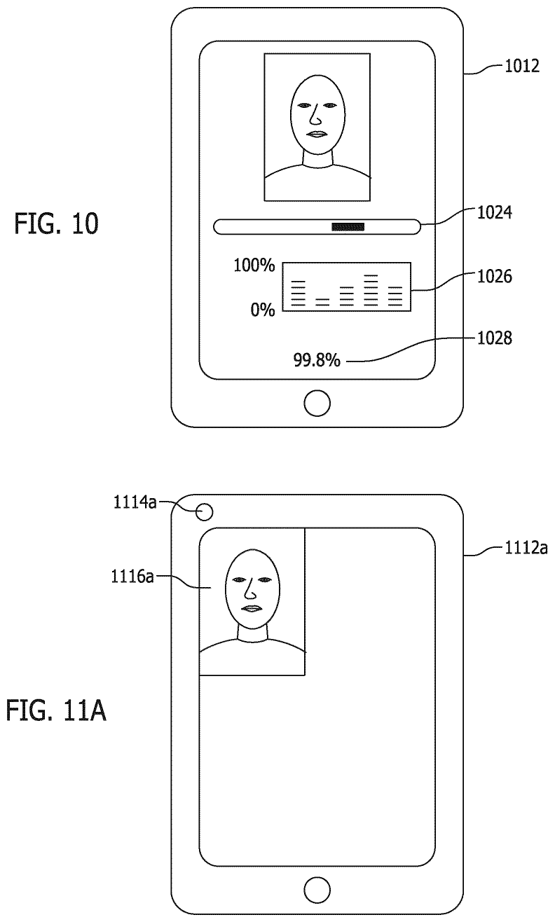

To further facilitate imaging, the mobile device may include various feedback meters, such as a movement meter or accuracy meter, as shown in FIG. 10. In one embodiment, the mobile device 1012 may display a movement meter 1024 that indicates the amount of movement the mobile device 1012 makes as the user moves the mobile device 1012 to different positions relative to his/her head. For example, the movement meter 1024 may be represented as a line that slides from one side of the screen. In this manner, the enrollment process may require a certain threshold of device movement to register a user with the multi-dimensional verification system. For example, the system could require that the mobile device 1012 be moved in an arc or straight line and be rotated at least 45 degrees to create the enrollment information. In another example, the system could require an acceleration experienced by the device exceeding a threshold amount. The movement meter may also aid the user in learning how to image himself/herself using the verification system.

The mobile device 1012 may also display an accuracy meter 1026 or any other visual representation of frames to ald the user in validating himself/herself using the verification system and learning to improve verification. The accuracy meter 1026 may show a user a match rate (graphical, alpha, or numerical) of a predetermined number of images obtained during the verification process. The accuracy meter can be represented on the display in a variety of ways, including numeric percentages, color representation, graphical representations, and the like. A combination of representations may also be utilized.

For example, as shown in FIG. 10, match rates for a predetermined number of images taken during verification are represented on the accuracy meter. In the embodiment shown in FIG. 10, each of the images may be represented by a column in a graph, and the accuracy can be shown for each image in each column. For example, the column with a longer bar represents higher accuracy, and a column with a lower bar represents lower accuracy. In addition to match rates for images, the match rates for the path parameter may also be displayed. Over time, the user can improve.

In another embodiment, each of the images may be represented on a table as a color that corresponds to the match rate. The color dark green may represent a very high match rate, light green may represent a good match rate, yellow may represent a satisfactory match rate, red may represent a mediocre match rate, and grey may represent a poor match rate. Other color schemes may also be used.

The height of the bars or the colors used may correspond to predetermined match rates. For example, a full bar or dark green may be a match rate greater than 99.9%, a three-quarter bar or light green may be a match rate between 90% and 99.9%, a half bar or yellow may be a match rate of 50-90%, red may be a match rate of 20%-50%, and a single line to a quarter bar or grey may be a match rate of 0-20%. A pie chart, line graph, or any other type of representation could also be used, or any other numerical or graphical display. An overall score may be presented or a score per image.

The accuracy meter may also include a message 1028 indicating an overall match score. For example, the accuracy meter may indicate an average overall match score or the number of images that achieved a 99.9% match rate, and display the message to a user. With the movement meter 1024 and the accuracy meter 1026 as described above, the user may quickly learn to use the verification system due to the feedback presented by the meters 1024, 1026.

### Gamification and Rewards

The movement and accuracy meters 1024, 1026 may also be configured to incorporate game features, aspects, or techniques into the verification system to encourage a user to try and get the best match possible (such as a high number score or a high percentage of frames), increasing the user's skill in utilizing the verification system. This also builds user adoption rates for the technology.

For example, the user may compete with themselves to mimic or improve past verification scores to encourage or train the user to achieve a high score. Further modifications of the verification meter may also be incorporated, such as the ability to share accuracy match results with others to demonstrate one's skill in using the system or to compete against others. In other instances, the user may receive a reward, such as a gift or coupon, for high accuracy scores. While this may slightly increase costs, the reduction in fraud loss would far outweigh the additional cost.

Further game techniques may be incorporated into the verification system to encourage users to take actions that will prevent unauthorized or fraudulent verification. In one embodiment, the verification system may award users who engage in fraud-preventing activities. One such activity is utilizing the face matching and/or verification system described herein. For example, based on the above-described accuracy meter, the system may reward a user who successfully verifies with the system above a certain match rate. The system may award reward points, cash, or other prizes based on the successful verification or on a predetermined number of successful verifications. Where reward points are utilized, the points may be cashed in for predetermined prizes.

Other game features may involve award levels for users who gain a predetermined amount of experience using the verification feature. For example, different reward levels may be based on users successfully authenticating 100 times, 500 times, 1000 times, etc. Because each instance of fraud loss can be significant and can damage the goodwill of the business or organization, the benefits of fraud prevention are significant.

In one embodiment, the user may be notified that he or she has achieved various competency levels, such as a “silver level” upon achieving 100 successful verifications, a “gold level” for achieving 500 successful verifications, or a “platinum level” for achieving 1000 successful verifications. An amount of points awarded for each verification above a given match rate may increase based on the user's experience level. Of course, the names of the levels and the number of verifications for each level, as described above, are only exemplary and may vary as desired.

In one embodiment, a verification only counts toward reward levels when business is transacted at the website, while in other embodiments, repeated attempts may be made, all of which count toward rewards. Another feature may incorporate a leaderboard where a user may be notified of a user ranking comparing his or her proficiency or willingness in using the verification system as compared with other users.

Successful use of the verification system benefits companies and organizations that utilize the system by reducing costs for fraudulent activities and the costs of preventing fraudulent activities. Those cost savings may be utilized to fund the above-described game features of the verification system.

Further activities that correspond to the verification system and contribute to the reduction of fraud may also be incorporated to allow a user to earn points or receive prizes. Such activities may include a user creating a sufficiently long and strong password that uses a certain number and combination of characters. This encourages and rewards users to set passwords that are not easily compromised. Other examples may include rewarding users to take time to perform verification steps in addition to an initial verification, such as a mobile phone or email verification of the verification, answering one or more personal questions, or other secondary verifications as currently known or later developed. This rewards users for taking on added time and inconvenience to lower the risk of fraud to a company or organization.

As another example, if the verification service is used to log in to websites or apps that provide affiliate programs, then the reward or gift can be subsidized from the affiliate commissions on purchases made on those sites. For example, if a commerce (product or service) website utilizes the method and apparatus disclosed herein to avoid fraud, and thus increase profits, then a percentage of each purchase made by a user using the verification service will be provided to the verification service. By reducing fraud, consumer purchases are more likely, and additional users will be willing to enter financial and personal information. An affiliate link, code, or referral source or identifier may be used to credit the verification system with directing the consumer to the commerce (product or service) website,

### Multiple Account Login

It is also contemplated that the verification system may be configured to allow a user to access several different websites using a single verification. Because the verification process and result are unique to the user, the user may first designate which participating websites the user elects to log into, and then, after selecting which one or more websites to log into, the user performs the verification described herein. If the secure verification is successful, then the user is logged into the selected websites. In this way, the verification process is a universal access control for multiple different websites and prevents the user from having to remember multiple different usernames and passwords while also reducing fraud and password overhead for each user.

### Automatic Start/Stop of Imaging

It is also contemplated that the system may be configured to have the video camera running on the phone. The mobile device would grab frames and path parameter data when the phone moves (using the camera, gyroscope, magnetometer, and accelerometer), but only process into biometric data on the device or send the frames up to the server if they have a face in them. In this embodiment, the application executing on the mobile device could trigger the software application to start saving frames once the phone is moving and then if the phone continues to move in the correct path (a semi-circle, for example) and the system detects a face in the frame the mobile device would start to send images, a portion of the image, or biometric data to the server for processing. When the system senses motion, it may trigger the capture of images at certain intervals. The application may then process the frames to determine if the images contain a face. If the images do include a face, then the application crops it out and then verifies if the motion path of the mobile device is similar to the one used during enrollment. If the motion path is sufficiently similar, then the application can send the frames one at a time to the server to be scanned or processed as described above.

### Banding and Edge Detection

When a fraudulent attempt is made using a display screen, such as an LED, LCD, or other screen, the system may detect the fraudulent login attempt based on expected attributes of the screen. In one embodiment, the verification system will run checks for banding produced by digital screens. When banding is detected, the system may recognize a fraudulent attempt at a login. In another embodiment, the system will run checks for edge detection of digital screens. As the mobile device is moved to obtain the verification movement during a login attempt, the system checks the captured images for the edges of a screen to recognize a fraudulent login attempt. The system may also check for other image artifacts resulting from a screen, such as glare detection. Any now known or later developed algorithms for banding and screen edge detection may be utilized. Detection of fraud will prevent verification and access to the website or prevent the transaction or account access. Other Attributes Estimation

The verification system may further conduct an analysis on the enrollment images to estimate at least one of a gender, an approximate age, and an ethnicity. In an alternative embodiment, the user may manually enter one or more of their gender, an approximate age, and an ethnicity, or this information may be taken or obtained from existing records that are known to be accurate. The verification system may then further store a user's estimated gender, age, and ethnicity as enrollment credentials or user data. Thus, when the user later attempts to verify with the system, the system will compare derived gender, age, and ethnicity obtained from verification images (using biometric analysis to determine such data or estimates thereof based on processing) with the stored gender, age, and ethnicity to determine whether to verify the user. For example, if the derived data for gender, age, and ethnicity matches the stored enrollment credentials, then the verification is successful, or this aspect of the verification is successful.

The verification system may make the gender, age, and ethnicity estimations based on a single image during the verification process or based on multiple images. For example, the verification system may use an image from a plurality of images that has an optimal viewing angle of the user's face for the analysis. In other embodiments, a different image may be used for each analysis of age, gender, and ethnicity when different images reveal the best data for the analysis. The verification may also estimate the gender, age, and ethnicity in a plurality of images and average the results to obtain overall scores for a gender, age, and ethnicity.

As an alternative to obtaining the gender, age, and ethnicity as enrollment information, the estimated gender, age, and ethnicity estimations as verification credentials may be set over a course of repeated use of the verification system. For example, if in previous successful verifications using biometrics and movement information, the verification system always estimates a user's age being between 40 and 50, then the verification may set credentials for that user requiring later login information to include images of a face estimated to be between 40 and 50. Alternatively, gender, age, and ethnicity estimations may be implemented as one of many factors contributing to an overall verification score to determine whether or not to verify a user.

For example, if the verification process has a gender estimation of +or −0.2 of 1.9 male rating, then if the actual results do not fall within that range, the system may deny access for the user. Likewise, if the user's age range always falls between 40-50 years of age during prior verification attempts or enrollment, and a verification attempt falls outside that range, the system may deny access or use the result as a compounding factor to deny access.

In a further embodiment, when a bracelet or watch capable of obtaining an EKG (electrocardiogram) signature is used, a certain EKG signature may be required at login. The EKG signature could also be paired with the face matching rotation to provide a multiple stage sign-on for critical security and identification applications. Further, the credentials could also include GPS information, where login is only allowed within certain geographic locations as defined during enrollment. In one configuration, the GPS coordinates of the mobile device are recorded and logged for a login attempt or actual login. This is additional Information regarding the location of the user. For example, if the GPS coordinates are in a foreign country known for fraud, then the attempt was likely fraudulent, but if the GPS coordinates indicate the attempt or login was made in the user's house, then fraud is less likely. In addition, some applications may only allow a user to log in when at a specified location, such as a secure government facility or at a hospital.

The enrollment information may further include distance information. Because the motion arc (speed, angle, duration ...) is unique to each user, face detection software on the device can process the images and determine if the device is too close or too far from the subject. Or in other words, the enrollment information may consider the size of the face in the images. Thus, the potential enrollment information may also vary based on the length of a user's arm, head, and face size, and on the optics of the camera in the user's particular mobile device. The user may also be positioned at a fixed computer or camera, such as laptop, desktop, or atm. The user may then move the face either forward and backward, side to side, or up and down (or a combination) to create the images. Hence, this method of operation is not limited to a mobile device. In one embodiment, the camera is disposed in an automobile, such as in a mirror, and the person moves their head or face to verify.

Gradual verification access In one embodiment, the system is set to limit what the user can do when first enrolled and verified. Then, after further verifications or after a predetermined time period and number of verifications, additional capabilities may be granted. For example, during the first 20 verifications during the first 3 months, a maximum transaction of $100 may be allowed. This builds a database of known verification data relating to non-objected to transactions by the user. Then, during the next 20 verifications, a transaction limit of $3000 may be established. This limits the total loss in the event of fraud when the verification data is limited, and the user is new to the system. For example, if an unauthorized user manages to fraudulently enroll in the verification system.

### Video Display for Imaging

When the user images himself/herself using a front-facing camera, the user may confirm that his/her face is being imaged by viewing the image on the display, as described above. The image shown on the display may be configured to be smaller in area than the entire display and may be positioned in an upper portion of the display towards the top of the device. When the user's image is shown only in the top portion of the user's display screen, the user's eyes tend to look more closely at the front camera. When the user's eyes are tracking up, the accuracy of the face matching may be improved. Further, tracking the movement of the eyes from frame to frame may allow the system to validate that the images are of a live person and are not from a photograph or video recording of the person.

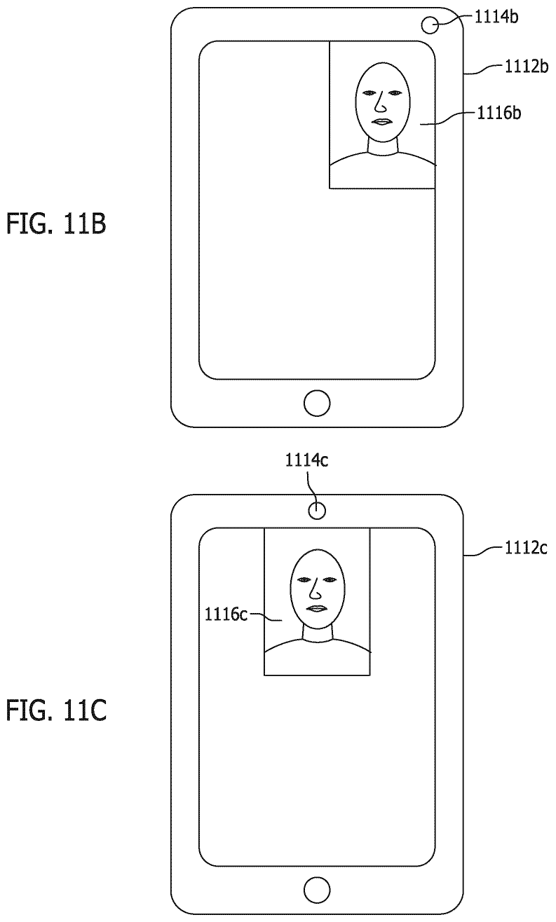

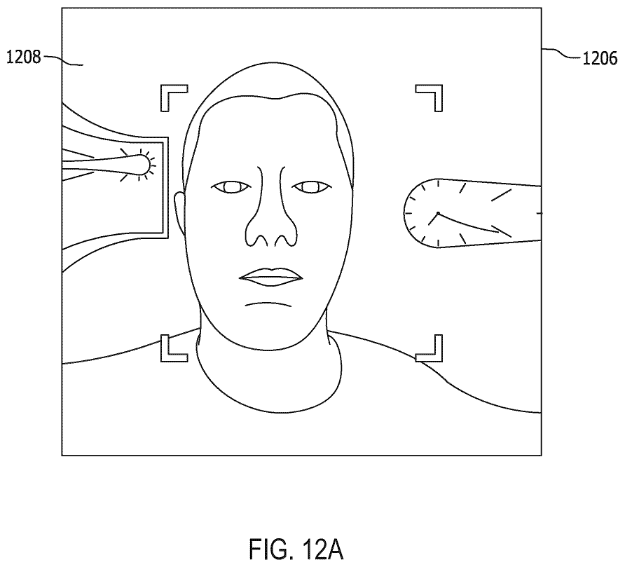

The image shown on the display may also be positioned to correspond with a camera location on the user's device, as shown in FIG. 11A through FIG. 11C. Mobile devices that are available today may include front-facing cameras disposed at several different positions. For example, one mobile device 1112a, 1112b may have a front-facing camera 1114a, 1114b that is disposed above the display and off-center towards one side or the other, as shown in FIG. 11A and FIG. 11B. Accordingly, the feedback image 1116a, 1116b of the user shown on the display may be positioned to correspond with the location of the camera 1114a, 1114b as shown. In FIG. 11A, where a camera 1114a is above the display and is off-center at a position left of the center, then the image 1116a may be shown in an upper left corner of the display. In FIG. 11B, where a camera 1114b is above the display and is off-center at a position right of the center, then the image 1116b may be shown in an upper right corner of the display. As shown in FIG. 11C, a mobile device 1112c may have a camera 1114c that is disposed centered directly above the display. There, the image 1116c may be displayed centered in an upper portion of the display. In this manner, a user's eyes are directed close to and/or tracked as close to the camera as possible, aiding eye tracking and movement verification. The user is also able to better see the feedback image and other feedback or information on the screen as they move the mobile device.

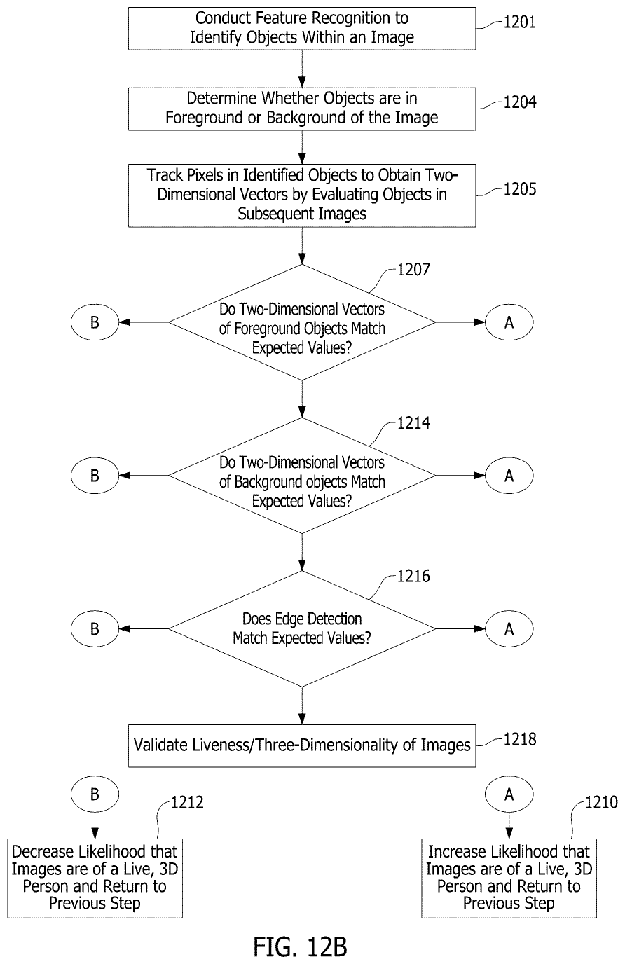

The image viewed on the display by the user may further be modified such that the edge pixels on the sides display are stretched horizontally, as shown in FIG. 12A. That is, a predetermined area 1206, 1208 on both the right and the left sides are warped to stretch towards right and left edges, respectively, of the screen. This allows a larger vertical portion of the displayed image to be shown on the display. Simultaneously, this trains a user to use the system correctly by keeping his or her face in the center of the screen, as his or her face will become warped on the screen if it becomes off-center and part of the face enters the one of the warped areas.

An example of this process is described with reference to FIG. 12B. When a first image is received by the device or server, feature recognition is performed on the image to detect predetermined objects within the image in step 1201. In this instance, facial or feature detection is used to confirm the presence of a user's face and/or facial features on the user's face, such as the user's nose, eyes, cheekbones, chin, etc.

Next, the system analyses the pixel placement in one or more subsequent frames to determine whether the pixels representing the detected features correspond with features located in the foreground or the background of the scene in step 1204.

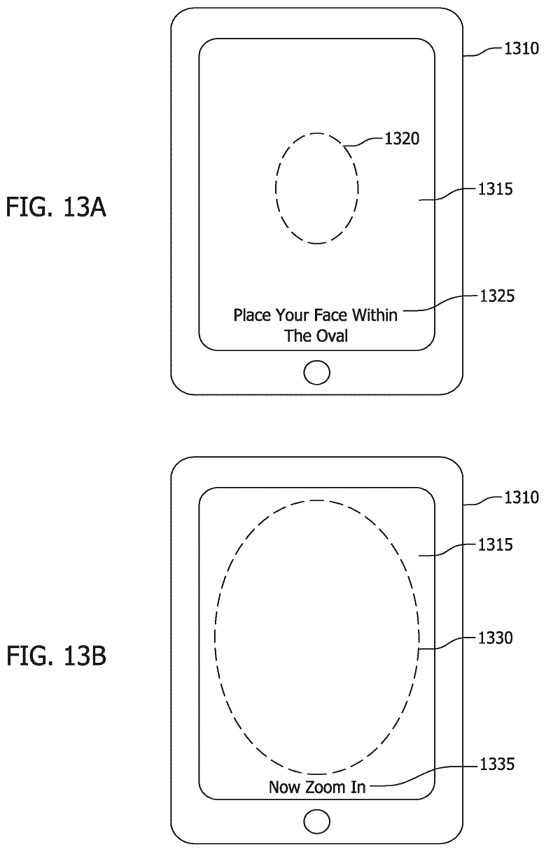

In one embodiment, when the user moves the device to fit his or her face within the ovals, such as those shown in FIG. 13A and FIG. 13B, the face of the user is identified as the foreground of the image, or the features within the ovals 1320, 1330. The area around the face showing the room or environment of the person is identified as the background of the image, or the features within area 1315. Additionally, the facial features can be verified to behave with characteristics of relatively different distances and locations in the frame. For example, the nose, mouth, and chin may be considered foreground features while the cheeks, ears, and jawline may be considered background features.

In step 1205, the various features are tracked through successive images to obtain two-dimensional vectors characterizing the flow or movement of the features. The movement of the features in this example is caused as the user moves the device to fit his/her face within the oval shown in the exemplary screen displays of FIG. 13A and FIG. 13B. Such movement may include the nose displacing pixels on the upper lip and inner cheeks, and then the cheeks displacing pixels representing the ears, and the chin displacing pixels representing the neck.

The device (processor executing machine-readable code stored in memory) then compares image frames (formed by an array of pixels) as the device moves closer to the face of the user. The pixels representing objects in the image are tracked to determine the velocity characteristics of the objects represented by the pixels in the foreground and the background. The system detects these changes in position of items based on pixel data, or two-dimensional pixel velocity vectors, by comparing the successive images taken by the device. When the live, three-dimensional user is authenticating, velocity characteristics of the foreground features (face) and the background features differ significantly as compared to velocity characteristics of a two-dimensional spoof being imaged. That is, the velocity characteristics of facial features are different for a live, three-dimensional person are different as compared to a two-dimensional spoof as the user moves the device to fill his/her face in the oval shown in FIG. 13A and FIG. 13B.

Thus, in step 1207, the system checks if the two-dimensional vectors of foreground features match expected values of a live, three-dimensional person. The expected values or expected rate of change of an item in an image, defined by pixel location or values, may be based on testing over time such as expected location, expected displacement, expected rate of change of the item, or even expected differences in the rate to change which would indicate three-dimensionality (as opposed to a 2D photograph or video screen of a person). In this example, testing may set an expected value of movement or velocities of the ear(s), cheekbone(s), nose, etc. When two-dimensional vectors match expected values, the method proceeds to step 1210 to increase the likelihood that the images are of a live, three-dimensional person. If the two-dimensional vectors do not match expected values (or match values that are expected when a two-dimensional spoof is used), then the method decreases the likelihood that the images are of a live, three-dimensional person, as shown in step 1212.

When a live, three-dimensional personis being imaged, the two-dimensional vectors, or displacement of pixels between successive images, are different in the foreground and background of the image. Thus, in step 1214, the system also analyzes the two-dimensional vectors of background objects to determine whether these match expected values. The likelihood of the images being of a live, three-dimensional person is again updated in either steps 1210 or 1212.

As explained above, some pixels representing certain background objects may appear or disappear completely. For example, as the user moves the device from arm's length to closer in towards his or her face, pixels, edges, and/or features of the user's face will have a higher rate of movement than features in the background, such as a picture frame on a wall, a clock, etc. Additionally, some pixels that are visible on or around the user's face when the device is furthest out from the user will no longer be visible when the user moves the device closer to his or her face. The pixels around a person's face may be defined as the facial halo, and the items in these pixels (facial halo) will no longer be captured by the camera in the image due to the person's face taking up more of the image and ‘expanding’ due to the movement of the camera closer to the person's face. As mentioned above, this check may be referred to as edge detection. In step 1216, the system verifies whether background images around the edges of foreground images match expected values. The system also ensures that pixels representing the edge of the foreground object (such as the face) replace pixels of background objects near the edges of the foreground object. The likelihood of the images being of a live, three-dimensional user is adjusted in steps 1210 and 1212 based on the outcome of the edge detectionin step 1216. Thus, by tracking these pixels and the displacement, the system can verify whether the pixel velocity analysis is consistent with three-dimensional objects having a foreground and background.

In step 1218, the liveness or three-dimensionality of the user being imaged and verified is validated based on the various checks described above. A determination that the user attempting verification is a live person is one element that must be met as part of the verification. Thus, attempts at fraudulent access to an account or device using screens or photos of the person can be more reliably prevented. This prevents attempts at fooling the verification system with a two-dimensional image, such as a printed picture, a digital projection, or a digital screen image of a person.

Further enhancements may also be achieved using pixel velocity analysis for liveness or three-dimensionality. When the user brings the device (camera) closer to the user's face, the facial features will distort differently due to the large relative distances between the various features and the camera, and the placement of the features in the field of view of the camera as the camera comes closer to the face. This effect may be referred to as perspective distortion. When this distortion begins to occur, pixels in the center of the frame that represent the features in the center of the face such as the nose will have the least amount of distortion in the frame, whereas the pixels that represent the outer portions of the face such as the cheeks, the chin, and the forehead will show the most relative pixel movement (more than pixels at the center of the frame) and the highest acceleration. Thus, the three-dimensionality can also be shown by comparing the features on the face itself. This is because, at close proximity to the device, facial features closer to the device can be considered foreground features, and facial features farther from the device are background features. For example, pixels representing the nose will show less movement between frames than pixels representing the cheekbone because of the nose's shorter relative distance from the camera when the device is held at eye level.

Pixel velocity analysis may also be used to track liveness characteristics that are very difficult to recreate during a fraudulent verification event. For example, the human eyes are never completely still, even when focusing on an object. There is always a quick involuntary movement of the eyes as the eyes scan an object, moving around to locate interesting parts of the object, and developing a mental, three-dimensional “map” corresponding to the scene. These movements are called saccades and are involuntary. Saccades last from 20 ms to 200 ms and serve as the mechanism of eye fixation. Two-dimensional velocity vectors, based on the movement of the eyes based on pixel values, may thus be generated by the saccadic motion of the eyes across frames. The presence of these vectors, the hertz of the eye jitter, and the acceleration of the pixel movement between frames can be compared to measurements of verified sessions and can be used to increase confidence that the user in front of the camera is not an inanimate spoof, such as a photo, a wax sculpture, or a doll.

In another example, when a bright light is presented to the human eyes, the pupil will constrict to mitigate the light's path to the retina. Cameras on typical mobile devices such as smart phones generally operate at high enough resolutions that two-dimensional velocity vectors will track the pupils constricting when compared over a series of frames where the amount of light entering the eyes increases, such as when the user moves the device and screen closer to his or her face, or when a front-facing flash of a mobile device is activated.

Another feature that may be detected by pixel velocity analysis is reflection off the eye of the user. The surface of the eye reflects a larger amount of the light hitting it when the pupil contracts, providing a brighter reflection of the light-emitting object. In the case of the device with an illuminated screen being moved closer to the face of the user, the size and brightness of the reflection of the device's screen will increase while the size of the pupil contracts. It is possible to observe and document these two-dimensional vectors in a consistent motion path and then provide a liveness evaluation on video frame sessions based on the expected two-dimensional vectors being observed or absent.

Face matching algorithms use landmarked points on the face to measure the distance and angles between the facial features. This creates the unique look of individuals and the corresponding unique biometric data. In some embodiments, pixel velocity analysis may be used not only to verify the three-dimensionality of the person, but also as an additional or alternative face matching algorithm.

### Verification in Low-Light Environments

To facilitate imaging, the screen on the mobile device may additionally be displayed with a white background, and the brightness of the screen may be increased to light up the user's face in a dark environment. For example, a portion of the display could provide video feedback for the user to ensure he or she is imaging himself or herself, while the remaining portion of the display is configured to display a bright white color. Referring to the example shown in FIG. 11C, this may be done by showing the video feedback 1116c on a center of the display, with the surrounding areas being displayed as bright white bars around the video feedback 1116c. In a very dark situation, an LED flash on the back side of the mobile device and the back facing camera may be used. Alternatively, the camera may be configured to create an image using infrared light or other night vision techniques.

When infrared imaging is used as thermal imaging, further security enhancements are possible. Particularly, the thermal imaging may be analyzed to indicate whether the obtained images are from an actual user or are fraudulent images from a screen or other device. When a person is in front of an infrared thermal imaging camera, the heat radiation detected should be fairly oval-shaped shaped designating the person's head. In contrast, the heat radiating from a screen is typically rectangular. Further, the heat patterns detected in the actual person's face, as well as the movement of the heat patterns in the images, can be compared with expected heat patterns of a human face to distinguish the images from fraudulent authorization attempts using a screen.

### Detecting Output from the Mobile Device

The display or other light source on the mobile device may further be utilized to provide additional security measures. During the verification process described above, light from the display or other light source is projected onto the user's face and eyes. This projected light may then be detected by the camera of the mobile device during imaging. For example, the color tone detected on the skin, or a reflection of the light from the cornea of a user's eye, may be imaged by the camera on the mobile phone. Because of this, random light patterns, colors, and designs may be utilized to offer further security and ensure there is a live person attempting verification and not merely an image or video of a person being imaged by a fraudster.

As one example, when a user begins verification, the verification server may generate and send instructions to the user's device to display a random sequence of colors at random intervals. The verification server stores the randomly generated sequence for later comparison with the verification information received from the mobile device. During verification imaging, the colors displayed by the device are projected onto the user's face and are reflected off the user's eyes (the cornea of the eyes) or any other surface that receives and reflects the light from the screen. The camera on the user's mobile device detects the colors that are reflected off the user's skin or eyes (or other surface) and generates color data indicating the colors detected based on the screen projection. This data may be returned to the verification server to determine if the color sequence or pattern sent to the mobile device matches that known sequence or pattern projected by the screen of the user device. Based on this comparison, at the verification server, the verification is a success or denied. The comparison with the random sequence of colors in the instructions may alternatively occur exclusively at the user device to determine that a live user is being verified.

As another example, when a user begins verification, the verification server may send instructions to the user's device to display a randomly generated pattern, which is then stored on the verification server. This pattern may include graphics, text, lines or bars, flashing light patterns, colors, a QR code, or the like. The randomly generated pattern is displayed during verification imaging, and the pattern is reflected off the user's eyes (cornea). The camera of the user's device detects the reflected pattern off the eye of the user and processes the reflected, mirrored image of the displayed pattern. The processed pattern (such as being converted to a numeric value) is transmitted to the verification server and compared to the pattern that was randomly generated and stored on the verification server to verify if the pattern displayed by the screen, and imaged after reflection off the user's face, establishes a pattern match.

If a match occurs, this establishes or increases the likelihood that a live person is being imaged by the device. If the pattern is not a match or does not meet a match threshold level, then the verification process may fail (access denied), or the account access or transaction amount may be limited. It is noted that this example could also be incorporated on desktop computer with a webcam that does not incorporate the enrollment movement and verification movement described above. Further, this example may not only be incorporated with face matching but could also serve as an added layer of security for iris recognition or any other type of eye blood vessel recognition, or any facial feature that is unique to a user.

When the above example is implemented on a desktop computer, eye tracking may also be utilized to further demonstrate the presence of a live user. For example, the screen could show a ball or other random object or symbol moving in a random pattern that the user watches with his or her eyes. The camera can detect this real-time movement to verify that the user is live, and not a picture or display, and verify that the eye or head movements correspond to and match the expected movement of the object or words on the screen, which are known by the verification system. Eye tracking can also be done by establishing an anchor point, such as via a mouse click at a location on the screen (if the user is looking at the location where the mouse click takes place), and then estimating where the user is looking at the screen relative to the anchor position.

The use of a moving object on the screen may also be beneficial during enrollment on either a mobile or a stationary device. For example, while capturing the enrollment images, the device may display a moving digital object (such as a circle or words(s)) that moves around the screen so that the user is encouraged to follow it with his or her head and eyes. This movement may be involuntary from the user, or the device may be configured to instruct the user to follow the object. This results in movement of the head and/or eyes, creating small changes in the orientation of the user's head and face with the device camera, providing more complete enrollment information. With more complete enrollment information, the system may better ensure that the user will later be verified at a high rate even at slightly different angles during future verification attempts.

### Intuitive User Training and Enhanced Security by “Zooming”

In one embodiment, the system is configured to aid the user to easily learn to verify with the system. As shown in FIG. 13A, once enrollment or verification is begun as described previously, the system causes the user's mobile device 1310 to display a small oval 1320 on the screen 1315 while the mobile device 1310 is imaging the user. Instructions 1325 displayed on the screen 1315 instruct the user to hold the mobile device 1310 so that his or her face or head appears within the oval 1320. Because the oval 1320 is small, the user is required to hold the mobile device 1310 away from his or her body, such as by straightening his or her arm while holding the mobile device 1310. The maximum arm length and face size is unique to the user. In other embodiments, the arm may not be fully straightened, such as to accommodate operation when space is not available, such as in a car or in a crowded location. It is noted that while the small oval 1320 is shown centered in the display, it may be positioned anywhere on the screen 1315.

Next, as shown in FIG. 13B, the system causes the user's mobile device 1310 to display a larger oval 1330 on the display 1315. The display 1315 may also show corresponding instructions 1335 directing the user to “zoom in” on his or her face to fill the oval 1330 with his or her face. The user does this by bringing the mobile device 1310 closerto his or her face in a generally straight line to the user's face (such as shown in FIG. 7A and FIG. 7B) until the user's face fills the oval 1330 or exceeds the oval. In other embodiments, the large oval 1330 may simply be a prompt for the user to bring the mobile device 1310 closer to the user's face.

Thus, the system provides and teaches the user a simple method to provide enrollment and verification images along with enrollment and verification movement, as explained above. The system may also teach varying enrollment and verification movement by varying the location of the small oval 1320 on the screen 1315, and by changing the order and the size of the ovals displayed. For example, the user may zoom in ½ way, then out, then in all the way, by moving the mobile device. The system may be configured to monitor that the camera's zoom function (when equipped) is not in use, which typically requires the user to touch the screen.

In one embodiment, the enrollment movement may be omitted, and the verification movement may be compared to expected movement based on the prompts on the screen. For example, the device or verification server generates a series of differently sized ovals within which the user must place his or her face by moving the mobile device held in the user's hand. In this manner, the verification movement may be different during each login depending on the order, size, and placement of the ovals shown on the screen.

The system may also incorporate other security features when the “zoom in” movement is used, as shown in FIG. 13A and FIG. 13B. Typical cameras on a mobile device or any other device include a curved lens. This results in a barrel distortion effect in the resulting images taken by the camera. In some instances, this curvature may not be visible to the human eye or may only be noticeable at certain focal lengths. The curvature or barrel distortion effect can vary with focal length or distance between the user and the lens. The degree of the barrel distortion effect is thus dependent on the type of optics used in the camera's lens and other factors.

The barrel distortion effect becomes more pronounced on an image of a person's face when the person images his or her face close to the lens. The effect results in the relative dimensions of the person's face appearing different than when the imaging is done with the person's face farther away from the lens. For example, a person's nose may appear as much as 30% wider and 15% tallerrelative to a person's face when the image is taken at a close proximity, as compared to when the image is taken at a distance. The differences in the relative dimensions are caused by the relatively larger differences between the camera and the various facial features when the person is imaged close to the lens, as compared to the relatively equal distances when the person is imaged at a distance farther from the lens.

Such differences have been found to be significant in many face matching algorithms. That is, a face matching algorithm may not recognize a live person imaged at a close proximity and a far proximity as the same person. In contrast, if a two-dimensional photograph of a person is imaged by the camera at both a close proximity and a farther proximity, the relative focal lengths between the lens and the two-dimensional image do not change so significantly. Thus, a face matching algorithm would recognize the two-dimensional photograph as the same person when imaged at both a close proximity and a distance farther from the lens.

This effect may be used to increase the security of the verification system. For example, during enrollment, enrollment images may be provided by the user at both close and far proximity from the lens, in addition to other positions through the movement. Later, during verification, verification images may be obtained at both the close and far distances from the lens to determine if they match with the enrollment information obtained from the enrollment images. Further, because the barrel distortion effect is expected when an actual, three-dimensional person is present, an absence of the relative change in the dimensions of the facial features alerts the system to a fraudulent attempt at verification. This effect could not easily be re-created with a two-dimensional picture (printed photograph or screen), and thus, this step can serve as a secure test to prevent a two-dimensional picture (in place of a live face) from being used for verification.

In other words, using this movement of “zooming” in and out on the user's face, two or more biometric profiles could be created for the same person. One of the multiple profiles for the person may be imaged farther from the camera, and one of the multiple profiles may be for the person imaged closer to the camera. For the system to verify the person, the verification images and biometrics must match the two or more profiles in the enrollment images and biometrics.

In addition, the system may detect the presence of a real person as compared with a fraudulent photograph of a person by comparing the background of the images obtained at a close and a far proximity. When the mobile device 1310 is held such that the person's face fits within the oval 1320, objects in the background that are almost directly behind the person may be visible. However, when the mobile device 1310 is held such that the person's face fits within the larger oval 1330, the person's face blocks the cameras'ability to see the same objects that are almost directly behind the person. Thus, the system may compare the backgrounds of the images obtained at the close and the far proximity to determine whether the real person is attempting verification with the system.

Of course, in FIGS. 13A and 13B, shapes or guides other than ovals 1320 and 1330 may be used to guide the user to hold the mobile device 1310 at the appropriate distance from his or her face. For example, the mobile device 1310 may show a full or partial square or rectangular frame. Further, the system may vary the size and location of the frame, such as the ovals 1320, 1330, to add further security. For example, the system may require a medium-sized frame, a small frame, and then a large frame. As another example, the system may require a small frame at a first location and a second location, and then a large frame. This may be done randomly to teach different users different enrollment and verification movements.

The number of frame sizes presented to the user may also vary for a single user based on the results of other security features described herein. For example, if the GPS coordinates of the mobile device show that the device is in an unexpected location, more frames at different distances may be required for verification. One or more indicators, such as lights, words, or symbols, may be presented on the screen to be visible to the user to direct the user to the desired distance that the mobile device should be from the user.

In FIGS. 13A and 13B, the system may predict the expected barrel distortion of the images based on the mobile device used for enrollment and verification, and based on known and trusted enrollment data. In addition or as an alternative, the known specifications of a mobile phone camera for a given model may be utilized to predict the expected distortion of the person's facial features at different distances from the lens. Thus, the verification may be device-dependent. Further, enrollment information from the user is not required at every possible distance from the camera.

For example, as described above, enrollment images and biometrics may be obtained for a user at two distances from the user. During verification, multiple images are captured in addition to images corresponding the close and far distances of the enrollment images and biometrics. Based on the expected distortion of these intermediary images according to the distance traveled by the device, the system may validate that the change in distortion of the images is happening at the correct rate, even though only two enrollment profiles are obtained.

The capturing of these images may be still images or video, such that frames or images are extracted from the video that is taken during the movement from the first position distant from the user and the second position proximate to the user. Thus, it is contemplated that the operation may capture numerous frames during the zoom motion and ensure that the distortion is happening at the correct rate for the head size and the movement of the mobile device distance based on data from the accelerometers, magnetometers, and so forth.

Over time, based on accumulated data or calculated data during design phase, the system will have data indicating that if a phone is moved a certain distance toward a user's face, then the distortion effect should fall within a known percentage of the final distortion level or initial distortion level. Thus, to fool or deceive the verification system disclosed herein, the fraud attempt would not only need to distort the fraudulent two-dimensional picture image, but would also need to cut the background, and then make a video of the face, distortion, and background that does all of this incrementally and at the correct speed, all while not having any banding from the video screen or having any screen edges visible, which is very unlikely.

Many currently known facial detection and face matching algorithms are configured to look for a small face within an image. Thus, to ensure that the facial detection and recognition algorithms detect and recognize the user's face in the zoomed-in image (FIG. 13B), the system may add a large buffer zone around the image taken at a close proximity. This creates a larger overall image and allows current facial detection and recognition algorithms to detect and recognize the face, even where the face of the user is large in the original image.

When the enrollment and verification movement resulting from the process described with FIGS. 13A and 13B is used, the eye tracking security features described above may also be enhanced. For example, when the user is instructed to bring the mobile device 1310 closer to his or her face to fill the oval 1330, the QR code, a random shape, a bar code, color, text, numbers, or any other visual indicator may be displayed on the screen. At this close distance, the reflection of the displayed indicator off the user's eye or face may be more easily imaged by the camera. Furthermore, eye movement, blinking, and the like to determine the “liveness” of the person being imaged may also be more easily obtained at the close proximity.

In one embodiment, at least one blink is required to prove liveness for verification. In another embodiment, blinks may be counted, and the number of blinks may be averaged over time during verifications. This allows for an additional factor in verification to be the number of blinks observed during the motion. If a pattern of when the user blinks during the motion is observed, the system may verify that the user blinks at the expected time and device location during the motion during future verification attempts.

In other embodiments, the size or location of the oval or frame may change to sizes or locations other than those shown in FIGS. 13A, 13B such that the user must position and/or angle the phone to place his or her face within the oval. This establishes yet another method of ensuring liveness of the user.

In one exemplary method, the mobile device is positioned at a first distance from the user, and a first image captured for processing. This distance may be linearly away from the user and, in this embodiment, not in an arc or orbit. This may occur by the user moving the mobile device, either by hand, or by the mobile device being on a movable device or rail system. Alternatively, the lens system may be adjusted if in a fixed system to change the size of the user's face in relation to the frame size. Alternatively, the user may stay stationary, the multiple cameras may be used, or camera may move without the user moving. Once some form of movement (from a device, camera, lens, or user) has occurred to establish the camera at a second distance, a second image is captured for processing. Movement from the first position to the second position may be straight toward the user. Processing occurs on both images.

The processing may include calculations to verify a difference between the two images, or a difference in biometrics obtained from the two images, which indicates that a real person is being imaged. Processing may occur to compare the first verification image to a first enrollment image (corresponding to the first distance) to determine if a match is present, and then compare the second verification image to a second enrollment image (corresponding to the second distance) to determine if a match is present. If a match occurs, then verification may proceed.

Variations on these methods are also possible with the system requiring a match at the first distance, but a failure to match at the second distance, thereby indicating that the second image is not of a two-dimensional picture. The processing resulting in a match or failure to match may be any type of image or face matching processing algorithm. As with other processing described herein, the processing may occur on the mobile device, one or more remote servers, or any combination of such devices.

All the processing described herein may occur on only the mobile device, only a remote server, or a combination thereof. The biometric data may be stored on the mobile device or the server, or split between the two for security purposes. For example, the images could be processed on the mobile device, but compared to enrollment data in the cloud or at a remote server. Or the images could be sent to the cloud (remote server) for processing and comparison.

Touch screen enhancements Additionally, added security modifications may include information about a user's finger. Many mobile devices with touch screens can detect the location and approximate size of a user's touch on the screen. Accordingly, an approximate size of a user's finger or thumb may be measured by the system. In addition to the size of a finger, an orientation angle of the finger, or whether the fingers or thumbs of the right or left hand are used can be detected.

In one embodiment, a user selects an account to open, begins enrollment imaging, or begins verification imaging by touching the touchscreen of the user device. The verification system may thus detect whether the touch by a user during verification corresponds with previously stored enrollment information, including the size of the user's finger or thumb, amount of pressure applied to the screen, and whether the user is right or left-handed. This adds an additional security layer for the verification system.

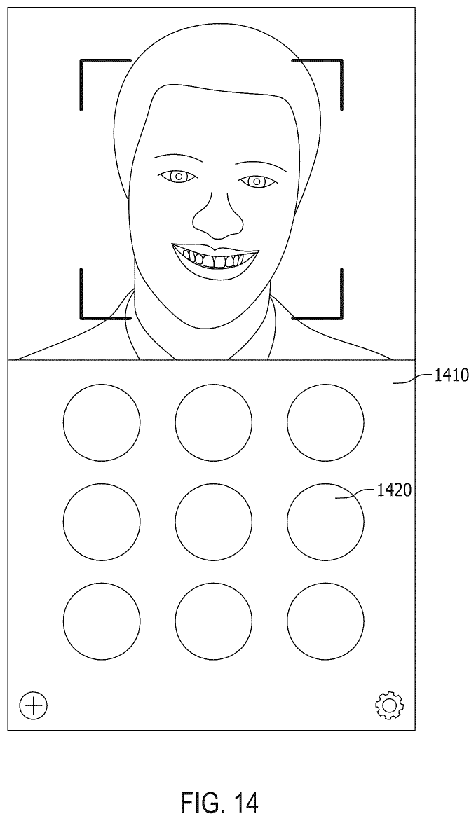

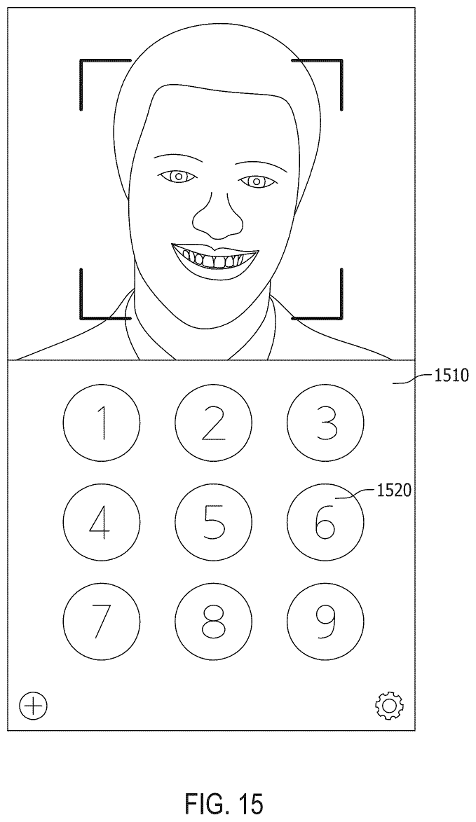

Furthermore, the verification system may require that the user initiates a verification by touching a fingerprint reader or the touchscreen in one or more predetermined manners. In one embodiment, as shown in FIG. 14, a touchscreen 1410 may be divided up into predetermined regions 1420. For example, there may be nine equal, circular, square, or other shaped regions 1420 on the touchscreen 1410 of the mobile device. During enrollment, the user selects one of the regions 1420 of the screen 1410 to touch to initiate verification. During verification, if the preselected region 1420 is not touched to begin verification or during the entire verification process, then verification is denied. This is but one possible design possibility, and other design options are contemplated.

The regions 1420 on the touchscreen may be visually represented by a grid or may not be displayed at all on the touchscreen 1410. As shown in FIG. 15, in addition to or in place of the regions 1420, buttons 1520 may be displayed on a touchscreen 1510. Here, the user may initiate the verification by pressing one or more of the buttons 1520 in a predetermined pattern. The user may also initiate verification via a predetermined swiped pattern. The position to be touched by the user may change with each verification attempt and may be conveyed to the user through any instructions from the verification server, such as a code, number, letter, color, captcha, or other indicator.

Voice parameters It is also contemplated that the user could record their voice by speaking a phrase while recording their images during the enrollment process when first using the system. Then, to verify, the user would also have to also speak the phrase when also moving the mobile device to capture the image of their face. Thus, one additional path parameter may be the user's spoken voice and use of voice recognition as another layer or element of the verification process.

Image quality assurance The verification system may also process the images received from the mobile device to determine if the images are of sufficient quality. For example, the system may check the images for blurriness caused by the images being out of focus or by the camera lens being obscured by fingerprints, oils, etc. The system may alert the user that the quality of the images is insufficient (or too bright or too dark) and direct the userto adjust a focus, exposure, or other parameter, or to clean the lens of the camera.

### Autofocus

The verification system may also utilize an autofocus feature when the mobile device camera is equipped with such. For example, when an actual, three-dimensional person is being imaged, the system checks to ensure that the sharpness of the image changes throughout as the camera performs auto-focusing. In another embodiment, the system may control the autofocus so that the camera focuses on a first location or distance to check for sharpness (in focus) of a portion of the image containing a face. The system then controls the camera to focus at a second location or distance where the presence of a face is not detected and checked for sharpness (in focus) of a portion of the image. If a three-dimensional person in a real environment is being imaged, it is expected that the focal length settings should be different at the first and second locations, which suggests a real person is presently being imaged. However, if the focal lengths of both locations are the same, this indicates that a two-dimensional photograph or screen is being imaged, indicating a fraudulent login attempt.

The system may also control the auto-focus of the device to check for different focal lengths of different features in the image. For example, when a person's face is imaged from the front, a person's ear is expected to have a different focal length (more distant) than the tip of a person's nose.

### Images of Login Attempt

The verification server may also be configured to store the verification images for a predetermined length of time. The images may provide additional security benefits as evidence of a person attempting to log in to a user's account. For example, the system may store a predetermined number of prior log in attempts, such as twenty login attempts, or store images from login attempts for a predetermined time period, such as during the past seven days or weeks. Any fraud or attempted fraud will result in pictures of the person attempting the login being stored or sent to the verification server of the account server.

The mere knowledge that photos will be taken and sent is a significant deterrent to any potentially dishonest person because they know their picture will be taken and stored, and it is an assurance of security to the user. Likewise, any attempted and failed attempt can have the photo stored and indicator of who is attempting to access the account. It is also contemplated that an email or text message, along with the picture of the person attempting the failed log in may be sent to the authorized user, so they know who is attempting to access their account. This establishes the first line of security for the account, as the user with the photo or image also being possessed by the verification server.

### Adaptive Match Thresholds

Further, the level or percentage of correspondence between the enrollment information and the verification information to verify the user may change over time. In other words, the system may comprise an adaptive threshold.

After a user regularly uses the verification system described above, the user will have logged in with the system by moving the mobile device in the predetermined path relative to his or her head many times. Accordingly, it may be expected that as the user will gain experience using the verification system, and that the user will gradually settle into a comfortable and standardized motion path. In contrast, the initial enrollment movement of a user will likely be the most awkward and clumsy movement, as the user has little experience with the verification system.

To make the verification system more convenient for the user without losing security, the adaptive threshold system allows the enrollment movement to adapt so that the user is not locked into the awkward and clumsy initial movement as the enrollment movement. To facilitate this, upon each successful authorization, the successful authorization movement is stored, and the motion path is added to a list of acceptable motion paths. The list of acceptable motion paths may be limitedto a predetermined number of paths. When a new successful authorization is completed, and the list of acceptable motion paths is full, the older enrollment motion path is deleted, and the newest is stored in its place. Alternatively, the motion path that is least like the other motion paths stored on the list may be deleted. Thus, by storing the most alike or newest motion paths, the enrollment movement may slowly adapt over time as the user becomes familiar with the system and settles into a comfortable motion path for verification.

In addition, other enrollment information may adaptively change in a similar manner as the user information. For example, successful verification photos or biometric information can be stored as part of the enrollment information, and old enrollment information may be discarded over time. In this manner, the verification system can be convenient for a user even over a long period of time as the user experiences aging, facial hair growth, different styles of makeup, new glasses, or other subtle face alterations.

Determining how much variance is allowed over time in the motion path or the biometric information, or both, may be set by the entity requiring verification to meet that entity's security requirements. Time or number of scans after the initial enrollment can be used to modify the adaptive threshold. For example, during a first few days after enrollment, the threshold may be lower while a security threat is low, and the differences in paths are likely to be higher. After several verifications or several days, the threshold may increase. The threshold may further be set based on trending data of either the motion path or biometric information. For example, the threshold may be more lenient in a direction the data is trending, while having a tighter tolerance for data against the trend.

A temporal aspect may also be added along with the location information. For example, if the user conducts and verifies a transaction near his home, and then one hour later another transaction is attempted in a foreign country, the transaction may be denied. Or it may be denied if the distance between the prior verification location and the next verification location cannot be traveled or is unlikely to have been traveled in the amount of time between login or verification attempts. For example, if the user verifies in the systemin Denver, but an hour later an attempt is made in New York, Russia, or Africa, then either first or second attempt is fraudulent because the user likely cannot travel between these locations in 1 hour.

Further, if the next transaction is attempted at a more reasonable time and distance away from the first transaction, the level of correspondence threshold may be raised to provide added security, without automatically denying the transaction. Likewise, an altimeter may be used such that if the altitude determined by the mobile device is different than the altitude of the city in which the user is reported to be located, then this may indicate a fraud attempt. Thus, altitude or barometric readings from the mobile device may be used to verify location and can be cross-referenced against GPS data, IP address, or router location data, or user-identified location.

Random image distortion To provide an additional layer of security to the face matching and/or verification system, the system may utilize random image distortion. For example, a user may be assigned a random distortion algorithm upon enrollment into the system. The distortion algorithm may include such distortions to the image as widening or narrowing the person's face by a predetermined amount, adding or superimposing a predetermined shape at a predetermined position on the user's face. As one example of this, the distortion may be a circle superimposed at 100 pixels above the user's left eye.

With the uniquely assigned distortion on the images from the user, the biometric data for that user will be unique to the account or device used by the user. That is, the enrollment biometrics stored on the verification server or on the mobile device will reflect not only the facial features of the user, but also will reflect the uniquely assigned image distortion. Thus, even if an accurate, fraudulent representation of a person were used on a different device or via a different account, the proffered verification biometrics would not sufficiently correspond due to a different or an absence of the unique distortion. Thus, the overall security may be enhanced.

### Security Layers

It is noted that each of the above embodiments, modifications, and enhancements may be combined in any combination as necessary to create multiple layers of security for verification. For example, the face matching may be combined with motion detection or path detection, or operate independently of these features for verification. Further, when more than one of the above-described enhancements or modifications are combined, the verification system may be configured so as not to provide any feedback or indication on which layer failed verification.

For example, when a predetermined touch pattern to initiate verification is combined with the verification movement and facial verification, the system does not indicate whether a touch pattern was incorrect, or the verification movement or verification images failed to correspond to the enrollment information. Instead, the system provides an identical denial of verification no matter what failure occurs. This is the case when any number of the security features described above are combined. In this manner, it is difficult for a fraudster to detect which aspect of the fraudulent credentials must be corrected, further enhancing the security of the system.

All the above features may be incorporated together, or only some features may be used, and others omitted. For example, when the device prompts the user to move the device so that the user places his or her head within a first small frame (such as an oval) then to a second large frame (such as in FIG. 7A, FIG. 7B, FIG. 13A, and FIG. 13B), the system may be configured such that face matching need not be performed on the image(s) in the first frame (distantly captured frames). The security of the system is maintained by performing face matching throughout the imaging at some point between the first and second frames, and at the second frame. This may especially be true when also integrated another layer of security, such as checking eye tracking following a moving object on the screen, or reading a reflection of a QR code or random shape off the user's eye. In another embodiment, when two or more cameras are used to create three dimensional, stereoscopic images, the face matching may not be performed at the first, far-away frame, but instead the liveness of the person may be validated at the closer in frame only after the movement of the device. In still other embodiments, other security layers may be used, and the motion parameters may be omitted. Such combinations may be beneficial for larger or stationary devices, such as gaming laptop computers, personal desktop computers, a stationary kiosk, or the like.

### Example Applications

Likewise, although described herein as financial account verification, the verification using path parameters and image data may be implemented in any environment requiring verification of the user's identity before allowing access, such as auto access, room access, computer access, web site or data access, phone use, computer use, package receipt, event access, ticketing, courtroom access, airport security, retail sales transaction, loT access, or any other type of situation.

For example, an embodiment will be described where the above verification system is used to securely conduct a retail sales transaction. In this embodiment, a user is enrolled with the verification server or a verification application on the mobile device as described above and has generated enrollment information, including enrollment images and/or biometrics, and enrollment movement. In this example, the user initiates or attempts to complete a transaction at a retail establishment with a credit card, smart card, or using a smartphone with NFC capabilities.

The user begins the transaction by swiping a credit card, smart card, or using an application on a smartphone with NFC capabilities to pay for goods or services. The retail establishment would then authorize the card or account with the relevant network of the financial institution (“gateway”). For example, the retail establishment, through a gateway such as one operated by VISA or AMERICAN EXPRESS, would determine whether the account is available and has sufficient available funds.

The gateway would then communicate with the authorization server to authorize the transaction by verifying the identity of the user. For example, the gateway may send an authorization request to the verification server, and the verification server then sends a notification, such as a push notification, to the user's mobile device to request that the user confirm or verify the transaction.

Upon receipt of the notification from the verification server, such as through a vibration, beep, or other sound on the mobile device, the user may then verify his or her identity with the mobile device. The verification server may also send information concerning the transaction to the user for verification by the user. For example, the verification server may send information that causes the mobile device to display the merchant, merchant location, and the purchase total for the transaction.

Next, as before, the user may hold the mobile device and obtain a plurality of verification images as the user moves the mobile device to different positions relative to the user's head. While moving the mobile device to obtain the verification images, the mobile phone further tracks the path parameters (verification movement) of the mobile device via the gyroscope, magnetometer, and accelerometer to obtain the verification movement of the device. The mobile device may then send the device information, the verification images, and the verification movement to the verification server. In other embodiments, the mobile device may process the images to obtain biometric data and send the biometric data to the server. In still other embodiments, the mobile device may process the images, obtain the verification information, compare the verification information to enrollment information stored on the mobile device, and send pass/fail results of the comparison to the verification server.

The verification server may then verify the identity of the user and confirm that the user wishes to authorize the transaction on his or her account if the device information, verification images, and/or biometrics, and verification movement correspond with the enrollment device information, the enrollment images and/or biometrics, and the enrollment movement. The verification server then transmits an authorization message to the gateway. Once the gateway has received confirmation of the authorization, the gateway then communicates with the retail establishment to allow the retail transaction.

Several advantages may be obtained when a retail transaction is authorized utilizing the above system and method. Because the identity verification of the user and the confirmation of the transaction are completed via the verification system and mobile device, there is no longer a requirement for a user to provide his or her credit card or signature, or to enter a PIN number into the retailer's point of sale system. Further, the retail establishment does not need to check a photo identification of the user. The above method and system also have the advantage that they provide secure transactions that can work with mobile and online transactions that do not have cameras, such as security cameras, on the premises.

In the secure retail transaction described above, the user obtains the total amount due on his or her mobile device from the retail establishment via the gateway and verification server. However, in one embodiment, the mobile phone may use the camera as a bar code, QR code, or similar scanner to identify the items and the prices of the items being purchased. The mobile device may then total the amount due and function as the checkout to complete the transaction with the retail establishment.

In another embodiment, a user of the application may want to anonymously pay an individual or a merchant. In this instance, the user would designate an amount to be paid into an application, and the application would create a unique identifying transaction number. This number may then be shown to the second user, so the second user can type the identifying transaction number on an application on a separate device. The unique identifying transaction number may also be sent from the user to the second user via NFC, Bluetooth, a QR code, or other suitable methods. The second user may also type the amount and request payment.

Upon receiving the payment request and unique identifying transaction number, the verification server may send a notification to the first user's mobile device to verify the transaction. The user would then verify his or her identity using the face matching and/or verification system described above. The user may alternatively or additionally verify his or her identity using other biometric data, such as a fingerprint or retina scan, path based motion and imaging, or the user may enter a password. Upon verification, the user's device would send a request to the user's payment provider to request and authorize payment to the second user. In this manner, the payment may be made securely while the users in the transaction are anonymous.

According to one embodiment, as an additional measure of security, the GPS information from the mobile device may also be sent to the verification server to verify and allow the retail transaction. For example, the GPS coordinates from the mobile device may be compared with the coordinates of the retail establishment to confirm that the user is actually present in the retail establishment. In this manner, a criminal who has stolen a credit card and attempts to use the card from a distant location (as compared to the retail location) is unable to complete a transaction because the user's phone is not at the location of the retail establishment. IP addresses may also be used to determine location.

As explained above, the level or percentage of correspondence between the enrollment information and the verification information to verify the user may also be adjusted based on the coordinates of the GPS of the mobile device. For example, if the retail establishment and GPS coordinates of the mobile device are near a user's home, then the level of correspondence may be set at a lower threshold, such as at a 99% match rate. Alternatively, if the location is very far from the user's home and is in a foreign country, for example, then the level of correspondence may be set at a higher threshold, such as at a 99.999% match rate.

### Biometric Identification Using Root Identity Information

Most biometric identification systems in recent years use devices such as smartphones to capture biometric data (e.g., A digital photograph or scan of a fingerprint). This biometric data is matched to preexisting biometric data either on the device (in compliance with the FIDO (Fast Identity Online) alliance standards) or on the cloud (a remote computing device), where the biometric data is sent to servers and compared to preexisting data.

However, with the ability to convert images or other biometric data into biometric templates on the device without sending the raw data files up to a server, an additional option is available. Existing raw biometric data, such as facial images, fingerprint scans, etc. Or converted biometric templates may be downloaded to the device. The downloaded biometric data may then be converted and/or compared to a biometric template that was created from the data captured on that device and previously uploaded to the cloud or captured and uploaded to the cloud from a different device.

This allows a third party to provide an existing root identity profile for comparison to the biometric information obtained at the device for verification. For example, the root identity profile may comprise an image or other biometric reading from a customer that was captured and verified in a bank branch, from a DMV (Department of Motor Vehicles) file, or from another authorized and trusted source. The root identity profile may alternatively or additionally comprise biometric templates created from the verified image or biometric reading. In this manner, the identification match at the device has an increased level of trust based on the verified, third-party root identity profile.

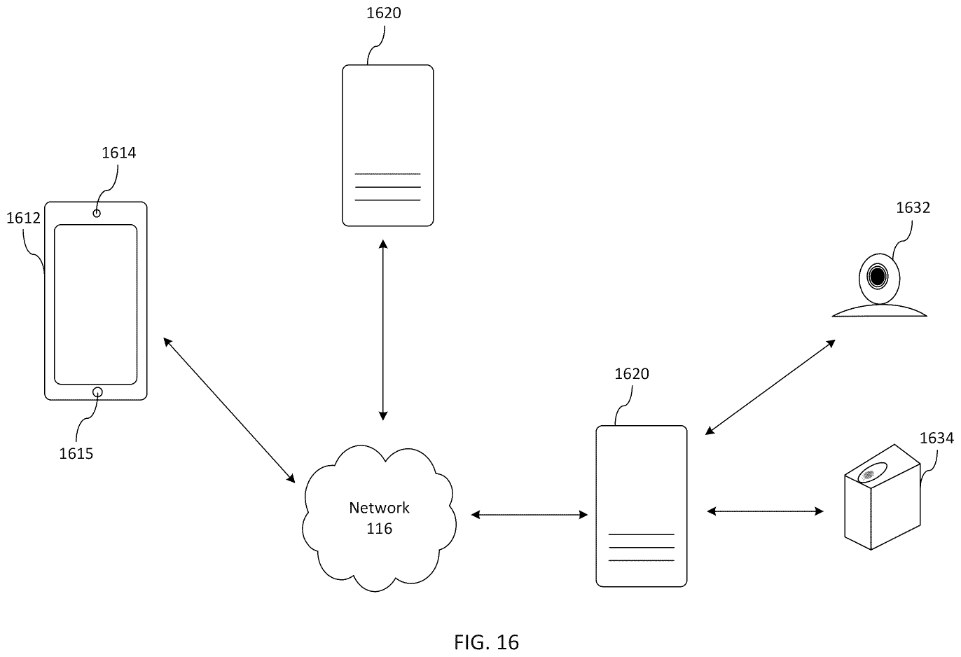

FIG. 16 shows a system for biometric identification using root identity information, according to an exemplary embodiment. The system includes a user device 1612, such as a smartphone or tablet computing device that comprises one or more biometric sensors, such as a camera 1614 and a fingerprint scanner 1615. The device 1612 communicates with a network 116, such as the Internet.

A root identity server 1630 is also connected to the network 116. The root identity server 1630 may be a bank server, a government server, or other “trusted” server that stores the root identity information, including biometric information and/or biometric template(s). The root identity server 1630 is connected to biometric sensing devices such as a camera 1632 or a fingerprint scanner 1634, A verification server 1620 providing an application, such as face matching algorithms and the like, is also connected to the network 116.

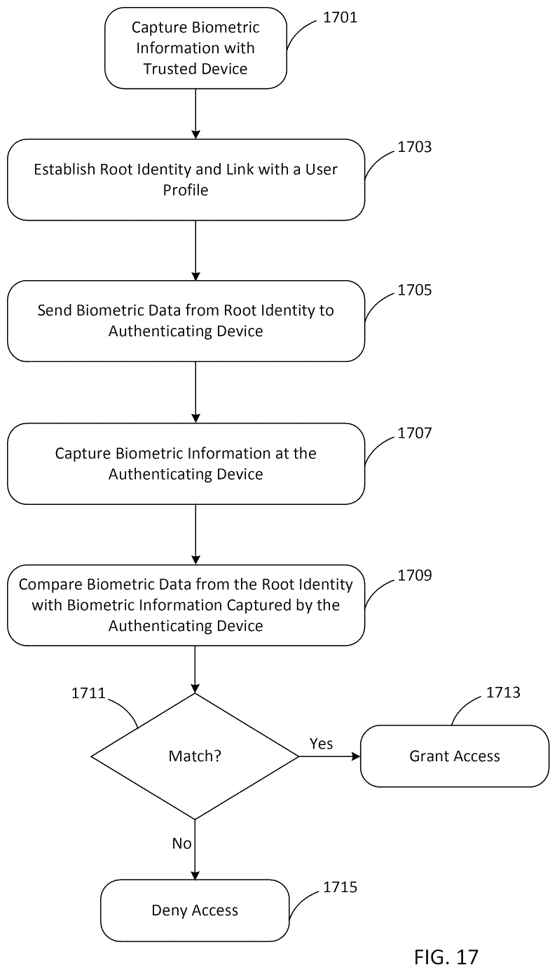

FIG. 17 shows a method for authenticating using a root identification system, according to one exemplary embodiment. Verification or verification using face matching or face data as the biometric information analyzed for a root identity profile may work as explained in the following exemplary embodiment. First, in step 1701, biometric information is captured via a trusted device (camera 1632 or scanner 1634 in FIG. 16). The device is considered trusted because the biometric information collected at the device is verified by a trusted institution such as a bank or government agency. A root identity profile is established in step 1703 that comprises the biometric information from the trusted device and links the biometric information to a user identity. This root identity profile is stored on the server, such as server 1630,

In step 1705, biometric information, such as an image that contains data about the face of an individual from the root identity profile, is sent from the server 1630 to the smart device 1612 upon a verification request from the smart device 1612. The user of the smart device 1612 then articulates the camera 1614 so that the user's face can be captured by the device's camera 1614, in step 1707. The image downloaded from the server 1630 and the image that has been captured on the device 1612 can now be compared in step 1709. For example, each image is converted into a biometric template by a face matching algorithm for comparison. Upon comparison, if the templates are similar enough based on the thresholds set by, for example, an application publisher, the device captured image (device identity) and the previously captured image (root identity) can be considered a match in step 1711. Access may then be granted, or the signup/enrollment process may then be completed based on the matching images in step 1713. If there is no match in step 1711, the access is denied in step 1715.

The benefits of this system include, but are not limited to, the ability to match previously captured biometric data from a different device with a new device while no biometric data leaves the new device during the matching. This is important in some regulatory environments and industries.

For face matching systems with a server component, the same face matching algorithm can be loaded onto the server as is running in an application on the smart device. This allows only the template to be transferred to the device instead of the biometric reading itself (e.g., the facial images, fingerprints scans, etc.). For example, in step 1705, the biometric information may be the biometric template instead of an image from the root identity profile. The algorithms must be configured so that the templates they create are homogeneous and can be compared. That is, if the algorithms output data in different formats, the resulting biometric templates/data format is incompatible, and no matching can occur because the similar facial features would not be represented by similar biometric template data patterns. The term template is defined herein as biometric data points represented by a string of numbers or other data formed in a consistently formatted pattern so that similarities and differences may be determined via various methods of comparison.

In an embodiment in which the template is transferred to the device, the root identity established in step 1703 may include a biometric template created from a biometric algorithm, such as a face matching algorithm. For example, an image that includes the face of an individual that was captured with a trusted device (camera 1632 at a bank branch, DMV, etc.) is sent to the server 1630, where it is converted to a biometric template with a face matching algorithm. As mentioned above, the biometric template from the root identity profile is sent to the smart device 1612 upon a verification request in step 1705. This can be referred to as the root identity biometric template. The method proceeds as previously explained with reference to FIG. 17, where the biometric templates are compared in step 1709.

In another example, two or more biometric modalities could be used together, such as fingerprints, face, and voice. Another example of the method of FIG. 17 using two or more biometric modalities may work as follows. First, images of a user's face, scans of the user's fingerprints, as well as a recording of the user's voice are captured with trusted devices in step 1701 (e.g., Devices 1632, 1634 at a bank branch, a DMV, etc. where the identity of the captured data is verified) to establish a root identity in step 1703. The images, scans, and recording may be considered root identity biometric data because this information is captured from a trusted source. In step 1707, the user of the smart device (1) presses one or more of his/her fingers on a fingerprint sensor, and/or takes a photo of their fingers; (2) articulates the camera so that the user's face can be captured by the device's camera; and/or (3) speaks words into the device's microphone to be recorded. The device recorded data may be considered device identity biometric data.

The root identity biometric data and the device identity biometric data are converted into biometric templates (root identity biometric templates and device identity biometric templates) by fingerprint recognition, facial recognition, and/or voice recognition algorithms. In some instances, the root identity biometric data may be converted into the root identity biometric templates at the server, and the templates may be sent to the device. The root identity biometric templates and the device identity biometric templates are compared in step 1709, and if the templates are similar enough based on the thresholds set by, for example, an application publisher, the root identity templates, and the device identity templates can be considered a match. Based on the match, access may be granted, or a signup/enrollment process can be completed in step 1713.

In another embodiment, in step 1709, the images and/or the biometric template(s) from the user's device may be uploaded to the server, where they can be stored and/or compared with the root identity biometric images and/or template(s). Then, if the user wishes to replace the original device or add a second user device to the account, both the root identity image(s) and/or template(s) the device identity image(s) and/or template(s) captured on the first device can be sent to the second device during set up or enrollment for comparison and matching. This daisy-chains the root identity from the server to the first device identity, and then again to the second device identity. If no root identity image and/or template has been captured previously and stored on the server, the image and/or template that is uploaded from the first device can still provide added security. If the user chooses to add a second device to an account, the image(s) and/or template(s) from the first device can be downloaded to the second device, and the comparison described above may again occur. This allows the user to add a second device with increased security because the user identities on both devices were deemed to be a match.

In addition, when the image(s) and/or template(s) are uploaded to the server, the on-server comparisons between the image(s) and/or template(s) can be performed independently from a comparison performed directly on the device. This offers a significant increase in security because even if a hacker were somehow able to manipulate the user's device to send a “match” result back to the server, the server would also compare the same image(s) and/or biometric template(s). Hence, the verification may occur at two or more devices or servers to make the system more secure. If fewer than all or a predetermined number of devices/serves to not verify, then a match is not declared. Thus, the server would also need to determine that the image(s) and/or biometric template(s) were a match using the same thresholds. Therefore, the hacker would not only need to compromise the user's device, but also the one or more servers to defeat the security.

In addition to the biometric matching, liveness checks may be included on the device portion of the matching as well as the server portion, as have been described in detail above. For example, additional information, such as device movement, skin texture, and three-dimensional depth information, can be used to help determine that the biometric data being presented to the camera is from a live human being and not a photo, video, or mask spoof.

### Remote Collection of Biometric Images/Templates

To verify biometric data, an individual typically is required to enter a bank branch, a government office such as a DMV or police station, or other “trusted” location to have his/her biometric data collected. For example, a bank may require a photograph, a fingerprint, or a voice recording to open certain types of accounts. The obtained biometric data is then linked to the person and the account. This in-person collection of biometric data has typically been required because there was no other way to trust that an individual was indeed who they claimed to be. Through the in-person collection, the identification is verified by, for example, the person providing documents with their name and photograph issued by a governing body.

However, according to an exemplary embodiment disclosed herein, an individual may provide his/her own biometric data using any smart device with a biometric sensor or camera to be verified without in-person verification. In fact, according to the disclosed embodiments, account providers, or financial institutions, may trust with more certainty than ever before that the biometric data provided is from the correct individual and not an imposter, hacker, or bad actor.

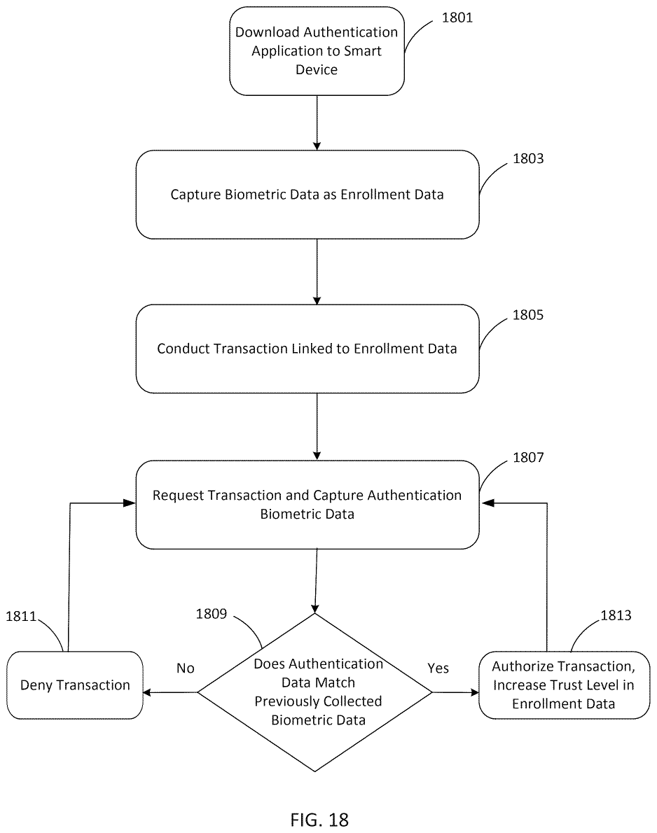

FIG. 18 shows a method of remotely establishing a biometric identity, according to one exemplary embodiment. In this embodiment, an individual first downloads an application to his/her smart device from an institution with which he/she either has an account, or with which he/she wants to open an account in step 1801. Upon opening the application and when prompted, the person presents his/her face, fingerprint, etc. To the camera or sensor. The biometric data is captured and stored on the device as “enrollment data” in step 1803. In some embodiments, the enrollment data is sent to the server.

Next, the user makes a payment or a deposit to the institution in step 1805. For example, if a lending institution has provided a mortgage to the user, then the user would enter his/her payment account information into the application so that the institution could collect payment. When the payment information and authorization is transmitted to the lending institution, some or all of the biometric enrollment data from the user is collected and transferred to the lending institution's server with it. Because the payment is made by the user for the user's debt, which causes money to flow away from the user and thus would not occur by a potential hacker or person committing fraud, the resulting biometric data collected as part of the transaction is considered trusted.

Later, when the user again opens the application to conduct another transaction, the user is again prompted to present his/her biometric information to the camera or sensor, and new biometric templates can be created in step 1807. The new biometric templates are compared to the previous “enrollment data” on the device, and/or the new templates can be sent to the server for comparison in step 1809. In some embodiments, the device may compare the templates by downloading the enrollment data templates from the server to the device for matching.

When it is determined that the new biometric information and/or templates do not match the enrollment data, then the transaction may be denied, as shown in step 1811, and the root identity will not have the unmatched biometric data added to it. However, when the new biometric information sufficiently matches the enrollment data, the transaction may be authorized as shown in step 1813. Furthermore, when there is a match, the trust level of the biometric data appended to the user's profile is increased.

Because the user is sending funds into the account, for example, to pay a debt or to make a deposit, he/she has an incentive to be able to later access the account that contains those funds or that has had debt reduced. Thus, over time, as several deposits and/or payments are made with matching biometric templates, the trust in the identity of the user performing the transactions increases, as shown in the loop of steps 1807, 1809, and 1813.

To limit liability, access to withdrawals can be limited to the same amount or less than has been deposited or paid in total by the user. For example, if a user pays a $3,000 mortgage payment each month for three months using his/her smart device and using his/her face to identify themselves each time, the lending institution may be willing to allow that person to transfer up to $9,000 from a different account that the bank has for the user, such as a checking account.

As banks and other lending institutions report on outstanding balances, credit limits, and payment timeliness to the credit bureaus, it is envisaged that the bank could also provide the biometric template (possibly in an encrypted format) to the credit bureau to store as part of the identifying information in the user's credit file. Then, if the user desires to apply for credit from a different institution, that institution can require that the user access their version of the application with the same biometric data collection system as was used to create the template. The biometric templates could be sent to the credit bureaus servers and compared with the templates on file for that individual. With this process, the user can positively identify themselves and grant access to the financial institution to view their credit information without providing or transmitting their social security number, date of birth, or other sensitive information.

If a user does not have a debt to pay to the account issuer or the issuer is not a financial institution, it is possible to simply offer a temporary escrow service to provide the assurance that the biometric data provided is true and correct for the user being claimed. For example, a user can provide a credit card number with his/her name and address, the card could be billed $100, and the user would provide their biometric data to the app in their smart device. The user would then correctly answer a series of knowledge-based verification questions based on their credit report, insurance information, medical information, or other potential confidential information, and provide their biometric data again to the app to retrieve the funds. The result is a biometric identity that can be trusted in future transactions up to the amount that was previously placed into escrow and successfully retrieved.

### Decentralized Biometric Identity Ledger

There are numerous security and privacy benefits to a decentralized, anonymous, biometric identity network as compared to biometric verification conducted on a centralized database or solely on a user device. As previously explained, biometric identity information may comprise images having biometric data, such as digital photographs of a face or a fingerprint, and/or biometric templates, which are strings of numbers representing data that has been captured by a sensor and converted to a string by a biometric recognition algorithm.

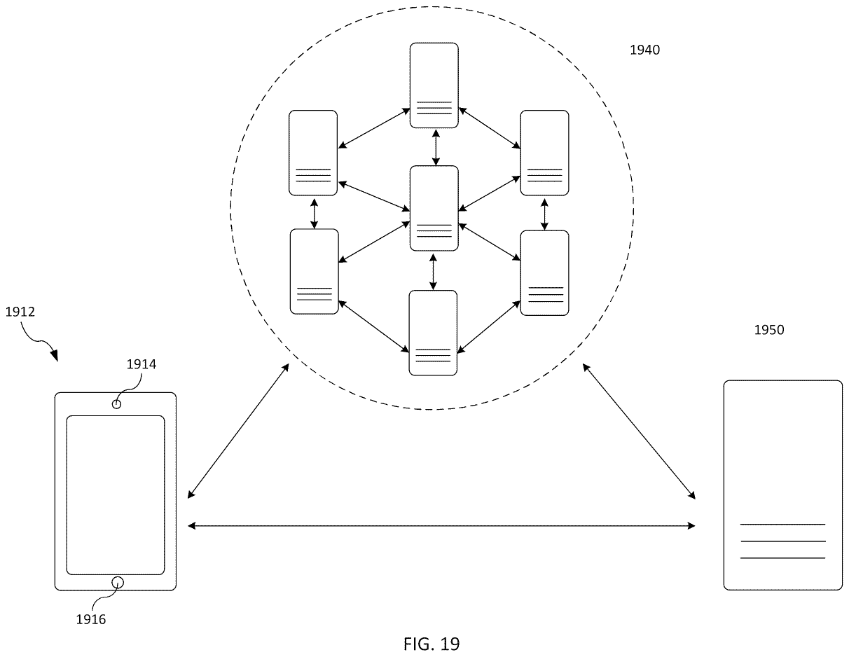

Decentralized ledgers such as blockchains, tangles, hashgraphs, etc., referred to hereafter as blockchains, can be used to create public or private records that provide an immutable transaction history. The blocks may store various data, and in this embodiment, the blocks may store biometric data in the form of an image or a biometric template created from a biometric sensor (camera, fingerprint scanner, etc.). And/or from an algorithm analyzing an output from the biometric sensor (photograph, fingerprint scan, etc.). FIG. 19 shows a system of biometric verification using a blockchain, according to an exemplary embodiment.

In an exemplary biometric verification method, a smart device 1912 would run an application allowing a sensor 1916 or camera 1914 to capture biometric data and optionally convert the biometric data to one or more biometrictemplates. That biometric data and/or template(s) would be added to an encrypted block along with additional information such as a device ID, a unique user ID, user identity information, the algorithm/sensor version/type info, date and time stamp, GPS information, and/or other data.

The block may be added to the blockchain 1940 where it is stored. If the user attempts to open the application again or provides the public key or a unique user identifier that corresponds to the public key for the block into another application. Then the user is again presented with the biometric data capture interface through which the user again presents his/her biometric data to the sensor 1619 or camera 1914. The captured biometric data may again optionally be converted to a biometric template on the device 1912. Next, the user's previous block is requested from the blockchain 1940 and is downloaded to the smart device 1912, where a private key may be kept in the application to decrypt the block. The data and/or biometric template(s) from the block can now be compared to the recently captured biometric data and/or biometric template(s). If a match is found, then the user is verified and granted access to the application, can make a transaction, etc. And the successful decryption of the block and the matching of the templates can be recorded with any combination of the data, the transaction, original template, the most recently successfully matched template, or both may be stored in the new block.

In addition to or as an alternative to the comparison and matching being done on the device 1912, the comparison and matching may be completed on the blockchain ledger servers 1940. In this instance, biometric data obtained at the user device 1912 and/or biometric template(s) generated at the user device 1912 from the biometric data is encrypted and sent to the blockchain ledger servers 1940. Next, the public key and the private decryption key may be sent to the blockchain ledger servers 1940 to decrypt one or more previous blocks of the user's biometric information and/or template(s), as well as to decrypt the most recently sent biometric data and/or template(s). The blockchain ledger servers 1940, then run the matching algorithms to determine if the biometric information and/or template(s) stored in the block and the most recently collected biometric information and/or template(s) are deemed a match by the thresholds previously set in the matching algorithm. By providing template matching on all the blockchain ledger servers 1940 (which could be hundreds or thousands of servers), an account provider can be sure that the device 1912 running the application has not been compromised if the matching results are the same as on the blockchain ledger servers 1940. The device 1912 and all of the blockchain ledger servers 1940 would have to be compromised at the same time for a hacker to change all of them, which, of course, would be highly unlikely if not impossible.

In yet another embodiment, a dedicated “matching server” 1950 could be employed that would be sent a copy of both the recently collected biometric information and/or template(s) from the device and the biometric information and/or template(s) in the block. The device 1912 may provide the decryption key directly to the matching server 1950, or the blockchain 1940 could be instructed to send the encrypted biometric template(s) to the matching server with a “smart contract,” which is a set of computer instructions coded into the block. This is a feature of blockchains with decentralized processing abilities like Ethereum.

It is also envisaged that when a new device requests a block using a user's unique ID, for example, an email address, phone number, or a public key, that the device is only authorized to download blocks in the chain that contain biometric templates of the user that are associated with that unique ID because the device contains the private keys. So, the user's most recent templates could be compared with all the templates that have been captured and are stored on the blockchain, allowing for multiple matches. This may provide fewer false rejections of the correct users that can result from changes in appearance due to lighting, aging. makeup, hair, beard, glasses, etc.

In one configuration of the system and method disclosed herein, there is a private key, and the private key will decrypt the block contents, but the biometric data inside the block is what is used on the comparison to determine if there is a match between new biometric data and stored biometric data. Thus, the private key is required to gain access to the biometric data block. The private key may be created by the user, the system, or the private key could correspond to a combination of unique identifiers that is easier to remember, a phone number, a social security number, an email address and a date of birth, etc., and thus also unique to the user. In this configuration, it is possible and contemplated that there are two blockchains, one with the personal data in it, and one with anonymous storage of biometrics templates only in it. The personal data blocks in the first blockchain would be decrypted by a private key or corresponding personal data combos that only you know, and you share it only with specific vendors that you want to be able to verify that identity, then in that data the block number of another block(s) with your biometric data is appended to that record and then the app can go unlock that block and match/update your newly uploaded biometric data to the data in that biometric block.

In addition to the biometric matching, the application collecting the biometric data may perform liveness tests on the biometric data collected, such as those described above. If the user is proven to exhibit traits that typically only exist in living humans, at the exact moment that the identity is verified, then the biometric data can be trusted to be from a real human being, not a non-living object such as a photo or video spoof.

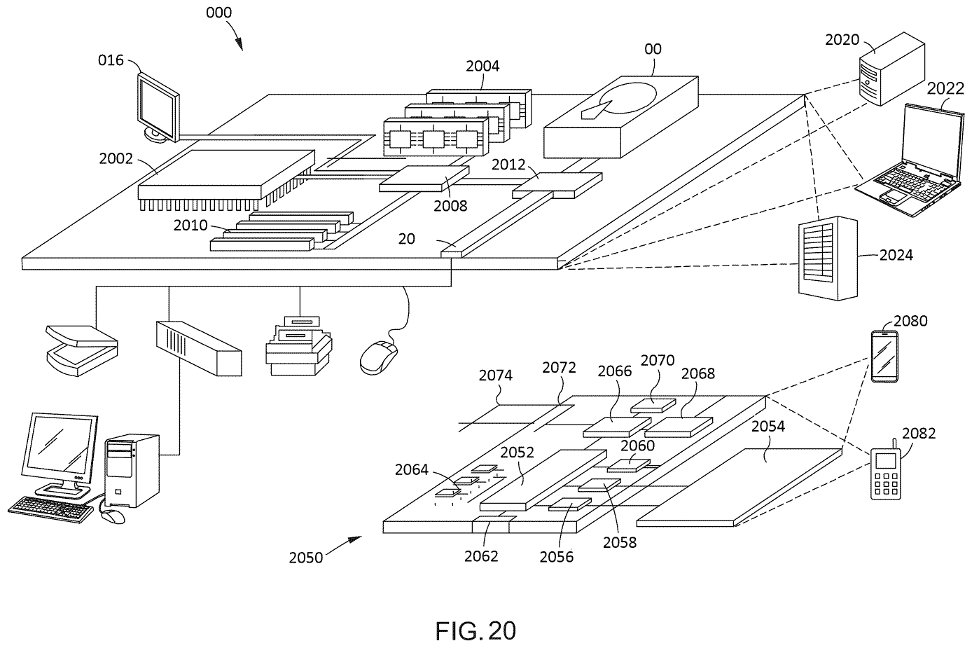

FIG. 20 is a schematic of a computing or mobile device, or server, such as one of the devices described above, according to one exemplary embodiment. FIG. 20 shows an example of a computing device 2000 and a mobile computing device 2050, which may be used with the techniques described here. Computing device 2000 is intended to represent various forms of digital computers, such as laptops, desktops, workstations, personal digital assistants, servers, blade servers, mainframes, and other appropriate computers. Computing device 2050 is intended to represent various forms of mobile devices, such as personal digital assistants, cellular telephones, smart phones, and other similar computing devices. The components shown here, their connections and relationships, and their functions, are meant to be exemplary only, and are not meant to limit the Implementations described and/or claimed in this document.

Computing device 2000 includes a processor 2002, memory 2004, a storage device 2006, a high-speed interface or controller 2008 connecting to memory 2004 and high-speed expansion ports 2010, and a low-speed interface or controller 2012 connecting to low-speed bus 2014 and storage device 2006. Each of the components 2002, 2004, 2006, 2008, 2010, and 2012 is interconnected using various buses, and may be mounted on a common motherboard or in other manners as appropriate. The processor 2002 can process instructions for execution within the computing device 2000, including instructions stored in the memory 2004 or on the storage device 2006 to display graphical information for a GUI (Graphic User Interface) on an external input/output device, such as display 2016 coupled to high-speed controller 2008. In other implementations, multiple processors and/or multiple buses may be used, as appropriate, along with multiple memories and types of memory. Also, multiple computing devices 2000 may be connected, with each device providing portions of the necessary operations (e.g., as a server bank, a group of blade servers, or a multi-processor system).

The memory 2004 stores information within the computing device 2000. In one implementation, the memory 2004 is a volatile memory unit or units. In another implementation, the memory 2004 is a non-volatile memory unit or units, The memory 2004 may also be another form of computer-readable medium, such as a magnetic or optical disk.

The storage device 2006 is capable of providing mass storage for the computing device 2000. In one implementation, the storage device 2006 may be or contain a computer-readable medium, such as a hard disk device, an optical disk device, or a tape device, a flash memory or other similar solid-state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 2004, the storage device 2006, or memory on a processor 2002.

The high-speed controller 2008 manages bandwidth-intensive operations for the computing device 2000, while the low-speed controller 2012 manages lower bandwidth-intensive operations. Such allocation of functions is exemplary only. In one implementation, the high-speed controller 2008 is coupled to memory 2004, display 2016 (e.g., Through a graphics processor or accelerator), and to high-speed expansion ports 2010, which may accept various expansion cards (not shown). In the implementation, low-speed controller 2012 is coupled to storage device 2006 and low-speed bus 2014. The low-speed bus 2014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2000 may be implemented in a number of different forms, as shown in the Figure. For example, it may be implemented as a standard server 2020, or multiple times in a group of such servers. It may also be implemented as part of a rack server system 2024. In addition, it may be implemented in a personal computer, such as a laptop computer 2022. Alternatively, components from computing device 2000 may be combined with other components in a mobile device (not shown), such as device 2050. Each of such devices may contain one or more of computing devices 2000, 2050, and an entire system may be made up of multiple computing devices 2000, 2050 communicating with each other.

Computing device 2050 includes a processor 2052, memory 2064, an input/output device such as a display 2054, a communication interface 2066, and a transceiver 2068, among other components. The device 2050 may also be provided with a storage device, such as a Microdrive or other device, to provide additional storage. Each of the components 2050, 2052, 2064, 2054, 2066, and 2068 is interconnected using various buses, and several of the components may be mounted on a common motherboard or in other manners as appropriate.

The processor 2052 can execute instructions within the computing device 2050, including instructions stored in the memory 2064. The processor may be implemented as a chipset of chips that include separate and multiple analog and digital processors. The processor may provide, for example, for coordination of the other components of the device 2050, such as control of user interfaces, applications run by device 2050, and wireless communication by device 2050.

Processor 2052 may communicate with a user through control interface 2058 and display interface 2056 coupled to a display 2054. The display 2054 may be, for example, a TFT LCD (thin film-transistor liquid crystal display) or an OLED (organic light-emitting diode) display, or other appropriate display technology. The display interface 2056 may comprise appropriate circuitry for driving the display 2054 to present graphical and other information to a user. The control interface 2058 may receive commands from a user and convert them for submission to the processor 2052. In addition, an external interface 2062 may be provided in communication with processor 2052, so as to enable near area communication of device 2050 with other devices. External interface 2062 may provide, for example, for wired communication in some implementations, or for wireless communication in other implementations, and multiple interfaces may also be used.

The memory 2064 stores information within the computing device 2050. The memory 2064 can be implemented as one or more of a computer-readable medium or media, a volatile memory unit or units, or a non-volatile memory unit or units. Expansion memory 2074 may also be provided and connected to device 2050 through expansion interface 2072, which may include, for example, a SIMM (single in-line memory module) card interface. Such expansion memory 2074 may provide extra storage space for device 2050 or may also store applications or other information for device 2050. Specifically, expansion memory 2074 may include instructions to carry out or supplement the processes described above and may also include secure information. Thus, for example, expansion memory 2074 may be provided as a security module for device 2050, and may be programmed with instructions that permit secure use of device 2050. In addition, secure applications may be provided via the SIMM cards, along with additional information, such as placing identifying information on the SIMM card in a non-hackable manner.

The memory may include, for example, flash memory and/or NVRAM memory (Non-Volatile Random-Access Memory), as discussed below. In one Implementation, a computer program product is tangibly embodied in an information carrier. The computer program product contains instructions that, when executed, perform one or more methods, such as those described above. The information carrier is a computer-or machine-readable medium, such as the memory 2064, expansion memory 2074, or memory on processor 2052, that may be received, for example, over transceiver 2068 or external interface 2062.

Device 2050 may communicate wirelessly through communication interface 2066, which may include digital signal processing circuitry where necessary. Communication interface 2066 may provide for communications under various modes or protocols, such as GSM voice calls, SMS (Short Message Service), EMS (Enhanced Messaging Service), or MMS (Multimedia Messaging Service) messaging, CDMA, TDMA, PDC (Personal Digital Cellular), WCDMA (Wideband Code Division Multiple Access), CDMA2000, or GPRS (General Packet Radio Service), among others. Such communication may occur, for example, through radio-frequency transceiver 2068. In addition, short-range communication may occur, such as using Bluetooth, Wi-Fi, or other such transceivers (not shown). In addition, GPS (Global Positioning System) receiver module 2070 may provide additional navigation-and location-related wireless data to device 2050, which may be used as appropriate by applications running on device 2050.

Device 2050 may also communicate audibly using audio codec 2060, which may receive spoken information from a user and convert it to usable digital information. Audio codec 2060 may likewise generate audible sound for a user, such as through a speaker, e.g., in a handset of device 2050. Such sound may include sound from voice telephone calls, and may include recorded sound (e.g., Voice messages, music files, etc.) And may also include sound generated by applications operating on device 2050.

The computing device 2050 may be implemented in a number of different forms, as shown in the Figure. For example, it may be implemented as a cellular telephone 2080. It may also be implemented as part of a smartphone 2082, a personal digital assistant, a computer tablet, or other similar mobile device.

Thus, various implementations of the systems and techniques described here can be realized in digital electronic circuitry, integrated circuitry, specially designed ASIC, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., Magnetic discs, optical disks, memory, programmable logic devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., A CRT (cathode ray tube) or LCD (liquid crystal display) monitor) for displaying information to the user and a keyboard and a pointing device (e.g., A mouse or a trackball) by which the user can provide input to the computer. Other kinds of devices can be used to provide for interaction with a user as well; for example, feedback provided to the user can be any form of sensory feedback (e.g., Visual feedback, auditory feedback, or tactile feedback), and input from the user can be received in any form, including acoustic, speech, or tactile input.

The systems and techniques described here can be implemented in a computing system (e.g., Computing device 2000 and/or 2050) that includes a back end component (e.g., As a data server), or that includes a middleware component (e.g., An application server), or that includes a front end component (e.g., A client computer having a graphical user interface or a web browser through which a user can interact with an implementation of the systems and techniques described here), or any combination of such back end, middleware, or front end components. The components of the system can be interconnected by any form or medium of digital data communication (e.g., A communication network). Examples of communication networks include a local area network (“LAN”), a wide area network (“WAN”), and the Internet.

The computing system can include clients and servers. A client and server are generally remote from each other and typically interact through a communication network. The relationship between a client and a server arises by virtue of computer programs running on the respective computers and having a client-server relationship with each other.

Biometric data templates are not suitable to be used as public keys and cannot be reliably hashed into public keys because each session contains biometric data that is slightly different than previous sessions. Biometric matching is done by creating a probability of a match and setting an acceptable threshold. In one embodiment, the settings are such that if the comparisonreveals collected biometrics data that is a 100% match, it may be considered to not be a match and instead a potential fraud attempt because biometric data comparisons are typically never a 100% match unless a replay (of the same data) attack is being perpetrated. Because biometrics rely on probability to confirm a matching identity, it is important not to allow bad actors to specifically target a known identity armed with copies of that individual's biometric data, such as photos, videos, or masks. This may be achieved by limiting access to the blockchain using user question data. It is also contemplated that an efficient means to provide a blockchain wherein the identity of the individual whose biometric data contained in each encrypted block is not readily known to the other users of the blockchain and therefore cannot be easily singled out and targeted is desirable. This is typically accomplished in blockchains with a public key; however, if a bad actor knows the public key for a specific individual, they can target a spoofing attack with reproduction of that individual's biometric data. By using a questions layer (requiring users to answer questions before granting access to the blockchain) that does not require the users to store, transmit, or even know their public key, the likelihood that a bad actor could match a specific block to a specific user and then spoof the system is reduced significantly. This method would allow a user to easily input data from memory that would then be used to recreate their public key and then used to identify the blocks in the blockchain system that contain their encrypted biometric data for verification, but not use personally identifiable information (PII) to do so. In one embodiment, this is accomplished through a series of questions that the person answers to generate user question data. In one embodiment, these questions are such that the person would always know the answers, such as city of birth, parent names, or high school name. In one embodiment, the questions are such that the person creates the answers such as favorites, things that change, or opinion-based questions. Examples of this type of user question data include favorite color, favorite food, or favorite holiday. In one embodiment, the user question data is created based on system requirements but does not relate to the user. Examples of this type of user data may be data containing only numbers, data containing special symbols, data containing only letters, and/or data containing a required number of each type of character. Some of this data may be easily recalled and thus not forgotten by the user. Other data is less likely to be guessed by others, but is harder to remember. It is contemplated that any other type of information and questions may be used for the user questions and associated user question data.

For the questions that are easily recalled or which are memorized, this user question data is always available to the user. In one embodiment, as part of an identification process, the user is asked questions or asked to provide the answers (user questiondata) to the questions. The user question data is concatenated and then hashed to create a public key and/or block identifier. This may then be used for one or more of the following: identify the user, identify the block associated with the user in the blockchain, combined with personally identifiable information to identify the user or the blocks that contain a user's encrypted information. For example, this concatenated and hashed user question data may identify to the verification system which block to match their biometric verification session against. This user question data may be referred to as a public key.

Examples of the type of user questions include, but are not limited to, best year of your life, number of siblings, shoe size, height, favorite color, eye color, last 4 digits of your first phone number, middle name, parents name, favorite grade in school, favorite month, favorite day of the year, best physical trait, school name, favorite food, dietary choices, political affiliation, and religious affiliation or any other similar type of question or data. In one embodiment, the data is well known (and not forgettable by the user) but is not of the type that is of public record or can be obtained by typical identity theft methods.

In one example method of operation, this verification system may be used when obtaining a money loan, at an automobile dealership, or any other situation where it is necessary or desired to positively identify the person and allow them to grant access to their credit bureau information to a third party (or some other function where identity is required and important).

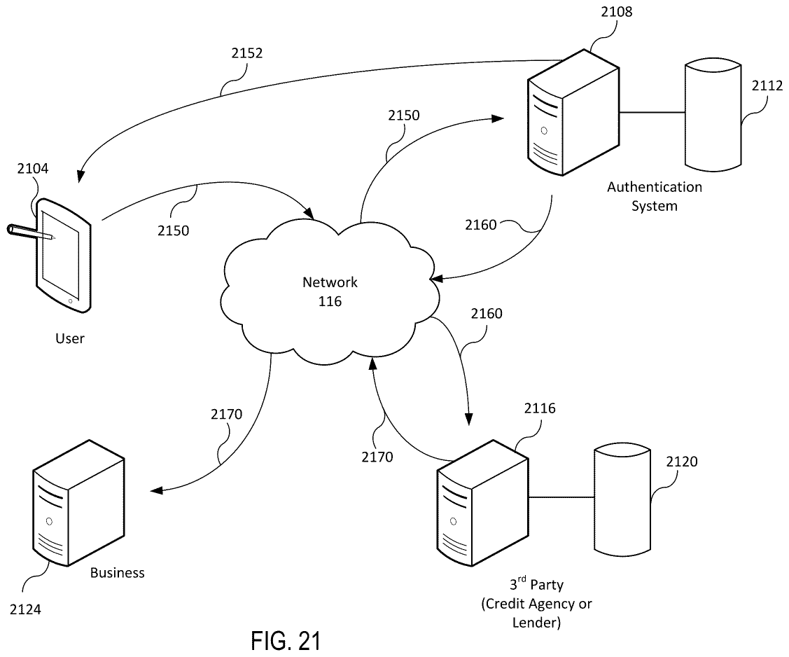

FIG. 21 illustrates a block diagram of an example system and environment of use. In reference to FIG. 21, at the automobile dealer (business) 2124 (one example environment of use), the user is presented with a computer interface 2104, such as a tablet. Using the computer interface 2104, the user's questions data may be inputted into a secure application or web interface with drop-down fields or text fields which do not store or record the user's input. The user is presented with questions for which they select their previously specified answers, or they provide the user question data without being presented with questions. At this stage, a hash operation or other algorithm processing may occur on the one or more user question data. The hash may occur on device 2104 or on a separate device 2108. Example operations that may occur on the user question data may include, but are not limited to, hash, encryption, combination with personal identifiable information such as name or social security number. By hashing or otherwise processing the user question data at this stage (prior to electronic transmission or storage), the user question data is protected. A biometric verification session may also be performed on the same device prior to, at the same time as, or after, providing and processing the user's question data.

The user device 2104 provides the user question data, which, after hashing or other processing, is provided 2150 by electronic transmission, to the remote verification system 2018 with associated database 2112 to identify both the user and their block. The verification system 2108 can run a same hash operation on the stored previously captured data stored in database 2112 to determine if the received data matches a user, account, block in a blockchain, or another identifier. In accordance with blockchain operation, many verification systems 2018 may be provided at different locations, or their blockchain data for the user may be stored in many different databases 2112 at different locations. The verification system 2108 may provide communication back to the user. Thus, the submitted user answer data matching the stored user answer data may identify the blockchain that stores the user's verification data, grant access to the blockchain, or both.

Once the block or blocks that are associated with that public key are identified, they can be decrypted with the hash to obtain the contents of that block. In this example, the hashed user question data provides access to the user's blocks and can be used to reveal the biometric data stored in the block, which is then compared to the newly submitted user's verification attempt (facial data and movement data) to determine if the user's identity matches the identity stored in the block chain (distributed at different locations thus preventing unauthorized access and unauthorized changes). If a match occurs, then, credit agency, loan department, or other entity 2116 will receive notice of the verification via communication 2160. This, in turn, may allow the loan to occur or a credit report to be sent to the business 2124 via communication 2170. For example, if the loan or credit is approved by the 3rd party 2116, then that will be communicated to the car dealership 2124, which in turn will allow the car to be driven away with only the down payment and/or a payment agreement. The match may also be a gateway requirement before the dealership can pull a user's credit or access a user's credit report. It is contemplated that in some embodiments, the lender 2116 and business 2124 may be combined.

Using this method, the user may provide user question data that would not be easily known by a third party since it is personal to the user and not asked by third parties. This form of data and associated method overcomes the drawbacks of the prior art by providing and associating complex data (user question data) that the user will have memorized and thus always with them, but yet that others do not know, and which uniquely identifies themselves or their block or account in the blockchain. The answer to the user question data is complex, difficult to guess, and longer and more difficult to obtain by a third party than the nine-digit social security number or other personal information (PII), but is generally easy for the user to remember.

If a third party knows the answers to all of the user's questions, the system would only allow them to attempt to match presented biometric data with the data stored in the blocks for that user. Because the third party will not easily match the biometric data with a photo, video, or mask if the biometric verification has strong depth and liveness detection systems, the verification attempt would not be verified, and thus the third party would not be able to impersonate the user. In addition, an email address or mobile phone number could be entered into the encrypted block when the user is enrolling, and an email or text message could be sent to the registered user's email address or phone number every time that block is unlocked, and the biometric data matched from a verification session or for every attempt. This would alert a user if a bad actor had gained the answers to their public key generating questions and was attempting to impersonate them through various means, such as using a look-alike of the user for a biometric spoof. If the bad actor were to be successful in spoofing the system, the real registered user would get an email saying that a successful verification session had been performed, and if it were not them, they could initiate steps to stop the bad actor. Notification could also be provided for unsuccessful attempts to access the block. It is contemplated that notification may be sent by email, phone call, or text, or any combination. In embodiment, the system may alternatively or in addition send a verification code to the user, such as by mail, phone (voice), or text, that must be entered with the user question data to provide an additional level of security. Sending and entry of verification codes are known and thus not described in detail.

It is contemplated that the user question data can arrive at the dealership, credit agency, bank, or other entity, in any manner. For example, the user question data may be entered by the user with the business's device, uploaded by the user on their own device, by using a third-party kiosk, provided by telephone, text messages, or any other means. Using this innovation, a method of creating a public key that people can easily remember, because it is well-suited for how human memory works. While the user question data may not all be secret, it can be easily remembered, and it is not publicly available and has not been part of the numerous data breaches, as the questions are not typical data, such as social security numbers, birth dates, and middle names. Any number of questions may be provided to create the public key, for example, two questions or ten questions, such that the more questions, the less likely someone is to know or guess the answers to access the block data for a verification attempt. While it is possible to use a user's name, social security number, email, or phone, this data would also identify the user and easily lead back to the blocks in the blockchain, but would expose the user's identity and can become known due to the use of that Information in other situations. With the disclosed system, utilizing user question data, the identity of the user and the block that stores their corresponding biometric data are anonymous to everyone, including the operators of the blockchain nodes. It is still possible for an individual to provide all of the answers to their user questions to a dishonest 3rd party or have that information phished from them unknowingly, but this is unlikely. For this to occur would still require the bad actor to spoof the biometric verification system to gain access to any credit information or other information, which due to the extreme accuracy of the verification routines disclosed herein, is extremely unlikely.

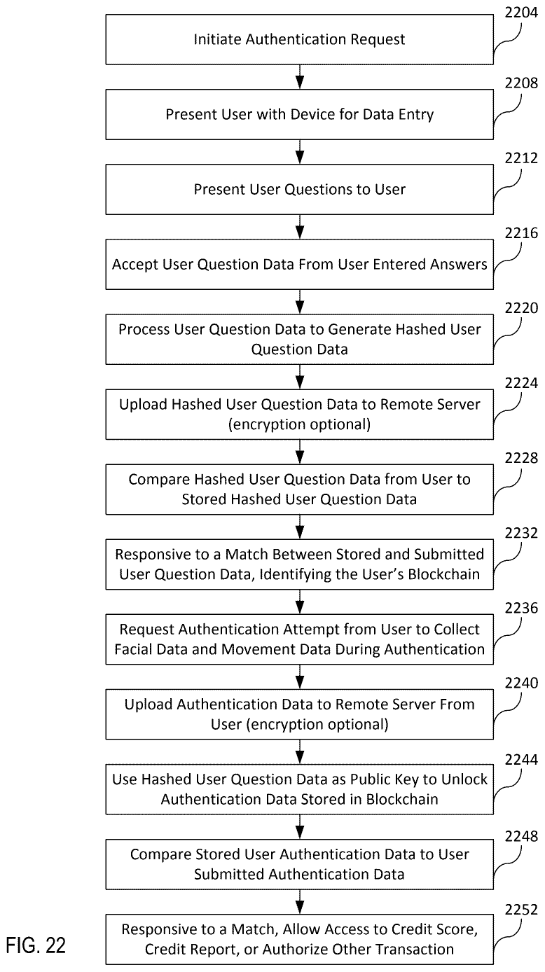

FIG. 22 illustrates a flowchart providing an example method of operation. This is but one possible method of operation, and it is contemplated that in other systems and environments the method may depart from that disclosed in FIG. 22 without departing from the claims. At a step 2204, the user, business, or system initiates a verification session, and as part of this, at a step 2208, the business attempting to verify the identity of the person may present to the user a computing device for data entry. The device may be any computer, including a tablet. The device and any server described herein may include a processor with memory such that the memory stores non-transitory machine executable instructions which are executable on the processor. The non-transitory machine executable instructions may also be referred to as software. At a step 2212, the computing device presents questions to the user, and as the user provides their answers, the computing device accepts the user question data at step 2216.

At a step 2020, the system processes the user question data to generate hashed user question data. This could also occur at a remote location. The hashed user question data may serve as a public key. Then, at a step 2024, the system uploads the hashed user question data to a remote server (encryption optional). Then, at a step 2228, the system, such as a remote computer configured for user verification, compares hashed user question data from the user to stored hashed user question data that is stored on one or more databases. The stored data was from earlier input from the user when the identity was known.

At a step 2232, responsive to a match between the stored user question data and the submitted user question data (hashed or unhashed), the system identifies the user's blockchain. Thereafter, the system requests a verification attempt from the user to collect facial data and movement data during verification. This occurs at a step 2236. In this embodiment, this data is collected the user question data matches, but in other embodiments, the user facial and movement data may be collected at the time of collection of the user question data. At a step 2240, the system uploads the verification data to a remote server from a user (encryption optional), and at a step 2244, the system uses the hashed user question data as a public key to unlock the verification data (facial, movement, or combination thereof) that is stored in the blockchain. This may occur at multiple locations such is the nature of a distributed blockchain.

At a step 2248, the verification system compares the stored user verification data to the user-submitted verification data to determine if there is a match within a predetermined threshold. As discussed above, 100% matches are unlikely or impossible, so the similarities between data should be within some range or threshold, which can be adjusted based on the use and need to verify identity. At a step 2252, responsive to a match, access is allowed, or the requested Information is provided, such as access to a credit score, credit report, or authorization for another type of transaction or loan. This system can be used in any scenario where verifying a person's identity is important. For example, buying an expensive watch or jewelry would benefit from identify verification, as would access control to secure location or data.

### Identity Verification with an Issued Photo Identification Card

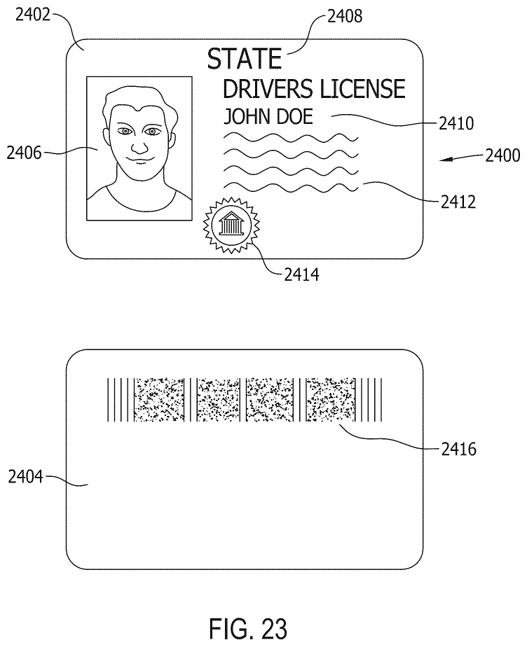

In some embodiments, the identity of a person authenticating using the above-described systems and methods may be verified using a photo identification card issued to the person. Identification using only the card analysis described herein is also contemplated. FIG. 23 illustrates an exemplary photo identification card. In FIG. 23, a photo identification card 2400 may be a driver's license, a passport card, a passport, or any other government-issued or privately issued identification card.

A photo identification card 2400 typically has a front side 2402 and a rear side 2404, which are each shown in FIG. 23. The front side 2402 includes a photo 2406 of the person to whom the identification card 2400 is issued. Here, the photo 2406 is shown positioned to the left side of the front 2402 of the card 2400. However, the photo 2406 may be placed in any position on the card 2400.

Other information is also printed on the card and may be formatted as shown or may be varied as needed and/or according to design preferences. For example, a name of a state 2408 issuing the card may be printed on the top of the front 2402 of the card 2400. The person's name, 2410, and other identifying information, 2412 may also be printed, such as a home address, height, weight, sex, date of birth, etc. The card 2400 may comprise one or more security features, such as a hologram 2414. On the back 2404 of the card 2400, a barcode 2416 may be provided, which is encoded with the holder's personal information and/or other information related to the identification card 2400.

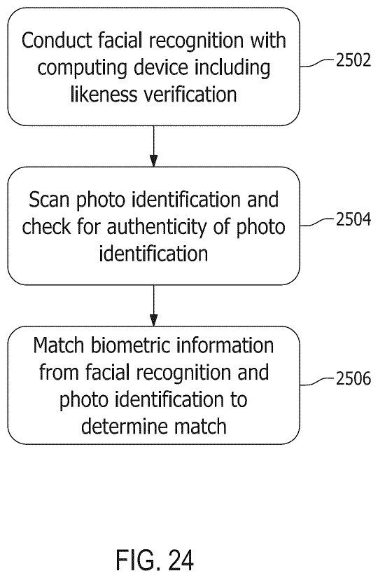

FIG. 24 illustrates a method for verification using biometric identification and a photo identification card. The method may be executed via software running on a device such as a computer, a laptop, a mobile device, etc. As described previously. In some embodiments, the method may be executed via a “presentation device” where the presentation device is connected to a remote device, such as a server on which the software runs. In this embodiment, the method utilizes a camera of the device, such as a front and/or rear-facing camera on a mobile device, laptop, or desktop computer, or a web cam connected to the device.

In step 2502, face matching is conducted using the device, including liveness verification. As explained in detail above, the person authenticating with the system captures images of their face with the camera of the device as prompted on the display of the device. As discussed above, the system may check for liveness and/or three-dimensionality of the person by prompting the person to change the distance between themselves and the camera by moving the device/camera or themselves with respect to the camera. This allows the system to verify whether the person authenticating is a live person and not a spoof. This also allows the system to conduct face matching and to collect biometric information for the person being imaged. It is contemplated and disclosed that one or more of the face matching and/or liveness detection features described herein may be used, alone or in any combination, with the photo identification card method described below.

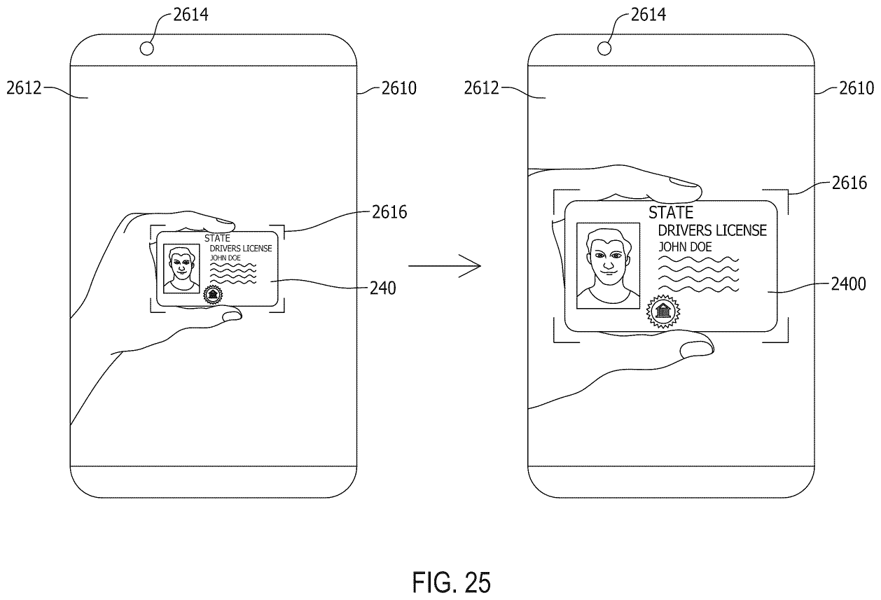

In step 2504, the person verified or being verified is prompted to capture an image or video his/her photo identification card, and the system scans the image of the card for authenticity and for the information contained on the card. The image could also be uploaded to a remote website configured with software to evaluate and verify the identification. During the image capture, for example, the system may prompt the user to move the card relative to the camera or the camera relative to the card. In other embodiments, the card/camera distance is not changed. If moving, the card (or camera) may be moved such that distance is changed between the camera and card in a straight line, closer or further away. FIG. 25 shows examples of validation of a photo identification card, according to an exemplary embodiment. In FIG. 25, a first example of a mobile device 2610 is shown having a screen 2612, and a front-facing camera 2614 among other features. A rear-facing camera is also provided, but not shown. As an example of step 2504 from FIG. 25, the display 2612 prompts the user to image the photo Identification card 2400 with the device 2610. The display 2612 may show guides 2616 that instruct the user at what distance to image the photo identification card 2400 with the device. The person may image the card 2400 with the device 2612 using the front-facing camera 2514 or the rear-facing camera.

As shown in FIG. 25, the device may then prompt the user to image the photo identification card 2400 at a closer distance relative to the camera of the device 2610. As shown, the guides 2616 may be animated to take up a larger portion of the display 2612 to instruct the user to hold the identification card 2400 closer to the camera. Either side or both sides of the card may be captured.

By requiring movement of the card relative to the camera, the system may perform several checks to determine whether the photo identification card 2400 is authentic, For example, as the card 2400 is moved relative to the camera, the hologram 2414 on the card 2400 may appear, disappear, and/or change. The system may include a check for the hologram on the photo identification card 2400 in order to verify that the card 2400 is genuine. In other embodiments, the system may perform banding, edge detection, and other screen detection processes as described above. In one embodiment, the system may check for the user's fingers at the edges of the card to help confirm that the card is genuine and being displayed on a screen of another device. Further, by imaging the card at a close proximity, the device can obtain a high-quality image of the card 2400, including all of the information on the card. It is also contemplated that the card may be rotated while being held so that the camera can see not only the face of the card and images and text on the face, but also the edges of the card. This further shows three-dimensionality and will further capture any security features of the card, such as holographic features. This would detect photocopies of the card on a piece of paper.

For example, in some embodiments, the device reads information from the card for use during verification or for other uses. The system may scan the photo 2406 on the photo identification card 2400 to obtain biometric information to compare to the biometric information obtained during step 2502. Further, the device may scan the card 2400 to retrieve the person's name and other identifying information via text recognition. The information may also be obtained by imaging the back 2404 of the card 2400 for the barcode 2416 or other type of code. This may be particularly useful for when a user sets up an account for the first time with an institution, so that the user does not have to manually input the user information.

In step 2506, the biometric information obtained from the user during step 2502 and from the photo identification card during step 2504 are compared to determine whether they are a match. The data obtained from processing the images of the card may be compared to a database of known card details to verify the format of the card is accurate and other details regarding the card match known formats such as but limited to picture location, card thickness, text font details, text location, security features, bar code format and location, card color scheme, and card aspect ratio. In this embodiment, facial biometric information obtained from imaging the user's face and from imaging the photo 2406 of the photo identification card 2400 are compared to determine whether the images are of the same person. This comparison may occur based on the captured image of the person that occurs as part of the verification process or from earlier captured photos stored in a database. If the biometric information from the different images are similar within a given threshold, then the user is verified.

Several variations to verify using a photo identification card are also contemplated. For example, steps 2502 and steps 2504 may be conducted in reverse order. That is, the user may first image the photo identification card prior to imaging themselves. In another example, the user may image themselves and the photo identification card simultaneously. This provides the advantage of having an image of the person holding the actual card, thus showing that the person is in possession of the actual card.

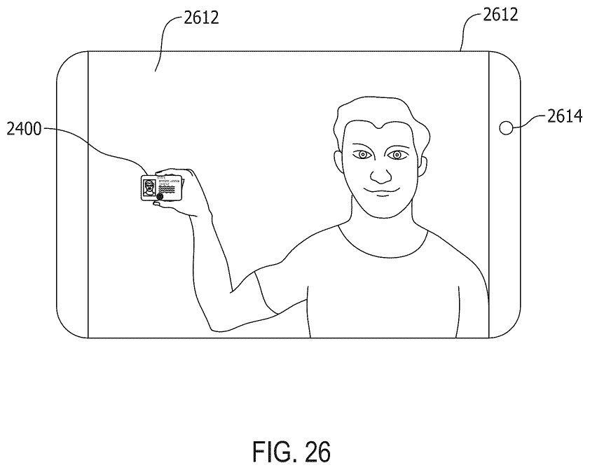

FIG. 26 shows an example of validation of a photo identification card, according to an exemplary embodiment. In this example, the user holds up the photo identification card 2400 and images themselves and the photo identification card 2400 with the mobile device 2610. The user may use the display 2612 of the device 2610 to ensure that both the user's face and photo identification card 2400 are clearly within view of the front-facing camera 2614. The device then captures images of both the identification card 2400 and the user simultaneously. As above, the display 2612 may include prompts that instruct the user how to image the card 2400 and himself/herself, including at different distances from the camera. The display may also prompt the user to move the camera to image the user's face and then the identification during the same verification session. This allows the images of both the user and the user's photo identification card 2400 to be tied together in time.

### Digital Identification

Also disclosed is a digital identification configured to further identify or provide assurances of the identity of a user. In many instances, it is desirable to have assurances that a person is who they say they are. Instances when this may be helpful occur in many situations. For example, prior to or as part of a transaction between two parties that are not conducting the transaction in person, it would be desirable for one or both parties to verify the identity of the other party. In particular, if one party has to pay before receiving the goods or before the goods are shipped, then they may want assurances regarding the person selling the goods. Internet and long-distance transactions are increasingly common. In addition, identity verification prior to a loan is another instance when it would be desirable to verify the identity of the person receiving the money. Likewise, hiring some to work remotely is an instance when verifying their identity is preferred. Further, when renting a house, car, or other item to a person without meeting them or verifying their identity is unwise. Many other instances exist where a third party may want to verify a person's identity, including, but not limited to dating, business relationship, care giver, transaction counterparty, or voter, such as a voter ID or an ID used to verify eligibility of government benefits. Therefore, there are numerous instances when it is preferred or needed to have some assurances or verify the identity of a person.

The system and method disclosed allow a user of the system to become a verified user. A verified user is a person to performs the steps disclosed herein, receives a digital ID, and the authenticity of the digital ID is conferred by a verification server. The verification server comprises one or more computer systems with associated software configured to process data received from the user during the creation of the digital ID and during the verification of the digital ID by a third party. The third party may be any individual or entity that is using the digital ID to verify the identity of the user. The digital ID may be used to verify the identity of the user the making the user a verified user.

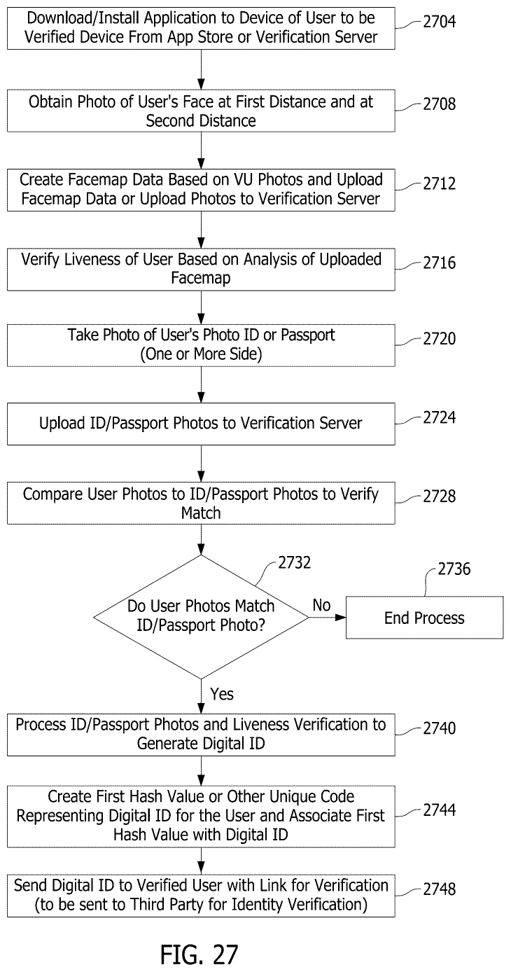

The verification server may be one or more servers or computers executing machine executable code. For example, one server or computer may act as a web server while another may function as a verification processing. Another server may perform data storage and database functions. FIG. 20 provides a diagram of an exemplary computer server configuration. FIG. 1 illustrates exemplary components that are described herein. A user may be the person 108, and their mobile device 112 captures the pictures of the user and the photo ID. Any of the servers 120 may be the verification server that stores in databases 124. Communication occurs over a network, such as network 116, that may include the internet. FIG. 21 also illustrates a hardware arrangement that may be re-configured for use with the digital ID system. The user may use the mobile computing device 2104, the server 2108 may function as the validation server, and the third party may use a computing device, such as a computer 2116. FIG. 27 is an operational flow chart of an example method for creating the digital ID. This is, but one possible method of operation, and other methods are contemplated. At a step 2704, a user is seeking to create a digital ID, downloads or installs to the user's device an application (software) from an app store or a verification server. In other embodiments, a web browser or website may be used to interface with the user to create the digital ID. Any type of device may be used, including but not limited to a mobile computing device such as a smartphone or tablet device, a personal computer, or any other device or system. At a step 2708, after installation of the application, the application is executed, and the application performs liveness verification (liveness detection) on the user to verify that the user is a live person and not simply a photograph or a three-dimensional model or figure of the user's face. In one embodiment, the liveness verification includes capturing a first photo of the user's face at a first distance and a second photo of the user's face at a second distance. Other methods of liveness verification can be used. The process of capturing photos of the user's face with the camera located at different distances from the user's face is discussed above in detail. The captured photos may be stored on the user's device or processed to create facemap data at a step 2712. Facemap data is data representing the user's face as captured in the image, but it is not an image of the user, and the user's face cannot be reconstructed from the facemap data. The images, facemap data, or both are uploaded to a verification server for processing. Facemap data may be considered biometric data or image data.

At step 2716, the images or facemap data are processed to verify liveness of the user. Liveness verification may occur in any manner, including any manner disclosed herein. If the liveness verification determines that the user is not a live user, such as if the photos represented a two-dimensional image or a non-human three-dimensional representation of a person (mannequin, bust, 3-D face model), then the operation ends, and the digital identification cannot be created.

Alternatively, if at step 2716 the photos or facemaps are determined to be a live person, the operation advances to a step 2720. At a step 2720, the user is instructed to take a picture of their photo ID (ID which has a picture of the user), such as a driver's license, military ID, state or country-issued ID, or their passport. In one embodiment, the user has the option, either manually or automatically, black out and not show one or more items of information from the photo ID. For example, the user's driver license number, passport number, birthdate, and/or address, or any other sensitive information, may not be shown on the digital ID or not uploaded to the verification server. One or both sides of the ID are photographed by the user using their device to capture the photos using a camera associated with device. At a step 2724, the user uploads the captured image to the verification server. In one embodiment, the user manually uploads the image while in other embodiments, the application software automatically uploads the image of the user's ID or passport.

It is also contemplated that alternative or additional documents may be captured with an image and uploaded to the verification server. For example, to verify that the user has the goods or the right to rent/sell the property, or conduct the transaction, additional images may be captured and uploaded. This may include, but is not limited to, images of the item being sold, or a vehicle title, property tax records, work history, themselves in or at a property, themselves with the goods, or showing the VIN (Vehicle Identification Number), or a voter registration card, or any other image capture.

Next, at a step 2728, the verification server and software (machine executable code) running on the verification server compares the one or more of the first image and the second image (captured at different distances) of the user to the photo of the user in the user ID to verify that the user ID photo matches the photos of the user captured at step 2712. This may occur using face matching or any other image comparison techniques for determining or matching the identity of a user.

At a decision step 2732, a determination is made whether one of the images of the user matches the photo ID or passport. If the photos do not match, then the user's ID does not match the uploaded photos. The photo ID may be outdated, stolen, or forged. As a result, the operation advances to step 2736, and the operation terminates with a message to the user that the photos do not match and, as such a digital identification (ID) cannot be created.

Alternatively, if the photos match, then the operation advances to step 2740, and the verification server processes the liveness verification determination and the photo(s) of the user's photo ID or passport to generate the digital ID. The digital ID may take any form, but in this embodiment, it is an image or PDF (Portable Document Format) file that shows one or more of the following: photo ID image or variation thereof, user's photo, user's email address for the user, verification of liveness, and GPS location, specific or generalized, city or country, timestamp, estimated age, or any other information.

Next, at a step 2744, the verification server processes the digital ID to generate a hash value representing the digital ID. It is also contemplated that any other type of processing may occur on the digital ID file to generate a unique code that represents the digital ID. A hash function is one example of processing that generates a unique value corresponding to the digital ID. Hash functions performed on an image are known to one of ordinary skill in the art and are not described in great detail herein.

The value resulting from the hash function is stored for future use and associated with the digital ID. At a step 2748, the digital ID is sent from the verification server, such as by email as an attachment file, to the user. The digital ID may be an image file that is viewable by the user and which may be stored by the user or sent to a third party by the user.

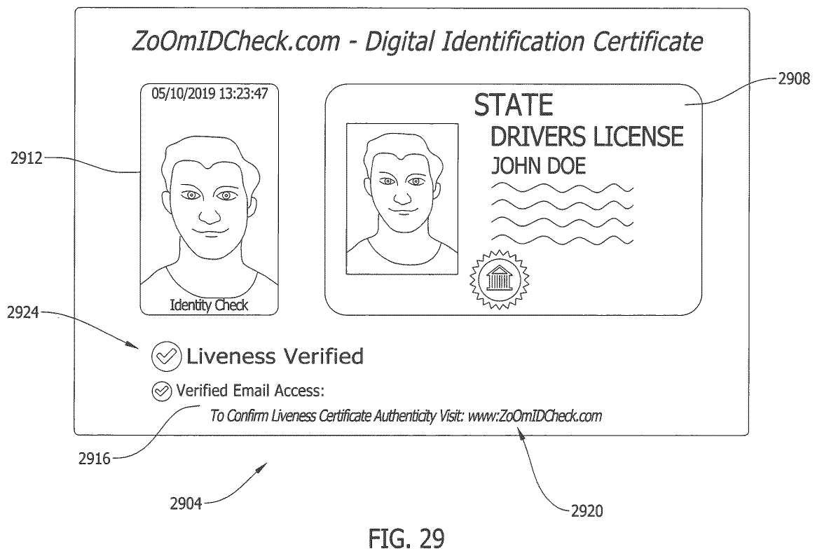

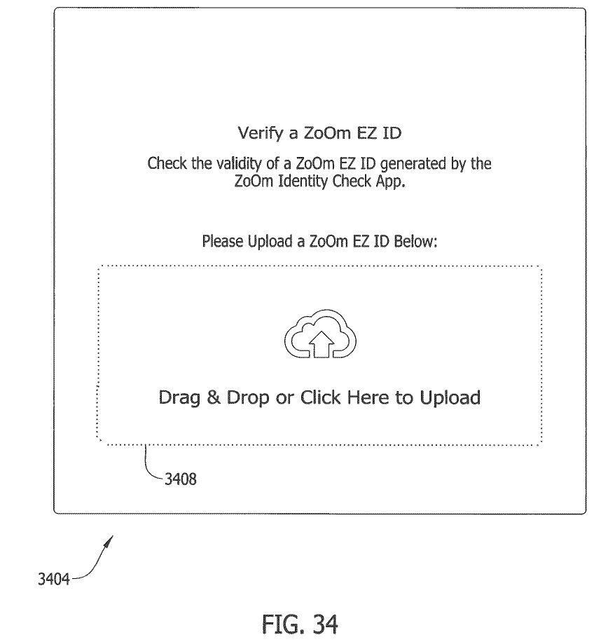

The user may also be provided a link to the verification server, such that the link may also be shared with a third party. Use of the link is discussed below in connection with FIGS. 29 and 34.

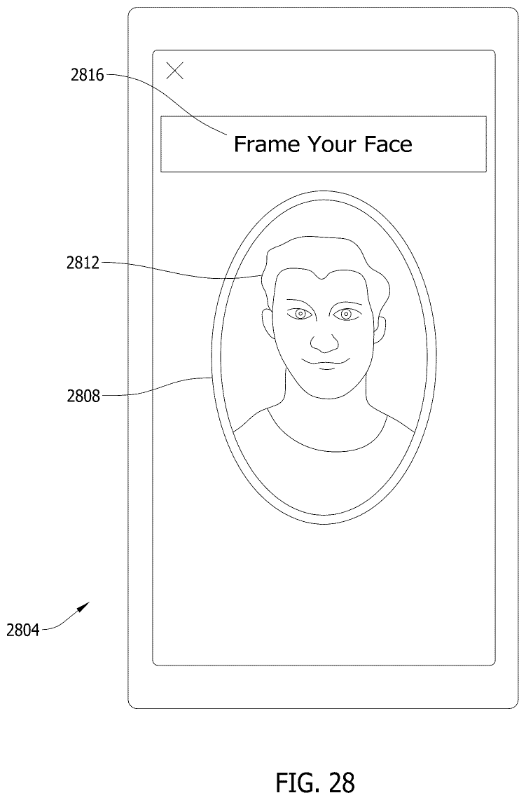

FIG. 28 illustrates an example screen display for the software used to capture the first image. As shown a screen 2804 may be on a mobile computing device, tablet, laptop, or desktop computer with a web camera. Also shown on the screen 2804 is an oval used to frame the face and provide guidance to the user on where to place their face on the screen, as captured by the camera. Inside the oval 2808 is the user's face 2812. During image capture, the size of the oval may change, thereby prompting the user to change the distance between the user and the camera, which in turn changes the size of the user's face on the screen 2804. One or more instructions 2816 may be provided on the various screens of the software during use to aid and guide the user.

FIG. 29 illustrates an exemplary digital ID. This is but one possible configuration of a digital ID, and other arrangements are contemplated. As shown, the digital ID 2904 includes the user's photo ID image 2908 as well as one of the first or second images captured of the user during the liveness determination. Also part of the digital ID 2904 is a liveness indicator 2924 declaring the image captured was of a live user. Also provided is a verified email address. The verified email address is the user's email address used when downloading the application (as part of signing into the application) and to which the digital ID was sent. These must match. The digital ID 2904 also includes a verification link 2920. Use of the verificationlink 2920 is discussed below. In otherembodiments, the digital ID may also include locations for images of other items, are described above, such as copies of the item being sold, the user at the residence being rented, a copy of the title to the item with the user or any other image used to build trust in the transaction or interaction between the user and the third party.

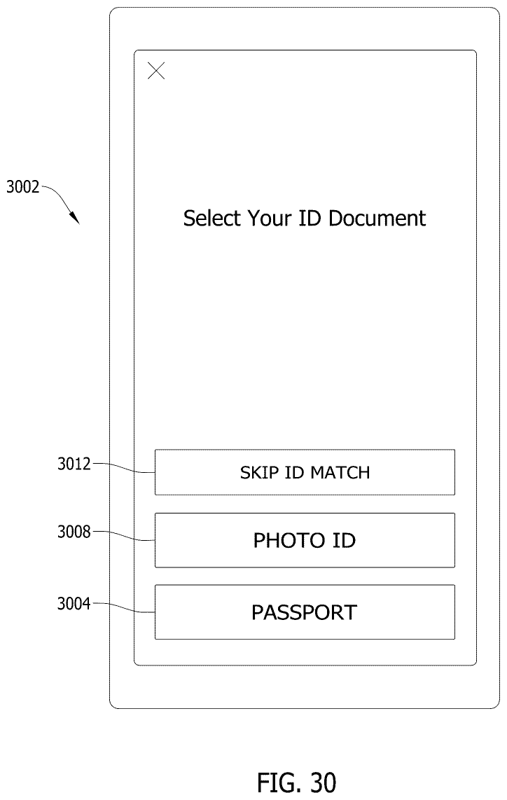

FIG. 30 illustrates an example screen display for photo ID type selection. This is but one possible screen display. The photo ID type selection screen 3002 includes a passport selection button 3004, a photo ID selection button 3008, which may be used for any type of photo ID that would be trusted by the third party, and also a skip ID match button 3012, so the user can skip this step and features of the digital ID.

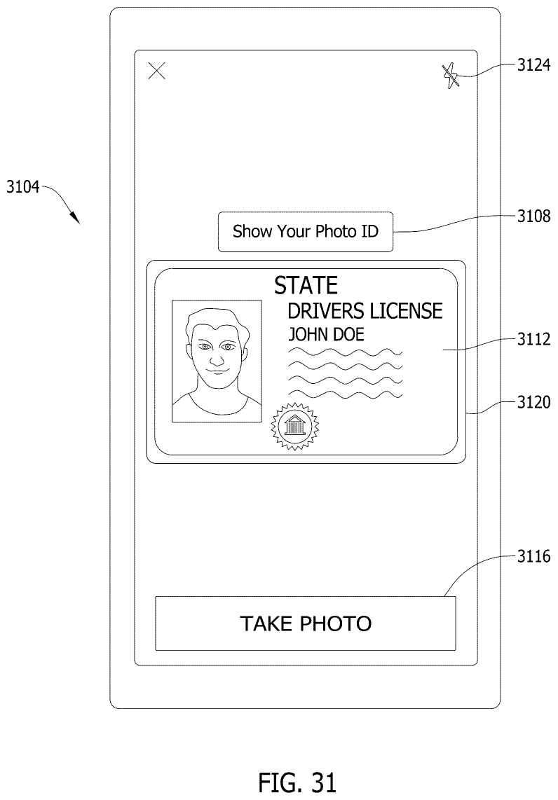

FIG. 31 illustrates an exemplary photo ID image capture screen display. This is but one possible arrangement and layout for the photo ID image capture screen. In this exemplary screen layout for the photo ID capture screen 3104 is an ID framing area 3120 in which a photo ID 3112 is framed. An instruction area 3108 is provided for guidance to the user. A flash enable/disable button 3124 is provided to the user to activate or deactivate the device's flash or light, if so equipped, or image processing and light sensing may be used to automatically enable or disable the flash or adjust the flash timing or intensity. The brightness of the captured image may also be adjusted after capture. A capture photo button 3116 is also provided to activate the mobile computing device to capture the image of the user's ID when the ID is properly framed.

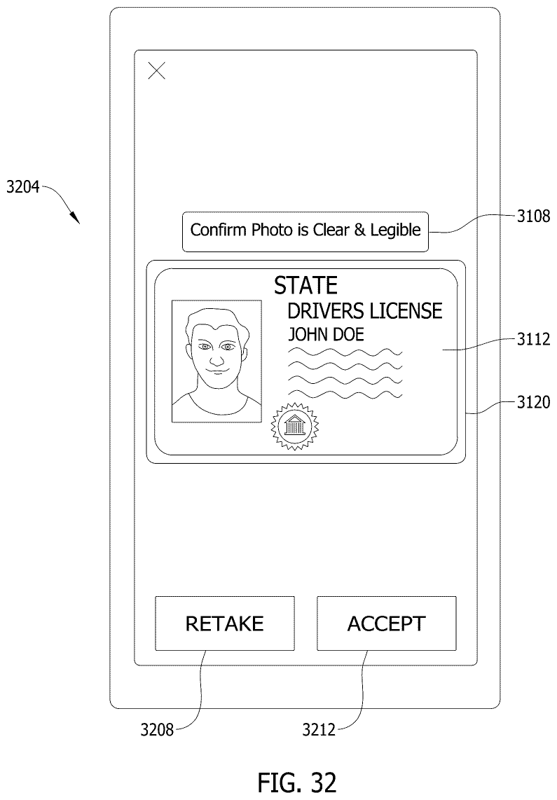

FIG. 32 illustrates an exemplary photo ID image acceptance screen. This is but one possible arrangement and layout for the photo ID image acceptance screen. In this exemplary layout for the photo ID image acceptance screen 3204, some elements from FIG. 31 are repeated and not discussed again. On this exemplary screen, a retake button 3208 is provided in case the photo is not focused or not aligned properly. An accept button 3212 is provided to allow the user to accept the image of the photo ID displayed in area 3120.

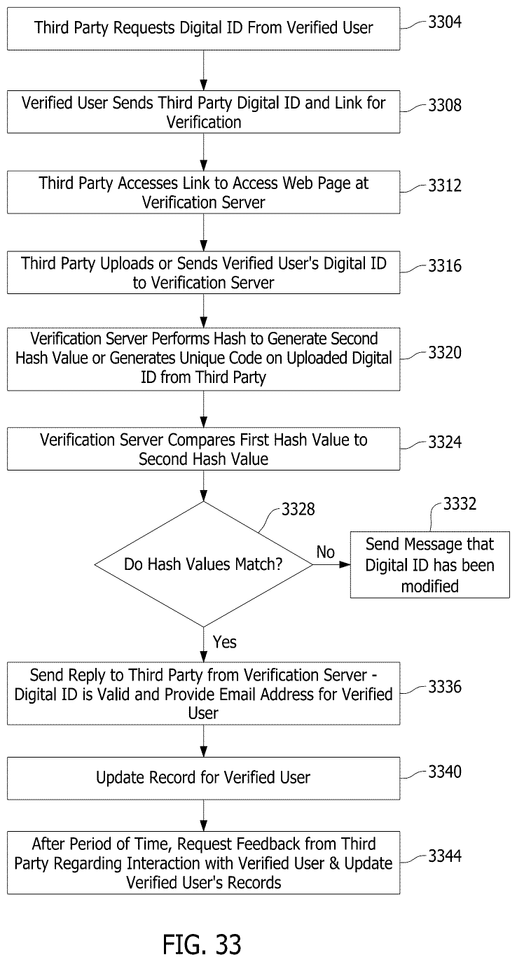

FIG. 33 is an operational flow chart of an example method for a third party to verify the digital ID at the verification server. This is but one possible method of operation, and it is understood that one of ordinary skill in the art will arrive at other methods which do not depart from the scope of the claims which follow. This method begins at a step 3304, when the third party requests a copy of the digital ID from the verified user. This may be for any reason that the third party seeks assurances with respect to the verified user's identity. Next, at a step 3308, the verified user sends the third party the digital ID. This typically occurs via email, but other methods are possible, such as a text message or any other way of sending the electronic copy of the digital ID to the third party. The sending of a picture (that is verified to be a live user) and an image of the user's photo identification that also matches the live user gives confidence to the third party. The verified user can also send a verification link to the third party, or the third party may independently access the verification server on their own.

At a step 3312, the third party accesses the verification server using the verification link, and then at step 3316, the third party uploads the digital ID to the verification server using the interface shown in FIG. 33. At a step 3320, the verification server performs the hash functions (same operation as performed on the newly created digital ID) on the uploaded digital ID to generate a second hash value. As discussed above, the verification server could perform other operations to generate a unique value that is uniquely associated with the digital ID. Next, at a step 3324, the verification server compares the first hash value (generated at the time of creating the digital ID) to the second hash value (generated from the digital ID uploaded by the third party). By comparing the two hash values, the verification server determines if any changes have occurred to the digital ID image file between when it was sent to the verified user (by the verification server) and to the third party from the verified user. This prevents the verified user from passing off a modified digital ID, such as by swapping out the image of the user or the image of the ID, and the verification server or the company (such as Face Tec, Inc.) does not have to store a copy of the digital ID, only the hash, yet the validity and authenticity of the digital ID can be assured to be genuine based on the hash value comparison.

At a comparison step 3328, a determination is made whether the first hash value matches the second hash value. If the values do not match, then the operation proceeds to step 3332, and the verification server indicates to the third party that the digital ID has been modified. The digital ID is not verified.

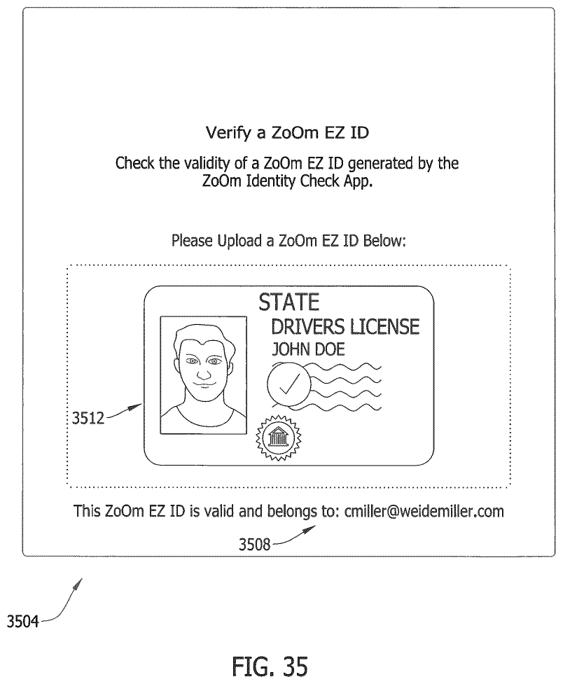

Alternatively, if at the decision step 3328 the two hash values do match, then the operation advances to step 3336, and the verification server sends a reply to the third party that the digital ID is valid and verified, along with the email address used by the verified user to use the digital ID software and receive the digital ID from the verification server. FIG. 35 illustrates an exemplary notification screen that may be provided to the third party.

Next, at a step 3340, the verification server may update a record associated with the verified user of the submission of the digital ID for verification and the successful match of the two hash values. This may be useful to validate the verified user over time to provide a trust score to the verified user or to create a history profile. At a step 3344, the verification server may request feedback from the third party regarding their interaction with the verified user. For example, the request for feedback may ask if the third party had a successful interaction with the verified user, or whether the verified user turned out to be who the verified user represented themselves to be. This feedback can be used to build a trust score for the digital ID and the verified user, or conversely, associate the verified user with fraud or misrepresentation. This information may be shared with other users or future users as a way to establish further trust in the system and digital ID.

FIG. 34 illustrates an exemplary digital ID upload screen presented by the verification server to the third party. This is but one possible arrangement and layout for the digital ID upload screen. In this exemplary layout, the digital ID upload screen 3404 is presented to the third party when the third party accesses the link from the verified user or independently accesses the verification server (website). On this page, there are one or more mechanisms for the third party to upload the image file of the digital ID. In this example embodiment, the third party may drop and drag the file to the upload location 3408. In other embodiments, other mechanisms to upload the image file for the digital ID may be used.

FIG. 35 illustrates an exemplary digital ID verification screen presented by the verification server to the third party. This is but one possible arrangement and layout for the digital ID verification screen. As shown, the digital ID verification screen 3504 includes a notification that the digital ID is verified, meaning that the email address on the digital ID is the same email address to which the digital ID was sent (to the user) and that the image file of the digital ID matches (as verified by the hash operation or other comparison process) the digital ID file that was originally sent to the user. Also shown in the digital ID verification screen 3504 is the email address used by the verified user, such as the email address to which the digital ID was mailed. A copy of the verified digital ID is also provided to confirm that the verification corresponds to the proper digital ID. In other embodiments, other items may be displayed.

In one or more embodiments, additional steps may occur to build trust in the user or the photo ID. In other embodiments, if the image of the photo identification provided to the verification server is a type that is known to the verification server database, such as a driver's license, then one or more matching algorithms may be run on the photo identification to verify that the photo identification matches a template of acceptable formats for the photo identification. Stated another way, if the photo identification does not have the required information in the required location and other aspects of the photo identification do not match the accepted template for that type of photo identification, it is noted on the digital ID, or the digital ID is not generated and provided to the user. For example, the matching algorithm may cross check the submitted photo ID image against the accepted template for the following factors, but are not limited to the following factors: font type, layout of elements on photo ID, color of elements or background of elements, expiration date, arrangement of information, format of information, watermarks, photo size, size ratio of elements to other elements, images, pictures, or artwork on photo ID, holograms, anti-copy features, bar codes, facial features compared to information on ID such as eye color, skin color, hair color, or any other factor or features.

As discussed above, a verification server, which may comprise one or more servers or computers, may receive the information from application software installed and executed on the user's computing device. The application software executes to provide the screen displays and functionality described herein. For example, the app software executing on the user's mobile computing device may capture images of the user and user's photo identification, and also upload the image files to the verification server. This provides a controlled, secure, closed system for obtaining the required information and transmitting the information to the verification server. It is also contemplated that a web page may be created that acts as the portal for the user to interface with the verification server. It is also contemplated that a user or third party may use a desktop computer or laptop computer to interface with the verification server.

As discussed herein, the facemap comprises data that is derived from the images of the user's face. The facemap data may be sent to the verification server instead of the entire image to reduce bandwidth requirements, reduce the time (for a given bandwidth) required to upload required information to the verification server, and add greater privacy for the user's images. In one embodiment, the facemap data cannot be used to re-create the image of the person. When generating the facemap data or selecting which image(s) to send to the verification server, specific face frames are selected for their position and quality.

The digital ID may be in any format of electronic file suitable for sending via text message, email, or other electronic transmission means. For example, and not limited to, the digital ID which may be an image file such as a JPEG (Joint Photographic Experts Group), TIFF, raw image format, PDF, BMP (bitmap), GIF (Graphics Interchange Format), PNG (Portable Network Graphics), or any other type of image file format. In one embodiment, the image file is locked and non-editable. The file format for the digital ID may be a proprietary format, usable by only the application software that is executed on a computing device. This may make editing or making changes to the digital ID more difficult, although any changes would be detected during the comparison of the hash values derived from the digital ID.

A drawback of prior art systems is the risk of face photo information release and the ongoing, varying state-by-state or country by country biometric and privacy laws, many of which are proposed and written by lawmakers with minimal knowledge of the technology and how advanced and complex verification system operation. One valid privacy concern from Individuals and trusted entities is the privacy of face image data obtained by a trusted source. For example, while an employer, bank, or government entity, such as the Department of Motor Vehicles (DMV) or police department, may have face image data and other personal information, there is an understood interest in maintaining internal control over this information and preventing release to the public of this data to third parties. In particular, the DMV and police departments are typically unwilling to release or receive face image data as part of identity verification. As a result, there is a need for a method and apparatus to verify the identity of a user based on data from a trusted source identity issuer's database (such as a database belonging to the DMV, employer, federal government, or police) without having to send face image data from or receive face image data from the trusted source.

To overcome the drawbacks in the prior art and provide additional benefits, it is proposed, in one embodiment, to create a graphical code (also referred herein to as a graphic code) with face feature vector data derived from facial images encoded into the graphical code. This graphical code (which may be referred to as graphic (UR™) code) can then be printed on an ID document established on any item (such as but not limited to documents, diplomas, credit cards, credit reports, passports (oridentificationcards), event tickets, voting ballots) or shown on digital screens. Once established on an item, imaging of the code and the face of the person associated with the code can occur to verify the identity of the person presenting the graphic code. This occurs by verifying a patch probability or a match within a threshold value between the face vector data stored in the graphical code and the person that is presenting their face to the camera for comparison. Other aspects of the document may be incorporated into the security checks to ensure that the graphic code (e.g., UR code) has not been added to the document later or swapped from another document. One approach is performing OCR (Optical Character Recognition) on the text on a document, or scanning a barcode and comparing the contents of the barcode that are also contained in the UR Code, like the name, DL# (Driver License Number), or DOB (Date of Birth), or obtaining data from the barcode, hashing it and storing that in the UR Code, which is discussed in detail below. This ensures the barcode, and the UR Code are connected and have not been swapped. These may be considered secondary checks. So that the UR Code can stand on its own, it is disclosed to include checksums and/or hash functions results in the graphic (UR™) code to verify a high confidence in the graphic code and prove that the graphic (UR™) code was not edited. To verify the graphic code, hashing of the all or a part of the data derived from the graphic (UR™) code and comparing the resulting value to a digital signature stored in the graphic may occur. Alternatively, the process may be performed by an encoding entity. These are possible approaches for the relying party to verify that the UR Code has not been edited.

Stated another way, the disclosed method and apparatus can establish identity or an association between a user and an item (such as a document) by using a graphic code (e.g., graphic (UR™) code) that stores biometric data and is printed on a document that comes from a trusted source (government identification, diploma, credit report) and match it to the face image data from the live 3D human (the person) without the document or graphic code exposing the photo of the person's face or revealing the person's physical characteristics like gender, age or ethnicity.

In other situations, a photo of the person is printed on the document in addition to the graphic code, which contains the encoded face vector data of that person. The face photo on the document can be imaged or scanned, and then processed and converted into a data format that can be compared to the data stored in the graphic code printed on the document or compared to the graphic code face vector data which was derived from an actual image of the person collected at the time of validation. The term ‘validation’ and ‘verification’ are used interchangeably. By matching two, three, or more, of these trusted, or liveness-proven biometrics to each other, a very high confidence that the presenter of the document containing the graphic code is indeed the person that was issued the document is achieved. This can occur with or without communication over a network to a trusted entity, such as the entity that issued the document to compare the graphic code data to graphic code data generated from trusted images at the trusted entity, or to a 3rd party that can confirm legitimacy of the graphic code and that is has not been tampered with using any number of cryptographic checks.

An additional benefit to the described method and apparatus is that the face image of the person, the person's face shape, the person's age, gender, or ethnicity, or person's identity cannot be reverse engineered or derived from the graphic code in any human viewable, comparable, or evaluable form. This allows the graphic code to be transmitted to and from a trusted entity without revealing or compromising the person's physical likeness.

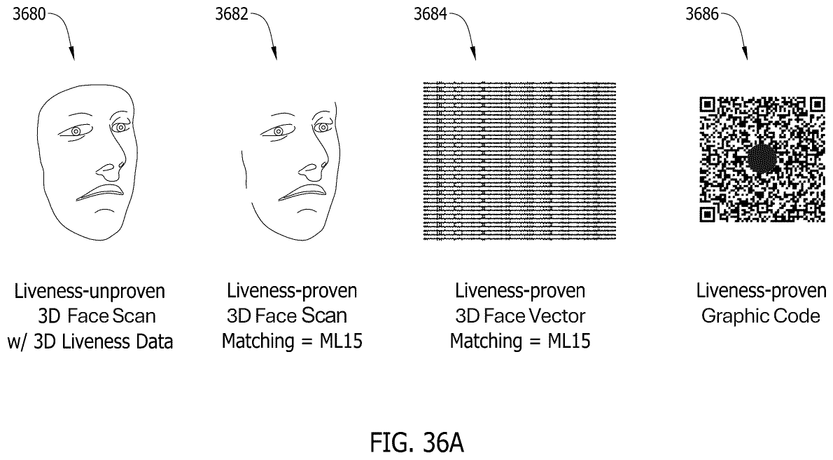

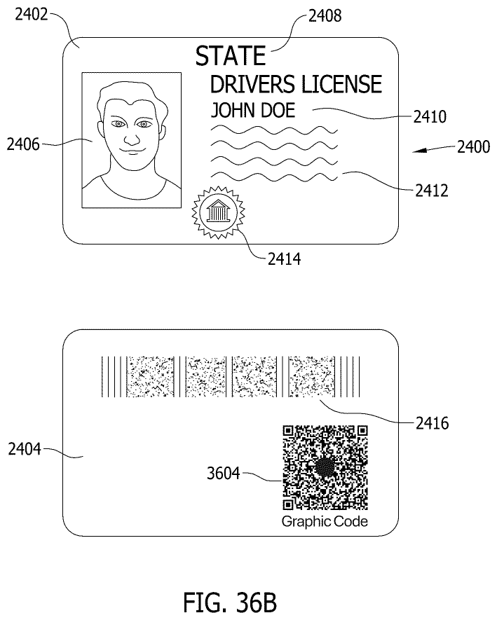

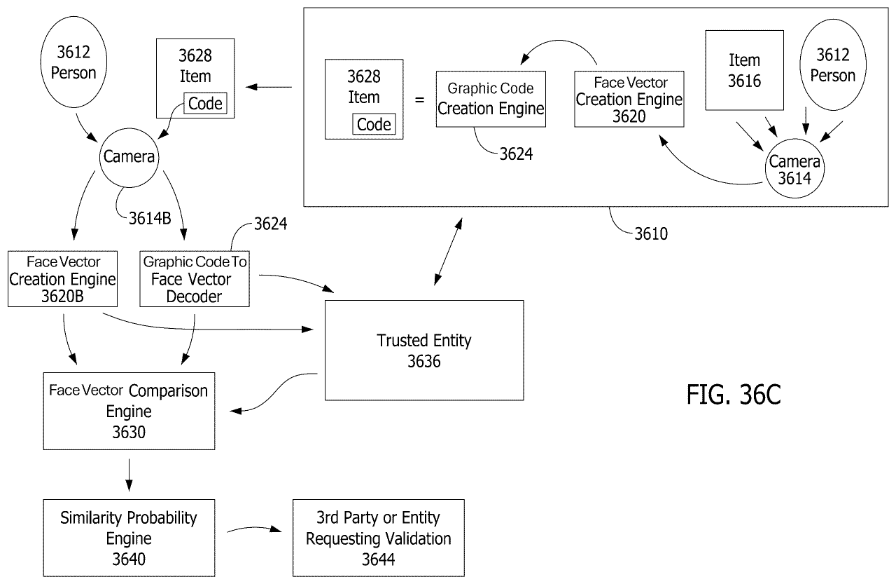

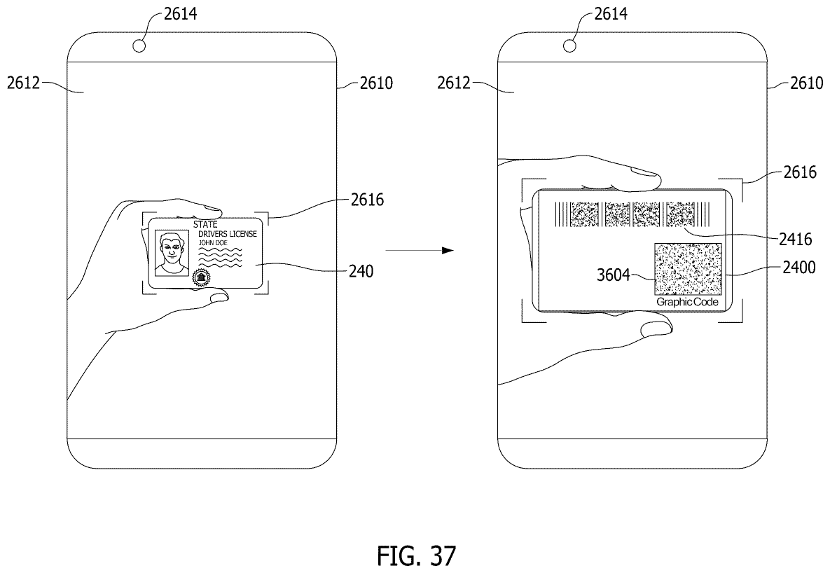

FIG. 36A illustrates an exemplary embodiment of the various stages of facial image data processing during the creation of the face vector data suitable to be stored in a graphic code (graphic (UR™) code, for example), which represents facial biometric data. Although shown in relation to a face, any type of biometric content could likewise be processed, including eye or iris scans, fingerprints, or any other type of biometric content. This Figure is provided for purposes of discussion and as an example. As such, this application is not limited by the processing shown in these stages. As part of the creation of the graphic code at a step 3686, which may be referred to as a graphic (UR™) code, an image or images of the person's face is captured. This can be just an image or multiple images that serve to provide more data about the shape of the user's face. These face images are processed at a stage 3680, to create a 3D facescan or just a mugshot-style face image. The face images or series of images that observe or capture the face from variable angles, positions, or camera locations, hereafter facescan, contain a high level of facial feature details. The facescan created at step 3680 can be used for liveness detection(anti-spoofing), three-dimensional depth verification, or both, as well as other processing due to the high level of face feature detall contained in the facescan. Thus, after initial processing as described above, the facescan may be considered liveness and or three-dimensionally proven.

As can be understood, the size of the data that is in the facescan file is large, and thus, for subsequent processing, the file size is reduced to provide benefits for storage and transmission efficiency. For example, 3D facescan files are created on the user device and encrypted before transmission over a network to a server that will decrypt and process the image data to determine if the face shown in the images stored in the 3D facescan were captured in real time from a live person, and are first generation captures of the physically present human, not photos of photos (spoofs), or replayed video frames.

Next, at a stage 3682, some of the face images in the facescan related to liveness detection are removed to create a 3D facemap (hereafter facemap). The facemap is a smaller file size and does not contain data sufficient for the previous level of liveness detection, but contains the record that liveness was previously proven to a high level of confidence on the larger data that comprises the 3D facescan file, if needed, at stage 3680. The facemap is suitable for use for matching to other facemap data, such as from an identification, prior image, or collected image, or to face feature vector data. While encrypted with sophisticated, proprietary encryption schemes with the facescan and the facemap files, images of the user's face are included and stored as human-viewable face images. Thus, these two data types do not hide the user's facial features, and if decrypted, could be reverse processed into human-viewable face images of the user. The terms user and person may be used interchangeably at times herein.

Next, at a stage 3684, the facemap (containing face image data) is processed into a face feature vector file, and remains in a face feature vector format that can be processed by a face matching algorithm, neural network model, or similar data comparison method, or be encrypted, and requires decryption prior to processing by a data comparison algorithm. (hereafter face vector). The face vector comprises a much smaller data size and may be represented by a string of alpha numeric values. In one embodiment, the size of the face vector data is as small as 128 bytes. The face vector cannot be reverse processed into a human viewable face image or used to recreate the person's face or likeness in any meaningful way that would reveal source data subject's identity. In this way, the face vector, either represented as an alpha numeric string or stored in a graphical graphic (UR™) code, can be published, shared, or distributed without providing an ability to re-create the person's face image, or face likeness.

Finally, at a stage 3686 the face vector is encoded into the format of a graphical code, like a barcode, which may be referred to as a graphic (UR™) code. In one embodiment, the face vector is 64 kilobytes, however in other embodiments, the graphic code may be made to be larger or smaller, or a greater or less resolution. As the graphic code becomes larger or higher resolution the amount of data which can be stored in the graphic code increases Stated another way, face vector data is face image derived data that cannot be used to re-create the likeness or identify the person visually, and does not visually link the face vector to the subject person's face whose data is encoded into it. Face vectors are created by processing face image data to create a face feature vector value, which may be numeric, alpha, alphanumeric, or any other data format. The processing should be considered a one-way conversion, such that the processing and face vector cannot be used to recreate the face image, the image data, or be used to identify the person in the image, unless that person is physically present, provides their face images again, and then with their consent the newly collected face data is converted into face feature vector data and then matched to the face feature vector data encoded into the graphic code as part of non-surreptitious identity verification process the subject person opts into. If the person who is attempting to match their face to the face feature vector data encoded into the graphic code is not a high probability match then no information about the characteristics of the subject's face that the facial feature vector stored in the graphic code was derived from is revealed, protecting the privacy of the subject. As a result, transmission orreceipt of a face vector (or graphic (UR™) code, which is a graphic code that includes an encoded face vector) is not transmission of user-identifying biometric data without additional data, such as data that links the face vector to a particular user. In one embodiment, face vector is similar to a hash function output such that it cannot be reverse processedto reveal the original data, yet face vectors have the added benefit of revealing similarities to another face vector that was created from the same person's face data.

This is a significant benefit because a hash function output can be compared to another hash function to determine if the original data is exactly the same, but provides no indication that the original data is similar or the degree to which the original data (prior to hashing) was similar. For example, if two face vectors are created based on DMV images taken one after another at the DMV, then those two face vector data sets can be processed to determine that those two face vectors were generated from the same person, and not from a different person. As a result, a probability may be generated of similarities between images which provides information regarding whether, and to what extent, an image is similar to another image, all from face vector data which cannot be used to recreate the original image or reveal data regarding the user's face.

By way of a nonlimiting example, if the original face image(s) of the person in the video frames output by a smart devices camera are over 200 mb in size, the 3D facescan at stage 3680 may be reduced to 350 KB in size, the 3D facemap at stage 3682 may be 180 KB in size, while the 3D face vector at stage 3684 may be 128 bytes ) in size (with no encryption layers or meta data). The graphical code 3686 is capable of graphically containing the encoded the 3D face vector 3684. The graphical code may be any size, shape, configuration, or be created using any type of printing or imposing technique, and as such is not limited to that shown herein.

FIG. 36B incorporates many of the same features as shown in FIG. 23, and as a result, the description of FIG. 23 as set forth above is incorporated and adopted for FIG. 36B. In addition to the elements of FIG. 23, FIG. 36B also includes a graphic code (e.g., a graphic (UR™) code) 3604 or any other type of code or information that is unique to the user, and the graphic code is machine-readable. The code 3604 may represent or contain face vector data. The creation and use of this code 3604 is discussed below in greater detail. The code 3604 may be similar to a QR code, such that it is configured as a graphical element that stores data and may be read or converted to a digital file (image file) with a camera, laser, or other graphic interpretation device to decode the graphical code into a string of values. To read or image the graphical code, the graphical code is held in front of the reader, such as a camera, and the image data is processed. Use and reading of traditional QR codes™ is known in the art and, as such, is not discussed in detail herein.

In this embodiment, the graphical code is printed on a driver's license or ID card. In other embodiments, the graphical code may be on any type of document or item that is to be verifiably associated with a person. This includes but is not limited to transcripts, diplomas, passports, deeds, titles to property, license plates, auto registrations, access cards or badges, legal documents, visas, credit cards, social security cards, green cards, assignments, transcripts, shipping labels or transport documents, medical or auto insurance cards, pet ownership tags, property ID badges, event tickets, voting ballots, or any other type document or item, including digital versions of these items, images or renderings of these items, or digital iterations of these items, such as mobile driver licenses (mDLs) or digital Identity or payment wallets.

To aid in the understanding of one or more aspects of the innovation disclosed herein, FIG. 36C is provided as a high-level overview of the graphical code (used interchangeably with graphic (UR™) code herein) that is established and used during validation of a person's identity or an items association with a person. Any of the hardware, software, or systems described herein may be used to enable the method and apparatus that relates to graphic (UR™) codes, including the computing system or servers shown and described herein. During a graphic code creation process 3610, a trusted face photo of a person, such as one on file with an identity issuer, or the face of a person 3612 is imaged with a camera 3614. The camera output is provided to a face vector creation engine 3620, which may be software, hardware, or both, that is configured to generate a face vector. One or more additional image data processing steps may occur prior to creation of the face vector, such as but not limited to liveness verification. In addition, in one or more embodiments, the camera's output feed when capturing the image of the person and the UR code is analyzed to ensure that it is a real camera feed coming from the camera in use. This proves that the document that is being scanned and the face images and UR code on it are physical objects, and their first-generation images are being collected by a real, working, physical camera, and not a video-injected replay attack or deep fakes.

After creation of the face vector, the face vector is provided to a graphic code creation engine 3624, which may be a software, hardware, or both, configured to generate a machine-readable graphic code that may be placed or imprinted on an item 3616 to create a coded item 3628.

At a later time, to validate or verify that the code on the coded item 3628 that is associated with the person 3612 may be imaged or scanned, and the person, such as their face, may be imaged with the same or different camera 3614B. As shown, the scan of the person's face is provided to the same or different face vector creation engine 3620B to generate a face vector of the person's face. Similarly, the image/scanned code is provided to a graphic code to face vector decoder 3624, which may be a software, hardware, or both, configured to convert the imaged/scanned graphic code to a face vector. Face vectors can be created from any digital 2D face image or facemap, but the source images a preferred to have characteristics similar to ICAO (International Civil Aviation Organization) 9303 and ISO (International Organization for Standardization) 29794: biometric sample quality part 5—face image data. The face vectors can be created at any time with any face image, similarto a mugshot or driver's license photo, and the matching accuracy potential of the face vector may be influenced by the resolution and quality of the source face images. In some embodiments a face vector that was created in the past that has been encoded into a graphic and a newer face vector that has been encoded into a different graphic code can be compared. Based on the relative dates of the graphic code creation, the code may be considered the older code or the newer code, and certain characteristics about the subject can be assumed, such as the subject is now older in the more recent graphic code encoded face vector than in the older graphic code face vector.

The face created validation face vector created from the person's face at the time of validation, as well as the graphic code derived face vector, which was derived from the graphic code, are provided to a face vector comparison engine 3630, which may be a software, hardware, or both, that is configured to compare the two face vectors. The results of the comparison are provided to a similarity probability engine 3640, which may be software, hardware, or both. The similarity probability engine 3640 evaluates one or more aspects of the comparison and generates a probability value or other indicator of a degree of match between the face vector derived from the graphic code and the face vector calculated from the person's face at the time of validation. The results of the comparison and/or the probability value or match level may be provided to a 3rd party or an entity 3644 requesting the validation of the document being associated with the person. The entity 3644 may be any entity that seeks confirmation that the item imprinted with the code is associated with the person.

Also part of this system overview is a trusted entity 3636 that may be the same as or different than the graphic code creation entity 3610. It is contemplated that the output of the face vector creation engine 3620B and the graphic code to face vector decoder 3624 may be provided to the trusted entity for comparison to trusted face vector data, such as by using a face vector derived from a trusted image that is stored by or accessible by the trusted entity 3636. The trusted entity 3636 may be a government entity such as the DMV, a financial institution, or a corporate entity which has trusted face vectors or images of the person which can be compared to face vectors created later in time. Although not shown, the trusted entity 3636 may include face vector comparison engines and/or similarity probability engines.

FIG. 37 incorporates many of the same features as shown in FIG. 25 and FIG. 36B, and as a result, the description of FIG. 25 and FIG. 36B as set forth above is incorporated for FIG. 37. In addition to the elements of FIG. 25, FIG. 37 also includes the step of scanning the back side of the ID with a camera that is part of mobile device 2610 (such as a smartphone) or another type scanner, The ID or other type of document has the graphical code 3604 shown in FIG. 36B. The screen of the mobile device 2610 displays the document containing the code so the user can properly align the code and/or ID card (or document) on the screen. The creation and use of this graphic code is discussed below in greater detail.

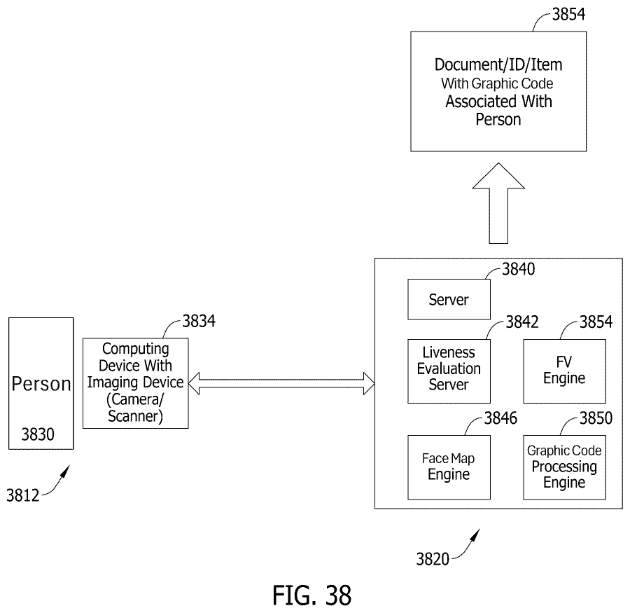

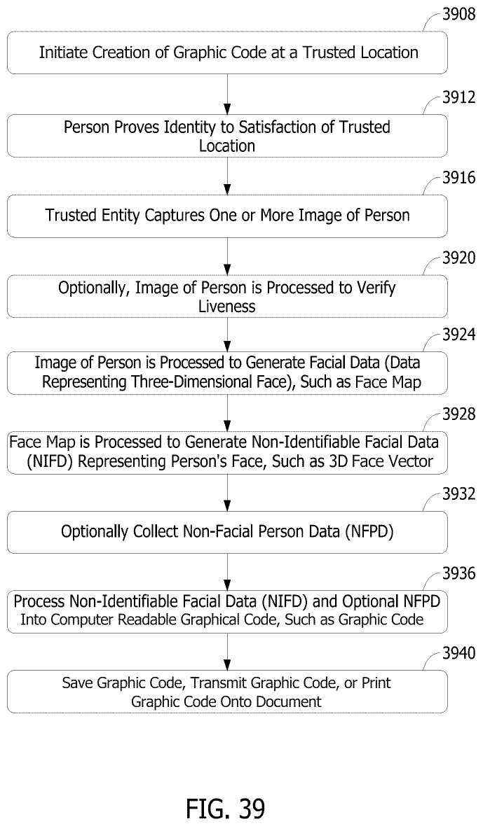

FIG. 38 illustrates an example embodiment of a graphical code generation system. This is but one possible system for creating documents (or other items) that have a graphical code thereon. In this embodiment, a graphical code is created that contains face feature vector data that is derived from a person's facial image data. A face feature vector data may also be referred to as a face vector. A user or person 3830 is present, and their face will be imaged, and the image file processed to create the face feature vector that is stored in the graphical code (graphic (UR™) code). A computer device with an imaging device 3834, such as a camera, is provided, and one or more images of the person's face are captured. At this time in the process, the processing could occur on either the computing device 3834 that captured the image(s) or the image, or a processed version of the image, may be transmitted to a different processing system for further processing. It is contemplated that the processing may be split between the device or one of the other devices could perform a larger amount of processing. In the following embodiment, the image or a portion thereof is provided to the code or document creation entity 3820. In some embodiments, the computing device 3834 is located at or part of the entity 3820.

The code or document creation entity 3820 comprises data communication elements configured to accept data from the computing device 3834. In this embodiment, the code or document creation entity 3820 comprises a server 3840 or other computing system having typical elements associated with a server. In addition, the code or document creation entity 3820, either part of or separate from the server 3840, includes a liveness evaluation engine 3842, a facemap engine 3846, a face vector engine 3854, and graphical (UR™) code processing engine 3850. These elements may be hardware, software, or a combination of both, including machine executable code (software) stored in a non-transitory state in a memory.

The server 3840 or other computing system performs typical server or computer processing functions such as data input/output, printing, data storage and retrieval, and execution of software code. These are known elements and functions and, as such, are not described in detail herein. The liveness evaluation engine 3842 is a combination of software, hardware, or both that is configured to process the image data or data derived from the image data of the person (referred to above as a facescan) to evaluate liveness, three-dimensional depth of the person, or both. The facemap engine 3846 is a combination of software, hardware, or both that is configured to process the facescan data set to create the facemap data set. FIG. 36A is helpful to understand the different stages of the data processing and the associated details of each dataset. The face vector engine 3854 is a combination of software, hardware, or both that is configured to process the facemap data set to create the face vector data set. The graphical (UR™) code processing engine 3805 is a combination of software, hardware, or both that is configured to process the face vector data set to create face feature vector that is stored in the graphical code, which can be printed at the time onto a document (item) 3854. Or the graphical code may be stored as a graphic file representing the code for printing at a later time, or for transmission to another entity for placement on the item. The face feature vector data stored in the graphic code will match the person's face feature vector data at a high probability, even though the face feature vector data stored in the code cannot be used to re-create the person's likeness. Matching data derived from a live human face to the graphic code may be used to prove ownership of, issuance too, or right of possession of an item.

At the time that the item (such as an identification card (ID) 3854 is created, it is contemplated that an image of the user is captured (or a trusted image that was previously captured) and placed on the item. This is typical of many or most forms of ID. In other embodiments, the photo may be omitted. In addition, an image of the user that is placed on the ID is stored in the trusted image database and is also processed with the face vector creation engine 3854 to create the face vector. The resulting face vector may optionally be stored or for security reasons may not be stored so it cannot be improperly obtained. The face vector is encoded into a graphic code using the graphic code creation engine 3850 and the graphic code is printed or otherwise incorporated on the front or back of the ID document or digital ID document 3854. Creation of the face vector and the graphic code is discussed below in greater detail.

FIG. 39 illustrates an example method of creating a graphical code that includes facial biometric data (graphic (UR™) code). This is but one possible method of creating a graphic (UR™) code. At a step 3908, the process to create the graphic (UR™) code is initiated. This may include the execution of software code, orreceiving a link or website access. In this embodiment, the method occurs at a trusted location, such as a bank or government entity, so that the collected data is also trusted and the identity of the user can be verified in person. In other embodiments, the process may occur remotely or online. In other embodiments, it may occur at other locations or by the user using the verification process described above. At a step 3912, the person which is the subject of the graphic (UR™) code provides their identity to the satisfaction of a trusted entity at the trusted location. Identity may be established with a driver's license or other trusted identification, or by being personally known to the trusted entity. Any other means may be used to verify the identity of the person, such as based on a comparison of image(s) of the person to prior collected images.

Then, at step 3916, the trusted entity captures one or more photographs or images of the person. Optionally, at a step 3920, the one or more captured images may be processed by computer algorithms to verify the existence of a physical camera, the three-dimensional depth and liveness of the person, or the liveness may be attested to by a trusted person operating a camera, such as a DMV employee or bank employee. As part of an automated, AI (Artificial Intelligence) powered liveness verification, the data processed may be referred to as a facescan. This step may occur if the person is not physically in front of the person creating the graphic (UR™) code.

At a step 3924, the image (digital data representing the image of the person) is processed to generate facial data, which is data representing the three-dimensional facial data. This data after processing, may be referred to as a facemap. As discussed above, the facemap data is smaller in size than the images of the user. Then, at a step 3928, the facemap is processed to generate Non-Identifiable Facial Data (NIFD) that represents one or more aspects of the person's face. One example type of a NIFD is a face vector. The NIFD is data that represents the face of the person, but which cannot be reverse processed to re-create the image or likeness of person's face. Thus, the NIFD is data that cannot be reverse processed to identify the user, unless by comparison to similarly created NIFD data.

At a step 3932, the NIFD is further processed ed into into a computer-readable graphical code, such as the referred to graphic (UR™) code. This code can be imaged with a camera or scanner, and the resulting image is processed to convert the graphical code into an alphanumeric string. It is also contemplated that the graphical code may be scanned with a laser scanning system, such as a bar code reader, to derive the alpha-numeric string of data. As an optional step 3936, Non-Facial Personal Data (NFPD) may be collected from an ID card, document, a database, or from the user. The NFPD may comprise, but is not limited to, all or a portion of name, address, driver's license number, full or partial social security number, date of birth, eye color, height, weight, location of birth, or similar information. At step 3940, the created graphical code may be saved as a digital file, transmitted to a third party or entity as an image file for use on a digital screen, or printed directly onto a document or item.

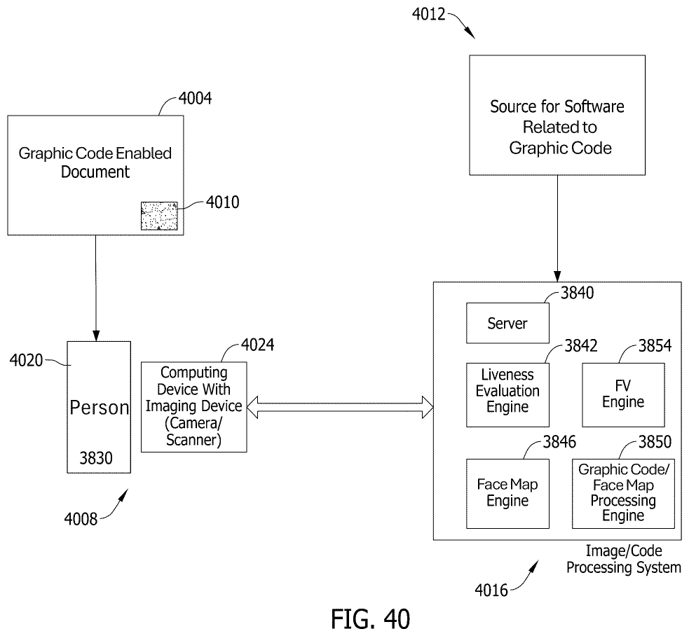

FIG. 40 illustrates an example embodiment of a system configured to process the graphical code and analyze the similarities between the graphical code data and a face vector generated from an image of the person. This is but one possible exemplary embodiment of a system configured to perform this process. In general, there are 4 aspects to the system shown in FIG. 40. The four aspects are the document 4004, which contains the graphical code 4010, the person with an associated imaging device 4008, the software source 4012 for software that creates and processes the image and graphical code, and the image/code processing system 4016.

The document 4004 may be any item as described herein or which would benefit from a verifiable association between the item and the person 3820 associated with the document. The person 4020 is the person who is to be verified as being associated with the document, namely, the person should be matched to the face vector data stored in the graphical code 4010 on the document 4004. The person 4020 may utilize a computing device 4024 (either their own computing device or another's computing device) to scan or image the code 4010 on the document 4004 and also capture one or more images of their face. The images may be captured at different distances from the person as described herein, such as a first distance which is at around arm's length and a second distance which is closer to the person's face. The source of the software 4012 may be the entity that provides the software (machine executable code stored in a non-transitory state in a memory). One exemplary source of such software is FaceTec, Inc., with headquarters located in Summerlin, Nevada (NV).

Turning now to the image and code processing system (ICPS) 4016, shown is one example embodiment of a system for processing the face vector code (extracted from the graphical code) received from the computing device 4024, as well as processing the image data, or associated facemap from the user, and performing a comparison therebetween. In this embodiment, face vector data extracted from the graphic (UR™) code on the document is received at the processing system 4016 from the person 4020 and/or the computing device 4024, such as over the internet or a computer network. Also received from the person 4020 or the computing device 4024, or from a database, is an image of the user, or data derived from a user of the image, such as facemap data.

The processing system 4016 comprises data communication elements (not shown) configured to accept data from the computing device 3834. In this embodiment, the processing system 3816 comprises a server 3840 or other computing system having typical elements associated with a server. In addition, the processing system 3816, which may be either part of or separate from the server 3840, includes a liveness evaluation engine 3842, a facemap engine 3846, a face vector engine 3854 and graphical (UR™) code processing engine 3850.

The server 3840 or other computing system performs typical server or computer processing functions such as data input/output, printing, data storage and retrieval, and execution of software code. Server functions are known elements and functions and, as such are not described in detail herein. In addition to the server functions, the new aspects include the liveness evaluation engine 3842 which is a combination of software, hardware, or both that is configured to optionally process the image data or data derived from the image data of the person (referred to above as a facescan) to evaluate liveness, three-dimensional depth, or both of the person. The facemap engine 3846 is a combination of software, hardware, or both that is configured to process the received image of the user facescan data set to create the facemap data set. This step may occur at the computing device 4024 or at the processing system 4016. FIG. 36A is helpful in better understanding the different stages of the data processing and the associated details of each dataset.

The face vector engine 3854 is a combination of software, hardware, or both that is configured to process the facemap data set to create the face vector data set. The face vector engine 3854 can be used to process facemap data, received from the user, into the face vector data. The graphic (UR™) code processing engine 3850 is a combination of software, hardware, or both that is configured to process the face vector data to create the graphical code, which can be printed at the time onto a document (item) 4004. The graphic (UR™) code processing engine 3850 may also be configured to compare the document face vector (extracted from the graphical code)-that was on the document or items and provided by the user-to the face vector that is derived from an image of the user that was captured just prior in time, or compared to a stored photo or stored face vector (or facemap) of the user from a trusted entity (describe below in detail). As discussed herein, the face vector data cannot be used to re-create the person's face or reveal the person's identity.

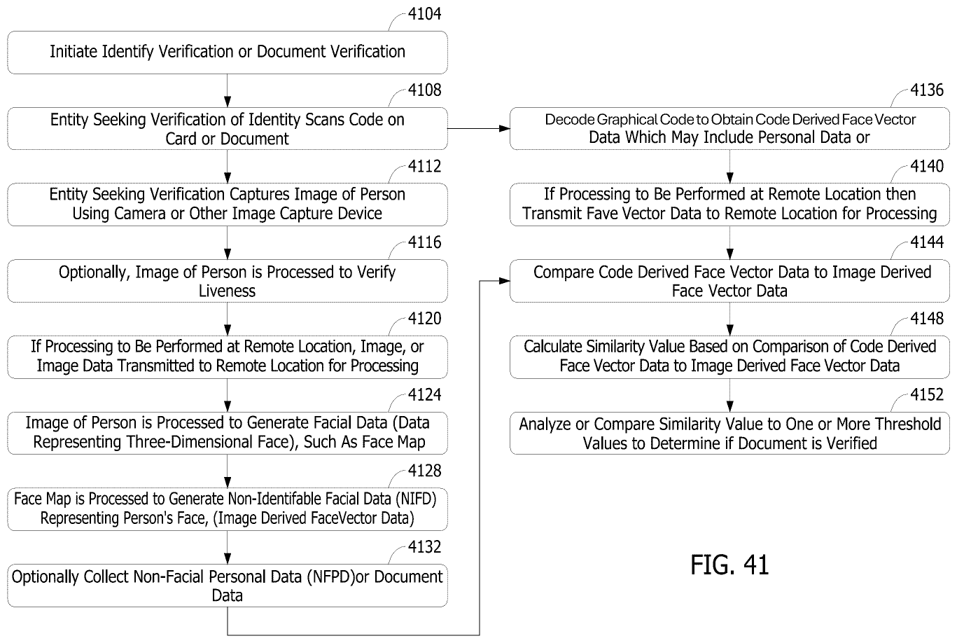

FIG. 41 is an operational flow diagram of an example method of verifying an association between a document or other item having a code and the person associated with the document. This method of operation may also be used to provide assurances of a person's identity based on a trusted identifying document. This is, but one possible method of operation, and other methods of operation are contemplated. This method does not utilize, access, or interface with a database of images or face vectors and instead relies on the collection of image data from the person and an image or scan of the graphical code.

At a step 4104, the person or a third party seeking to verify or validate an association between the person and an item marked with the code (or obtain identity verification) is initiated. At a step 4108, the entity seeking verification is presented with the document containing the graphical code and scans or images the code. After step 4108, the operation branches to step 4136 and step 4112. At a step 4136, the device or computer that scans or images the code may convert the code into data, such as an alphanumeric code, which may be referred to as a face vector code or face vector data. At a step 4140, if the process is to be performed at a remote location, then the face vector is transmitted to a remote location for processing. Alternatively, the processing may occur at the same location at which the code was scanned or imaged.

At a step 4112, the entity seeking verification captures an image of the person, such as using a camera or other image capture or scanning device. A camera of a smartphone or webcam may be used. The image of the person may be processed to reduce the file size and to prevent transmission of data that can be used to identify or recreate the image of the person. As an optional step 4116, one or more images of the person may be processed for liveness as described herein by looking for expected differences between two or more images of the user. At a step 4120, the graphic (UR™) code stored data and the image data, or a processed version, may be transmitted to a remote location if such for processing. Alternatively, the processing may occur at the same location as the image collection.

At a step 4124, the image of the person is processed to create facial data which represents the person's face. This may be referred to as a facemap. Then, at a step 4128 the facemap is further processed to generate non-identifiable facial data (NIFD) which represents the person's face. The NIFD may comprise or be referred to as a face vector. The NIFD cannot be used or reverse processed to generate or re-create an image of the user. It is contemplated that the processing of the image data may progress directly to face vector data.

At a step 4132, the system may also collect non-facial personal data (NFPD) or document data. The NFPD may comprise any data about the person as is described herein, and the graphic (UR™) code may also include or be encoded with the same type of data. This allows for a comparison between the graphic (UR™) code encoded data and data from the document collected at the time of verification. The type of information collected from the document may vary based on the type of item or document.

After steps 4132 and 4140, the operation advances to step 4144. At step 4144, the system, such as the processing system 4016 (FIG. 40), compares the code stored face vector data (NIFD) to the image derived face vector data. This comparisonmay occur with a neural network or other similarly capable processing device. Face vectors are compared by the neural network model which, in this embodiment, measures the distance (or difference) between the face feature vector data in N-dimensional space. The closer the face features are to each other, the higher the probability that the subject images were derived from the same human. Then, at a step 4148, the system calculates a similarity value based on the processing and comparison that occurred at a step 4144. The similarity value, which may also be referred to as a match level, represents the likelihood that the face vectors were generated from the same face. It is contemplated that if the two face vectors were not generated from the exact same image, then the codes will not perfectly match. However, if the codes were derived from different images of the same person, then those codes will have a relatively small difference delta that indicates the face feature vectors were derived from images of the same person, even when the collected image is different than the image used to generate the graphic (graphic (UR™) ) code. Conversely, if the face feature vectors were derived from different images of different people, then those face vectors codes will typically have a higher distance delta that indicates the codes represent different people. Thus, at a step 4152, the operation compares or analyzes the similarity values to one or more threshold values to determine if the face feature vector data, and hence the item marked with the code containing that face vector, is associated with the person. The threshold value defines a value at which the distance delta value must be at, or exceed, to have the face vector from the collected image of the person be deemed to be close enough to the graphic (UR™) code stored face vector to conclude the face vectors represent or are derived from the same person.

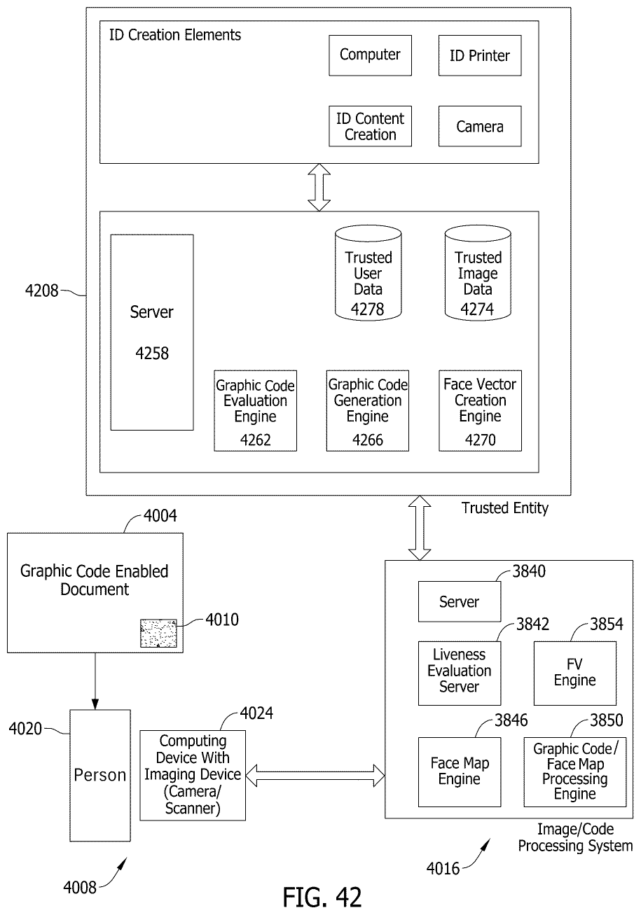

FIG. 42 is a block diagram of an example embodiment of a system configured to process the graphical code and analyze the similarities between the face vector stored in the graphical code with the use of a trusted source and/or trusted source image or code. The embodiment of FIG. 42 is similar to the system shown in FIG. 40, and as such, identical or similar elements are not discussed again. Other embodiments may have a greater or smaller number of entities or elements. In addition, all or only some of these entities may be required for or involved in the process disclosed herein.

In addition to the structure of FIG. 40, this embodiment further includes a trusted entity 4208, which is an entity that obtains, stores, and/or controls the images or codes. The trusted entity 4208 may be a government entity such as the DMV or police department, a bank or other financial institution, a private company or group that utilizes identification for employees or one or more aspects of their business, such as access control or remote login to a network. Other types of trusted groups are contemplated. The person 4020 is an individual who is seeking to or being requested to validate their identity or their association with an item having the graphic (UR™) code thereon. The validation may occur either in person or online using the systems described herein. A requesting entity may be an entity that is requesting identity verification of the person based on the graphic (UR™) code or validation of an association of the document (item) containing the code and the person. The requesting entity may be a business, government entity, or an individual that wants to obtain a greater level of confidence that the document 4004 presented by the person is valid and belongs to the person and not a third party or fictitious person, or to validate an identity. The processing system 4016 comprises an entity or element that provides one or more aspects of the document and code analysis and provides input regarding the identity of the person or the association between a coded item and the person for a requesting entity.

The trusted entity 4208 may optionally include identification (document) creation elements such as a computer, printer, ID printer, camera, and ID content creation, or these elements may be controlled by a third-party business or contractor. These elements are not described in detail as such elements are known in the art. The camera may be used to capture the trusted image(s), which may be processed into face vectors. Also part of the trusted entity 4208 is a server 4258, which executes many of the functions of the trusted entity. Databases are part of this embodiment, such as a trusted personal data database 4278 and a trusted image data database 4274, which store images of the person, and/or face vectors or facemaps of the person, and optional other data regarding the person(s). These databases may be combined into a single database. In many instances, the trusted entity 4208 may be unwilling to release information (image data and/or personal data) to third parties or receive additional image data from third parties. As a result, the face vectors may be used in place of images to protect privacy.

Also part of the trusted entity 4208 is a graphic (UR™) code evaluation engine 4262, a graphic (UR™) code creation engine 4266, and a face vector creation engine 4270. The graphic (UR™) code evaluation engine 4262 is hardware, software, or a combination of both that evaluates graphic (UR™) codes, such as by decoding the graphic (UR™) code to determine the face vector values represented by the graphic (UR™) code, or by comparing the face vector that is derived from the code. It is contemplated that a graphic representation (image, for example) the graphic (UR™) code, the derived face vector, or all may be provided to the trusted entity 4208. The graphic (UR™) code generation engine 4266 is hardware, software, or both, which generates (UR™) codes based on face vector data. The face vectors are data derived from an image. Face vectors are described below in more detail. The face vector engine 4270 is hardware, software, or both that processes an image or portion of an image to create face vectors.

Validation of association between coded document and person or identity validation At a later time, a person 4020 may seek to provide assurances of their identity or validate an association between the document having the graphic (UR™) code thereon and themselves through use of imaging and analysis of themselves and the graphic (UR™) code. However, documents can be synthetically created, tampered with, or altered to create what is commonly referred to as a fake document or a fake ID. To provide assurances that the document is accurate the graphic (UR™) code may be placed on the document as discussed herein.

The following is an overview of one method of operation. The person 4020 may capture images of the graphic (UR™) code on the document 4004 and upload those image(s), in a camera interface and then the URL (Uniform Resource Locator) stored in the graphic (UR™) code can use the QR code decoding software and instructions to open a web interface or application executing on their computing device to the entity requesting verification (not shown) or to a validating entity. In this example, the document is a photo ID, such as a driver's license. Alternatively, the graphic (UR™) code may be scanned or processedby the camera on a computing device to collect and decode the face vector. In the case of an ID, the front of the ID may also be photographed to capture an image of the picture of the person. The entity requesting verification 3816 may forward the images of the ID 3824 to the validating entity 3820 for processing, or processing may occur on the person's computing device. The person's computing device may be a smartphone, tablet, desktop computer, kiosk, laptop, or any other computing device usable by a user.

Upon receipt of the image of the ID and/or the graphic (UR™) code on the ID, which may be scanned separately as occurs with QR codes or as part of the image, the validating entity may perform one or more steps to evaluate whether the user is the person identified on the ID. As discussed above, liveness evaluation may occur by capturing images of the person's face to evaluate whether the images of the face that is presented to the camera are from a person that is physically present, live and are being captured in real time, meaning the camera is not seeing a mask, figurine, printed 2D picture, or video or deepfake imagery that is being injected by virtual camera software, or similar camera bypass attacks. In addition, the data may be collected from the ID and the graphic (UR™) code on the ID may be processed with the graphic (UR™) code processing engine to derive the face vector from the graphic (UR™) code. In the event that only the graphic (UR™) code or only face vectors are sent to the validating entity (such as the processing system 4016), no face image data or personal identifying data is being sent.

The resulting face vector (and/or the graphic (UR™) code) may be sent to the processing system 4016 for validation, and the processing system may interface with the trusted entity 4208 as part of the process. In one embodiment, an additional code or identifier may be sent to the trusted entity 4208 with the face vector to aid in the validation of the face vector, such as to ald the trusted user in narrowing down or locating a trusted face vector to be used in the comparison. Upon receipt of the face vector, the trusted entity performs a database lookup to determine if there is a match with the face vector to a face vector stored in the trusted database, or the name (or other identifier) may be used to index into the database. In one embodiment, the comparison is performed by a neural network located at the processing system 4016 or the trusted entity 4208. The neural network may be custom-tailored for the particular validating entity, but should be the same neural network model used when generating and analyzing face vectors. For example, the DMV may use one neural network model, and face vectors created using that model should then, in the future, be processed with the same model, although that model may be replicated at different entities. Similarly, a credit agency may have its own different neural network model and face vectors associated with that model must then be, in the future, processed with the same model. The neural network may be shared between two devices, or two neural networks may be shared. For example, one or more elements of the processing system 4016 and/or the trusted entities 4208 may be neural networks.

If the name or other code that identifies the person is also sent, then that data may be used to locate a corresponding face vector that should match, or an image of the person that was originally used to create the face vector and the graphic (UR™*) code, on the ID, at the time of ID creation. The original image, stored in the database, that was used to create the face vector which was processed into the graphic (UR™) code and placed on the ID can be processed again to re-calculate the face vector and the re-calculated face vector from the stored image is compared to the face vector from the person and/or face vector derived from graphic (UR™) code on the document.

Based on the analysis by the trusted entity, the trusted entity 4208 can return a match or not a match response, and/or provide a probability of match. In the event that the same image (stored at the trusted entity) that was used to originally calculate the face vector is again processed to create a re-calculated face vector, then the two resulting face vectors should be a perfect match or very close to a perfect match because both face vectors (face vector from stored image and graphic (UR™) code derived face vector) were created from the exact same image. Alternatively, if the face vector is calculated by the face vector creation engine at the validating entity (or at any location) based on the image of the user on the ID or from a new photograph of the person, then the comparison of this new face vector will not exactly match or be the same as the face vector stored or calculated by the trusted entity because there will be inherent differences between these trusted entity images (orface vector) and the image (or face vector) as actually captured by the camera. However, the comparison will determine a high likelihood of a match, thereby giving confidence that 1) the image on the ID is of the same person as 2) the person to which it matches in the trusted image database, and 3) the same person photographed at the time of the validation. All of this can occur without the transmission of any image data or identifying data to or from the trusted entity. The face vectors will not be a 100% match because the image of the ID will not be exactly the same as the trusted image at the trusted entity due to it being a photograph of a photograph.

The outcome of the analysis by the trusted entity is then sent to the validating entity, in this embodiment, the processing system, or in other embodiments, any entity that sent the request to the trusted entity. The outcome of the analysis, which may be referred to as match probability data, may be a match or a no-match response, or some probability value or similarity value that the photo in the ID matches the trusted photo, and both match to the person presenting the ID (or document). Businesses or requesting entities can then make a decision based on the match level from the trusted entity or processing system regarding the match probability. The validating entity can also provide additional analysis to the decision from the trusted entity.

Because the trusted entity is traditionally unwilling to transmit or share trusted images or received images for comparison, in this method and apparatus, the output from the trusted entity does not include any image data or person-identifiable data, nor does the data sent to the trusted entity contain any person-identifiable data. The matching occurs between two face vectors. This protects a person's privacy and biometric data while also allowing the trusted entity to further transactional goals of the business community, the citizens of the state, and to prevent fraud, which are all in the best interests of a government entity and Its citizens. For example, it benefits the person (citizens) by having a secure and accurate way to provide assurances of their identity or association with an item (such as a document) for an online interaction, thus reducing fraud. Businesses benefit because they are less likely to be subject to fraud, thereby increasing profits or allowing a price reduction, and the additional tax revenues aid local governments.

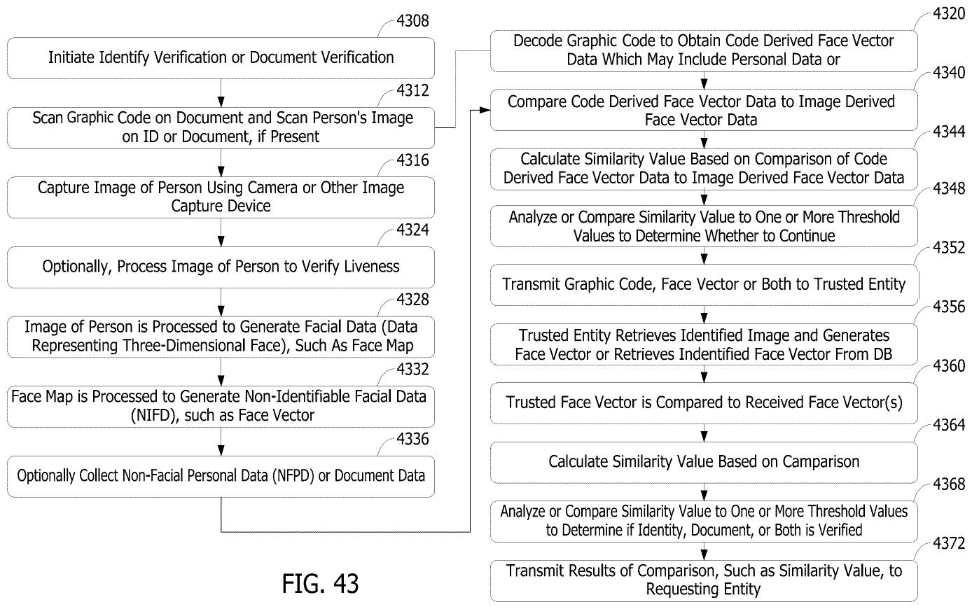

FIG. 43 illustrates an operational flow chart of an example method of operation of verifying identity or association of an item bearing a graphic code using access to a trusted entity. This is but one possible method of operation, and as such, other methods of operation are contemplated based on the disclosure contained herein. In this method of operation, a trusted entity is utilized as part of the validation process. Aspects of the method of FIG. 43 that are discussed in FIG. 41 are not discussed in detail again.

In addition to the steps of FIG. 41, at a step 4308, a person or requesting entity initiates identify verification or document verification. At a step 4312, the graphic (UR™) code on the document is imaged or scanned, such as with a camera, as well as the picture of the person on the document, if so equipped. One or more aspects of the document may also be imaged, such as in one of the images or separately, and optical character recognition may be used to convert the image to text information. After step 4312, the operation advances to step 4316, as discussed below. At step 4320, the device or computer that scans or images the graphic (UR™) code may extract data from the graphic (UR™) code, such as an alphanumeric code, which is referred to as a face vector code and may also include metadata (data regarding the person or document which does not identify the person) as well as hash or checksum data.

At a step 4316, one or more images of the person may be captured, such as at a first distance from the person's face and a second distance from the person's face, as disclosed herein. As an optional step 4324, one or more images of the person may be processed for liveness, three-dimensional depth, or both as described herein by looking for expected differences between two or more images of the user captured at different distances or any other aspect of liveness or three-dimensionality.

At a step 4328, the image of the user is processed to create facial data that represents the person's face. This may be referred to as a facemap. Then, at a step 4132, the facemap is further processed to generate non-identifiable facial data (NIFD), which represents the person's face. The NIFD may comprise or be referred to as a face vector. In one embodiment, processing may proceed directly to face vector generation from the face image(s) without creating facemap data. The NIFD cannot be used or reverse processed to generate or re-create an image of the user. At a step 4336, the system may also collect non-facial personal data (NFPD) or document data, such as by performing optical character recognition of the text on the document. The NFPD may comprise any data about the person as described above or hashes of personal data that can later be verified against in zero-knowledge proofs. In addition, personal data may optionally be collected, such as if the user were to enter personal data manually. The type of information collected from the document may vary based on the type of item or document. Examples of such items or documents are driver's license number, passport number, employee number, credit card number, and badge number.

Personal data (NFPD) may comprise, but is not limited to, the following or a portion of the following: a person's name, date of birth, address, age, eye color, height, place of birth, personal preferences, life events, social security number, maiden name, parents'name(s), and occupation. Including personal data, which does not identify the person, into the graphic (UR™) code prevents an existing graphic (UR™) code from another ID from being cut and glued, laminated or taped onto another ID to create a fake ID or from being printed directly into a high quality fake ID because the text on the document, such as a driver's license would undergo an optical character recognition OCR process. The OCR NFPD would be compared to the NFPD extracted from the graphic (UR™) code when the graphic (UR™) code is decoded. If these two types of NFPD do not match (or the hash of one of the data does not match the stored hash), this is a sign of fraud or a fake document.

After step 4320 and step 4336, the operation advances to step 4340. At step 4340, the system, such as the processing system or the trusted entity, compares the code stored face vector data (NIFD) and/or the face vector data from an image of the person on the document (if present) to the image derived face vector data from the image of the person that was just captured at step 4316. Then, at step 4344, the system calculates a similarity value based on the comparison that occurs at step 4340. The similarity value provides an indicator of the distance delta of two or more face vectors in N-dimensional space in the neural network model. At a step 4348, the system compares the similarity value to one or more threshold values to determine whether to continue. If the comparison between the graphic (UR™) code derived face vector and the image derived face vector are a low probability of being sourced from the same human subject, then the operation may end at this step, and involvement of the trusted entity is avoided. Steps 4340, 4344, and 4348 may be optional, but they provide a greater level of security by allowing access to the trusted entity only when the person's face and the code on the document match sufficiently.

Next, at a step 4352, the face vector extracted from the graphic code on the document, the face vector derived from the person's image(s), the face vector from the image on the document, or a combination thereof, are transmitted to the trusted entity for processing. At a step 4356, the trusted entity received the one or more face vectors (or images of the graphic codes) and retrieves or attempts to retrieve from a trusted database, a file or record that matches the person. This may be based on an identifying code that was also sent (such as an address into a database), or based on a match to one or more of the actual received face vectors to a face vector in the trusted entity database. A face vector retrieved from the trusted database at the trusted entity, or a face vector calculated from an image stored in the trusted database, is referred to herein as a trusted face vector, At a step 4360, the trusted face vector(s) from the trusted entity are compared to a received face vector(s), which may be a face vector currently derived from the person, stored in the graphic (UR™) code on the document, or created from a picture of the person on the document. At a step 4364, the trusted entity calculates a similarity value based on the comparison at step 4360. Then, at a step 4368, the trusted entity or other entity compares the similarity value from step 4364 to one or more threshold values to determine the degree or probability of validation of a person's identity and/or the association between the person and the document bearing the graphic (UR™) code. As discussed above, the two face vectors will not have a 100% probability of match, but will still indicate a match to the trusted face vector stored in a trusted database due to differences in the original image from which the trusted face vector was derived and subsequent face vectors derived from photos or images captured later in time. The face vectors still indicate or suggest that the person is the same and/or the document is validated. Finally, at step 4372, the trusted entity or other entity transmits the results of the comparison, such as the similarity value or the probability calculated at step 4368, to the requesting entity or to the person, or both so that a decision may be made regarding the identity of the person or the association between the person and the document bearing the graphic (UR™) code.

### Proprietary or Open Source Face Vector Creation, Graphic (UR™) Code Creation and/or Decode Engine

It is also contemplated that the face vector creation engine may be open sourced, partially open sourced, or alternatively, proprietary such that it is not a public domain program or processing engine, thereby further increasing security by making it impossible or difficult for an entity to recreate an accurate and meaningful image to face vector conversion/associated graphic (UR™) code, and likewise difficult to decode a graphic (UR™) code into a face vector and any contained identity related info or metadata. In one embodiment, the creation of the face vector is proprietary and secure, while decoding a graphic (UR™) code into a face vector is open source or partially open source. Thus, the creation of graphic (UR™) codes is secure, to prevent creation of fraudulent graphic (UR™) codes, but decoding the graphic (UR™) code into a face vector for comparison is available to the public.

### Key Created Graphic (UR™*) Codes

In addition, it is also contemplated that a unique key (number, code, value, alpha string, or combination thereof) may be used as input when creating and/or decoding a face vector and/or associated graphic (UR™) code. For example, in one embodiment a unique 79-digit or 1224-digit alphanumeric key (or any size or length) may be provided to a trusted entity (for example, DMV). Each trusted entity may be provided with a different key for securityreasons. In such an embodiment, the key is used and required when creating the face vector, and that same key or a derivative must be used to process images to create the graphic (UR™) code and/or when verifying identity or the graphic (UR™) code later in time. Without this code, the face vector (graphic (UR™) code) cannot be created and/or decoded, thereby preventing or reducing the person's ability to create a fake ID with a fake graphic (UR™) code. graphic (UR™) codes could contain a URL, and then the remaining data as a variable in the URL, for example www.URCodes.com/verify?data=xxxx.....xxxx, (of any length string) and this data could be encrypted and only be unlocked with a private key.

### Additional Information Stored In the Graphic (UR™) Code

As mentioned above, it is also contemplated that additional information may be inserted into the graphic (UR™) code beyond data regarding or derived from the image. This additional data encoded into or part of the graphic (UR™) code may comprise or represent, but is not limited to, select portions of information regarding the person or the document, such as year of birth, first letter of last name, last letter of first name, 3rd number (or any of the one or more numbers) in the person's social security number, sum of both numbers in day of birth, document information, details or creation date, or other information that adds further details about the person or document, but which does not identify the person. For example, a person cannot be identified, to the exclusion of other people, by only their first letter of their last name, and the last letter of their first name; however, that information does exclude a tremendous number of people to greatly narrow the possible matches that may occur for the face vector. Same with the day number of a person's date of birth. Assuming an even distribution of birthdates over a course of a month, adding this information to the graphic (UR™) code reduces the match possibilities by a factor of about 30. These are non-limiting examples of a person's information that may be incorporated into a graphic (UR™) code, but which does not identify the user, yet does reduce the number of face vectors (people) against which the person's face image could match. For example, there is a greatly reduced number of people whose last name starts with N, and first name starts with T, yet no single person can be identified by that combination. In contrast, the prior art barcode on the back of a driver's license can be read to identify the person's name.

The trusted entity 4208 can verify that the person identified by the graphic (UR™*) code also has those same personal details, even though the person cannot be identified by the additional details. Additional data incorporated into the graphic (UR™) code will increase the accuracy of the identity assurances and document association provided by the trusted entity. It will become increasingly difficult to create a fake ID or document that can also bypass interrogation by the trusted entity based on the graphic (UR™) code while also maintaining a higher accuracy of face vector matching across different images. Even with this additional information, no biometric data (that can be used to re-create the user's face or identify the user) is sent to or from the trusted entity.

### Face Vector Creation and Graphic (UR **) Code Encoding

In one embodiment, the face vector may be created directly from the image of the user, while in other embodiments, the face vector may be created as part of a multi-step process. The multi-step process makes it more difficult to pass a fake ID as a valid ID. In one exemplary multi-step process, the ID photo (or any photo, such as but not limited to the trusted image) is provided to a neural network that may optionally be configured to perform liveness processing and/or face matching against a database of images that is not located at the trusted entity. As part of this process, multiple images of a person's head or face may be captured, such as at different distances from a user. Liveness analysis may occur on one or more of these images that yield a liveness answer or liveness probability, which indicates the likelihood that the person being imaged is a live person and not a mask, figurine, or printed image of the person. This provides another level of security.

Using these images, a 3D facemap may be created, which is a processed version of the image. The facemap may be used for matching the photos of the person to the photo on the ID that is asserted by the person to be the ID of the person. Thus, the photo taken by the person during the session is compared to the photo on the ID. This provides another level of security. Alternatively, the photos collected during a verification or ID check session of the person may be used for matching the images to a pre-existing collection of photos of the person stored in a remote database. Unlike the face vector, facemap data could potentially be decrypted and expose images of the user's face.

The facemap may then be further processed, such as with a neural network or any other processing device executing the same neural network model (such as a processor executing software stored on a memory as machine executable instructions), to create the 3D face vector (face vector). Using a neural network for creation and comparison of the face vectors adds another layer of security because most people committing fraud are not going to design, build, and enable a neural network or have access to the same neural network model used to create the face vector that the graphic (UR™) code represents. The facemap data is pushed into a transforming system (facemap engine) that generates the face vector that can be stored in memory for processing and comparison, or stored as a specific file, referred to herein as a facemap file type. The facemap and face vector generation engine software, also referred to as a transforming system, is available from FaceTec, Inc. located in Las Vegas, NV. In one embodiment, the face vector data comprises long strings of alphanumeric data. In one embodiment, the match accuracy data when matching two face vectors that were created from the data in two 3D facemaps is 1 in 125 million, meaning that the comparison is only expected to incorrectly match two random people who are not the same once in every 125 million comparisons, which is astonishingly accurate.

The facemap and face vectors may be encrypted if stored or transmitted over a computer network. Similarly, the face vector may be input into a processing engine or a server SDK (Software Development Kit), such as a graphic (UR™) code creation engine, to create the graphic (UR™) code. In one exemplary environment and embodiment, the original photo of the user, such as the stored trusted image or a photograph collected by the computing device of the user, may be in the size range of 300 Kbytes to 400 Kbytes. The 3D facemap, created by processing the trusted image, may be in the size range of 200 to 250 Kbytes. The face vector can be stored in a graphic (UR™) code, which has usable storage capability in the 2 to 3 Kbyte range. The use of the smaller sized face vector provides the benefit of reduced storage space for all applications such as but not limited to, block chain verification arrangements, databases with a large number of users such as 5 million or 100 million users, and less data must be transmitted over a network, thereby reducing lag, as well as avoiding privacy issues or BIPA (Biometric Information Privacy Act) lawsuits liability exposure.

### Use of URL code in Connection with Graphic (UR™) code

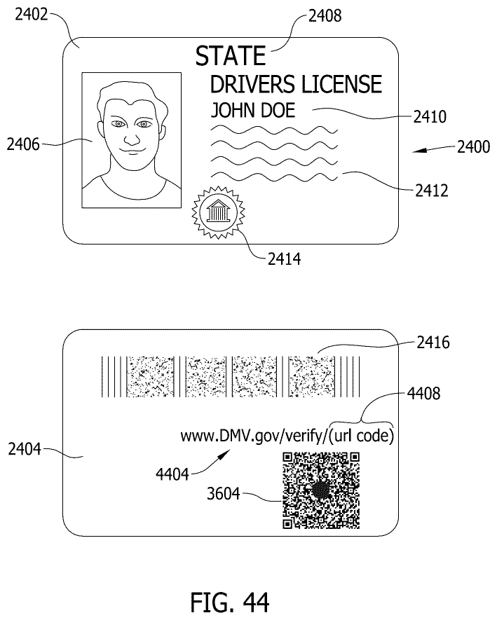

FIG. 44 Illustrates an embodiment with an additional feature of a URL address to assist in the ID assurance process. As shown in FIG. 44, the back (or any location) of the ID 2400 may also include a URL address 4404 that can be accessed as part of the graphic (UR™) code 3604, independent of the graphic (UR™) code, or which may be automatically read or manually entered into an internet browser by an entity seeking to gain assurances regarding a person's identity or documents validity (in this example embodiment in identification card such as a driver's license) or scanned as part of the ID scan is discussed above. The URL address 4404 is used by internet browsers to retrieve any published resource on the internet. URL stands for uniform resource locator and is the address of a given unique resource on the web. The URL address 4404 would lead the user to a website, such as a website run by a third party, such as the validating entity, or directly to the trusted entity. At that website, a variety of options may exist. The website may offer the ability for the user to scan the graphic (UR™) code or other aspects of the ID as discussed herein for validation. Other options may also be available that include or do not include the graphic (UR™) code 3604. This allows for any web browser and camera-equipped computing device to validate the graphic (UR™) code and its association with a person.

Different URLs can be used to direct the process to different websites. For example, a URL on a driver's license may direct the processing system to the DMV for verification, while a URL on a college diploma may direct the processing system to the college that issued the diploma for verification. Thus, the URL may be tailored to the person, document, or key used for creating the face vector or graphic (UR™) code.

It is also contemplated that the URL address 4404 may include a URL code 4408 that provides information to the website accessed by the URL address, or which is unique to the user. In one embodiment, the URL code 4408 and/or URL address 4404 may be part of and included in the graphic (UR™) code 3604. The URL code 4408 may be used by the website retrieved by the URL address 4404 to access a record associated with the ID or direct the computing device using the URL code to a particular website or location within a server. The code 4408 may identify the user or be a pointer into a database to a particular face vector for that person, or be part of the face vector itself. In one embodiment, the URL code 4408 may direct the query from the link to a particular image in the database that is used for comparison or processed to create a face vector that is compared to the captured image of the ID.

### Performance Parameters

Testing on large data sets has confirmed that the system and method disclosed herein can reduce the face vector data set down to as little as 128b, and still achieve accuracy at a level of 1/>125 m FAR (False Acceptance Rate)@<0.99 FRR (False Rejection Rate). Stated another way, the FAR of the graphic (UR™) coded data and an image of the user is less than 1 in every 125 million attempts. In other embodiments, a higher or lower level of FAR may be achieved based on the size of the face vector data size, and similarly the size or resolution of the graphic (UR™) graphic (UR™) code, and other factors. In one embodiment, the face vector data size is 1 kilobyte.

In one embodiment, the face vector data is mapped in N-dimensional space, which may be represented by large arrays of data. High-value dimensional space is difficult, if not impossible, to visualize mentally as compared to traditional three-dimensional X, Y, and Z coordinate systems. For example, N may be set at 512. For instance, it can attempt to be visualized by imagining that a face vector representing a human face would be represented as a small sphere inside a much larger sphere, and that the best algorithms would spread the spheres (face vector values with overlap volume for FAR at specified FRR) out such that they are the centers are spaced away from each other, and the small spheres overlap as little as possible. This would give each face the most volume or separation for itself in relation to and from other face vectors, but the FAR level would be represented by the overlap of the smaller spheres, as it is possible for the model to falsely match two very similar-looking people. This would be an ideal face vector to space conversion, but in practice, some face vector data is closer or more similarto other face vector data than other face vector data, because some faces lack as many distinguishing features or have similar shapes from the face vector encoding algorithm approach. Stated another way, some people look very similar. The lower the overlap or proximity between face vector location mappings when mapped into N-dimensional space, the more accurate the face matching is, the more likely that the face vector of one person can be distinguished from a face vector of another person. It is preferred to map the same face vectors of the same person to as close to the same point as possible, every time a facescan is converted to a face vector.

To further aid in understanding the mapping of data into face vectors, it is disclosed that the dimensions are not traditional X, Y, Z dimensions, but Instead are an algebraical mapping. Any number of dimensions may be represented by independent variables. To describe where a point is in a 3D geometric space requires 3 variables, namely the positions of X, Y, and Z. The axes may not even be fully perpendicular, but they can represent all points in the universe using any three axes as a basis. Location information is lost if fewer than 3 axes are used, which means that to describe a point in the space people physically occupy requires, at minimum, 3 independent variables.

It can be understood that two variables provide two-dimensional mapping, and with three variables, three-dimensional mapping can be achieved. In addition, with three-dimensional mapping a greater accuracy is achieved, and a greater number of unique data points can be mapped. Expanding this to a greater number of dimensions, such as N dimensions where N is any whole number, the face vectors can be represented as or considered an n-dimensional geometry mapping. In one embodiment, the n-dimensional ‘space’ is an array that the face vector maps to a 512-dimensional space. While this can clearly not be imagined or processed in the mind, it can be represented mathematically when multiplying two matrices, such as matrices that map into or represent a transformation on a 512-dimensional space. Different embodiments may utilize different matrix sizes and different dimensional space mappings.

Considering this N-dimensional mapping, the further away or greater the distance of the mathematical mapping may be considered as being less similar facial data people. While closer mappings may be considered to indicate that the people appear more similar. The difference is that mapping may appear different mathematically, but not to the human eye/brain. In this way, face vector mappings of the same person, even using different photos taken at different times, will map closer in the N-dimensional space than a mapping of a different person. In this way, mappings that are not exactly the same but are close may indicate the same person even though there is not an exact match. In this manner, the mappings differ from a hash function. A threshold value may be used as a guide to determine if the degree of similarity in the mapping is sufficient to advise that the two face vectors are of the same person or different people.

### Hash Function with Graphic (UR™) Code

Also disclosed herein is the use of a hash function in connection with the face vector, which may be represented in a graphic (UR™) code. In one embodiment, the face vector, which is a long string of numbers and letters, which can also be represented as a number, can be hashed to create a hash value. This hash value can be stored inside the graphic (UR™) code, as part of the face vector, or stored at a secure location such as a trusted entity or a trusted third party that controls the face vector hashes. This may be referred to as the digital signature of the graphic code.

In the event that the hash value is placed inside the graphic (UR™) code, upon extraction of the data from the graphic (UR™) code, all or a portion of the data can again be hashed to generate a hash value of the graphic code. This newly calculated hash value can be compared to the hash value embedded in the graphic (UR™) code. If any value or aspect of the face vector or data that form graphic has changed, the hash values will not be the same. This is a further security feature.

In another embodiment, the hash function may also or alternatively be stored at a secure location instead of being embedded in the graphic (UR™) code. This secure location that stores trusted hash values may be referred to as a trusted hash value entity. As such, upon extraction or conversion of the face vector from the graphic (UR™) code, a hash function may be performed on the graphic (UR™) code stored face vector to obtain a calculated hash value. The calculated hash value can be sent to the trusted hash value entity for comparison to the trusted hash value that was calculated at the time of creation of the face vector to verify that the face vector stored in the graphic (UR™) code is the same as the face vectors that was originally calculated. If the hash values do not match, then the graphic (UR™) code or face vector represented in the graphic (UR™) code was tampered with or edited. This is a further security feature. The trusted hash value storing entity may be FaceTec Inc., a bank, credit agency, government entity, corporation, or any entity. The trusted hash value entity may be the same as or different from the trusted face vector entity to provide separation between the two entities, which provides further security such that both entities would have to be hacked or internally compromised for fraud to occur.

In addition, other or supplemental calculations may occur to identify a face vector that has been edited. In one embodiment, a checksum operation may occur on the face vectors. Other mathematical operations are also contemplated. To avoid confusion, while the face vector calculated from a collected image of the user, taken at the time of document or person verification, will differ but be similar to the face vector stored in the code, the face vector stored in the code should be exactly the same as the face vector calculated at the time of creation/printing of the original graphic (UR™) code.

In one embodiment, plain text from the document may be scanned and subject to OCR (optical character recognition) processing. The scanned OCR text may be compared to what is in the bar code of the ID and/or what is in the graphic (UR™) code. As discussed herein, information from the document with the graphic (UR™) code may be encoded into the graphic (UR™) code. In addition, the text may optionally be hashed to obtain hashed document text data. Hash functions are known in the art and as such are not described in detail. The hashed text is then encoded in the bar code and/or the graphic (UR™) code to create an additional level of security such that the hashed text that is encoded into the bar code or graphic (UR™) code must match a newly created hash of the text on the ID (document). For example, data from the document that does not identify the person or a hashed value thereof may be stored in the graphic (UR™) code. At a later time, the non-face vector data encoded in the graphic (UR™) code must match the OCR data from the document at the time of verification. In this way any alterations to the actual text of the document will be detected when it is hashed at the time of validation and compared to the previously hashed text that is encoded in the bar code or the graphic (UR™) code.

It is also contemplated that a hash value resulting from a hash of image file representing the graphic (UR™) code or a hash of the graphic (UR™) code graphic may occur to detect and prevent fraud attempts that tamper with the graphic (UR™) code itself. In such an embodiment, an unchanged version of the graphic (UR™code or digital file representing the graphic (UR™) code would be hashed and the resulting value would be compared to a trusted hash of the graphic (UR™) code graphic or digital file. graphic code verification with liveness and/or three-dimensional depth verification

It is also contemplated and disclosed that the graphic (UR™) code processing may occur in connection with liveness verification, three-dimensionality verification, or both. Liveness verification is discussed above in greater detail. In one embodiment, images are captured of the person at a first distance from the camera and at a second distance from the camera. The images are then compared to determine if expected differences are found as disclosed above to verify or provide an assessment of whether the person is live and/or three-dimensional. This provides an additional security layer by preventing a fraud attempt whereby a 2D image, mask, figurine, Al-generated injection, or other false representation of the person is presented to the camera to generate the person generated face vector. Verifying liveness on the captured image of the person used to calculate the face vector, prevents a graphic (UR™) code to person comparison with the use of 2D image, mask, figurine, or other false representation of the person. For example, absent liveness and or three dimensionality verification, use of something other than a captured image of the person could be used in an attempt to spoof the system by presenting an image of a 2D image, mask, figurine, or other false representation of the person to create the person's generated face vector which is to be compared to the face vector stored in the graphic (UR™) code.

Combining user liveness verification with the graphic (UR™) code face vector comparison is particularly useful when performing online or remote verification because in such embodiments, a live trusted person is not there to monitor, supervise, and ensure that the image(s) captured of the face are from a real live person. In online or remote unsupervised verification, the person can attempt fraud without being monitored by anyone overseeing the process and ensuring its integrity.

### Example Environments of Use

In addition to the use environments discussed above, it is also contemplated that the UR™ code (graphic code) may be placed on numerous items or documents that will result in numerous benefits throughout the economy and establish greater security.

### Package Shipping Label

One such additional environment of use is on a shipping label, which is affixed to a shipped package. In this use environment, the face of the person set to receive the package may be images or scanned when the product is ordered. For example, a person ordering an expensive product will undergo a facescan or facial image collection at the time of purchase of the product or at least once in the purchase history, which may also include a liveness verification and/or identity check based on an in-person or ID card/driver's license scan and analysis. The person's face vector data is then associated with the order. When the shipping label is printed, the face vector generated from the purchaser's face is converted to a graphic (UR™) graphic (UR™) code and printed on the shipping label.

When the package is delivered to a person representing themselves to be the purchaser (receiver), the delivery person will scan the receiver's face and the graphic (UR™) code on the shipping label. A computing device will process and compare the face derived face vector and the graphic (UR™) code derived face vector. Based on the comparison, a determination can be made that the person receiving the package is the same person who ordered the package. In this example method of operation, no internet access is required because all the processing can occur on the same computing device. Additional identity verificationmay occurby communication with a trusted entity as described above. This not only confirms the receiver actually received the package, thus preventing the common fraud of claiming the package was not delivered, but also verifying the package is handed to the actual purchaser. It is also contemplated that a receptionist or family member could also have their face vector on file and be authorized to receive packages for third parties, such as co-workers or family.

### Passport

Another exemplary environment of use is with a passport or visa, collectively a passport. Prior art e-passports contain an electronic chip. The chip holds the same information that is printed on the passport's data page: the holder's name, date of birth, and other biographic information. An e-passport also contains a biometric identifier. The United States requires that the chip contain a digital photograph of the holder. All e-passports issued by the United States have security features to prevent the unauthorized reading or “skimming” of data stored on the e-passport chip.

As discussed herein, graphic (UR™) codes contain encoded face data from a liveness-proven (optional) 3D facemap or a trusted 2D face photo and are a significant improvement for remote KYC (know your customer)/IDV (identity verification) and user privacy. Security is enhanced significantly versus using a photo from of a photo ID for remote IDV because of internal cryptographic proofs (keys, hashes etc.) Ensure the graphic (UR™) code has not been tampered with, and the face vector data enables significantly more accurate face matching or validation than can be performed using a photo on a photo ID document as used in prior art passports, even if the image data is directly encoded into an RFID (Radio Frequency Identification) chip in the passport.

As discussed above, the graphic (UR™) code is a cameral scannable graphical code that can be printed onto any document. Thus, the graphic (UR™) code may be a 2D matrix graphic that defines encoded data from a FaceTec 3D face vector, which comprises data derived from an image of a person, along with some hashed personal data. Any image of the user may be used, such as a previously captured image on a driver's license, or an image of the person captured proximate in time, such as when the person is passing through a border and presenting their passport for entry to a country.

This provides security equal to or better than an NFC passport chip, with similar internal security features, but the face data is not humanly viewable, protecting privacy and preventing bias, etc. In addition, the graphic (UR™) code can be printed on a credit report, credit card, health insurance card, diploma, state issued ID, customers paperwork, shipping label, event tickets, voting ballots, as well as a passport as discussed herein. It can also be transmitted digitally or optically, stored in a wallet, on a blockchain etc., while protecting (not revealing) the image of the person from human viewing and recognition.

In one embodiment, the passport chip (NFC chip in or associated with the passport) contains a file, such as a document security object (DSO), that stores hash values of all files stored in the chip (including but not limited to person's picture, fingerprint data, etc.). And a digital signature of these hashes. The digital signature is made using a document signing key which itself is signed by a country signing key. If a file in the chip (e.g., the picture) is changed, this can be detected since the hash value is incorrect. This provides an additional level of security. The readers may be provided access to all used public country keys to check whether the digital signature is generated by a trusted country. The graphic (UR™) code and its associated processing can replace or supplement traditional passport identity and security features. In one embodiment, the hash of the SOD photo may not be stored, but the hash of the face vector data itself could be part of the hash. The facescan, the 2D photo, or both, may be encoded into the graphic (UR™) code.

It is contemplated that, in addition to the data derived from a person's face, additional data may be incorporated into the graphic (UR™) code or used in connection with a hash function to form the graphic (UR™) code. This data includes but is not limited to the following:
3D face vector data, or 2D face vector data that was encoded from a 2D photo
Full name (and/or hash) Date of birth (and/or hash)
Biographical information, such as birthplace (or hash)
Unique number generated at the time of the print function that adds additional uniqueness to the graphic (UR™) code (or hash)
Number associated with devices that print the graphic (UR™) code
Digital signature that protects the stored data from being altered
Passport no., Driver's license no., Hashed social security no., Or hashes of any unique no. (Or hash)
Date of graphic (UR™) code encoding
Expiration date for the ID or the graphic (UR™) code itself
Information regarding the photo or image used to create the graphic (UR™) code, such as but not limited to the photo pixel size, location, date of image capture, color, or intensity values, and/or camera data

In one embodiment, the following may be the suggested default supplemental data fields:

0=unique ID number
1=hashed unique ID number
2=first name
3=middle name
4=last name
5=hashed first name
6=hashed middle name
7=hashed last name
8=date of birth
9=hashed date of birth.

To supplement the passport security features, as many of these security features and data fields may be included to meet or exceed prior art passport security levels. In addition to the features described herein, the following may also be included. One such feature is active verification (VA), which helps to prevent cloning of biometric passports. Passive Verification (PA) may be included to detect chip modifications. Basic access control (BAC) protects the channel of communication between the passport chip and the e-passport reader. Extended access control (EAC) is an extra safeguard for iris scans and fingerprint data.

Renewals for driver's license and passports It is also contemplated that the disclosed method and apparatus may be used as or to enhance online remote driver's license and passport renewals, with the option for liveness/three-dimensionality checks during the renewal process. The renewal process can compare and match newly collected photos to two-dimensional photos, or 3D facemaps or face vectors which are on file with the ID or passport issuing entity. This provides a greater level of security during the renewal process as compared to a system that does not use images to verify identity during an online renewal. In addition, numerous ICAO factors may be checked.

The newly captured images for the user, which were captured by the person using their web camera or phone camera, can be isolated from the background that is in the image, and then the person's face can be placed on an ICAO compliant background, such as is suitable for a passport. This provides the benefit of an updated photo for the document picture, which was verified by liveness checks and graphic (UR™) code validation to more accurately reflect what the person looks like at the time of renewal. Thus, the updated photo of the person that was used in identification verification will be the official passport or driver's license photo and printed on the ID or passport. In addition, this photo may be included inside the e-passport chip and used to create an updated graphic (UR™) code. The graphic (UR™) codes can be created based on the updated photo, which includes or comprises the face vector data or the graphic (UR™) code, which can be encoded from the 2D ICAO output image.

### Neural Network Configured for Image Processing and Face Vector Generation

As discussed herein, the image of the person, or another asserting to be the person, and processing of the graphic (UR™) code occurs as described herein. The processing may occur on a number of different devices and structures, In one embodiment, as discussed herein, the processing occurs on a neural network. In general, a neural network is a computational structure that comprises interconnected nodes that process data and feedback paths with error analysis that allow the system to learn from training data. The neural network enables tasks such as pattern recognition and decision making in machine learning. Neural networks can be embodied in purely hardware, but such a structure can be inflexible. Neural networks are typically embodied as software code (machine executable instructions) that are stored in a non-transitory state in a memory. The software code is executed by one or more processors, ASIC, DSP, or other processing elements. As such, the elements that perform the neural network functions are shown as flow charts and processing steps, which are typical of software code functions that execute on a processor or other purpose-built device.

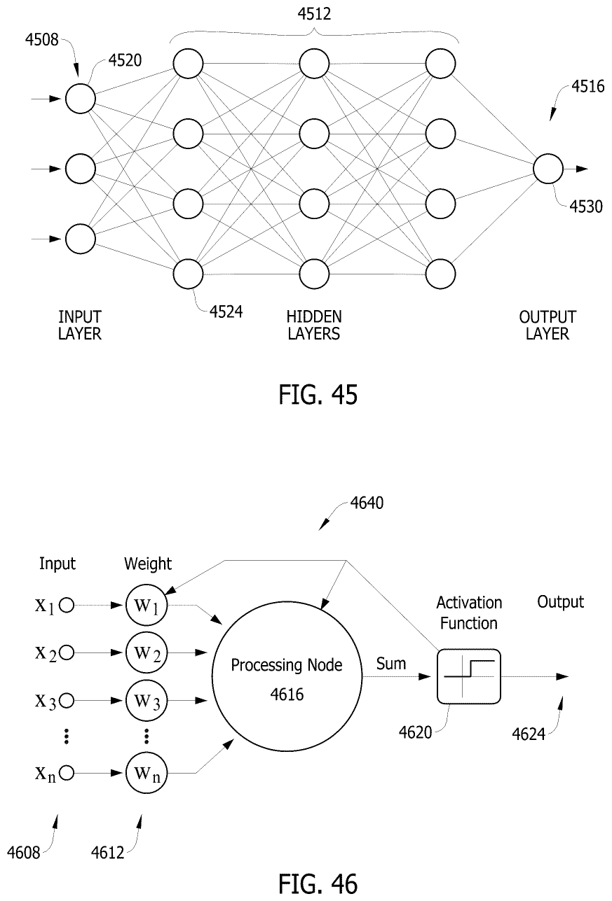

FIG. 45 illustrates a general block diagram of a neural network. This is but one possible structure. Shown are input layers 4508, hidden layers 4512, and an output layer 4516. The input layer receives the data to be processed by the neural network. The input layer 4508 comprises one or more input nodes 4520, which perform processing on the received data. In the case of graphic (UR™) code creation, the data may comprise image data, a processed version of the image data, such as a facemap, or subset of image data. Subsequent to the input nodes 4502 is the hidden layer 4512 which comprises the hidden nodes 4524. The hidden nodes 4512 process the data from the input nodes 4520. A greater or fewer layers of hidden nodes 4524 may be provided based on the processing to be performed, accuracy and/or resolution of the face analysis, and other factors, The output of the hidden layer 4512 connects to an output node 4530 in the output layer. As with the other nodes, the output node 4530 may perform processing. In one configuration, a node threshold may be established such that if the output of any individual node is above the specified threshold value, that node is activated, sending data to the next layer of the network. Otherwise, no data is passed along to the next layer of the network.

The nodes and layers may include forward propagation and back propagation. The process of passing data from one layer to the next layer defines this neural network as a feedforward network and comprises forward propagation of the data. As discussed below, this may include weighting of the inputs and/or outputs from a node to establish a greater or lesser emphasis on that node. The neural network may also be trained or reinforced with back propagation of data or node outcomes or the final outcome from node 4530.

Backpropagation allows the system to calculate and attribute the error associated with each node, allowing the system to adjust and fit the parameters of the model(s) appropriately. In the case of image analysis, training may occur using a known dataset of images, such as, for example, millions of image sets which are known not to be the same person and other image sets which are known to be the same person. Outcome errors from the processing of these datasets may be fed back into the system to allow or force the neural network to increase or decrease weightings, or the processing algorithms within each node, to obtain a correct outcome.

Each node may be equipped with processing algorithm, logic, or other processing to process and analyze the received data, which may include input data from numerous other nodes as well as feedback data from numerous other nodes. For image processing as described herein, the inputs may be the image file, or derived characteristics of facial features from the image, or other data. Different embodiments may be configured or programmed differently. It is contemplated that one of ordinary skill in the art concerning image processing and/or neural network will be able to program the node algorithms to arrive at face vector datasets which function as described here.

As shown in FIG. 46 illustrates a block diagram of an example node. This is but one possible structure for a hardware or software implementation. In this example embodiment, the inputs 4608 feed into the weighting elements 4612. The weighting elements may comprise multipliers, or a separate weighting algorithm comprised of a mathematical function applied to each input prior to the weighted input being applied to a processing node 4616. The weighting function is important because changing the weighting factor or algorithm will adjust a model's behavior during training to optimize accuracy. As shown, the weighting is applied to a single input, and the weighting function may vary from input to input or be the same.

The processing node 4616 receives multiple weighted inputs and may be configured to perform recursive processing, multiplication, and addition, or any other type of processing function upon the multiple weighted inputs to form the face vectors. The neural network training can adjust the node processing, subject to predefined parameters. In this embodiment, the processing node 4616 performs a sum function with an optional weighting function.

The activation function element calculates the output value for the neuron. This output value is then passed on to the next layer of the neural network through another synapse. Also shown are one or more feedback paths 4640 from the activation function elements to either or both of the processing node 4616 and the weighting elements 4612. Although only one feedback path 4640 is shown, each weighting element may receive a feedback signal that can be used to update the weighting factor. An output 4624 provides an output from the node, such as to a subsequent node. The system of FIG. 46 is representative of a node of FIG. 45.

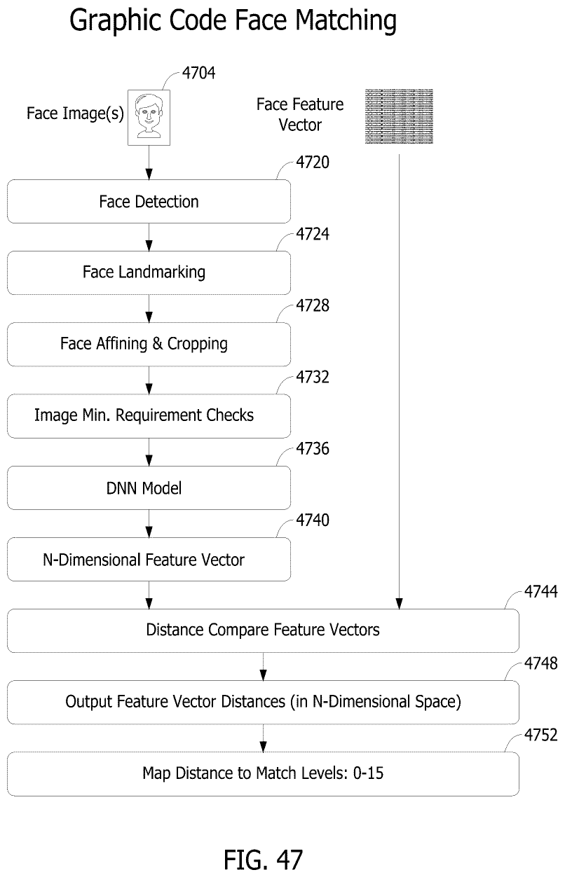

FIG. 47 illustrates a flow chart of one exemplary method of facial image processing in connection with face vector generation and comparison using a neural network. This is, but one possible method of operation, and as such, other methods of operation are contemplated that do not depart from the scope of the claims. This method of operation starts with a facial image 4704, such as from a captured image of a person's face captured with a camera of a computing device. The face image may be stored as a digital file suitable for processing by a computer. In addition, a UR™ code (graphic code) which stores a face vector 4708 is also provided. The graphic (UR™) code may be converted to the face vector 4708 as described above.

At step 4720, the image data is subject to face detection to detect if a face is contained within the image data. Face detection is known by those of skill in the art and as such is not described herein. If a face is not detected, the operation will end without progressing to any additional steps. If a face is detected, then the operation advances to a step 4724. At step 4724, face landmarking occurs. Landmarking of a face is the detection, identification, and locating of landmarks. Landmarks are points of interest on a face, such as nose outline points, eye location points, facial edges, or other unique facial characteristics that can be identified in the facial image.

At a step 4728, face affining and cropping occur. The step of affining performs rotation and alignment to correct any side tilt of the face or camera rotation issues on the image, while cropping occurs to isolate the face and any other portions of interest in the image. Cropping the image to isolate the face reduces the size of the image data, which in turn reduces the process burden for subsequent steps. Thereafter, at a step 4732, minimum requirement checks are performed on the image to verify that the remaining image data meets the minimum requirements for subsequent processing. These requirements include, but are not limited to, resolution, clarity, focus, noise, lighting, or any other image characteristics. Step 4736 may occur prior to or after step 4728.

If the image meets the minimum requirements for subsequent processing, then the operation advances to step 4736. At step 4736, the affined and cropped image data is provided as an input into a DNN (deep neural network) model. The DNN processes the image data using the weighting factors and node algorithms, with optional feedback or recursive processing, such as during training. Different algorithms and models may be used to arrive at a unique code, such as, for example, a face vector. DNN processing is described herein and is known by those of skill in the art. The output of the DNN model is an N-dimensional feature vector (which may be referred to as a face vector or the outputs of the DNN model may be assembled into the N-dimensional feature vector (face vector) at a step 4740. Face vectors are described above. The value of N may be any whole number. The value of N may be defined as the number of characteristics, features, or attributes, which are analyzed in the image data by the DNN to generate the face vectors.

At a step 4744, processing on the two or more face vectors occurs to determine distances between two or more face vectors. In this embodiment, one face vector is the graphic code stored face vector (from the graphic code 4708), and the other is the image derived face vector from the image 4704. In one embodiment, the distance may be a difference in values between the vectors, such as, for example, but not limited to, differences in vector direction, magnitude, and location. Although shown with two face vectors (feature vectors) being compared, it is contemplated and disclosed that more than two may be compared, such as, for example, a face vector from a photo ID or a prior image may also be processed. Computing differences between two or more multi-dimensional vectors in n-dimensional space is known in the art, and as such is not described in detail. At a step 4748, the face vector distances (or differences) are output from the processing system, such as by using software code executing on a processor configured to calculate the difference or distance between face vectors.

Thereafter, at a step 4752, the distances (differences) between the face vectors are assigned a similarity value or match level based on a comparison or mapping of the distances to accuracy thresholds. In one embodiment, the match levels are 0-15, which are levels that define the accuracy of the match, based on the differences in the distances. The level correlates to accuracy levels, such as, by way of example, the following accuracy levels. In one embodiment, the following levels and FAR accuracy are as follows for 3D: 3D face matching: match level 15-1/125,000,000 FAR, match level 14-1/95,000,000 FAR, match level 13-1/70,00,000 FAR, match level 12-1/50,000,000 FAR, match level 11-1/25,000,000 FAR, match level 10-1/12,800,000 FAR, match level 9-99.99995% (1/2,000,000 FAR), match level 8-99.9999% (1/1,000,000 FAR), match level 7-99.9998% (1/500,000 FAR), match level 6-99.999% (1/100,000 FAR), match level 5-99.99% (1/10,000 FAR), match level 4-99.9% (1/1,000 FAR), match level 3-99.8% (1/500 FAR), match level 2-99.6% (1/250 FAR), match level 1-99% (1/100 FAR), match level 0-non-match and additional match levels up to level 15 are contemplated. In other embodiments, other scales or similarity indicators may be used to allow entities to accurately understand the degree of similarity and thus the likelihood of identity match or person to graphic (UR™) code association.

To provide additional benefits and overcome drawbacks over the prior art, disclosed is a method and apparatus for encoding biometric data derived from two or more face images into a graphic code. As described above, based on one or more digitally stored images or videos of a person's face, biometric data may be generated. This biometric data may be processed into a format that uniquely (with a great degree of exclusion) identifies the person's face, yet cannot be reverse processed to recreate or reveal the person's face. Further, as discussed above, this biometric data can be further encoded into a graphic code (graphic (UR™) code) that can be printed on an identification document (herein document) to associate or link the document with the person. The graphic (UR™) code can be imaged or read with a camera or a scanner, similar to reading a QR code or PDF 417 barcode, such that at a later time, when the document is presented, its authenticity and association with the person can be verified by scanning the graphic (UR™) code and repeating the image capture and processing of the user's face, to generate additional biometric data, and comparing the data derived from the biometric data and data stored in the graphic (UR™) code to determine if there is a high probability that the face data came from the same person.

In many instances, however, a document, account, or item may have more than one person associated therewith. By way of example, to aid in understanding, it is not uncommon for personal or real property to be co-owned. Real estate co-ownership has increased by 771% between 2014 and 2022, which indicates that the already high levels of real estate are increasing. Examples of property ownership by more than one party include tenancy in common, joint ownership, and community property. Numerous other types of property can be co-owned, such as artwork, automobiles, aircraft, boats and ships, intellectual property, and businesses. Typically, these types of property have an ownership document or title associated with them. In other instances, transfer of significant amounts of currency or assets from one account or person to another can occur, often over the phone, online, orby mail. In these situations, confidently identifying the person, or persons, who actually own the property or account is very important.

Unfortunately, these items are subject to fraud due to fraudulent title transfer and co-ownership, which can increase the risk of such fraud by having one person with ownership assist with the fraud at the expense of the other. In other instances, the two people can work together to more successfully perpetrate the fraud.

To overcome these fraud risks and provide greater security for property that is owned or controlled by two or more people, a method and apparatus for generating a graphic (UR™) code that incorporates data collected from two or more faces is disclosed. This type of graphic (UR™) code may be referred to as a 2UR code or multi-face UR code, which should be understood to mean a type of graphic (UR™) code that incorporates data from or represents the face of two or more people. In addition, it is contemplated that the codes, storing biometric data from one or more people, may be collected from portions of the body other than the face, such as any area of the body that can uniquely identify the user with high accuracy.

Combining data derived from the faces of two or more people into a single graphic (2UR) code provides several benefits over the prior art. These benefits are discussed herein.

In the various embodiments described herein, the capture of the face images whose data is encoded into the graphic (UR™) code and the processing of the graphic (UR™) code and additional collection and processing of new facial image data at the time of verification can be performed with the same camera/computing device or with a different camera/computing device.

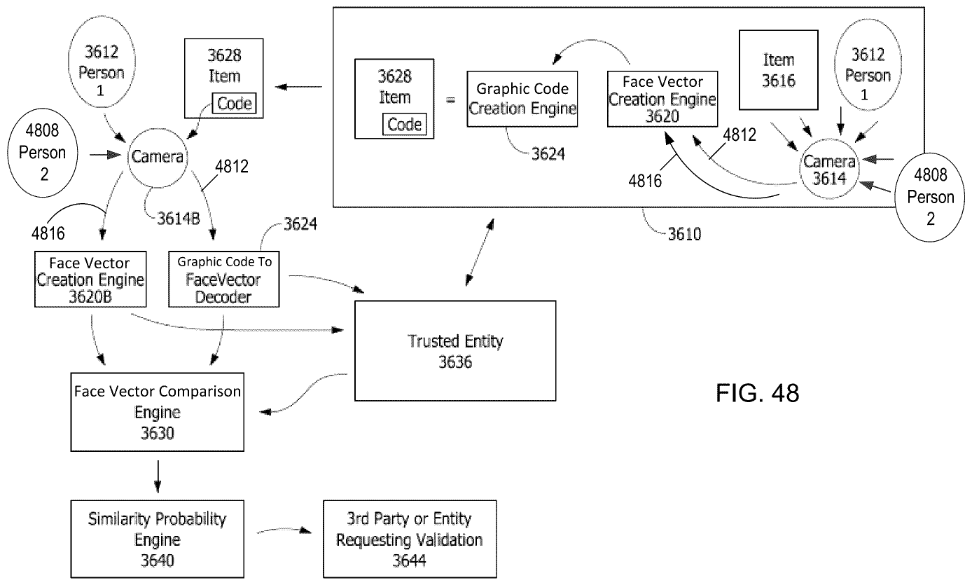

FIG. 48 illustrates a high-level overview of the creation and use of a graphical code that represents two or more people. Although shown with two people due to space limitations, a greater number of people than two may be imaged and their biometric information combined in a graphic (UR™) code. FIG. 48 is similar to FIG. 36C, and as such, the information set forth above for FIG. 36C is incorporated as part of the discussion of FIG. 48. As compared to FIG. 36C, identical or similar elements are identified with identical reference numbers.

In FIG. 48, an additional person, referred to as the second person 4808, is imaged by the camera 3614. Thus, the first person 3612 and the second person 4808 are photographed or videoed by the camera 3614. This can occur separately, such that the first person data 4812 and the second person data 4816 are provided to the face vector creation engine 3620. Liveness analysis, three-dimensional analysis, or both may also occur.

As discussed above, the item 3616 may also be imaged to incorporate one or more items of information of the item into the eventual graphic (UR™) code, such as by OCR analysis, or the user may manually enter the information into the software/application. As discussed above, the graphic (UR™) code creation engine or other processing block or module will also create a signature based on the first person data 4812 and the second person data 4816. This signature will be appended to the data that is encoded into the UR Code during creation of the graphic (UR™) code so that graphic code will be digitally signed and its contents verifiably untampered with.

At the time of verification of people to their 2graphic (UR™) code, both the first person 3612, the second person 4804, or both, can be imaged, and as discussed in connection with FIG. 36C, the resulting first-person data 4812 and the second person data 4816 are processed by the face vector creation engine 3620B for comparison to the face vectors extracted from the graphic (UR™) code. As discussed above, the embedded graphic (UR™) code signature can be compared to a signature created from face vector data of both people that are also within the graphic (UR™) code. In this manner, two or more people's facial data may be used to create a single graphic (UR™) code, thereby linking the two or more people and the document, item, or account with the graphic code. Additional benefits and use examples are provided below to further expand the scope of the innovation and aid in understanding.

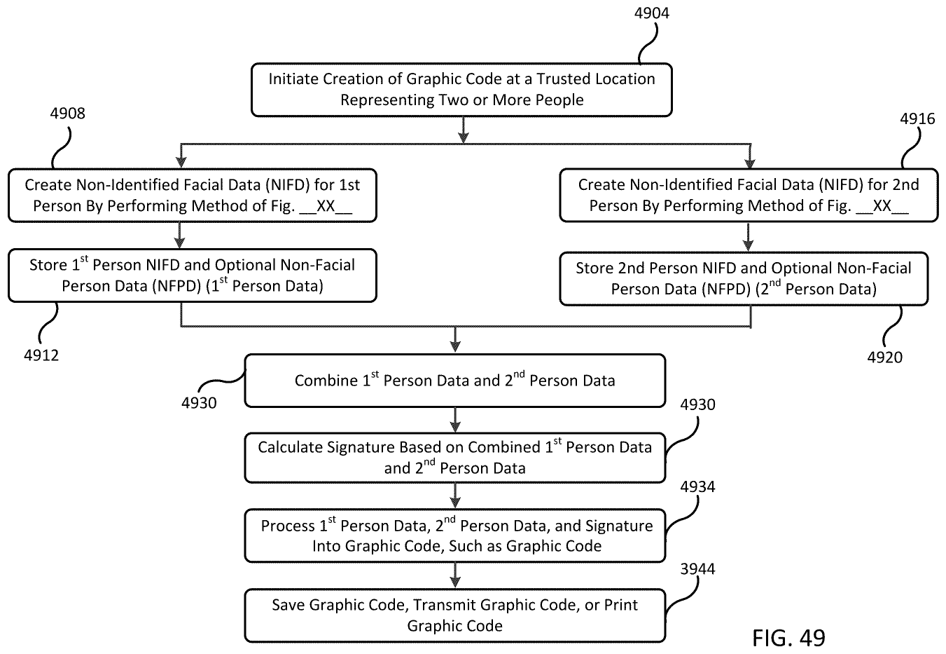

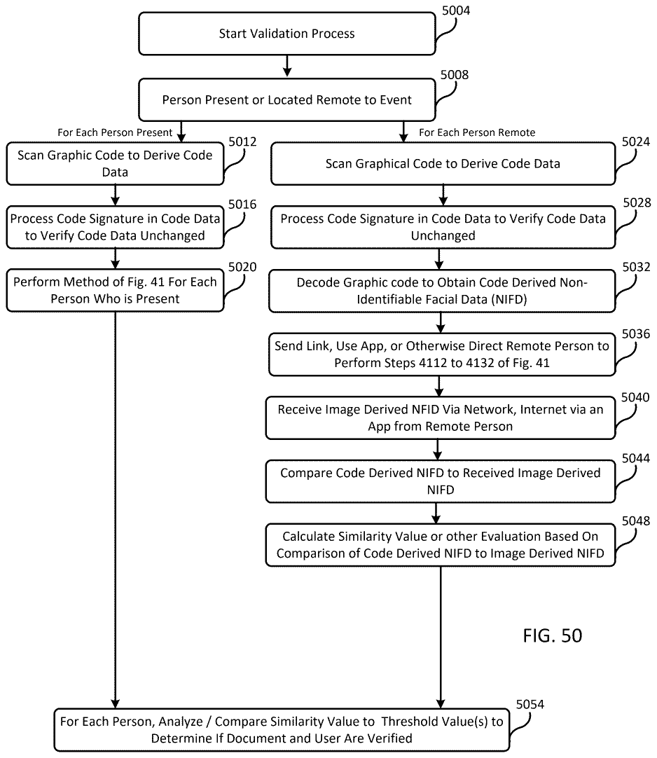

FIG. 49 illustrates an example method of operation for the creation of a graphic (UR™) code based on two or more faces. This is but one possible example method of operation, and as such, other methods may be developed which do not depart from the scope of the claims. At step 4904, the process to create a graphic (UR™) code based on two or more people is initiated. This may be at a trusted location, such as at a DMV, financial institution, school, government office, or trusted business, and in real time or with data collected previously. In other embodiments, the process of collecting the biometric data for each of the people may occur remotely. Next, at steps 4908 and 4916, the operation branches to a processing path for the first person and the second person. In other embodiments, more than two people may be imaged to link their identity into the graphic (UR™) code.

At steps 4908 and 4916, for each person, the non-identifiable facial data (NIFD) is created for the first person and the second person. This may occur based on the method shown and discussed in connection with steps 3912 through 3932 of FIG. 39. The discussion set forth above forthose steps is incorporated herein. Advancing to steps 4912 and 4920, the method stores the first person's NIFD and the optional non-facial personal data (NFPD) for the first person and the second person. This is referred to as first-person data and second-person data. This data may be stored in a memory of the processing system/software. If the two people are not co-located, then one or both of the person's data may be transmitted to a single location for further processing.

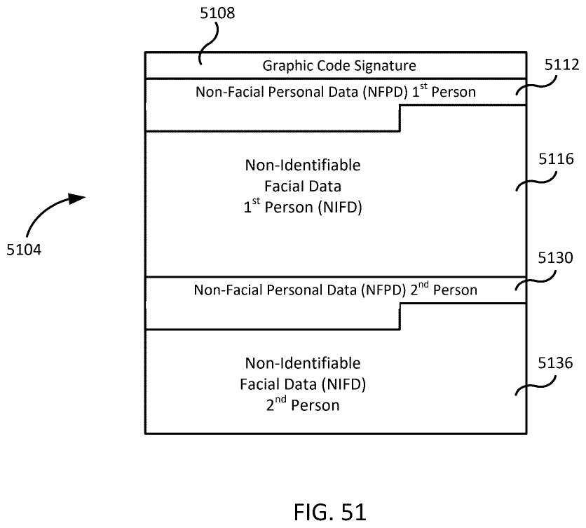

At a step 4930, the first person data and the second person data are stored in the same graphic (2UR) code. Any type of combination of data may occur, such as simply appending the second person data to the first person data. In other embodiments, the data corresponding to each person may be combined and then extracted based on a known arrangement or algorithm. Then, at a step 4934, a digital signature is calculated by processing the data that is going to be encoded into the graphic code. The signature can be recalculated in the future to verify the originality of the data in the graphic code. This is discussed below in greater detail in connection with FIG. 51.

At a step 4938, processing occurs to convert the first person data, the second person data, and the signature into a graphic code, such as a UR™ code, or in the case of two people, a 2UR code or dual-face UR code. In one embodiment, the signature is calculated based on the first person data and the second person data. Numerous methods and algorithms exist for creating a graphical code. In one embodiment, an encoder that is used to create a traditional bar code or QR code may be used to create a graphic code from the data mentioned above. The creation of the actual graphic code from data is generally known in the art, and as such is not described herein. At a step 3944, the graphic code graphic is saved for future use, printed onto a document, or transmitted to a third party for use on their document or in an App or webpage.

FIG. 50 illustrates a flow diagram of an example method of use of the graphic (UR™) code to verify the association of the document to the two or more people from which the graphic (UR™) code was created or otherwise, verify the association of the graphic (UR™) code, independent of the document. This is, but one possible method of operation, and as such, other methods of operation are possible. At a step 5004, the validation process is initiated to validate the graphic (UR™) code and verify the data within the graphic (UR™) code to the people presenting themselves as being associated with the graphic (UR™) code. At a step 5008, a determination is made whether the person is present or if the person is remote. If the person is present, the operation advances to step 5012, and the graphical code (UR™ code) is scanned to derive the code data. In one embodiment, the code data comprises a signature, the NIFD, and the NFPD. At a step 5016, the signature is used to verify that the NIFD and the NFPD, and other data, is the graphic (UR™) code, and has not been changed. Thereafter or concurrently, at step 5020, the operation performs one or more steps of FIG. 41 to which are discussed above and incorporated herein.

If the person is remote, the validation process can still occur. At a step 5024, the graphical code (UR code) is scanned to derive the code data and at step 5016 the signature is used to verify that the NIFD and the NFPD, and other data is the graphic (UR™) code, has not been changed. Then at a step 5032, processing occurs to identify or separate the code derived non-identifiable facial data (NIFD) from the code.

At a step 5036, the system (software/application executing on a processor) sends a link to direct the remote person to perform the steps 4112 through 4232 of FIG. 41 to generate NIFD of the person who is remote. Because the person is remote, the collection of the image and generation of the NIFD data may occur remotely, the image data can be sent to a server or other processing location, such as the location where the validation is occurring. At a step 5040, the image derived NIFD is received back from the remote person, such as from their computing device, and such as over a network or the Internet via an application.

At a step 5044, the validation system that processes the graphic (UR™) code data compares the NIFD derived from the graphic (UR™) code to the received NIFD derived from the remote person. Then, at a step 5048, a similarity value or other evaluation occurs based on the comparison of the two NIFD. Then, at a step 5054, for each person, the method of operation, performed by a software/application executing on a processor, analyzes or compares each similarity value to threshold values or otherwise determines if the people asserting to be associated with or represented by the graphic (UR™) code to be verified.

As discussed herein, the graphic (UR™) code encodes different types of data. FIG. 51 illustrates an example embodiment of a graphic (UR™ 2UR) code. In this embodiment, the encoded data 5104 comprises a graphic (UR™) code signature 5108, non-facial personal data (NFPD) 5112, and the non-identified facial data (NIFD) 5116. The NIFD 5116 comprises the data that is derived from the facial biometric data of the user, but has been processed to prevent reverse processing of the NIFD to re-create the person's face or identity. An example of this type of data is a 3D face vector.

As discussed herein, the NFPD 5112 comprises data that identifies the user by non-facial personal data. This may be extracted from an ID card, such as a driver's license, by OCR. This additional data encoded into or part of the graphic (UR™) code may comprise or represent, but is not limited to, select portions of information regarding the person or the document, such as year of birth, first letter of last name, last letter of first name, 3rd number (or any of the one or more numbers) in the person's social security number, sum of both numbers in day of birth, document information, details or creation date, or other information that adds further details about the person or document, but which does not identify the person. For example, a person cannot be identified, to the exclusion of other people, by only their first letter of their last name, and the last letter of their first name; however, that information does exclude a tremendous number of people to greatly narrow the possible matches that may occur for the face vector. Same with the day number of a person's date of birth. Assuming an even distribution of birthdates over a course of a month, adding this information to the graphic (UR™) code reduces the match possibilities by a factor of about 30. These are non-limiting examples of a person's information that may be incorporated into a graphic (UR™) code, but which does not identify the user, yet does reduce the number of face vectors (people) against which the person's face image could match. For example, there is a greatly reduced number of people whose last name starts with N, and first name starts with T, yet no single person can be identified by that combination. In contrast, the prior art barcode on the back of a driver's license can be read to identify the person's name. The NFPD 5112 may also comprise but is not limited to the following: 3D face vector data, or 2D face vector data that was encoded from a 2D photo, full name (and/or hash), date of birth (and/or hash), biographical information, such as birthplace (or hash), unique number generated at the time of the print function that adds additional, uniqueness to the graphic (UR™) code (or hash), number associated with devices that prints the graphic (UR™) code, digital signature that protects the stored data from being altered, passport no., driver's license no., hashed social security no., or hashes of any unique no. (or hash), date of graphic (UR™) code encoding, expiration date for the ID or the graphic (UR™) code itself. Also shown in the graphic (UR™) code 5104 is the 2nd person NFPD 5130 and the 2nd person NIFD 5136. It is generally a similar type of data as the data for the first person, but corresponds to the second person. Also part of the graphic (UR™) code may be a URL that directs the computing device to a website or server configured to perform the UR processing.

The graphic (UR™) code signature is a signature created by processing the combined group of data, namely the 1st person NFPD 5112, the 1st person NIFD 5116, the 2nd person NFPD 5130, and the 2nd person NIFD 5136 to create a unique value (the graphic (UR™) code signature). The graphic (UR™) code signature 5108 is stored in, such as appended to, the graphic (UR™) code, and at a later date, the portion of the graphic (UR™) code that was used to originally calculate the digital signature is again processed by the same process used to calculate a signature value. The calculated digital signature value is compared to the embedded graphic (UR™) code digital signature 5108 (stored in the graphic (UR™) code) to determine if the signatures match. If the signatures do not match, then some portion of the graphic (UR™) code data (first and second person's data) or the digital signature has been changed or altered as compared to the first and second person's data used to originally created the graphic (UR™) code and from which the embedded graphic (UR™) code signature 5108 was calculated. If the signatures do match, then it is confirmed that the graphic (UR™) code data has not been changed or altered from when it was originally created. Stated another way, the data plus the digital signature is in the graphic (UR™) code, then the public key is used along with that data (data in graphic (UR™) code other than the signature) to calculate the digital signature, and then the recreated digital signature and the imbedded digital signature are compared and if equal then it can be believed that none of the data has been tampered with.

In one embodiment, a public key, private key cryptography system may be used. Using the DMV as an example, the DMV would maintain and keep private a private key to process the graphic (UR™) code data, without the signature, to create the graphic (UR™) code signature 5108, which is appended to the other graphic (UR™) code data prior to it all being encoded into the graphical graphic (UR™) code. The DMV publishes and makes available to others a corresponding public key. When the graphic (UR™) code graphic is created, the graphic (UR™) code signature is embedded in the graphic (UR™) code graphic.

At a later time, a person or entity presented with the graphic (UR™) code graphic can determine whether the graphic (UR™) code graphic and/or the extracted graphic (UR™) code data has been altered, such so as to commit fraud, by processing the graphic (UR™) code data to using the public key to calculate a signature. The calculated signature is compared to the embedded signature in the graphic (UR™) code graphic/data to determine if they match. A match indicates the data from the graphic (UR™) code has not been altered and thus can be trusted. Public/private key processing to create a signature is known in cryptography and, as such, is not discussed in detail herein.

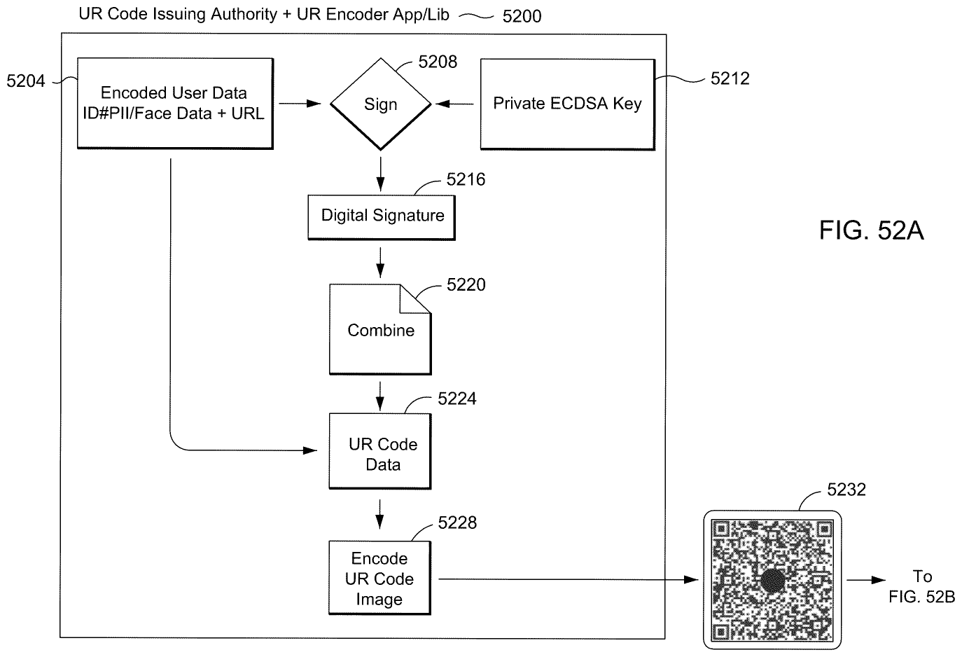

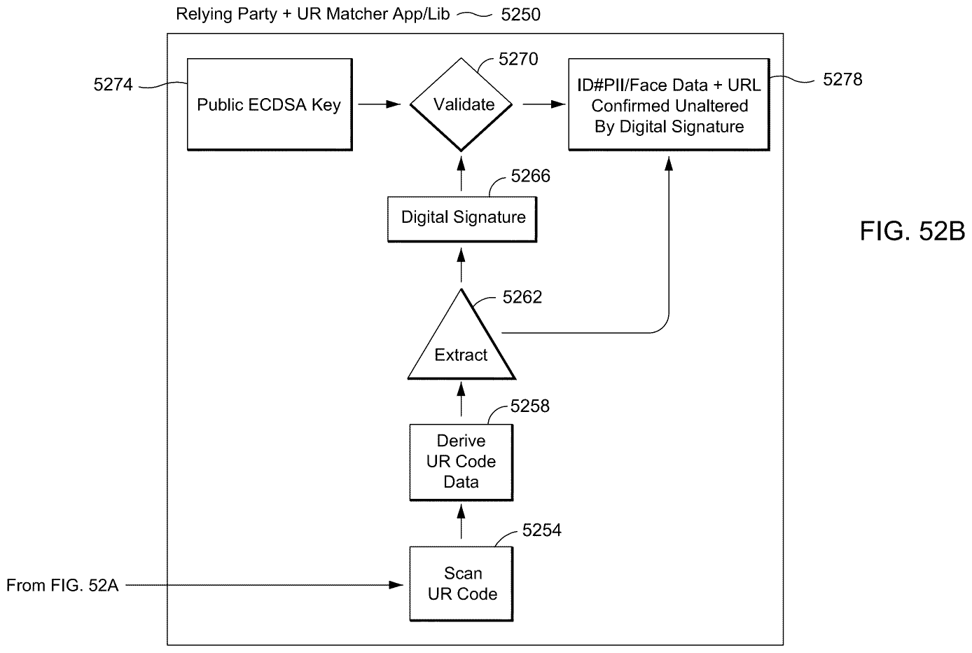

FIG. 52A Illustrates an exemplary block diagram flow chart of an exemplary method of creating a graphic (UR™) code. This is but one possible method of operation and associated processing elements, and as such, there are other possible methods and arrangements of making a graphic (UR™) code. This method of operation would occur at the UR code issuing authority 5200, such as the DMV or other government entity, school, business, hospital, event venue, financial entities (bank, credit companies, lenders, brokerages, etc.), or any other type of entity that creates or issues UR codes. In this embodiment, user encoded data 5204 is processed, using a signing algorithm 5208, that also utilizes a private key 5212 associated with an issuing authority. In some embodiments, the user data 5204 and the private key are processed by the signing algorithm(s) to generate a digital signature 5216.

The purpose of digital signatures is to establish a means to verify and confirm the authenticity of data. In general, a digital signature is a type of electronic signature, stored as data, that is generated from a mathematical algorithm. The resulting digital signature data can be used to validate the authenticity and integrity of data that was used to generate the digital signature. In some embodiments, a hash function may be part of the digital signature creation process. A hash function generates a fixed-length string of numbers and letters (data) generated by a mathematical algorithm based on data, in this case, encoded user data. This generated hash algorithm output is unique to the file being hashed and is a one-way function such that a computed hash cannot be reversed to create other data that may generate the same hash value. Some of the more popular hashing algorithms in use today are Secure Hash Algorithm-1 (SHA-1), the Secure Hashing Algorithm-2 family (SHA-2 and SHA-256), and Message Digest 5(MD5 ).

In some embodiments, the disclosed system and method utilize public-private key cryptography (a type of asymmetric cryptography), which involves two distinct keys, one key is private, and one is public. Public key cryptography (also known as asymmetric encryption) is a cryptographic method that uses a key pair system. One key, called the public key, encrypts the data. The other key, called the private key, decrypts the data. Public key cryptography can be used in several ways to ensure confidentiality, integrity, and authenticity. Public key cryptography can ensure integrity by creating a digital signature of the message using the sender's private key. As discussed above, this can occur by hashing the message and encrypting the hash value with the issuing authority's private key. By doing this, any changes to the data, in this case the UR code data, will result in a different hash value. Other methods of digital signature are possible and contemplated for use with UR codes. This approach may also ensure confidentiality by encrypting the entire message with the recipient's public key.

At step 5220, the digital signature 5216 is combined with the encoded user data 5402 (face data (3D face vectors), Pll). The combination may occur in any manner, such as but not limited to appending the digital signature to a predefined area or location in the encoded user data. The resulting data (with optional additional data) is the UR code data 5224. The content of the encoded user data 5304 can be verified using the appended digital signature.

At a step 5228, the UR code data is processed by an encoder, In some embodiments, the encoder is a QR code encoder that encodes the UR code data into a graphic 5232 that looks like and can be read in the same manner as a QR code. This may be referred to as a machine-readable graphic. In other embodiments, other types of encoders can be used which transform the UR code data into a graphic which is capable of being imaged and decoded by a computing device, such as a smartphone camera and processor executing software.

FIG. 52B is an exemplary block diagram flow chart of an exemplary method of processing a graphic (UR™) code. This is but one possible method of operation and associated processing elements, and as such, there are other possible methods and arrangements of use of the UR code by a relying party. This method of operation would occur at the relying party and the UR matcher application or library. The relying party could be any person, entity, or system that is presented with a graphic (UR™) code to verify a document or item association with the person(s) or to aid in identity or ownership verification.

In this embodiment, at a step 5254, the UR code graphic is presented, typically along with an item, document, or as part of an online process, for scanning or image capture and processing. At step 5258, the UR code data is derived or extracted from the UR code graphic as part of the scanning and processing of the UR code graphic. Then, at a step 5262, an extraction or parsing process occurs whereby the digital signature 5266 is separated from the UR code data, and other person related data is also extracted for the one or more people (face and Pll) encoded into the UR code data. The related data may include one or more of UR code ID number, PII (personal identifying information), face data, and a URL, and this data is used for a comparison at steps 5278 and 5270.

At a validation step 5270, the public key 5274, such as but not limited to an ECDSA (Elliptic Curve Digital Signature Algorithm) key that corresponds to the private key used to create the UR code data, is utilized to validate the digital signature extracted from the UR code. A public ECDSA key is the counterpart to a private ECDSA key, used to verify digital signatures created by the corresponding private key. In some embodiments, the private key is a secret integer used for signing, the public key is typically an elliptic curve point derived from the private key, and is used to confirm the signature's authenticity. At step 5278, the UR code data, not including the digital signature, is confirmed to be unaltered, thereby confirming that the UR code data can be relied upon. In some embodiments, this occurs by a comparison between the digital signature extracted from the UR code data and a re-calculation of the digital signature. Common hashing algorithms used to create the unique digital signature include SHA-256 and SHA-3. The hash algorithm produces a fixed-length string (the hash) that uniquely represents the UR code content. The public key can be used to decrypt the digital signature and/or the entire UR code data. The hash values (digital signature) have to match for the UR code to be considered unaltered. Some embodiments may also include validation of the public key and its associated certificate. This involves checking whether the certificate has expired or been revoked. This step confirms that the public key indeed belongs to the issuing authority and that the certificate or use of the private key is still trustworthy.

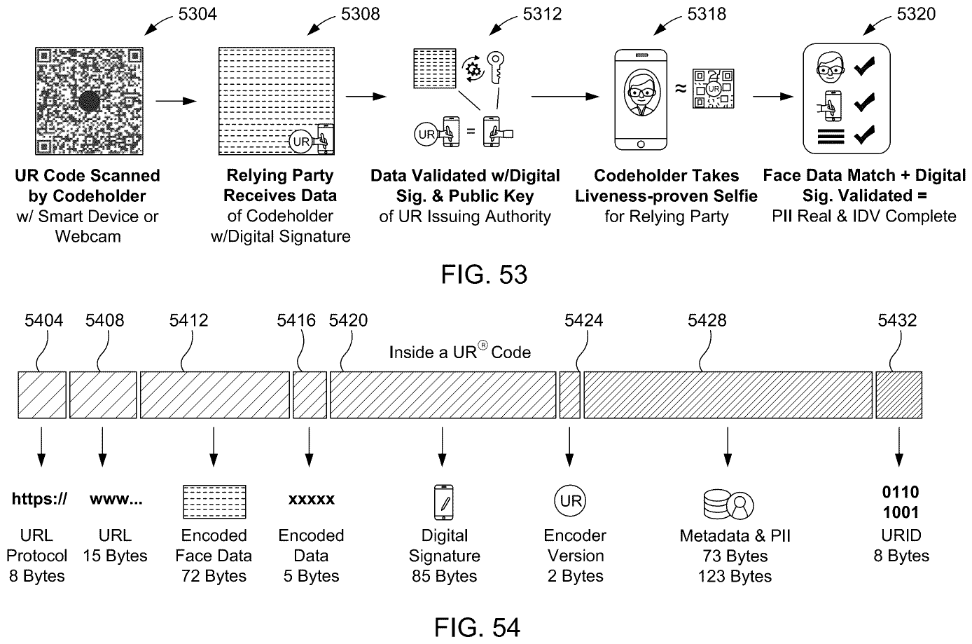

FIG. 53 illustrates an example method of verifying the association of a UR code graphic with a person presenting the code, which is referred to in this embodiment as the codeholder. The codeholder(s) is the person(s) whose facial image data is encoded in the UR code or the person presenting the UR code. This is but one possible embodiment, and as such, other embodiments are contemplated. At a step 5304, the UR code graphic is scanned with a camera (such as a smartphone camera, web cam, kiosk cam, or image scanner). The scanning may occur by the codeholder or a person seeking to validate the UR code. At step 5308, the UR code graphic from step 5304 is converted to UR code data. The UR code data includes the digital signature. The UR code data may be received by a relying party. The relying party is defined as the party or entity that is relying on the processing of the UR code to validate the item bearing the UR code and its association with the person, or for identity verification.

At a step 5312, the UR code data is validated using the digital signature and the public key of the issuing authority that issued (generated) the UR code. Then, at a step 5316, the codeholder takes a selfie-type picture of their face, or another party that is relying on the UR code takes a picture of the codeholder. The captured facial image undergoes processing similar to or the same as that which occurred when the UR code was created based on a facial image. At a step 5320, a comparison occurs between the UR code data created from the just captured facial image and aspects of the UR code data extracted from the UR code graphic. The comparison may comprise a comparison of digital signatures. If the comparison results in a match within certain threshold limits or within a certain percentage, and the digital signature is validated, then the personal identifying information is considered to be accurate, and the IDV (identification verification) is complete. If, in some embodiments, document data is included in the UR code, then the document may be considered to have an association with the UR code as well.

FIG. 54 illustrates exemplary data types that form exemplary UR code data. This is but one example of the data content and arrangement of a UR code data. The byte values provided are for purposes of discussion only, and the embodiments disclosed herein are not limited or bound to these sector bytes sizes. In other embodiments, other data content and arrangements are possible, such as different data types, additional data, coverage for additional document data, additional security data, or any other type of encoded content. In this embodiment, the UR code data includes a URL protocol sector 5404 that specifies how a resource should be accessed and transferred over a network. Different protocols define how data is transmitted between the client (like a web browser) and the server. The next sector comprises a URL sector 5408 that contains the uniform resource locator data, which is commonly known as a web address on the World Wide Web. The web address may be that of an issuing authority server, or another entity's server. The URL directs the application software scanning the UR code graphic to a particular server or other resource on the internet.

Also part of the UR code data is the encoded face data sector 5412. This is discussed above in detail as comprising the data that is generated based on facial image(s) of one or more persons. An encoded data sector 5416 is also provided that includes a date and optional time stamp for UR code creation date or other date-related aspects of the UR code data. Next, a digital signature sector 5420 is provided that represents the digital signature of the UR code. The digital signature 5420 may be a hash function result or other type data that may be used to confirm that the UR code data has not been tampered with or altered. Also provided is an encoder version sector 5424 that stores data that represents which UR code encoder was used to create the UR code data, such as a newer or older version. Different encoder versions may be presented to encode the UR code data in different formats, and as such, a different decoder may be required or preferred so as to decode the UR code data extracted from a UR code graphic.

Also part of this embodiment is metadata and PII (personal identifying data) sector 5428, such as but not limited to name, address, birth date, driver's license number, email address, second person face data, passport number. In some embodiments, no PII may be included. Other data may also be part of the metadata and Pll sector 5428 that is used to interpret or define other data in the UR code data. The final sector, in this embodiment, is the URID sector 5432. The URID comprises an identifier, typically a unique identifier, that is associated with a particular UR code data set. In one embodiment, the URID comprises 8 bytes.

Usage Examples The disclosed innovation, which encodes data derived from facial data of two or more people, has numerous environments of use which will increase security for individuals and documents to prevent fraud. Although described in relation to two or more people represented by the graphic (UR™) code data, the following also applies to graphic (UR™) codes that encode data from a single person.

In one example environment of use, the graphic (UR™) code is used in connection with the sale of an item that has two or more owners. In such a situation, the title to the item being sold would have the graphic (UR™) code printed thereon. The graphic (UR™) code is printed on the title at the time it was issued to the two co-owners who purchased or otherwise obtained title to the item. The item could be any titled item, such as an automobile, airplane, boat, or any other item. In the case of a car, at the time of purchase, the two co-owners of the car could undergo the graphic (UR™) code creation process as described above to have data representing their face encoded in the graphic (UR™) code, as well as other personal data as described above. The graphic (UR™) code would also be signed with a signature value created by processing the data that will eventually be stored in the graphic (UR™) code. The resulting signature would be appended to the data before all of the data is encoded into the graphic (UR™) code graphic. The resulting graphic (UR™) code is printed as a graphic on the title document of the car to contain information about the two owners.

Then, in the future, when the car is to be sold, the sellers may want assurances that the car is owned by the two people and that, in fact, the two people presenting the car for sale are who they assert, which are the owners of the car. To provide those assurances, the graphic (UR™) code on the title of the car is scanned to extract the data from the code. The data will comprise the graphic (UR™) code signature and information regarding each owner.

To verify that the graphic (UR™) code or its internal data has not been altered, the information in the graphic (UR™) code is subject to processing to calculate a signature. The calculated signature is compared to the embedded signature that is within the graphic (UR™) code, and if the two signatures match, then the graphic (UR™) code data has not been tampered with and can be considered reliable. In addition, the calculated signature and embedded signature may also be compared to a signature stored at the issuing authority entity, in this situation the DMV, or the respective issuing authority of the ID, and creating the graphic (UR™) code on the ID.

Next, both co-owners would provide face images, and the resulting data compared to the corresponding data stored in the graphic (UR™) code to determine if the identities of the two people presenting themselves as the owners are, in fact, the owners as defined by the graphic (UR™) code on the title. By verifying a graphic (UR™) code has not been tampered with and verifying that the facial data from the two people asserting to be owners, when processed, highly match the face data stored in the graphic (UR™) code, it follows then that those people are proven, to a high level of confidence, to be the owners. Due to the nature of the data stored in the graphic (UR™) code, the graphic (UR™) code data cannot be used to re-create an image (i.e., facial image) of the owners, norcan it be used to identify the owners without the accompanying personal info. This prevents fraud by preventing two non-owners from forging a title document and trying to sell the car, or using an original title, faking their identification to fraudulently appear as the owners.

Although described in connection with a car, this same process can be applied to any item for sale that has a graphic (UR™) code associated with it to identify ownership. In addition, one or more of the sellers can be located remotely, and their facial data can also be collected remotely. In addition, a driver's license of one or more people can be imaged to further confirm identity.

### Associations Between People

Also disclosed is a method and system to use graphic (UR™) codes to establish an association between people. As one skilled in the art will understand, this has numerous applications. One such application is on a birth certificate document. At the time of birth, the birth certificate is created, and a facial image of each parent (or just one parent) is collected and processed to create NIFD, such as a face vector. Personal information (NFPD) for that parent is also collected, such as name, social security number or a portion thereof, city of birth, eye color, etc. The collected data is processed into a graphic (UR™) code such that the graphic (UR™) code contains the information for both parents, as well as optional additional data such as date and time of birth, city of birth, birth location, . . . Parental data is of public record and the parent names may also be printed on the birth certificate. Once the graphic (UR™) code is printed on the birth certificate document, the parents are linked to that child. Also part of the graphic (UR™) code data may be the relationship between the parties, such as spouses, or parents/child. In some embodiments, the graphic (UR™) code scan and verification may have to occur successfully on each parent of the child before the birth certificate will be issued for the child, thus establishing possession of the child with the parents. The graphic (UR™) code scan for the parents may occur using a graphic (UR™) code equipped driver's license or government ID card.

This provides many advantages. If attempting to prove citizenship, the graphic (UR™) code can be scanned to verify its signature is accurate and has not been tampered with, or the information changed. In addition, parental data may be extracted to link the child to the parent. This can be used to establish parental rights and even used to verify if a person is the true parent or has abducted the child. The birth certificate document and/or the graphic (UR™) code thereon may also be used if the child is to be taken out of the country to avoid trafficking or to require that both parents approve. Immigration control and tracking is another area where parental verification is of utmost importance. There are numerous instances where being able to accurately link or establish the parents of a child is imperative.

Similar benefits can be gained when linking two people on a marriage certificate to establish their identity as a married couple. This can reduce fraud with regard to medical benefits, pension, immigration, at the time of probate, and numerous other situations. By establishing that two people are linked by marriage, and the details of the marriage, in the graphic (UR™) code based on this data, a verifiable record of the marriage and parties can be firmly confirmed, and it further establishes that the identity of each party in the marriage is verifiable.

Financial Account or Transaction Control There are also many situations wherein a financial account is either co-owned, such that two people have control over the account, or a financial transaction requires two authorizations (traditionally signatures). However, an ink signature or a voice approval over the phone is ripe for fraud. In such a situation, the account co-owners or co-holders can have a graphic (UR™) code generated based on their faces, and the graphic (UR™) code (or graphic (UR™) code data) is linked to the account as described herein. This graphic (UR™) code would be generated at the time of account creation, such as at the bank or other financial institution, or when the account is funded.

Then, at the time of use of the account, such as to make a large wire transfer or if the graphic (UR™) code is printed on the check, the graphic (UR™) code can be scanned (or graphic (UR™) code data retrieved for that account), to obtain the NIFD in the graphic (UR™) code for each account holder. Then, as part of obtaining authorization or sign-off from each account holder, each account holder is imaged, and their face image is processed to generate NIFD. Then, the graphic (UR™) code is processed (hashed/public/private key) to calculate a calculated signature, which is compared to the embedded signature as discussed herein. Then, the NIFD stored in the graphic (UR™) code is compared to the NIFD calculated from the captured image of the person to verify that the party attempting to make the wire transfer or transaction is in fact the account holder. A person attempting to make the wire transfer, other than the account holder, cannot make the wire transfer because the data resulting from their face image will not sufficiently match the graphic (UR™) code (data) associated with the account. Note that an exact match is typically not required but the processing may determine a similarity level or value, which may be compared to a threshold. However, the graphic (UR™) code data cannot be used to re-create the account holder's face or determine their identity.

Because more than one person's data can be incorporated into the graphic (UR™), this method and system can be used to link more than one person to the account and establish secure control over the account. In some instances, only one person's authorization is required to transfer money, and thus, the graphic (UR™) code or the account settings could be set up with that logic embedded therein.

### Events Involving Two or More People

In other instances, the two (or more) person graphic (UR™) code can be used to link two or more people involved in an event. In the case of a car accident, both parties to the accident may have their face imaged and personal data collected, along with details about the accident and the car. The resulting data is processed into a signed graphic (UR™) code, which represents the details of the accident and the actual parties involved. This can be used in the future to prevent insurance and medical fraud. In addition, the people in the car may be imaged and the data processed to avoid ‘extra’ people from claiming they were in the car and thus also injured as an attempt to commit insurance fraud. This could be built into an insurance company application or a government-based application. The data and or graphic (UR™) code can be associated with a URL or website address to provide a direct link to the accident details and claim process, but only for the actual parties to the wreck. At a medical treatment setting, the graphic (UR™) code can be part of the verification process to verify that they were in the car prior to receiving medical treatment.

### Graphic (UR™) Code on ID Card

The graphic (UR™) code will also find beneficial use on an ID card, such as a driver's license or, for example, a student ID. In the case of a student ID, the school, which could be a college, high school, middle school, elementary school, or trade school, would be the issuing authority and use its private key to generate a signature from the data to be encoded in the graphic (UR™) code. The public key for the school acting as the issuing authority. The graphic (UR™) code could contain data derived from facial images of the student and one or more parent(s). This links the student to the parent. The graphic (UR™) code on the student ID may include the student's age. The graphic (UR™) code can be verified as corresponding to and identifying the student prior to attending online class, taking a test to avoid test fraud, and to establish age online.

As is understood, age verification is a popular requirement to access certain online websites, and using the graphic (UR™) code in the student ID can be used to establish the age of the student for social media content limitations and for online content access, such as allowing access to only information that is age-appropriate. Youths often do not possess a driver's license or legal ID card, yet need some type of ID that can prove the age and identity of the student. Third party web sites can utilize the public key published by the school to re-process the content of the graphic (UR™) code to verify the calculated signature matches the imbedded signature (within the graphic (UR™) code) to verify that the data in the graphic (UR™) code, and hence the ID information itself is accurate and not edited. As discussed above, these same principles apply to driver's licenses as well.

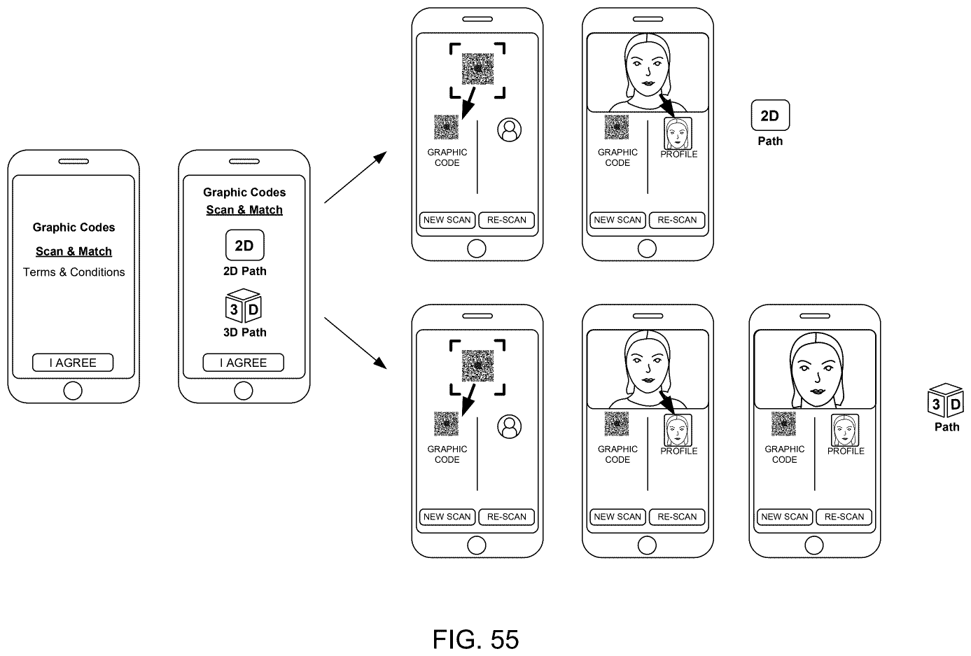

FIG. 55 is an illustration of exemplary user interfaces displayed on a user device, in accordance with some of the disclosed embodiments. As further explained below, such user interfaces may be used as part of a process for determining the likelihood of a graphic code (e.g., graphic (UR™) code) being associated with a person presenting the graphic code.

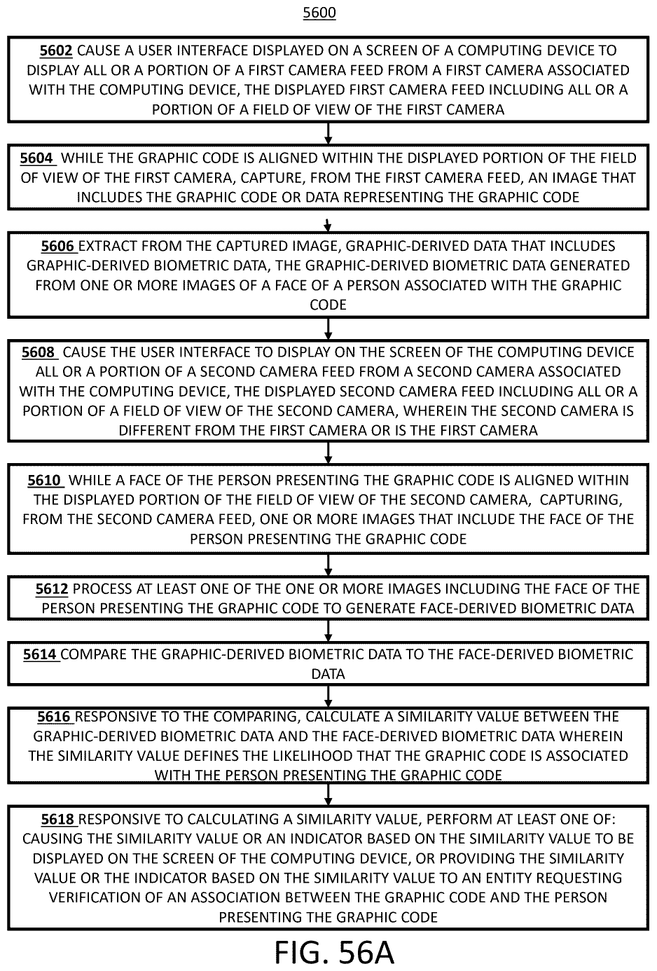

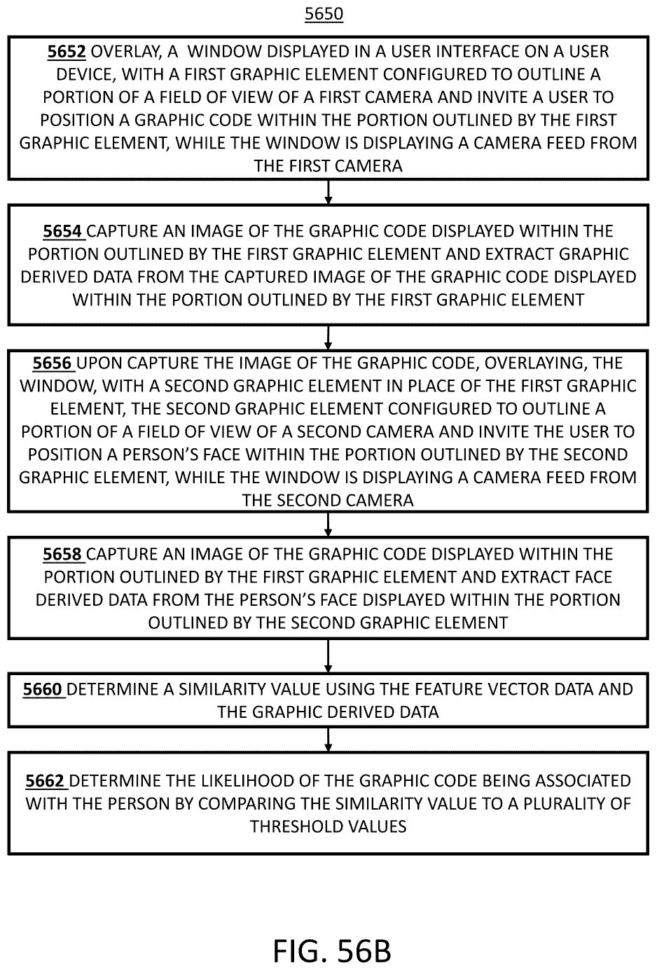

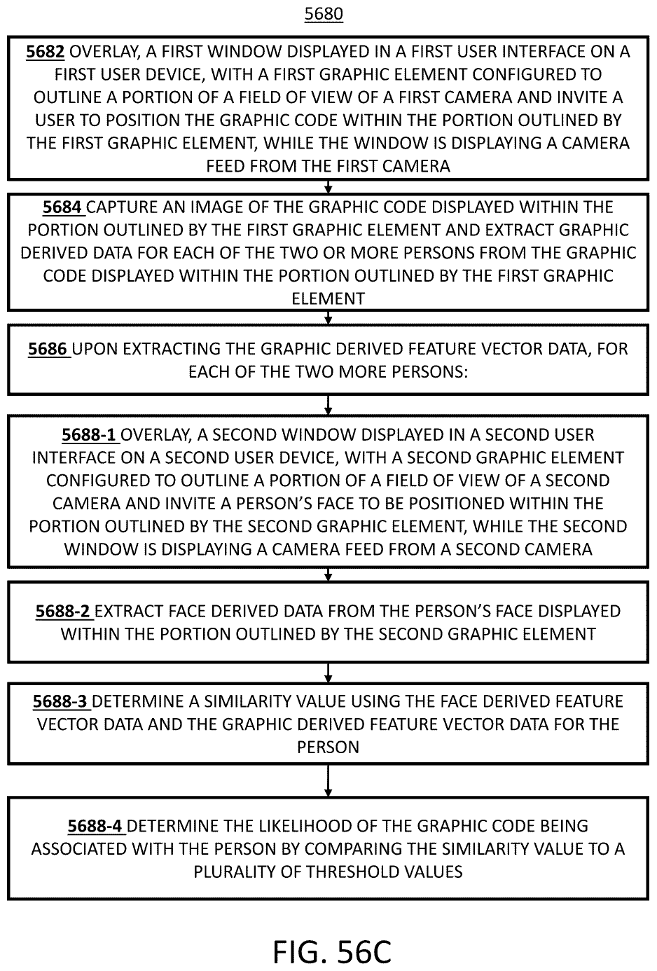

FIG. 56A is a flowchart of an exemplary process 5600 for determining the likelihood of a graphic code (e.g., graphic (UR™) code) being associated with a person presenting the graphic code. Process 5600 is discussed herein for explanatory purposes and is not intended to be limiting. In some embodiments, steps of process 5600 may be changed, modified, substituted, or rearranged, consistent with the present disclosure. Process 5600 may be implemented using one or more components of a user device. For example, mobile device 200 illustrated in FIG. 2 may be used to implement process 5600 using components such as camera 276, display 228, and processor 208. Some disclosed embodiments may include at least one processor that may be configured to execute stored instructions to perform operations for determining the likelihood of a graphic code being associated with a person. As shown in FIG. 56A, process 5600 may include steps 5602, 5604, 5606, 5608, 5610, 5612, 5614, 5616, and 5618 discussed in further detail below. The process and variations may be implemented on any type of computing device, including a user device, computer, smartphone, tablet, ATM (Automated Teller Machine), kiosk, or dedicated purpose-built device.

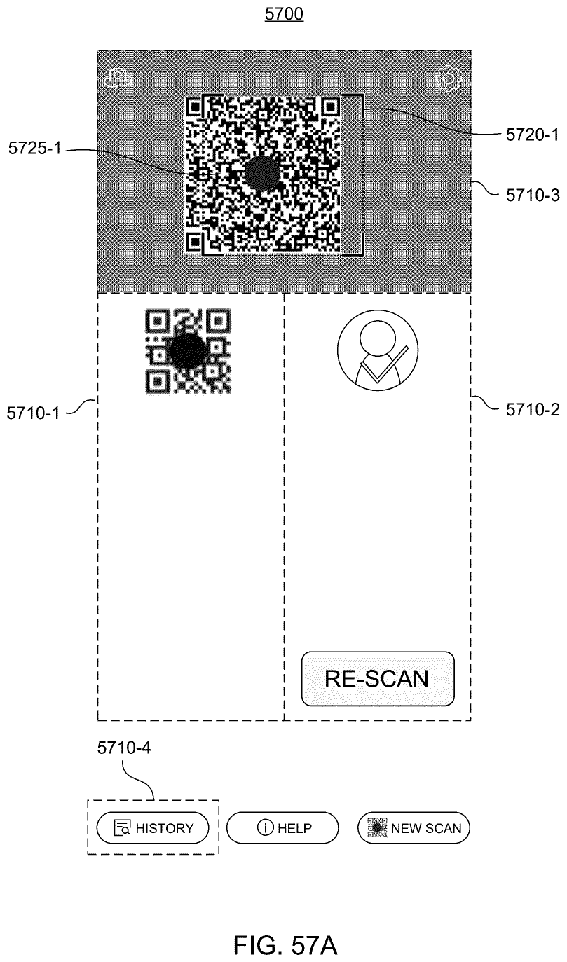

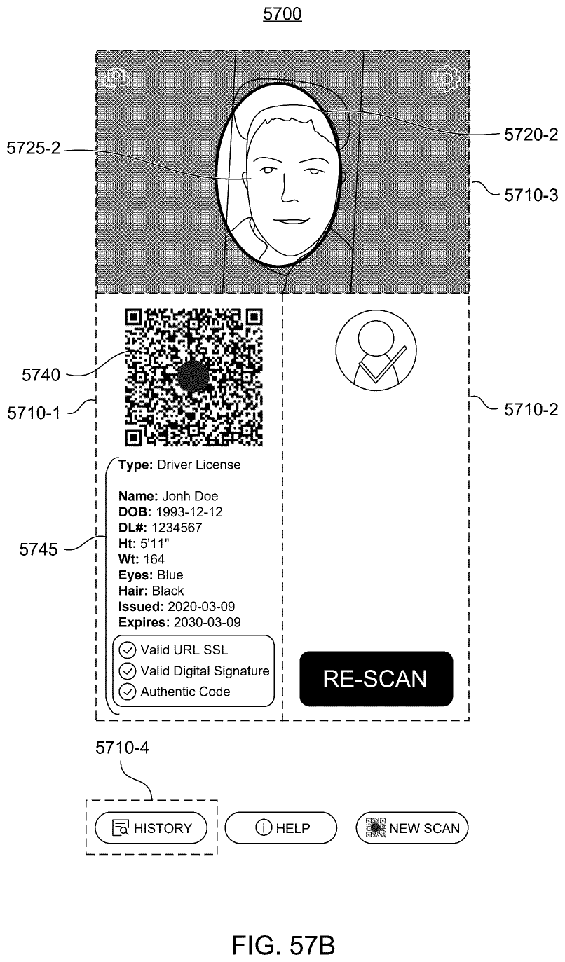

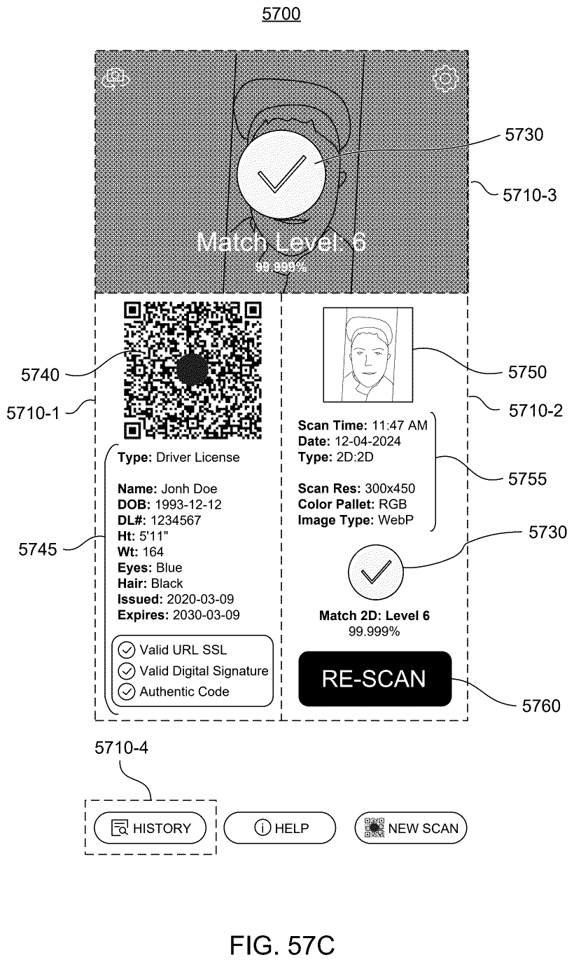

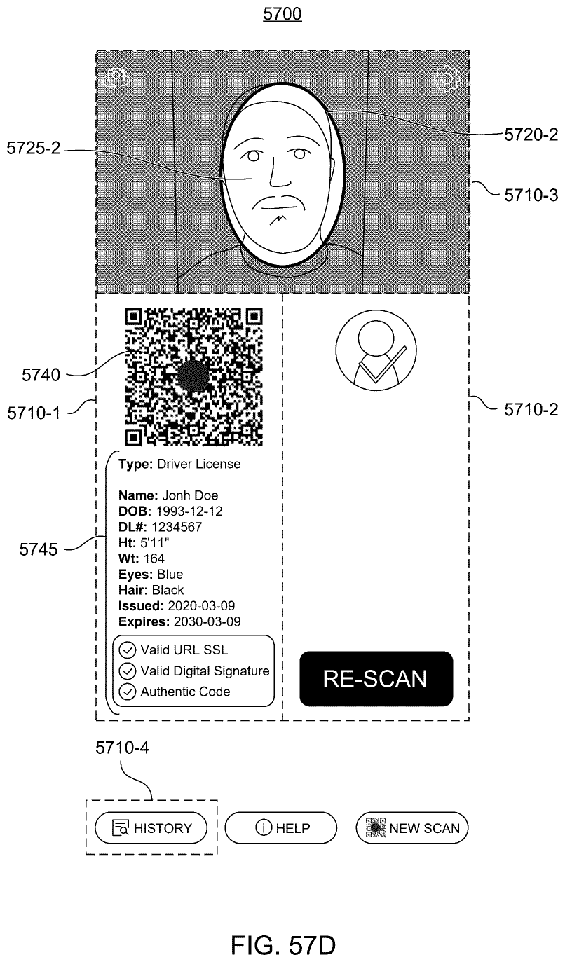

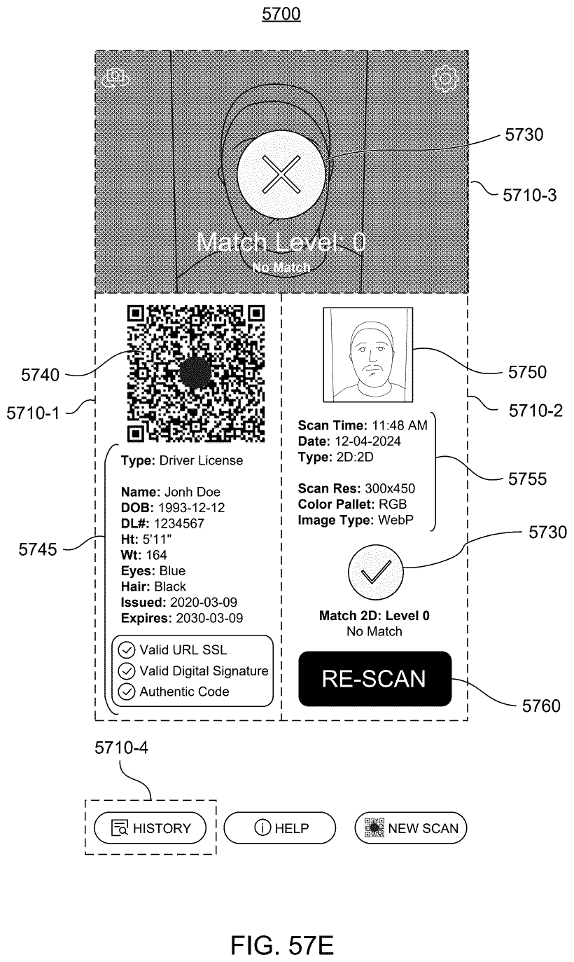

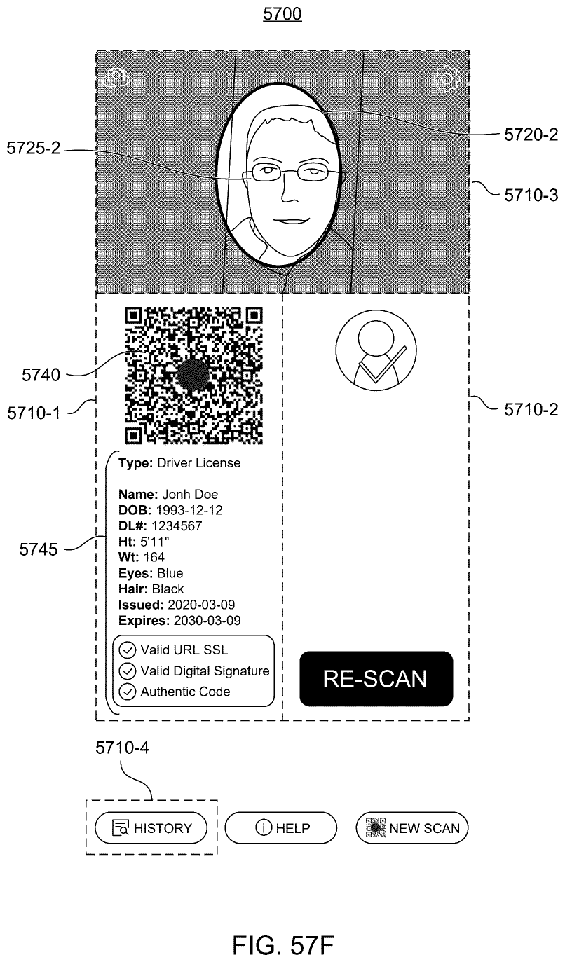

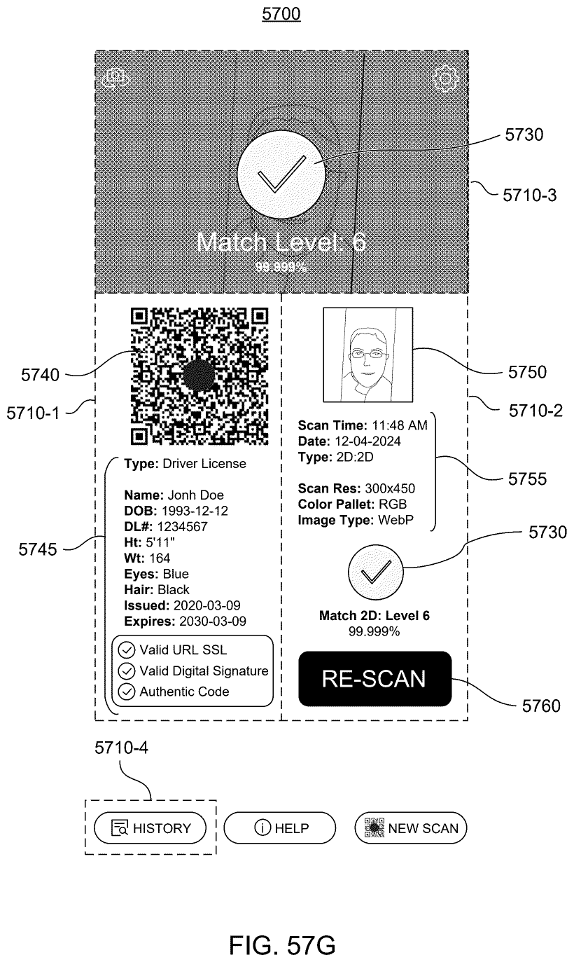

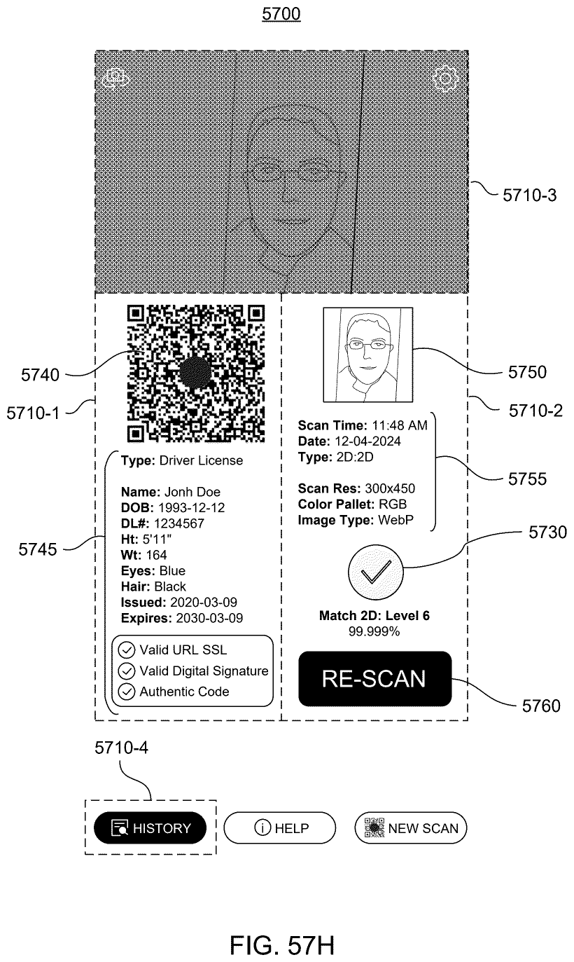

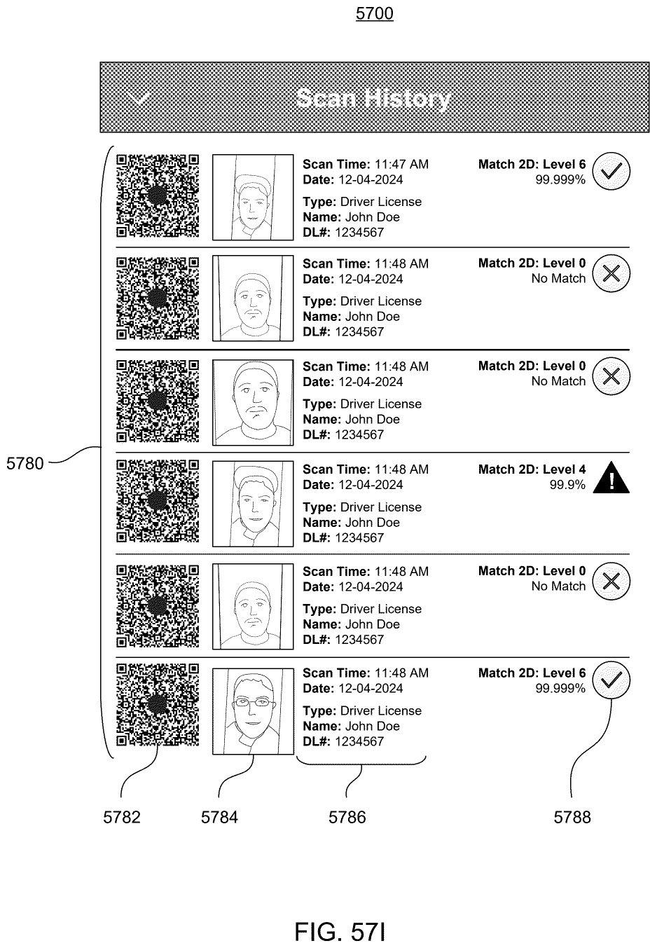

FIG. 56B is a flowchart of an exemplary process 5650 for determining the likelihood of a graphic code (e.g., graphic (UR™) code) being associated with a person. Process 5650 is discussed herein for explanatory purposes and is not intended to be limiting. In some embodiments, steps of process 5650 may be changed, modified, substituted, or rearranged, consistent with the present disclosure. Process 5650 may be implemented using one or more components of a user device. For example, mobile device 200 illustrated in FIG. 2 may be used to implement process 5650 using components such as camera 276, display 228, and processor 208. Some disclosed embodiments may include at least one processor that may be configured to execute stored instructions to perform operations for determining the likelihood of a graphic code being associated with a person. As shown in FIG. 56B, process 5650 may include steps 5652, 5654, 5656, 5658, 5660, and 5662, discussed in further detail below. FIGS. 57A-57I are exemplary illustrations of a user interface displayed on a user device and will be referred to in the following description in relation to process 5600. In some embodiments, process 5650 may be performed in conjunction with, or in addition to, process 5600, such that the two processes may operate sequentially or in parallel to enhance the determination of whether a graphic code is associated with a person. The process and variations may be implemented on any type of computing device, including a user device, computer, smartphone, tablet, ATM (Automated Teller Machine), kiosk, or dedicated purpose built device.

Process 5600 may include, at step 5602, causing a user interface displayed on a screen of a computing device to display all or a portion of a first camera feed from a first camera associated with the computing device. The displayed first camera feed may include all or a portion of a field of view of the first camera.

A user interface refers to a collection of visual, auditory, and interactive elements presented by a computing device that enables a user to interact with an underlying software or hardware functionalities. In this context, the user interface may include graphical elements such as windows, buttons, overlays, and guides that facilitate the alignment of the camera feed and the interaction with the system. The user interface may be responsible for providing feedback, instructions, and visual cues to the user, ensuring that the process of capturing and displaying the camera feed is intuitive and efficient. A screen refers to a physical display component of the computing device, such as an LCD, OLED, or other display technology, which renders the user interface and the camera feed visible to the user. The screen may serve as the primary output medium for visual information, allowing the user to view the live camera feed, interface elements, and any additional data or prompts generated by the system. A “computing device” in this context encompasses any electronic device capable of executing instructions and processing data, which is equipped with at least one screen and one or more cameras. Examples of computing devices include, but are not limited to, smartphones, tablets, laptop computers, desktop computers, kiosks, and specialized hardware such as ATMs or dedicated biometric verification terminals.

The computing device may be responsible for running the software that manages the user interface, processes the camera feed, and performs any necessary computations related to the verification process, As used herein, “all or a portion” refers to at least one portion. For example, all or a portion of a user interface refers to at least one portion of the user interface, such as a specific graphical user interface element. Similarly, all or a portion of a camera feed refers to either the complete camera feed or only a specific area or segment of that feed. Also similarly, all or a portion of a field of view of a camera refers to either the entire field of view of the camera feed or only a specific area of that field of view of the camera. Displaying a specific portion of the camera feed and/or field of view may enable the user interface to adapt to various use cases, such as focusing on a particular region of interest within the camera's field of view or providing a full view when necessary. By configuring the user interface to display all or a portion of the camera feed on the screen of the computing device, the system can enable the user to align the camera with the subject of interest, such as a graphic code or a person's face, thereby facilitating accurate data capture and subsequent processing.

Process 5600 may include, at step 5604, while the graphic code is aligned within the displayed portion of the field of view of the first camera, capturing, from the first camera feed, an image that includes the graphic code or data representing the graphic code. For example, a user may use the user interface to align the graphic code within the portion of or all field of view displayed in the user interface. In some embodiments, the computing device, through its user interface, guides or determines the placement of the graphic code within a specific region of the camera feed or field of view displayed on the screen. Alignment may be achieved through a combination of automated detection algorithms and user interaction. Alignment can also encompass the receipt of explicit user instructions or commands indicating that the code is properly aligned. For instance, the user may press a button, tap the screen, or provide a voice command such as “the code is aligned” to signal to the device that the graphic code is correctly positioned within the camera feed. Alternatively, the device may automatically determine alignment based on real-time analysis of the camera feed, such as detecting that the graphic code is fully within the designated area, is not skewed beyond a certain threshold, and is in focus. Upon determining that alignment has been achieved-either through user input or automated detection the device proceeds to capture an image that includes the graphic code or data representing the graphic code.

In some embodiments, aligning the graphic code within the displayed camera feed may involve overlaying, a window displayed in a user interface on a user device (e.g., a computing device), with a first graphic element (as shown in step 5652, of process 5650 shown in FIG. 56B). The first graphic element may be configured to outline a portion of a field of view of a first camera and invite a user to position the graphic code within the portion outlined by the first graphic element, while the window is displaying a camera feed from the first camera. In the context of a user interface, a window refers to a distinct portion of a user interface. A window may be configured to display content from a specific application or process. A camera field of view (FOV) refers to the extent of the observable world that is seen at any given moment by the camera. The FOV may correspond to the area that the camera lens can capture. The FOV may define how much of the scene in front of the camera is visible. A graphic element refers to a visual component displayed within a user interface that may serve to highlight, demarcate, or outline a specific area of a window. This element may be used to guide user interaction by visually outlining, separating, or emphasizing a particular section of the content, such as a portion of a field of view for a camera feed.

In the context of the present disclosure, the window may show a portion of what the first camera sees, allowing users to interact with or manipulate the content displayed within that defined space. The user may be invited to position the graphic (UR™) code within the first graphic element overlaid on the window. In some embodiments, the first camera may be included in the user device (e.g., mobile device 200) or communicatively coupled with the user device. In some embodiments, the first graphic element may have a square shape. Additionally, or alternatively, in some embodiments, the first graphic element and the graphic (UR™) code may have corresponding shapes. For example, if the graphic (UR™) code has a square or rectangular shape, the first graphic element may have a corresponding square orrectangular shape. Although the exemplary graphic (UR™) codes depicted in FIGS. 57A-57I are square, a graphic (UR™) code may have a different shape, e.g., a diamond, triangle, star, etc. Further, in some embodiments, the graphic (UR™) code may be embedded in a larger graphic code of any shape, where the graphic (UR™) code has discernible points identifying its boundaries, but not necessarily immediately visually apparent to a user.

FIG. 57A represents an illustration of an exemplary user interface 5700, consistent with the disclosed embodiments. In some embodiments, the user interface is on a device other than a user device, such as a device owned by a government entity or private company. The user interface 5700 may be displayed on a display device or screen included in the user device (e.g., display 228) or communicatively coupled with the user device. As shown, user interface 5700 includes different portions, such as graphic (UR™) code information portion 5710-1, face scan and comparison results portion 5710-2, and user options portion 5710-4. User interface 5700 also includes window 5710-3, displayed with an overlaid first graphic element 5720-1 represented by corners of a square, visually indicative of where to position a graphic (UR™) code 5725-1 within the first portion of the field of view of the first camera. The window 5710-3 may be configured to display a portion of a field of view of a first camera (e.g., camera 276). First graphic element 5720-1 and graphic (UR™) code 5725-1 have a corresponding square shape. The remaining area of window 5710-3 may either display another part of the field of view or the entire remaining field of view. In some alternative examples, the rest of window 5710-3 may be configured to display a black screen.

Consistent with the disclosed embodiments, first graphic element 5720-1 may be configured to outline a portion of the field of view of the first camera and invite a user to position graphic (UR™) code 5725-1 within the portion outlined by first element 5720-1, while window 5710-3 is displaying a camera feed from the first camera. The user may position graphic (UR™) code 5725-1 by displacing the first camera or the user device with respect to graphic (UR™) code 5725-1. In some embodiments, the graphic (UR™) code may be located on an item or an object. The item or object may be any one of the following: driver's license, identification card, passport, photograph of the person's face, diploma, education transcript, credit card, debit card, airline ticket, shipping label, event ticket, voting ballot, or title of ownership.

Returning to FIG. 56A, process 5600 may include, at step 5606, extracting. from the captured image, graphic-derived data that includes graphic-derived biometric data, where the graphic-derived biometric data was generated from one or more images of a face of a person associated with the graphic code. For example, such graphic-derived biometric data could have been generated when the graphic code was generated to the person(s) associated with the graphic code. Similarly process 5650, may include at step 5654 capturing an image of the graphic code displayed within the portion outlined by the first graphic element and extracting graphic-derived data from the graphic (UR™) code displayed within the portion outlined by the first graphic element. Referring to FIG. 57A, graphic-derived data may be extracted from graphic (UR™) code 5725-1 displayed within the portion outlined by first graphic element 5720-1. As used herein, graphic-derived data may refer to a numerical representation extracted from the visual pattern of the graphic code (e.g., UR™ code). When the graphic code (UR™) is imaged, scanned, or otherwise processed by the computing device, the encoded data embedded within the visual structure of the code, such as black and white squares or other graphical elements, is decoded and converted into a machine-readable format. In some embodiments, the graphic-derived data may comprise a string of alpha and numeric values. This data may capture different types of information, such as feature vector or face vector data as well as any other data encoded in the graphic as discussed herein. “Graphic-derived biometric data” refers specifically to the portion of the graphic-derived data that represents biometric information generated from one or more images of a face of a person associated with the graphic code. In the context of processes disclosed with reference to FIGS. 56A and 56B, feature vector data, also referred to as face or biometric data represents a set of alphanumerical values that represent the unique characteristics of a person's face. These features might include but are not limited to, distances between key facial landmarks (like eyes, nose, and mouth), angles, and other distinctive attributes. In some embodiments, the graphic derived feature vector data may be generated by encoding two-dimensional (2D) data and/or three-dimensional (3D) data of a person's face. In some embodiments, positioning the graphic (UR™) code entirely within the portion outlined by the first graphic element may enable extraction of the graphic-derived data. For example, positioning the graphic (UR™) code entirely within the portion outlined by the first graphic element may trigger the extraction of the graphic-derived data. In some embodiments, extracting graphic derived data from the graphic (UR™) code positioned within the portion outlined by the first graphic element may comprise capturing an image of the graphic (UR™) code positioned within the portion outlined by the first graphic element, and extracting the graphic derived data from the captured image of the graphic (UR™) code displayed within the portion outlined by the first graphic element. Capturing an image of the graphic (UR™) code may provide a detailed visual record that can be employed for further analysis or use.

In some embodiments, extracting the graphic derived data from the graphic (UR™) code may comprise performing image analysis of the captured image that includes the graphic code or data representing the graphic code and/or of the camera feed from the first camera of the portion outlined by the first graphic element to isolate graphic image data associated with the graphic (UR™) code and processing the isolated graphic image data to extract the graphic derived data. As mentioned earlier, graphic-derived data includes graphic-derived biometric data (e.g., a predetermined biometric template). Image analysis refers to a set of computational techniques used to interpret, process, and extract meaningful Information from visual data captured by a camera. In this context, the analysis may involve identifying and isolating the relevant graphical patterns or structures within the first camera feed that correspond to the graphic (UR™) code. This may include detecting edges, patterns, shapes, or other distinguishing characteristics to separate the desired graphic (UR™) code from the rest of the visual field. Advanced image analysis may utilize algorithms for pattern recognition, computer vision, and machine learning to enhance accuracy and ensure robust extraction of the graphic (UR™) code's image data. Biometric data refers to a digital representation of unique biological traits of an individual, and can be used for identity verification purposes by comparing new face vector data to previously collected, and trusted biometric data. These traits may include features such as facial structure. In this scenario, the graphic-derived feature vector data extracted from the graphic (UR™) code may be associated with a predetermined biometric template, corresponding to a given individual. The biometric template may be derived from the feature vector data through additional processing (quantization, transformation, encryption, etc.) such as to facilitate security and privacy.

Process 5600 may include, at step 5608, causing the user interface to display on the screen of the computing device all or a portion of a second camera feed from a second camera associated with the computing device, where the displayed second camera feed includes all or a portion of a field of view of the second camera. In some embodiments, the second camera is the first camera. That is, the same camera is used in steps 5602 and 5608. In some embodiments, the second camera is different from the first camera. For example, a second camera incorporated into the computing device can be used (e.g., front and back facing cameras of a mobile device) or a camera external to the computing device but in communication with the computing device can be used (e.g., a camera on another mobile device).

Process 5600 may include, at step 5610 that while a face of the person presenting the graphic code is aligned within the displayed portion of the field of view of the second camera, capturing, from the second camera feed, one or more images that include the face of the person presenting the graphic code. For example, a user of the computing device, using the user interface, may position the face of the person presenting the graphic code within the displayed portion of the field of view of the second camera. By a further example, aligning a face may involve a process by which the computing device, through its user interface, guides or determines the placement of the person's face within a specific region of the camera feed shown on the screen. The computing device may use real-time image analysis to detect when the face is properly centered, oriented, and meets the required criteria for image capture. Alignment may be confirmed either automatically by the device, using facial detection algorithms to verify that the face is within the designated area and is in focus, or by receiving explicit user input, such as pressing a button or tapping the screen to indicate that the face is correctly aligned. Once the alignment is confirmed, the device captures one or more images that include the face of the person presenting the graphic code. These images are then used in subsequent steps for biometric data extraction and verification.

In some embodiments, aligning a face of the person presenting the graphic code within the displayed camera feed may involve upon extracting the graphic-derived data, replacing or overlaying, the window, with a second graphic element in place of the first graphic element (as shown in step 5656, of process 5650 shown in FIG. 56B). The second graphic element may be configured to outline a portion of a field of view of the same first camera serving as the second camera or a different camera serving as the second camera and invite the user to position their or a person's face within the portion outlined by the second graphic element, while the window is displaying a camera feed from the second camera. In some embodiments, the person's face may be the user's face, for example, where the user is seeking to determine the likelihood that the graphic (UR™) code is associated with the user. In other embodiments, someone, other than a user of the computing device, may be imaged at step 5610. The second graphic element may have a shape designed to accommodate or resemble the facial structure of a wide range of individuals. For example, in some embodiments, the second graphic element may have an oval shape.

Some disclosed embodiments may involve resizing the second graphic element to invite the user to re-position the person's face within a portion outlined by the resized second graphic element and capturing images with the camera located at two or more different distances from the person by re-positioning the person's face within the portion outlined by the resized graphic element. This may occur with the camera moving, the persons/user moving, or both. The face biometric data, such as feature vector data, may be extracted from the images of the person's face. In other words, this sub-process may involve capturing at least two images of the person's face from slightly different perspectives or focal planes using the second camera. These two images may then be processed to generate 3D data of the person's face. In some embodiments, the face images are processed by analyzing the differences between them, such as disparities in depth and structure. The data from the captured images of the face may be used to create a feature vector data, representing the unique two or three-dimensional characteristics of the person's face. This can be encoded into the graphic or used as part of the comparison to the graphic-derived face data. In some embodiments, the user interface may include elements inviting the user to reposition the person's face within the resized second graphic element and capturing additional images of the person's face, as shown in FIG. 55.

The first and the second camera may be distinct and may have different FOVs. In some embodiments, the device may be a mobile device, the first camera and the second camera may be two different cameras of the mobile device, and the user may be the person. For example, in the situation wherein the user device corresponds to a smartphone, the user may position the graphic (UR™) code within a portion of the FOV of a rear/main camera and position their own face within a portion of the FOV of a front/selfie camera.

Alternatively, in some other embodiments, the first camera and the second camera may be the same camera or only one camera may be utilized. For example, both the first and second cameras may correspond to the rear camera of a smartphone. In such a scenario, overlaying the window with the second graphic element may comprise transforming the first graphic element into the second graphic element without delay. This transformation may occur in one of two ways; it could change quickly, meaning an instantaneous and abrupt change from the first graphic element to the second, or it could involve gradual morphing, where the first graphic element smoothly transitions into the second over a short period. However, regardless of the method used, the transformation may be designed to occur without any perceptible delay, ensuring a seamless user experience. Additionally, in some embodiments, the window may be configured to display uninterrupted feed from the camera.

FIG. 57B represents another illustration of exemplary user interface 5700, consistent with the disclosed embodiments. As Illustrated, a second graphic element 5720-2 (having an oval shape) is overlaid on window 5710-3 in place of first graphic element 5710-1. Consistent with the disclosed embodiments, second graphic element 5720-2 may be configured to outline a portion of the field of view of a second camera (e.g., camera 276 or another camera) and invite a user to position a person's face 5725-2 within the portion outlined by second graphic element 5720-2. The user may position the person's face 5725-2 by moving the second camera or the user device with respect to the person's face 5725-2, or the person can move. In some embodiments, upon extracting the graphic-derived data, process 5600 may further include displaying an image of the graphic (UR™) code on the user interface. For example, as illustratedin FIG. 57B, an image 5740 of graphic (UR™) code 5725-1 is displayed on portion 5710-1 of user interface 5700.

Returning to FIG. 561, process 5600 may include, at step 5612, processing at least one of the one or more images including the face of the person presenting the graphic code to generate face-derived biometric data. This step involves applying computational techniques, such as facial detection, feature extraction, and biometric encoding algorithms, to the image(s) of the person's face. The purpose of this processing is to convert the visual information contained in the image(s) into a digital representation that uniquely characterizes the individual's facial features. In some embodiments, processing at least one of the one or more images of the face of the person presenting the graphic code to generate face-derived biometric data may involve extracting face derived data from the person's face displayed within the portion outlined by the second graphic element (as shown in step 5658 of process 5650 shown in FIG. 56A). Face-derived biometric data refers to a set of numerical values that represent the unique characteristics of a person's face. This data may be obtained through various computational techniques and may be used to create a compact data representation of the face. For example, this data may be extracted through a series of steps: first, one or more images of the face may be captured using the second camera. The image(s) may then be preprocessed to enhance quality and normalize factors like orientation and lighting. In some embodiments, Neural networks, such as but not limited to, convolutional neural networks (CNNs), create face feature vectors by automatically learning abstract, hierarchical features from raw pixel data. In some embodiments, the face-derived biometric data may comprise a string of alpha and numeric values that are encoded in the graphic (UR™) code. In some embodiments, the graphic derived data embedded in the graphic (UR™) code may be generated using two-dimensional (2D) data or three-dimensional (3D) data of the person's face, and the face derived data may be generated using 2D data or 3D data of the face of the person presenting the graphic code (e.g., the person's face positioned within the portion outlined by the second graphic element). In some embodiments, the user interface may include an element that enables the user to select between a 2D data or a 3D data as illustrated in FIG. 55. In some other embodiments, hybrid paths may be used wherein the graphic-derived biometric data may be generated using three-dimensional data and the face-derived biometric data may be generated using two-dimensional data or vice-versa.

In some embodiments, positioning the person's face entirely within the portion outlined by the second graphic element will capture an image that is optimized for the calculation of the face-derived biometric data. For example, positioning the person's face entirely within the portion outlined by the second graphic element may trigger the software to capture an image that is suitable for processing to generate the face-derived biometric data. In some embodiments, extracting face derived biometric data from the person's face displayed within the portion outlined by the second graphic element may comprise capturing an image of the person's face positioned within the portion outlined by the second graphic element and extracting the face derived biometric data from the captured image of the person's face positioned within the portion outlined by the second graphic element. Capturing an image of the person's face may provide a detailed visual record that can be useful for further analysis or use.

In some embodiments, processing at least one of the one or more images of the face of the person presenting the graphic code to generate face-derived biometric data (e.g., extracting the face derived biometric data from the person's face) may comprise collecting 2D or 3D data associated with the person's face, by processing at least one of the one or more images of the face of the person presenting the graphic code (e.g., imaging or scanning the person's face positioned within the portion outlined by the second graphic element), and generating the face biometric vector data from the generated 2D or 3D data associated with the face of the person presenting the graphic code. Collecting 2D data may involve capturing a single image of the person's face, similar to a photograph. In some embodiments, capturing or collecting 3D data of the face of the person presenting the graphic code may be performed based on processing two or more images of the face of the person presenting the graphic code captured at different distance from the first or second camera associated with the computing device. In some embodiments, technologies like structured light scanning (e.g., employing infrared sensors to detect depth) or stereo vision (e.g., using a camera to capture multiple angles) can be used but this options suffer from added cost and complexity. The 2D or 3D data can then be converted into a numerical format, e.g., a feature vector. In some embodiments, processing at least one of the one or more images of the face of the person presenting the graphic code (e.g., extracting the face derived feature vector data) may comprise performing human face detection analysis on the at least one image including the face of the person presenting the graphic code and/or of the camera feed from the second camera displayed within the portion outlined by the second graphic element, to isolate face image data associated with the person's face and processing the isolated face image data to extract the face derived biometric data .. Human face detection analysis refers to a computational technique used to identify and locate human faces within visual data, such as a camera feed of video frames. This process may involve analyzing the image to recognize patterns, shapes, and features characteristic of human faces, such as the arrangement of eyes, nose, mouth, and overall facial contours. Algorithms for face detection may employ methods such as edge detection, color segmentation, or machine learning models trained on large datasets of facial images.

In some embodiments, the user device may be a trusted device. In this context, the face-derived biometric data may be directly generated at the user device itself. This may ensure that the analysis of the person's face is performed locally on the device, without the need to send the face data to an external entity, such as a remote server. By keeping the data processing on the trusted device, privacy and security may be enhanced, as the sensitive face information is not transmitted over potentially insecure networks. Additionally, this local processing negates the need for an Internet connection and may increase the speed and efficiency of the operation, as it eliminates the latency associated with transmitting data to and from a remote server.

In some embodiments, the graphic (UR™) code may comprise additional data encoded therein. For example, in some embodiments, the additional data may comprise one or more of: biographical information or identifying information associated with the person, information associated with a date of creation of the graphic (UR™) code, information associated with an identity of a device that created the graphic (UR™) code, a digital signature associated with information encoded in the graphic (UR™) code, Information associated with an object the graphic (UR™) code is associated with, information associated with an expiration date of the graphic (UR™) code, information associated with a trusted image used to create the graphic (UR™) code. Furthermore, somedisclosedembodiments may involve extracting at least some of the additional data and displaying at least some of the additional data on the user interface. For example, referring to FIG. 57B, additional data 5745 encoded within the graphic (UR™) code 5725-1 are displayed within portion 5710-1 of user interface 5700. Specifically, displayed additional data may include biographical information associated with the person (e.g., name, date of birth, height, weight, eye color, and hair color), information associated with a date of creation (e.g., issuance date) of the graphic (UR™) code, information associated with an identity of a device that created the graphic (UR™) code (e.g., F2143831), information associated with an object the graphic (UR™) code is associated with (e.g., a driver license), and information associated with an expiration date of the graphic (UR™) code.

Returning to FIG. 56A, process 5600 may include, at step 5614, comparing the graphic-derived biometric data to the face-derived biometric data; and at step 5616, responsive to the comparing, calculating a similarity value between the graphic-derived biometric data and the face-derived biometric data. The similarity value defines the likelihood that the graphic code is associated with the person presenting the graphic code. Similarly, process 5650 may include at step 5660, determining a similarity value using the face derived feature vector data and the graphic derived feature vector data. Determining or calculating a similarity value using the face-derived biometric data and the graphic-derived biometric data may involve comparing these two sets of data to assess how closely they match. These datasets may be compared using algorithms to measure their differences and similarities. For example, in some embodiments, determining the similarity value using the face-derived biometric data and the graphic-derived biometric data may comprise using a machine learning algorithm (e.g., via neural network) to compare the face derived feature vector data and the graphic derived feature vector data. Based on this comparison, a similarity value may be calculated, quantifying the degree of correspondence between the two sets of data. A higher similarity value indicates a closer match, suggesting that the facial features and the encoded graphic features represent the same or similar entities. This part of the process may serve verification purposes, ensuring that the person being analyzed matches the data encoded in the graphic (UR™) code, Le., the person for whom the graphic (UR™) code was derived. In some embodiments, the similarity value may be determined offline by the user device. In other words, the determination of the similarity value based on the face-derived biometric data and the graphic-derived biometric data may be performed locally, without the need for an internet connection or external remote server. Offline processing may improve the speed and efficiency of the operation, as it eliminates the need for an Internet connection and the latency associated with data transmission and server response times. This approach may ensure that the user device can quickly and securely verify the similarity between the facial features and the encoded graphic features, even in environments with limited or no internet connectivity.

In some embodiments, calculating the similarity value between the graphic-derived biometric data and the face-derived biometric data may comprise determining that the similarity value is greater than or equal to one of a plurality of threshold values. For example, process 5650 may include, at step 5662, determining the likelihood of the graphic (UR™) code being associated with the person by comparing the similarity value to a plurality of threshold values. These thresholds may represent different levels of confidence or likelihood that the graphic (UR™) code is associated with the person. In some embodiments, determining the likelihood of the graphic (UR™) code being associated with the person may comprise determining that the similarity value is greater than or equal to one of the plurality of threshold values. For example, if the similarity value exceeds a high threshold, it indicates a strong likelihood that the graphic (UR™) code is associated with the person. If the similarity value falls between medium and high thresholds, it suggests a moderate likelihood. If the similarity value is below a lower threshold, it indicates a low likelihood of association. Furthermore, in some embodiments, determining the likelihood of the graphic (UR™) code being associated with the person may comprise generating an indicator of the likelihood of the graphic (UR™) code being associated with the person based on a highest one of the plurality of threshold values, the similarity value is greater than or equal to. For example, if the similarity value exceeds or is equal to a high threshold, a strong likelihood indicator may be generated. By using multiple thresholds, different levels of match may be inferred, providing a more nuanced assessment of the likelihood that the graphic (UR™) code corresponds to the person. This approach may allow for more accurate and reliable verification, accommodating varying degrees of match.

Different levels of match may suit various use cases. For example, verifying the association of a person with a graphic (UR™) code on an event ticket or a shipping label may not require the same stringent level of match as verifying the association of a person with a graphic (UR™) code on a voting ballot or a title of ownership. In the case of event tickets or shipping labels, a moderate level of match might be sufficient to ensure that the ticket or label is being used by the correct individual. However, for voting ballots or titles of ownership, a higher level of match may be necessary to confirm the identity of the person with a high degree of certainty, as these scenarios involve higher stakes.

Returning to FIG. 56A, process 5600 may include, at step 5618, responsive to calculating a similarity value, performing either or both of the following: causing the similarity value or an indicator based on the similarity value to be displayed on the screen of the computing device or providing the similarity value or the indicator based on the similarity value to an entity requesting verification of an association between the graphic code and the person presenting the graphic code. In other words, an indicator reflecting the likelihood of the graphic (UR™) code being associated with the person presenting the code may be provided. This indicator may be provided via a display on the user interface of the computing device as the similarity value itself or as an indicator derived from the similarity value, such as a visual indicator representative of the determined likelihoodof the graphic (UR™) code being associated with the person. Additionally or alternatively, the similarity value and/or its corresponding indicator may be transmitted to an external entity or system that has requested verification of the association between the graphic code and the person presenting it. This may involve securely sending the result electronicallyto a remote server, a relying party, or another authorized stakeholder. Such stakeholders could include financial institutions, government agencies, employers, or service providers who require confirmation of identity or association for purposes such as access control, transaction authorization, regulatory compliance, or audit trails. By enabling both on-device feedback and remote reporting, the system supports a wide range of operational scenarios, from real-time user self-verification to integration with enterprise workflows and third-party verification services, ensuring that the outcome of the biometric comparison is actionable, traceable, and adaptable to diverse application requirements.

Furthermore, some disclosed embodiments may involve displaying, in the user interface, a result of at least one previously determined likelihood of the graphic (UR™) code being associated with the person. FIG. 57C represents yet another illustration of user interface 5700, consistent with the disclosed embodiments, which may be obtained after the completion of process 5600. As shown, a visual indicator 5730, representing the determined likelihood of the graphic (UR™) code being associated with the person, is displayed in both window 5710-3 and portion 5710-2 of user interface 5700. Visual indicator 5730 takes the form of an icon (a check mark) and further includes a match level and a confidence rate regarding the determined likelihood of the graphic (UR™) code being associated with the person. In the scenario presented in FIG. 57C, person's face 5725-2 positioned in the portion outlined by second graphic element 5720-2 corresponds to the person for whom graphic (UR™) code 5725-1 was derived, resulting in a high match level and confidence rate. In contrast, in the scenarios illustrated in FIGS. 57D and 57E, the person for whom graphic (UR™) code 5725-1 was derived does not match the person whose face 5725-2 is positioned in the portion outlined by a second graphic element 5720-2. Consequently, in this scenario, the displayed visual indicator 5730 takes the form of a different icon (a cross) and shows a lower match level and no confidence rate, indicating a weaker, if not null, likelihood of association between the graphic (UR™) code and the person.

Some disclosed embodiments may involve, upon extracting the face-derived feature vector data, displaying an image of the person's face on the user interface. For example, as illustrated in FIGS. 57C and 57E, an image 5750 of the person's face 5725-2 is captured and displayed on portion 5710-2 of user interface 5700. Additionally, or alternatively, some disclosed embodiments may involve displaying in the user interface information related to the person's face displayed within the portion outlined by the second graphic element. Specifically, information related to a captured image of the person's face displayed within the portion outlined by the second graphic element may be displayed. For example, in some embodiments, the information related to the person's face may include at least one of a timestamp or attributes associated with the displayed person's face. Referring to FIGS. 57C and 57E, information 5755 related to captured image 5750 is displayed on portion 5710-2 of user interface 5700, Some disclosed embodiments may involve repeating some or all steps of the method described with reference to FIG. 56A in response to determining that the likelihood of the graphic (UR™) code being associated with the person or the calculated similarity value is below a minimum threshold. This approach is intended to address situations where the initial attempt may have failed due to misalignment, poor image quality, a user error, or other factors that could result in a low confidence match. The method of FIG. 56A may be repeated by acquiring new images of the person's face, a new image of the graphic code, or both.

For example, while the person's face is or remains aligned within the displayed field of view of the second camera, the computing device may capture one or more additional images of the person's face from the second camera feed. These images are then processed to regenerate face-derived biometric data, which is compared to the previously obtained graphic-derived biometric data. Based on this comparison, the system calculates a second similarity value indicative of the likelihood that the graphic (UR™) code is associated with the person. Responsive to calculating the second similarity value, the computing device may cause the second similarity value or an indicator based on the second similarity value to be displayed on the screen of the computing device, and/or provide the second similarity value or the Indicator based on the second similarity value to an entity requesting verification of the association between the graphic code and the person presenting the graphic code. This iterative approach ensures that the verification process achieves a higher confidence level before concluding whether the graphic code is associated with the person.

In another scenario the computing device may respond by overlaying, the window with the first graphic element to invite the user to position the graphic (UR™) code within the portion outline by the first graphic element to initiate another determination of the likelihood of the graphic (UR™) code being associated with the person. This approach is intended to initiate another determination of the likelihood of the graphic (UR™) code being associated with the person. In other words, if the determined likelihood is too low, indicating either a mismatch or an error in the process, the system may invite the user to restart the process.

Some disclosed embodiments may incorporate a digital signature verification process to enhance the integrity and authenticity of the graphic code and its associated data. As mentioned earlier, graphic-derived data refers to the numerical or alphanumerical information extracted from the visual pattern of the graphic code (such as a UR™ code). This data may include biometric templates, feature vectors, or other encoded information used for identity verification. As part of the verification process, the computing device may extract a graphic-derived digital signature from the graphic-derived data. The graphic-derived digital signature refers to a cryptographic value that was generated and embedded within the graphic code at the time of its creation. This signature serves as a unique fingerprint for the data, allowing the system to later verify that the data has not been altered or tampered with. The computing device then processes all or a portion of the current graphic-derived data to independently generate/calculate a digital signature using the same cryptographic method or algorithm that was used to create the original signature. By comparing the extracted graphic-derived digital signature to the newly calculated digital signature, the computing device can determine whether the data has remained unchanged since its original encoding. If the two signatures do not match, this indicates that the graphic code or its underlying data may have been altered, tampered with, or corrupted. In response to a mismatch between the signatures, the computing device may perform one or both of the following actions. The computing device may display a notice on the user interface alerting the user that the graphic-derived digital signature does not match the calculated digital signature. Additionally, or alternatively, the computing device may present a similar notice to an entity requesting verification, which could be any external party, system, or stakeholder-such as a server, organization, or regulatory body-that requires confirmation of the association between the graphic code and the person presenting it. This notification enables the external entity to take appropriate action, such as denying access, flagging the transaction for review, or initiating further investigation.

Some disclosed embodiments may involve repeating steps 5602 through 5618 of process 5600, or steps 5652 through 5662 of process 5650, for at least one other person or one other graphic (UR™) code. For example, if the item including the graphic (UR™) code is a ticket to an event, a user in charge of controllingaccess to the event would use the described process in relationto each person trying to access the event.

It is to be appreciated that the person's face positioned within the portion outlined by the second graphic element may be the one of a real person physically present in the field of view of the second camera, or a person's face represented in a photograph present in the field of view of the second camera. The scenarios illustrated in FIGS. 57B and 57D correspond to situations where a photograph of a person's face is being used. FIG. 57F represents an alternative scenario in which a real person (corresponding to the photograph used in FIG. 57B) is located in front of the second camera. This leads to a similar process of determining the likelihood of the graphic (UR™) code being associated with the person, whether the face is from a live individual or a photograph. In both scenarios, data are processed to verify the match level and confidence rate, ensuring accurate and reliable verification regardless of the source of the facial representation. As shown in FIG. 57G, a similar match level is reached. This indicates that a comparable likelihood of the graphic (UR™) code being associated with the person has been determined, whether the face is from a live individual or a photograph. The process involves analyzing the face positioned within the portion outlined by the second graphic element, extracting the feature vector data, and comparing it to the graphic-derived feature vector data. This approach may ensure reliable verification across different scenarios, whether the face is captured in real-time or from a static image, including where the liveness of the person can be confirmed by other means.

Some disclosed embodiments may involve displaying, in the user interface, history information related to one or more likelihoods of one or more graphic (UR™) codes being associated with corresponding one or more persons. The history information may include one or more images captured of the one or more persons after scanning respective one or more graphic (UR™) codes, Such history information may be displayed in response to receiving a signal indicative of the user interacting with at least a portion of the user interface. For example, referring to FIGS. 57H and 57I, upon interacting with portion 5710-4 of user interface 5700 (greyed out in FIG. 57H), a scanning history interface may be displayed in user interface 5700 (as shown in FIG. 571). This interface may display history informationtaking the form of multiple scanning results 5780, including previously determined likelihoods of the graphic (UR™) code being associated with the person, indicated by visual markers 5788. Additionally, each scanning result 5780 may include a captured image 5782 of graphic (UR™) code 5725-1, a captured image 5784 of person's face 5725-2, and information 5786 containing additional data stored and extracted from graphic (UR™) code 5725-1 and data related to the captured image of person's face 5725-2.

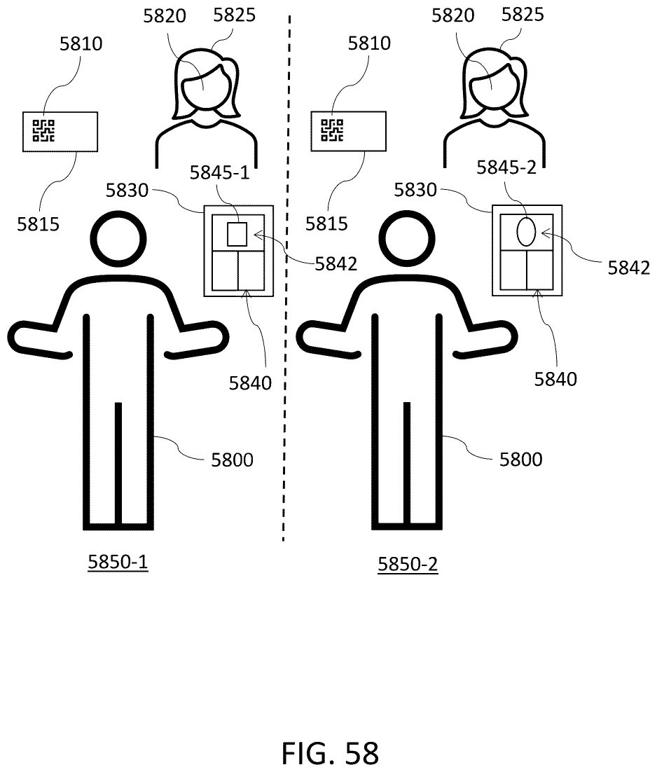

In some embodiments, as described earlier, particularly in connection with FIGS. 48 through 50, a graphic (UR™) code may be generated in association with two or more persons (2UR code). In such a scenario, the verification process may be adapted such that each of the two or more persons linked to the graphic (UR™) code can be authenticated independently and reliably. Accordingly, steps 5608 through 5618, outlined in process 5600, as shown in FIG. 56A or steps 5656 through 5662, outlined in process 5650, as shown in FIG. 58B may be adapted and repeated for each of the two or more persons for whom the graphic (UR™) code has been generated. This repetition may ensure that a separate verification cycle is performed for each individual, thereby maintaining the integrity and security of the association between the graphic (UR™) code and the respective persons.

FIG. 56C is a flowchart of an exemplary process 5680 for determining the likelihood of a graphic code (e.g., UR™) being associated with two or more persons. Process 5680 is discussed herein for explanatory purposes and is not intended to be limiting. In some embodiments, steps of process 5680 may be changed, modified, substituted, or rearranged, consistent with the present disclosure. Process 5680 may be implemented using one or more components of a user device. For example, mobile device 200 illustrated in FIG. 2 may be used to implement process 5680 using components such as camera 276, display 228, and processor 208. Some disclosed embodiments may include at least one processor that may be configured to execute stored instructions to perform operations for determining the likelihood of a graphic (UR™) code being associated with two or more persons.

Process 5680 may include, at step 5682, overlaying, a first window displayed in a first user interface on a first user device, with a first graphic element configured to outline a portion of a field of view of a first camera and invite a user to position the graphic code within the portion outlined by the first graphic element, while the first window is displaying a camera feed from the first camera. Step 5682 is similar to step 5652, as for process 5650, the details concerning this step with respect to FIG. 56C are identical to those previously described with respect to FIG. 56B and will not be repeated herein. Similarly, all other embodiments and variations previously discussed concerning process 5600 or 5650 or steps similar to those of process 5600 or 5650 remain applicable and are not repeated in this section.

As mentioned earlier, once a portion of the graphic code is positioned within the first graphic element, a data extraction process may occur, which may optionally include capturing an image before extracting the relevant data. In some embodiments, upon extracting data from the graphic code displayed within the portion outlined by the first graphic element, a determination is made regarding whether the graphic (UR™) code is associated with one person or with multiple persons. The user interface may then be dynamically updated to reflect this determination. For example, if only one person is associated with the graphic (UR™) code, the user interface may present the flow as illustrated in FIGS. 57A to 57I, guiding the user for a single person verification process (e.g., by following steps 5604 through 5612 of process 5600 shown in FIG. 56A). If multiple persons are associated with the graphic (UR™) code, the interface may instead invite the user a multi-person flow as further outlined below with respect to FIG. 56C and process 5680.

Process 5680 may include, at step 5684, extracting graphic graphic-derived feature vector data for each of the two or more persons from the graphic code displayed within the portion outlined by the first graphic element. While this step is similar to step 5604 of process 5600, the difference is that, in this present scenario, the graphic code may encode biometric and other data for two or more persons, rather than just one. As a result, the extraction process retrieves a corresponding set of graphic derived feature vector data, one for each person associated with the code. For example, in applications where a document or item, such as a title or certificate, is intended to be verifiably linked to multiple individuals, such as co-owners or co-signers, graphic graphic-derived feature vector data should be extracted for each of the individuals. As previously mentioned, the data for each person may be combined within the graphic code according to a predetermined arrangement or algorithm, and the extraction process may follow this established method, to separate and retrieve the feature vector data for each individual.

Process 5680 may include, at step 5686, upon extracting the graphic derived feature vector data, for each of the two or more persons: overlaying (step 5688-1), a second window displayed in a second user interface on a second user device, with a second graphic element configured to outline a portion of a field of view of a second camera and invite a person's face to be positioned within the portion outlined by the second graphic element, while the second window is displaying a camera feed from a second camera; extracting (5688-2) face derived feature vector data from the person's face displayed within the portion outlined by the second graphic element; determining (5688-3) a similarity value using the face derived feature vector data and the graphic derived feature vector data for the person; and (5688-4) determining the likelihood of the graphic code being associated with the person by comparing the similarity value to a plurality of threshold values. Steps 5686 and 5688-1 through 5686-4, performed for each of the two or more individuals are identical to steps 5606 through 5612 of process 5600 in the context of a single person verification process; the specifics of these steps will not be repeated herein. Stated another way, the process described earlier in the context of a single person may be repeated for each person, ensuring that the necessary biometric data for all persons associated with the graphic (UR™) code are captured, and that the degree of similarity between the live-captured facial data and the stored data for every individual associated with the graphic (UR™) code are independently assessed. The resulting similarity values may provide a quantitative measure of how likely it is that each person's biometric data corresponds to the data originally encoded in the graphic (UR™) code, thereby supporting robust and individualized verification for multiple persons within the same process.

In some embodiments, the second user device used for each of the two or more individuals may be dedicated to a specific person, meaning that each of the two or more persons'faces may be scanned using a separate device. This approach may enable the verification process for multiple people to occur in parallel, streamlining the overall multi-person verification workflow. For example, in an airport setting where a travel document contains a graphic code associated with several individuals, each person could have their face scanned simultaneously by an independent camera or device. Notably, one of these second user devices may also be the same device (first user device) originally used to scan the graphic code. In such scenarios, the various user devices, including the first user device used to scan the graphic code and the secondary devices used for facial capture may need to communicate with each other to coordinate and complete the multi-person verification process efficiently. Even when different user devices are involved, the user experience may remain consistent by presenting a similar interface across all devices. For instance, the same type of graphic element can be used on each device's display to guide the correct positioning of each person's face within the designated area.

Alternatively, in some embodiments, the second user device is common to each of the two or more persons, meaning that a single second user device may be used for all of the individuals involved in the verification process. In this scenario, the same device is used to sequentially extract face-derived feature vector data for each of the two or more persons. Notably, this single device may also be the same device originally used to scan the graphic code, effectively serving both as the initial and the secondary device for the entire verification workflow. In this approach, each person may take their turn in front of the camera, with the device guiding the process for each individual in sequence. The term “sequentially” in this context may encompass two distinct scenarios, depending on the implementation. In one scenario, the extraction process may be performed in bulk. In other words, the faces of all relevant persons are first captured. Once all faces have been captured, extraction of the face-derived feature vector data for each of the two or more persons from the captured images may occur. This approach may allow for the processing of multiple faces in a single batch, which can be efficient in situations where all individuals are present and ready for verification at the same time. Alternatively, the extraction process may be performed in a live or real-time manner. In this case, each time a new person positions their face within the portion outlined by the second graphic element, extraction of the face-derived feature vector data for that person may be performed before proceeding to the next person. This live extraction mode may be useful in dynamic environments, where individuals may present themselves for verification one after another, rather than all at once. Regardless of whether the extraction is performed in bulk or live, two or more face derived feature vector data are obtained, with each of the two or more face derived feature vector data corresponding to one of the two or more persons whose faces have been captured and processed. This may ensure that the biometric data for all relevant individuals is accurately and efficiently collected, supporting robust multi-person verification.

Additionally, the camera used to capture the face of each person may be the same or may differ between individuals. For example, in the context of a smartphone being used for the verification process, the first person may be the user of the smartphone, in which case the front-facing camera may be utilized to extract the face-derived feature vector data of the first person. The second person may be someone different from the user, and in this scenario, the rear-facing camera of the smartphone may be employed to extract the face-derived feature vector data of the second person or an entirely different device. This flexibility allows the system to accommodate various practical situations, ensuring that the verification process remains robust and user-friendly regardless of the number of persons or the specific camera configuration used.

In some embodiments, process 5680 may further include determining the likelihood that the graphic code is associated with the two or more persons based on the determined likelihood of the graphic code being associated with each of the two or more persons. After the likelihood of association between the graphic code and each individual has been established (by comparing their respective face-derived and graphic-derived feature vector data) and possibly other data in the graphic code, an overall likelihoodthat the graphic code is associated with the two or more persons may be determined. Such an approach may involve aggregating the individual results to reach a final determination. This aggregation may involve applying a logical rule, such as requiring that all individuals meet or exceed a certain similarity threshold, or it may use a weighted or statistical approach to combine the individual likelihoods into a single confidence score. By synthesizing the individual verification outcomes, the graphic code may be robustly and reliably linked to all intended persons, thereby supporting secure multi-person identity verification scenarios. However, such an overall likelihood may not be required in every scenario. For example, in the case of a graphic code that contains the face biometric data of two business partners that own the business, wire transfers require verification of the identity of either person for amounts under $50,000, but require both partners to be verified for wire transfers over $50,000.

In some embodiments, the graphic (UR™) code includes graphic (UR™) code rules or logic rules that the issuing authority may implement in the graphic (UR™) code. This is particularly useful for graphic (UR™) codes that represent more than one person. For example, for child pick-up from the school, only one parent needs to be present, but to take the child out of the country requires both parents to be present and authorize the travel via a graphic (UR™) code scan. Other rules or logic rules may be established within the graphic (UR™) code. In another example, for wire transfers less than $200,000 only one business owner needs to be validated with the graphic (UR™) code validation process, but for wire transfers over $200,000 then both business owners are required to be validated.

It is to be appreciated that any of the embodiments disclosed earlier in the context of a graphic (UR™) code associated with a single person remain equally valid and applicable in the above-described scenario where a graphic (UR™) code is associated with two or more persons. The principles, processes, and technical features described for single-person verification can be readily extended to accommodate multiple individuals. Conversely, a graphic code designed for multi-person association may also function effectively when used for just a single individual. Similarly, the logic can be applied by the software scanning application (Scan+Match) by not providing a match level until both faces are scanned, or by the agent controlling the scanning application, who could decide if both people have to be scanned successfully, or just one, based on their rules.

FIG. 58 illustrates stages 5850-1 and 5850-2 encountered by a user 5800, using a user device 5830 to determine the likelihood of a graphic (UR™) code 5810 being associated with a person 5825, such as when process 5600 or process 5650 is executed. The graphic code 5810 may be printed on, embedded in, or otherwise visible on an object or item 5815. The object 5815 may be an identification document of the person 5825, such as a passport or a driver's license, or any other items or documents.

The user device 5830 is a computing device and may be a mobile device such as a smartphone or a tablet equipped with at least one processor, a display, and one or more cameras. Alternatively, the device 5830 may be a stationary computer with an external camera, kiosk, purpose-built device, tablet, or ATM. Other types of computing devices may be used if they have at least one camera (internal or external) and a display. In some embodiments, the user device 5830 may run a dedicated application for determining the likelihood of a graphic (UR™) code being associated with a person.

In some embodiments, the user 5800 interacts with the user device 5830 through the user interface 5840 provided by a software application executing on the user device 5830. In the first stage 5850-1 (depicted on the left), the user interface 5840 on the user device 5830 invites the user 5800 to position graphic (UR™) code 5810 within the field of view of a first camera. For example, user interface 5840 may overlay a first graphic element 5845-1 on the window 5842 in user interface 5840 displayed on user device 5830. The first graphic element 5845-1 may be configured to outline a portion of the first camera's field of view and guide the user 5800 to position the graphic code 5810 within the portion outlined by the first graphic element 5845-1. In some embodiments, the first graphic element 5845-1 has a shape similar to the shape of the graphic code 5810 (for example, square-shaped as shown in FIG. 58) to encourage the user 5800 to align graphic (UR™) code 5810 with the portion outlined by first graphic element 5845-1.

Once the user 5800 positions the graphic (UR™) code 5810 within the portion outlined by the first graphic element 5845-1, thereby allowing extraction of graphic derived feature vector data from the graphic (UR™) code 5810 (as for example described with reference to process 5600) or capture of an image of the graphic (UR™) code 5810 (as for example described with reference to process 5650), the user interface 5840 moves the user 5800 to the second stage 5850-2 (depicted on the right).

In second stage 5850-2, user 5800 is invited to position face 5820 of a person 5825 within the field of view of a second camera (or the first camera). The user interface 5840 may switch to replace or overlay a second graphic element 5845-2 in place of the first graphic element 5845-1 on the window 5842 of the user interface 5830 displayed on the user device 5830, thereby replacing the first graphic element 5845-1 with second graphic element 5845-2. The second graphic element 5845-2 may be configured to outline a portion of the second camera's field of view and the guide user 5800 to position the person's face within the portion outlined by second graphic element 5845-2. In some embodiments, the second graphic element 5845-2 has a shape similar to a shape of the facial structure of a wide range of individuals (for example, oval-shaped as shown in FIG. 58) to encourage the user 5800 to align the face 5820 of the person 5825 with the portion outlined by the second graphic element 5845-2.

The transition between the first stage 5850-1 and the second stage 5850-2, i.e., the switch between first graphic element 5845-1 and second graphic element 5845-2, may occur after graphic-derived data, which includes feature vector, has been extracted from the graphic (UR™) code 5810 positioned in the portion outline by the first graphic element 5835-1 as per the process 5600 (shown in FIG. 56A) or after an image of the graphic (UR™) code 5810 has been captured as per the process 5650 (shown in FIG. 56B).

The user interface 5840 may include a window 5842 on which the first the graphic element 5845-1 and the second graphic element 5845-2 are overlaid. In some embodiments, the window 5842 is configured to depict a greater portion of field of view of the first camera and/or second camera than the one outline by the first graphic element 5845-1 or the secondgraphic element 5845-2, encompassing the portion of field of view outlined by the first graphic element 5845-1 at stage 5850-1 and the second graphic element 5845-2 at stage 5850-2. In some example embodiments, the user interface 5830 is configured to provide for visual contrast between how a portion of the camera's field of view is outlined by the first graphic element 5845-1 and the second graphic element 5845-2 in relation to the window 5842. This approach allows the user 5800 to see a greater portion of the current camera's field of view while the user 5800 is guided to focus on positioning the graphic (UR™) code 5810 or the face 5820 within the first or second graphic element 5845-1 or 5845-2, respectively. For example, the first graphic element 5845-1 and second graphic element 5845-2 may outline a portion with a higher brightness than the rest of window 5842, or window 5842 may have a partially opaque mask imposed thereon, except for the portion outlined by first graphic element 5845-1 and second graphic element 5845-2. In some embodiments, window 5842 may reflect the entire field of view of the first camera and/or second camera, In some embodiments, the same camera can be used for both stages. For example, in the scenario of FIG. 58, the user 5800 may use the same rear camera of a smartphone in both the first stage 5850-1 and the second stage 5850-2. In some embodiments, different cameras can be used at the first 5850-1 and second stage 5850-2. For example, in a scenario where the user 5800 uses the device 5830 to validate their own document 5815 using graphic (UR™) code 5810, the user 5800 may use a rear camera of a smartphone during first stage 5850-1 and a front camera of the smartphone during second stage 5850-2 (e.g., a selfie mode).

In addition, it should be understood that the methods of operation and various steps described herein can be combined in any combination or permutation. For example, the user can use their own device to scan the graphic and image their own face, or their device to scan the graphic and the face of another person. Similarly, a combination of different devices, owned or controlled by different entities, can be used to scan (capture and image) the graphic and the face of a person presenting graphic code. Capturing images of the face and the graphic code may occur in any order.

It is also contemplated and disclosed that the graphic code and the person(s) being imaged may or may not be at the same location. If at different locations, the graphic code may be imaged or scanned, and a link or invite may be sent electronically to the person at a different location so that they may use their device to capture one or more images of themselves, which are processed and the resulting data transmitted to the location where the graphic was scanned or to a server at another location for the comparison.

Further permutations are contemplated as discussed herein, where in addition to or instead of the person(s) face being imaged, an image of the person on a document (passport, driver's license, or ID document) is imaged to verify that the image on the document matches the biometric data stored in the graphic code using the process described above. This provides another or alternative layer of security. In some or all of the embodiments described herein, part of the processing that occurs in connection with the comparison of the biometric data from the graphic code and the biometric data derived from the captured image of the user is a verification of the digital signature contained within or associated with the graphic code, This would occur in connection with the method and apparatus of the embodiments shown in FIGS. 55-58.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

Various terms used in the specification and claims may be defined or summarized differently when discussed in connection with differing disclosed embodiments. It is to be understood that the definitions, summaries, and explanations of terminology in each instance apply to all instances, even when not repeated, unless the transitive definition, explanation, or summary would result in inoperability of an embodiment. Unless otherwise defined, all technical and scientific terms used herein have the same meaning as commonly understood by one of ordinary skill in the art. The materials, methods, and examples provided herein are illustrative only and not intended to be limiting.

Moreover, while illustrative embodiments have been described herein, the scope of any and all embodiments having equivalent elements, modifications, omissions, combinations (e.g., of aspects across various embodiments), adaptations, and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specifications and examples be considered as illustrative only, with a true scope and spirit being indicated by the following claims and their full scope of equivalents.

What is claimed is:

1. A method for determining a likelihood of a graphic code being associated with a person presenting the graphic code, the method comprising:
causing a user interface displayed on a screen of a computing device to display all or a portion of a first camera feed from a first camera associated with the computing device, the displayed first camera feed including all or a portion of a field of view of the first camera;
while the graphic code is aligned within the displayed portion of the field of view of the first camera, capturing, from the first camera feed, an image that includes the graphic code or data representing the graphic code;
extracting, from the captured image, graphic-derived data that includes graphic-derived biometric data, the graphic-derived biometric data generated from one or more images of a face of a person associated with the graphic code;
causing the user interface to display on the screen of the computing device all or a portion of a second camera feed from a second camera associated with the computing device, the displayed second camera feed including all or a portion of a field of view of the second camera, wherein the second camera is different from the first camera or is the first camera;
while a face of the person presenting the graphic code is aligned within the displayed portion of the field of view of the second camera, capturing, from the second camera feed, one or more images that include the face of the person presenting the graphic code;
processing at least one of the one or more images including the face of the person presenting the graphic code to generate face-derived biometric data;
comparing the graphic-derived biometric data to the face-derived biometric data;
responsive to the comparing, calculating a similarity value between the graphic-derived biometric data and the face-derived biometric data, wherein the similarity value defines a likelihood that the graphic code is associated with the person presenting the graphic code; and
responsive to the calculating of the similarity value, performing at least one of:
causing the similarity value or an indicator based on the similarity value to be displayed on the screen of the computing device, or
providing the similarity value or the indicator based on the similarity value to an entity requesting verification of an association between the graphic code and the person presenting the graphic code.

2. The method of claim 1, wherein the processing the at least one image to generate the face-derived biometric data comprises:
performing human face detection analysis on the at least one image including the face of the person presenting the graphic code to isolate face image data associated with the face of the person presenting the graphic code; and; and
processing the isolated face image data to extract the face-derived biometric data.

3. The method of claim 1, wherein the extracting the graphic-derived data comprises:
performing image analysis of the captured image that includes the graphic code or data representing the graphic code to isolate graphic image data associated with the graphic code; and
processing the isolated graphic image data to extract the graphic-derived data.

4. The method of claim 1, wherein calculating the similarity value between the graphic-derived biometric data and the face-derived biometric data comprises:
using a machine learning algorithm to compare the graphic-derived biometric data and the face-derived biometric data.

5. The method of claim 1, wherein calculating the similarity value between the graphic-derived biometric data and the face-derived biometric data comprises:
determining that the similarity value is greater than or equal to one of a plurality of threshold values, wherein the indicator based on the similarity value is based on a highest one of the plurality of threshold values the similarity value is greater than or equal to.

6. The method of claim 1, further comprising: causing the user interface to display on the screen of the computing device information related to the face of the person presenting the graphic code.

7. The method of claim 1, wherein the graphic code comprises additional data encoded therein, the additional data comprising one or more of: biographical information associated with the person associated with the graphic code, information associated with a date of creation of the graphic code, information associated with an identity of a device that created the graphic code, a digital signature associated with information encoded in the graphic code, information associated with an object the graphic code is associated with, information associated with an expiration date of the graphic code, information associated with a trusted image used to create the graphic code.

8. The method of claim 1, further comprising:
extracting a graphic-derived digital signature from the graphic-derived data, the graphic-derived digital signature stored in the graphic code;
processing all or a portion of the graphic-derived data to calculate a digital signature;
comparing the graphic-derived digital signature to the calculated digital signature;
responsive to the graphic-derived digital signature not matching the calculated digital signature, performing at least one of the following:
causing the user interface to display on the screen of the computing device that the graphic-derived digital signature did not match the calculated digital signature, or
providing a notice that the graphic-derived digital signature did not match the calculated digital signature to the entity requesting verification of the association between the graphic code and the person presenting the graphic code.

9. The method of claim 1, wherein the processing the at least one image of the face of the person presenting the graphic code comprises capturing 3D data of the face of the person presenting the graphic code based on processing two or more images of the face of the person presenting the graphic code captured at different distances from the second camera, wherein the face-derived data is extracted using the captured 3D data of the person's face.

10. The method of claim 1, wherein the graphic-derived biometric data embedded in the graphic code is generated using two-dimensional (2D) data or three-dimensional (3D) data of the face of the person associated with the graphic code, and the face-derived biometric data is generated using 2D data or 3D data of the face of the person presenting the graphic code.

11. The method of claim 1, wherein the processing the at least one image including the face of the person presenting the graphic code to generate the face-derived biometric data, comprises:
collecting 2D or 3D data associated with the face of the person presenting the graphic code, by processing the at least one image including the face of the person presenting the graphic code, and
generating the face-derived biometric data from the collected 2D or 3D data associated with the face of the person presenting the graphic code.

12. The method of claim 1, further comprising:
causing the user interface to display on the screen of the computing device, a result of at least one previously calculated similarity value of the graphic code being associated with the person presenting the graphic code.

13. The method of claim 1, wherein:
the first camera and the second camera are the same camera.

14. The method of claim 1, further comprising: in response to the calculated similarity value being below a minimum threshold,
while the face of the person presenting the graphic code is aligned within the displayed portion of the field of view of the second camera, capturing, from the second camera feed, another one or more images that include the face of the person presenting the graphic code;
processing at least one of the other one or more images including the face of the person presenting the graphic code to re-generate the face-derived biometric data;
comparing the graphic-derived biometric data to the re-generated face-derived biometric data;
responsive to the comparing of the graphic-derived biometric data to the re-generated face-derived biometric data, calculating a second similarity value between the graphic-derived biometric data and the re-generated face-derived biometric data; and
responsive to calculating the second similarity value, performing at least one of:
causing the second similarity value or an indicator based on the second similarity value to be displayed on the screen of the computing device, or
providing the second similarity value or the indicator based on the second similarity value to the entity requesting verification of the association between the graphic code and the person presenting the graphic code.

15. The method of claim 1, further comprising:
repeating the steps of claim 1 for at least one other person or one other graphic code.

16. The method of claim 1, further comprising: displaying, in the user interface, history information related to one or more likelihoods of one or more graphic codes being associated with corresponding one or more persons, the history information including one or more images captured of the one or more persons after scanning respective one or more graphic codes.

17. The method of claim 1, wherein the similarity value is calculated offline by the computing device.

18. The method of claim 1, wherein the computing device is a trusted device, and the face-derived biometric data is generated at the computing device.

19. A system for determining a likelihood of a graphic code being associated with a person presenting the graphic code, the system comprising:
a display for displaying a user interface on a user device; and
a processor configured to cause the system to:
cause a user interface displayed on a screen of a computing device to display all or a portion of a first camera feed from a first camera associated with the computing device, the displayed first camera feed including all or a portion of a field of view of the first camera;
while the graphic code is aligned within the displayed portion of the field of view of the first camera, capture, from the first camera feed, an image that includes the graphic code or data representing the graphic code;
extract, from the captured image, graphic-derived data that includes graphic-derived biometric data, the graphic-derived biometric data generated from one or more images of a face of a person associated with the graphic code;
cause the user interface to display on the screen of the computing device all or a portion of a second camera feed from a second camera associated with the computing device, the displayed second camera feed including all or a portion of a field of view of the second camera, wherein the second camera is different from the first camera or is the first camera;
while a face of the person presenting the graphic code is aligned within the displayed portion of the field of view of the second camera, capture, from the second camera feed, one or more images that include the face of the person presenting the graphic code;
process at least one of the one or more images including the face of the person presenting the graphic code to generate face-derived biometric data;
compare the graphic-derived biometric data to the face-derived biometric data;
responsive to the comparing, calculate a similarity value between the graphic-derived biometric data and the face-derived biometric data, wherein the similarity value defines a likelihood that the graphic code is associated with the person presenting the graphic code; and
responsive to the calculating of the similarity value, perform at least one of:
cause the similarity value or an indicator based on the similarity value to be displayed on the screen of the computing device, or
provide the similarity value or the indicator based on the similarity value to an entity requesting verification of an association between the graphic code and the person presenting the graphic code.

20. A non-transitory computer-readable medium storing instructions which, when executed by at least one processor, cause the at least one processor to perform a method for determining a likelihood of a graphic code being associated with a person presenting the graphic code, the method comprising:
causing a user interface displayed on a screen of a computing device to display all or a portion of a first camera feed from a first camera associated with the computing device, the displayed first camera feed including all or a portion of a field of view of the first camera,
while the graphic code is aligned within the displayed portion of the field of view of the first camera, capturing, from the first camera feed, an image that includes the graphic code or data representing the graphic code;
extracting, from the captured image, graphic-derived data that includes graphic-derived biometric data, the graphic-derived biometric data generated from one or more images of a face of a person associated with the graphic code;
causing the user interface to display on the screen of the computing device all or a portion of a second camera feed from a second camera associated with the computing device, the displayed second camera feed including all or a portion of a field of view of the second camera, wherein the second camera is different from the first camera or is the first camera;
while a face of the person presenting the graphic code is aligned within the displayed portion of the field of view of the second camera, capturing, from the second camera feed, one or more images that include the face of the person presenting the graphic code;
processing at least one of the one or more images including the face of the person presenting the graphic code to generate face-derived biometric data;
comparing the graphic-derived biometric data to the face-derived biometric data;
responsive to the comparing, calculating a similarity value between the graphic-derived biometric data and the face-derived biometric data, wherein the similarity value defines a likelihood that the graphic code is associated with the person presenting the graphic code; and
responsive to the calculating of the similarity value, performing at least one of:
causing the similarity value or an indicator based on the similarity value to be displayed on the screen of the computing device, or
providing the similarity value or the indicator based on the similarity value to an entity requesting verification of an association between the graphic code and the person presenting the graphic code.
